(19) United States
(12) Patent Application Publication
(10) Pub. No.: US 2003/0154182 A1
(43) Pub. Date: Aug. 14, 2003

(54) Content generation optimizer

(76) Inventor: William Sekulovski, Ravenna, OH (US)

Correspondence Address: BROUSE MCDOWELL, 500 First National Tower, 106 S. Main Street, Akron, OH, 44308-1471, US

(21) Appl. No.: 10/325,987

(22) Filed: Dec. 20, 2002

Related U.S. Application Data
(60) Provisional application No. 60/343,108, filed on Dec. 21, 2001.

(51) Int. Cl. G06F 7/00

(52) U.S. Cl. 707/1

(57) ABSTRACT

An e-commerce search directory provides an easy and quick way for associated users to find e-commerce sites. The e-commerce search directory provides a search area, a content area and sign up area. The directory always presents data in a way that optimally displays chosen company characteristics within the criteria of the content area. Listings are presented in four (4) equal columns on the display screen. Data is presented and integrated with search criteria allowing for quick and easy retrieval of presented data, which allows data to continuously be changed.

This application claims priority to U.S. Provisional Serial No. 60/343,108, entitled CONTENT GENERATION OPTIMIZER, filed Dec. 21, 2001.

### BACKGROUND OF THE INVENTION

A. Field of Invention

General Concept

This program is devised to automatically optimize the orderly integration and presentation of a database of ratings and related graphics (in this case—an e-commerce directory with a database of company name listings and related graphics [barmer/logo ads] of various sizes) to fit on a limited screen size, anal continue on successive web p˜gea of same size,

The presentation of these listings will be related to various search criteria (in this ease—a directory of company names or a directory of main/sub/and-categories).

The process will be dynamic, i.e. as new companies (a@ertiaers) sign up, their data incl. company name, size of listing and related graphic ad, will be spontaneously and automatically updated and integrated into the preexisting database. The on screen presentation is also reconfigured to the show the optimal integration of the revised data.

B. Description of the Related Art

### SUMMARY OF THE INVENTION

Basic Description

Seek. Zoom is an e-commerce search directory that allows viewers to find desired e-commerce sites easily and quickly. It has a novel way of displaying the contents of the search query in a highly compact and orderly format with s high integration of listings and related graphic ads, a differentiating option for each advertiser, as well as dynamic reconfiguration.

It has three main sections; the search areas (which is a permanent left sided bar containing the “category” or “name” search choices), the content area (which permanently occupies the right˜A side of the screen and lists the results of the search according to the Content Generation Optimizer, as described below)˜and the sign-up page (which allows companies to choose the desired advertisement criteria to be presented in the content area)

The Search Area (Left Yellow Frame Area)

The visitor will first need to choose between a “Category” or a “Name˜search by clicking the appropriate button cn left aide bar.

a) If a “Category” search is chosen:

a Java applet opens disclosing a listing of the main categories (in alphabetic order)

when each main category is clicked, one or more levels of sub- (child-) categories opens until an end-category appears

if this end-category is clicked then the larger right side of the page presents the content of the exact page where that end-category and it's listings start.

(see printed pages 1 and 2)

If a “Name” search is chosen:

a Java applet opens with a listing of all the company names (in alphabetic Listing order)

when the desired company is clicked, s sub-listing of all the end-categories in which this company is located in will appear below' it

when the desired end-category, that the viewer wishes to find the company in, is clicked, fire right side of the page presents the content of the exact page where that end-category and it's listings (incl. the desired company) starts.

(see printed pages 3 thru 7)

The Content Area (Right Side of Page)

Displays the end-categories (in alphabetic order), with the subordinate company names (in alphabetic order) for each end-category, in order from top to bottom in 4 vertical columns, starting from left to right, and extending to the next page(s), if necessary, and on a limited screen size.

Also, advertisement graphics (banner/logo) ads, associated with the respective eoml˜any, are placed as close as possible to the company name listing, within the limited web-page size and within the esthetic confines of the 4 columns. If the ad cannot be placed on the same page as the company name listing then it will he placed on the closest following page permitting it's placement. In such cases the company name listing will have a small “ad” icon at the end of it's name allowing the viewer to jump to the company's graphic ad on another page once it is clicked.

The viewer may go forward or backward to any other page on the content area. Once the viewer clicks on either a company name or a company ad they will be taken to that company's website.

The Sign-up (Advertisement) Page (Left Red Frame Button)

Companies can choose to advertise on SeekZoom by choosing varying characteristics;

1) the company‘: name” listing (incl. size, boldness and color of listing)

2) the main-, sub- and end-category

3) the size of their graphic (banner/logo) ad (if any)

4) the type of charge for their graphic listing (if graphics were chosen)

(see printed pages 8 thru 12)

This data is automatically incorporated into the preexisting database, and, when the content area reappears, it will reconfigure itself in such a way that the company name and ad listing will be automatically and optimally integrated into the presentation, conforming with the above stated criteria and limitations. This adjustment occurs dynamically with each database alteration. Thus, regardless of the amount and variability in company data, Seekzoom will always present the data in a way that optimally displays the chosen company characteristics within the criteria of the content area (as described above).

Also in this section there is a button for existing subscribers to review, update and alter their data, as well as info on how a merchant may use SeekZoom as an Affiliate advertiser as well.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIGS. 1-232 are screen shots from applicant's web site.

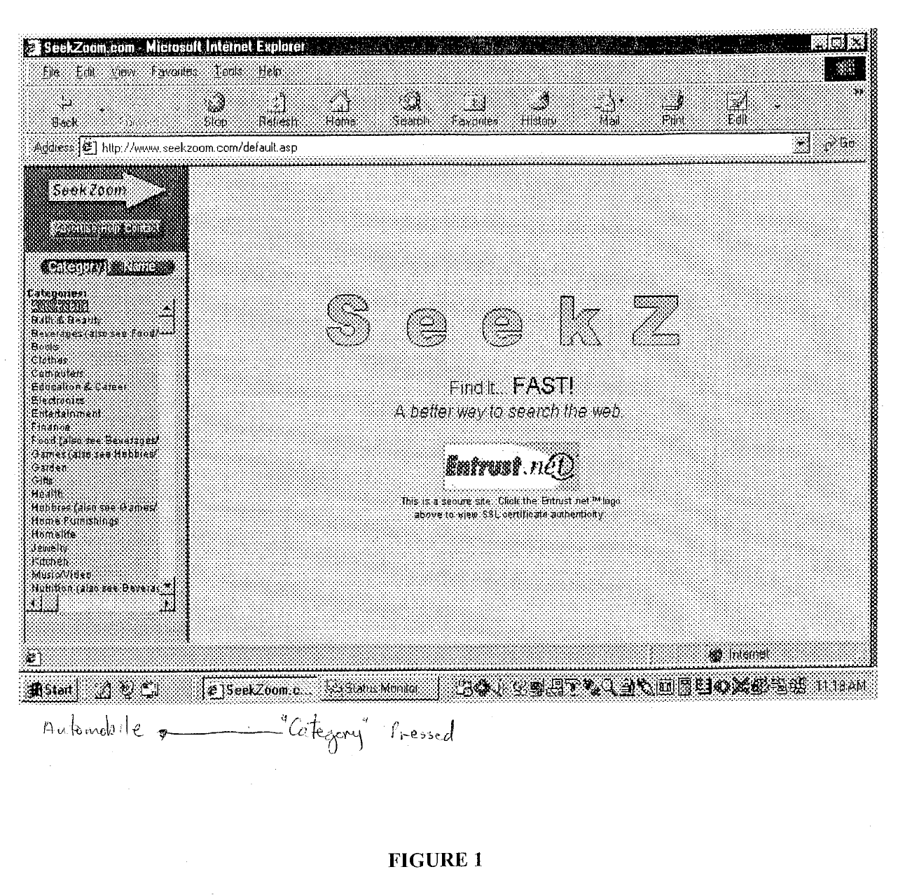

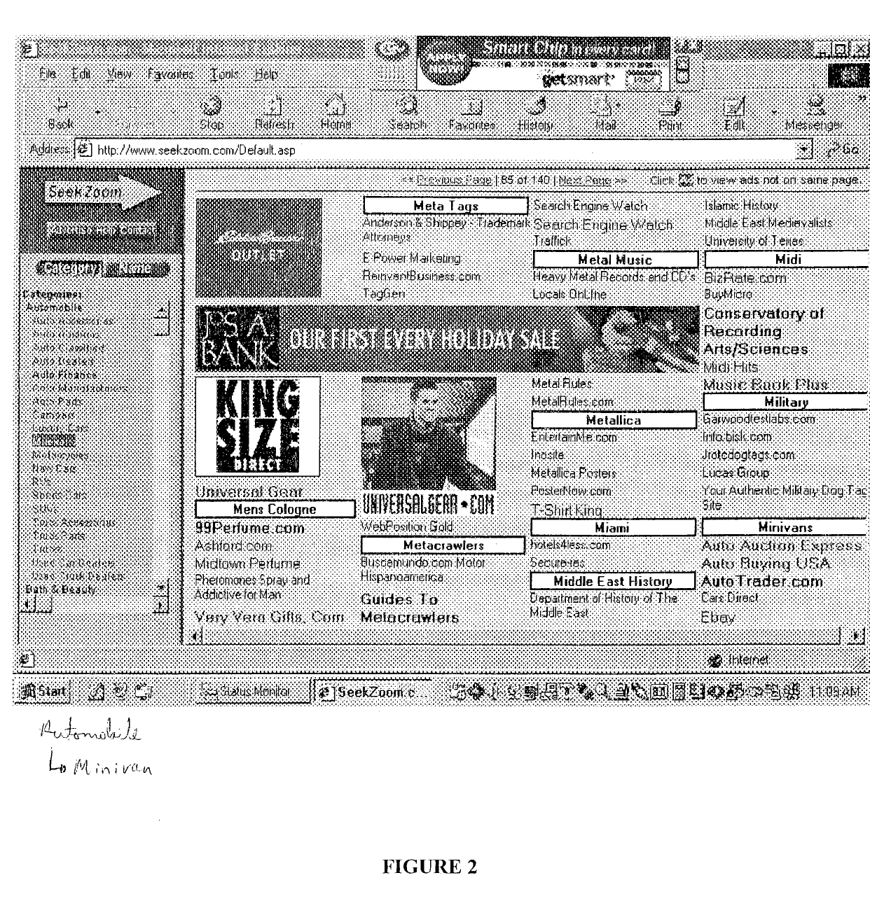

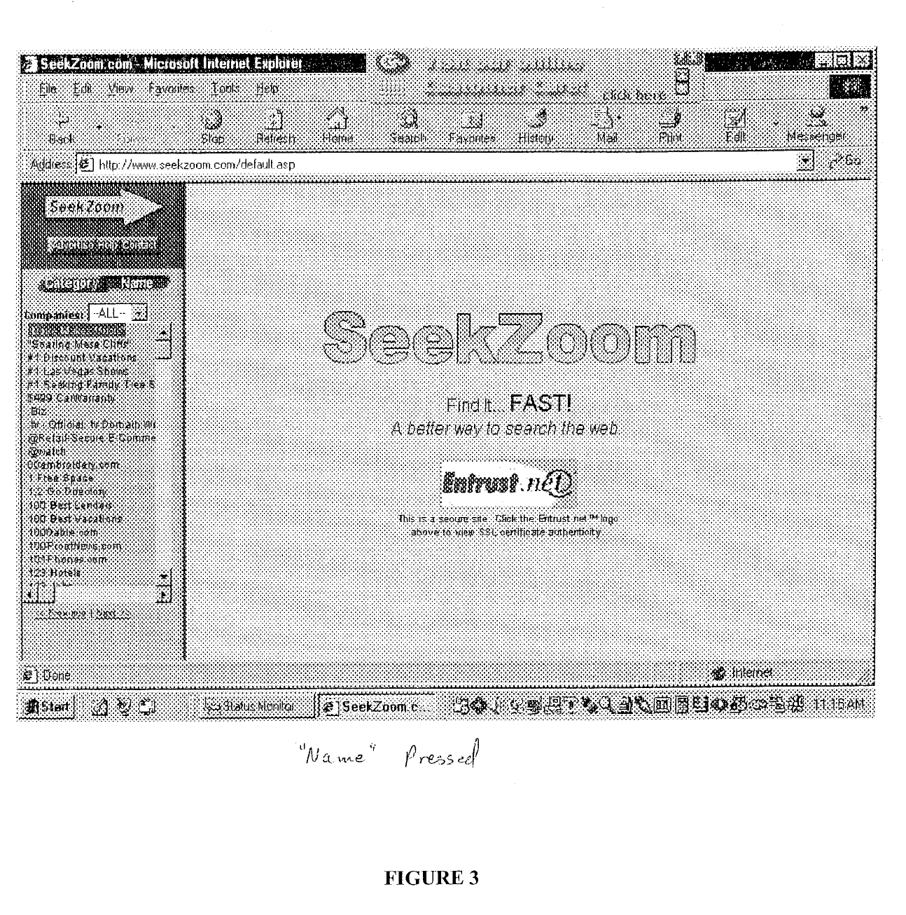

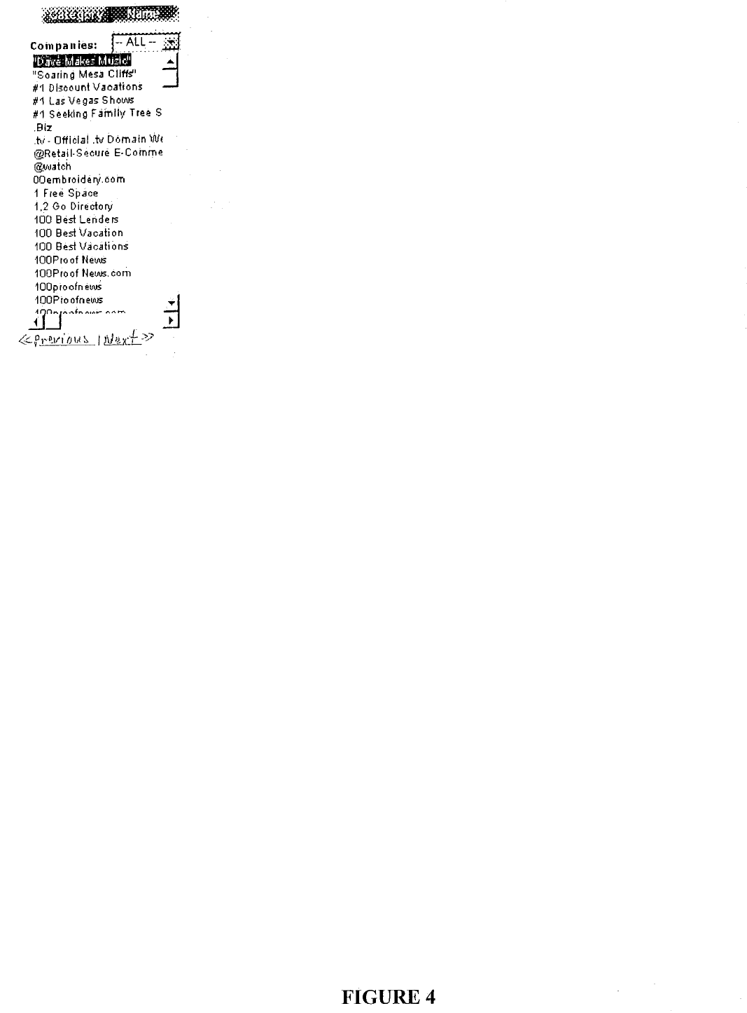

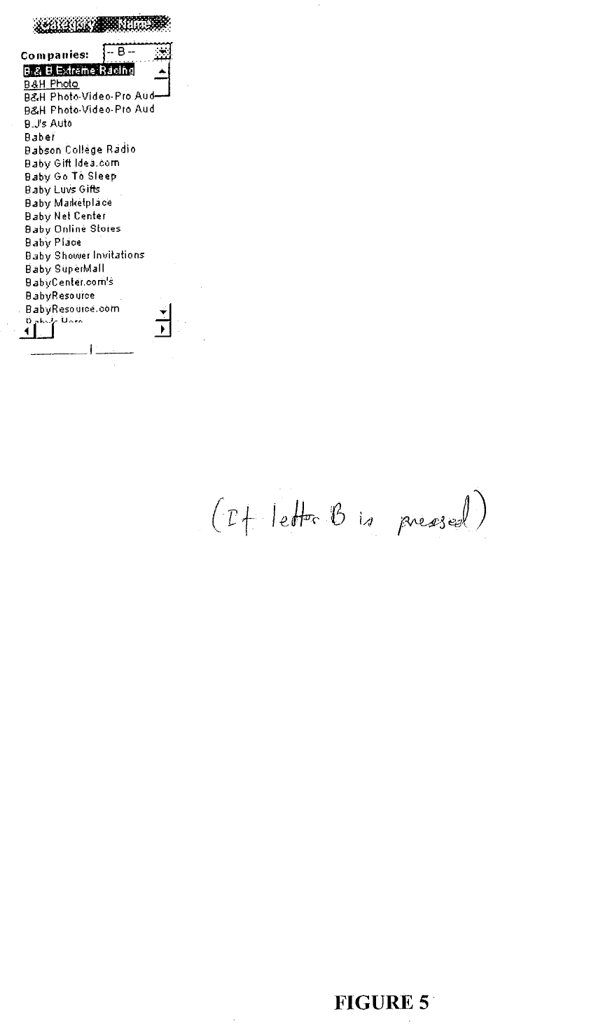

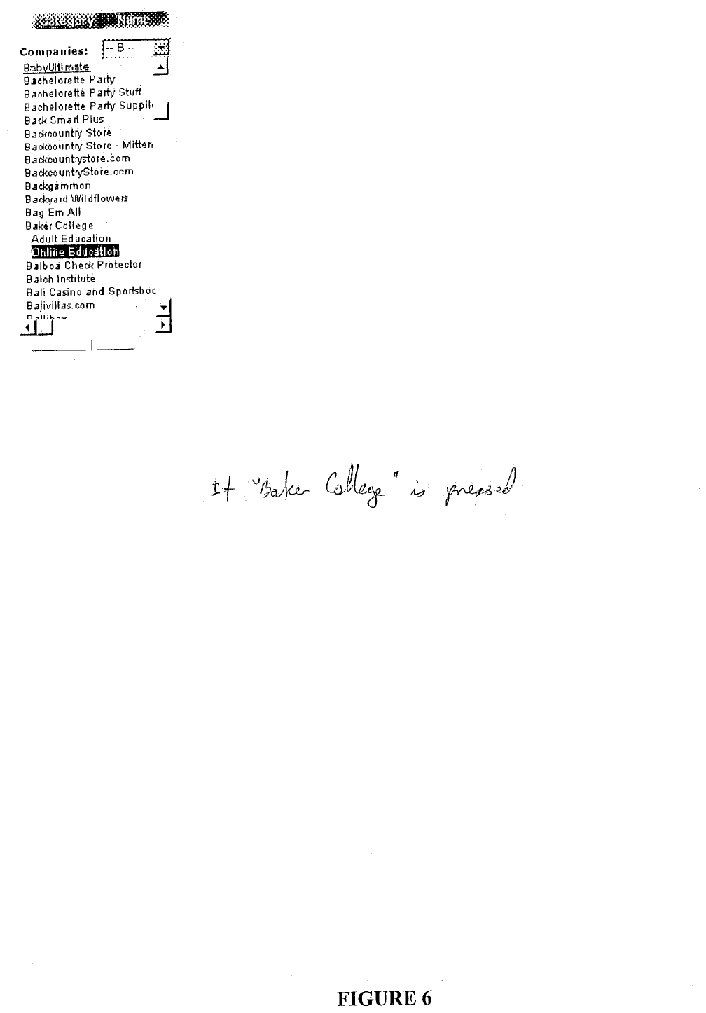

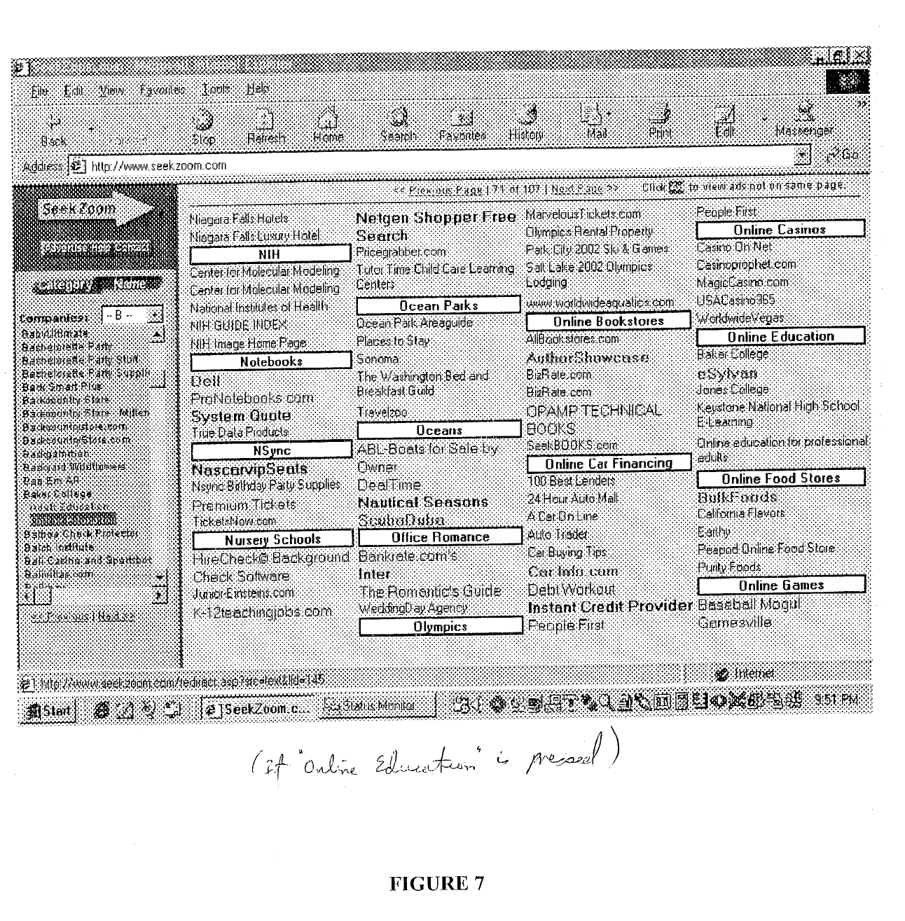

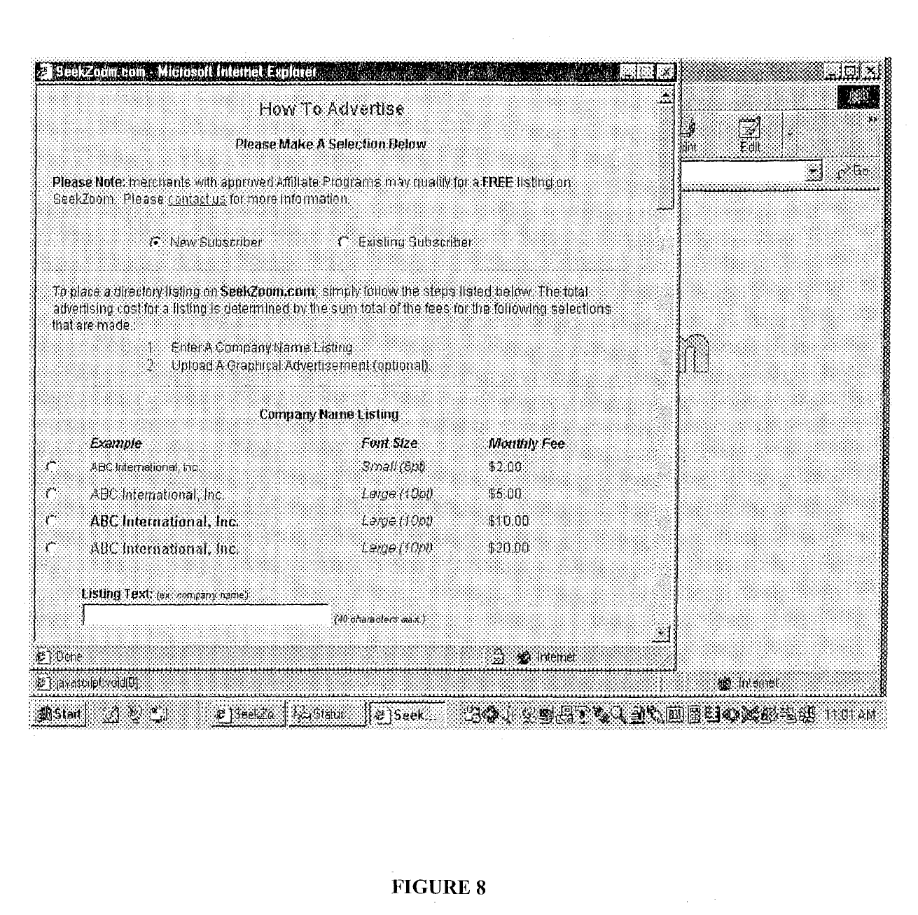

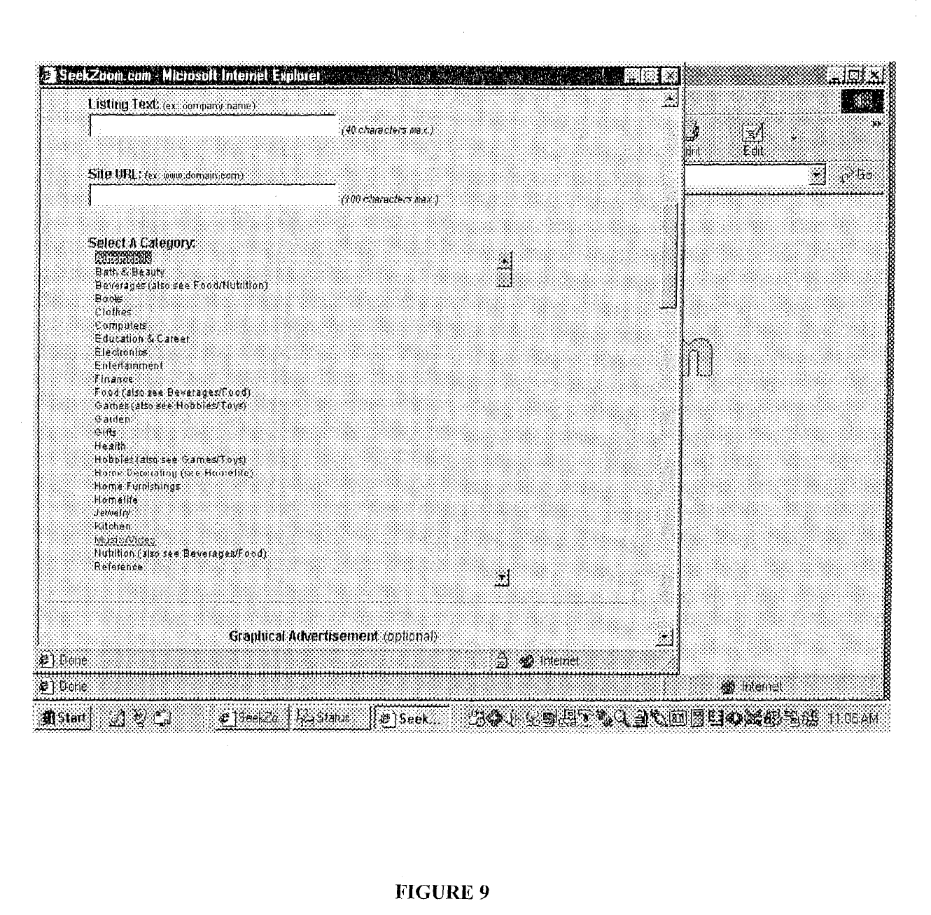

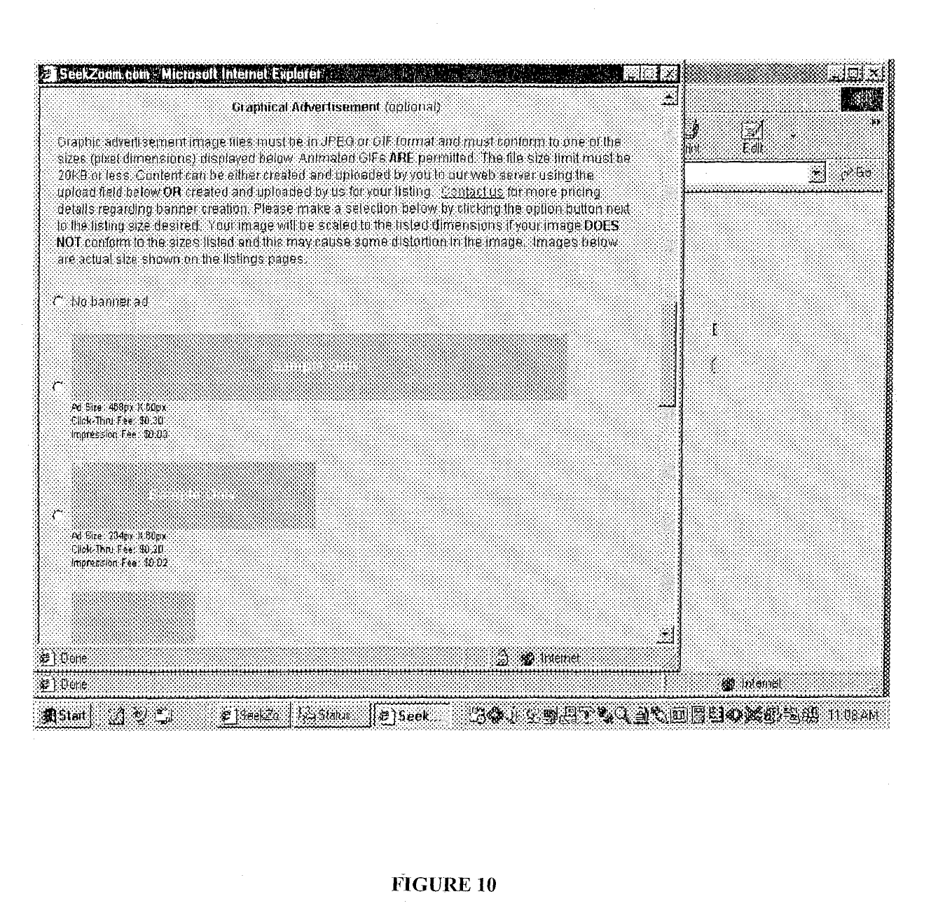

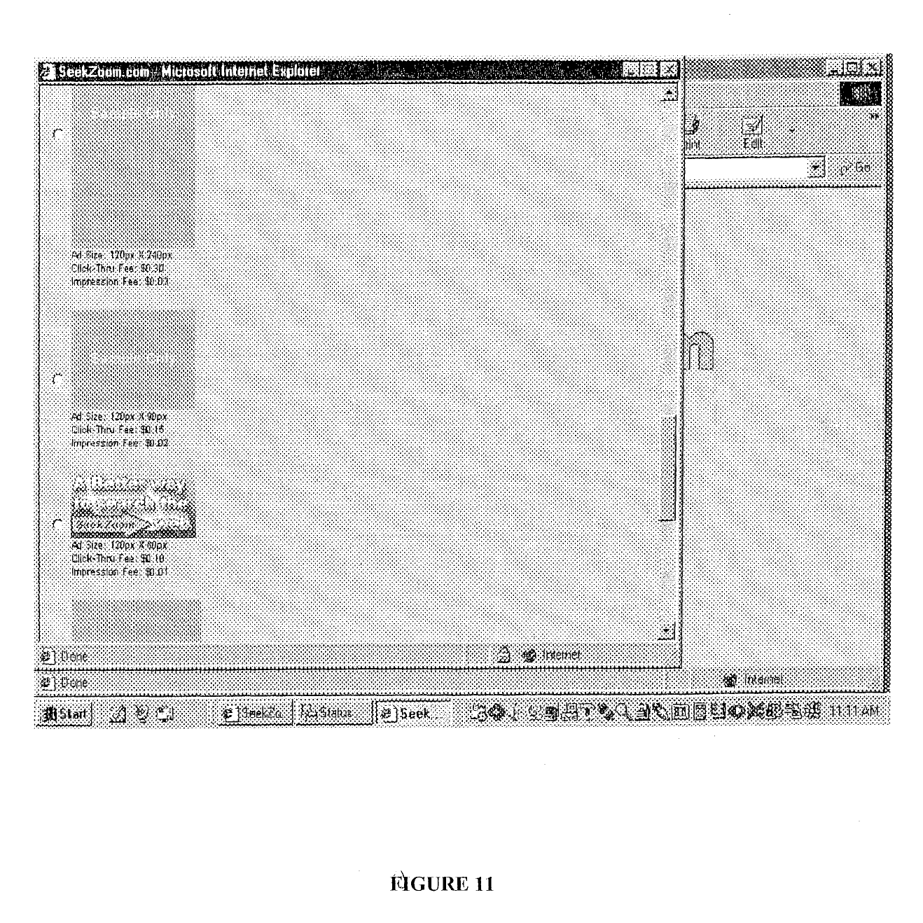

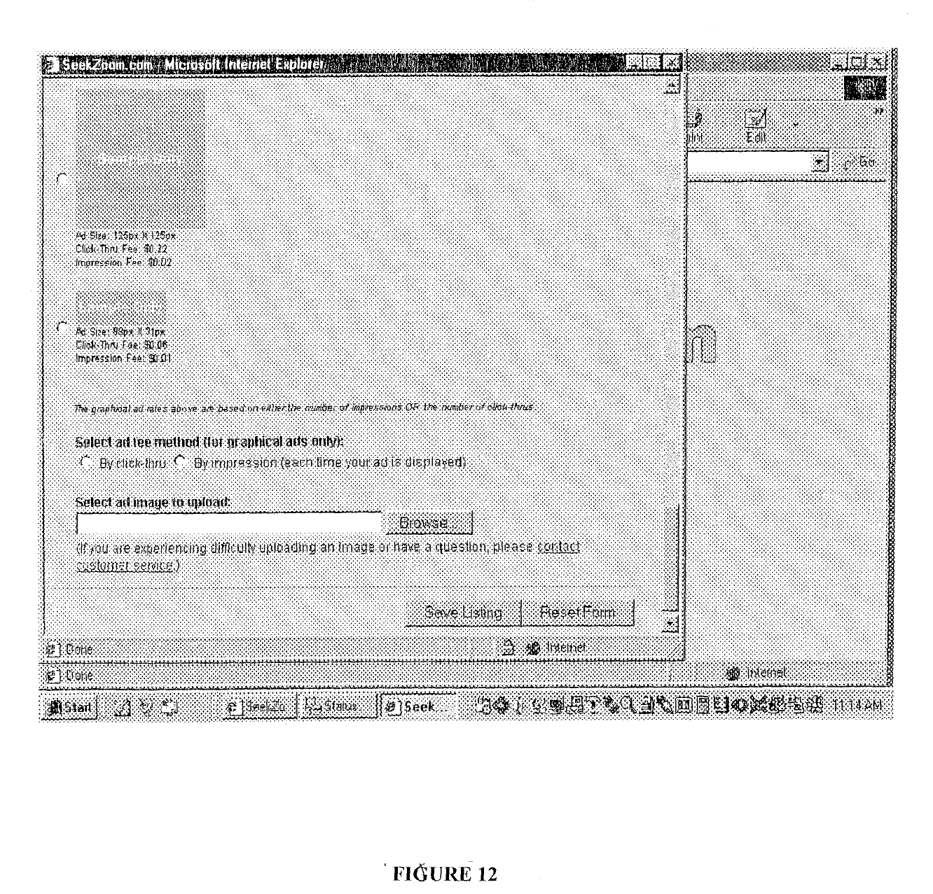

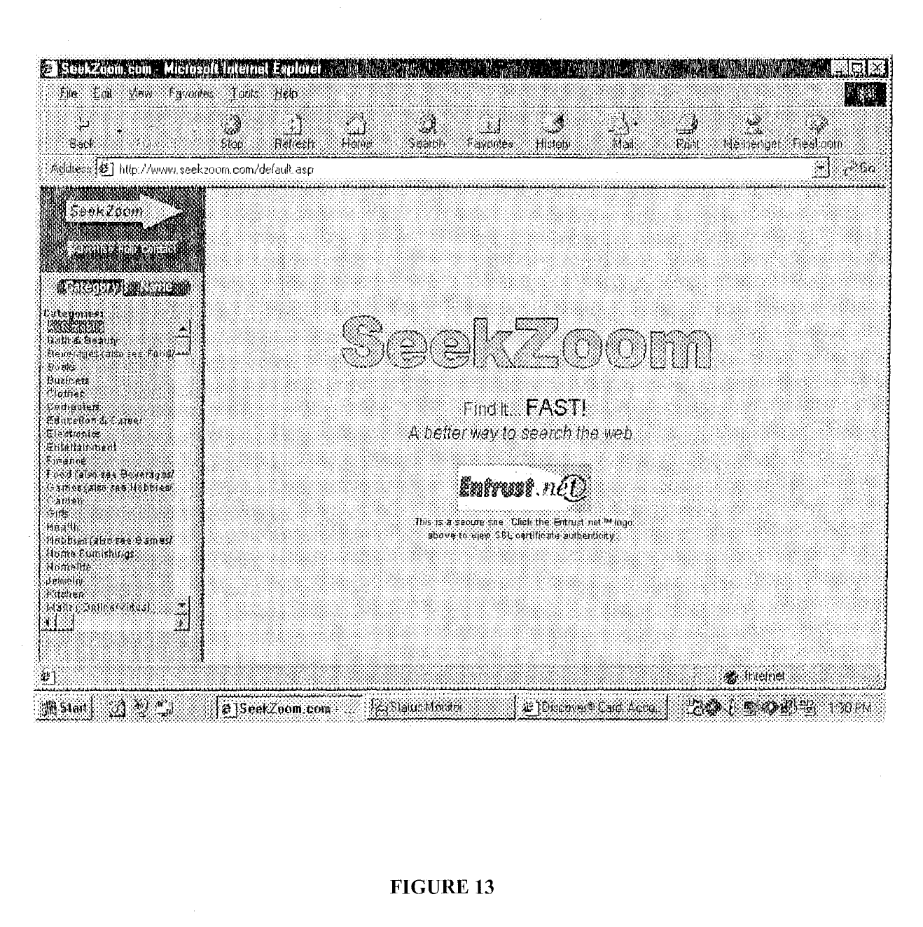

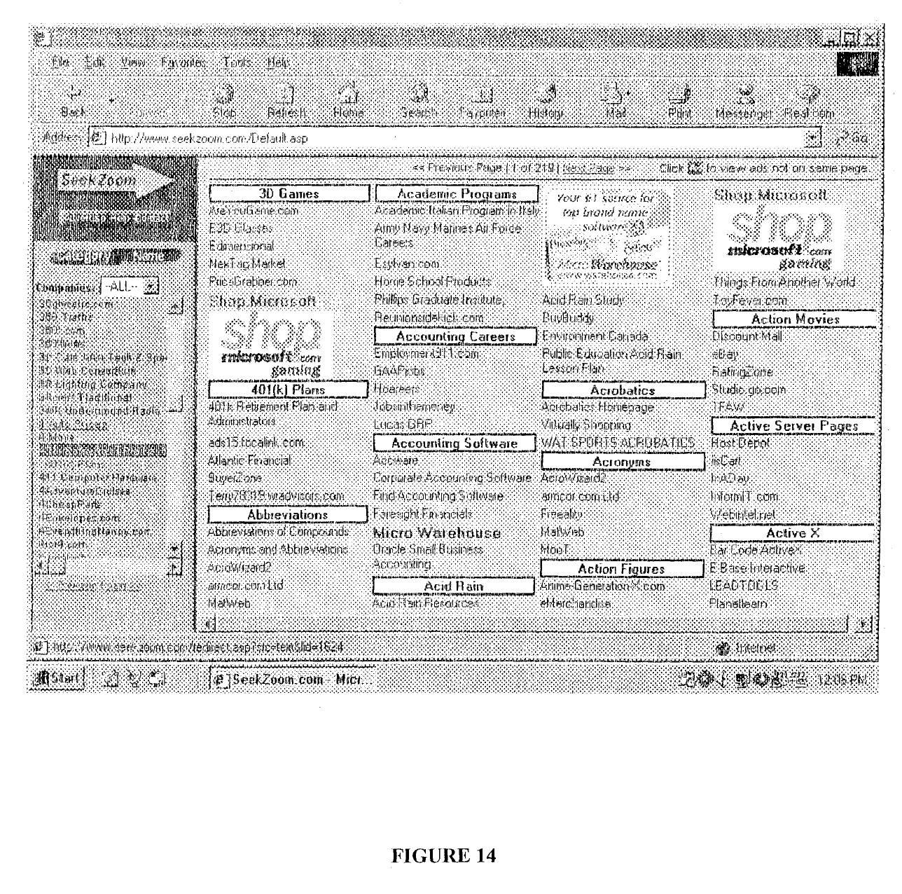

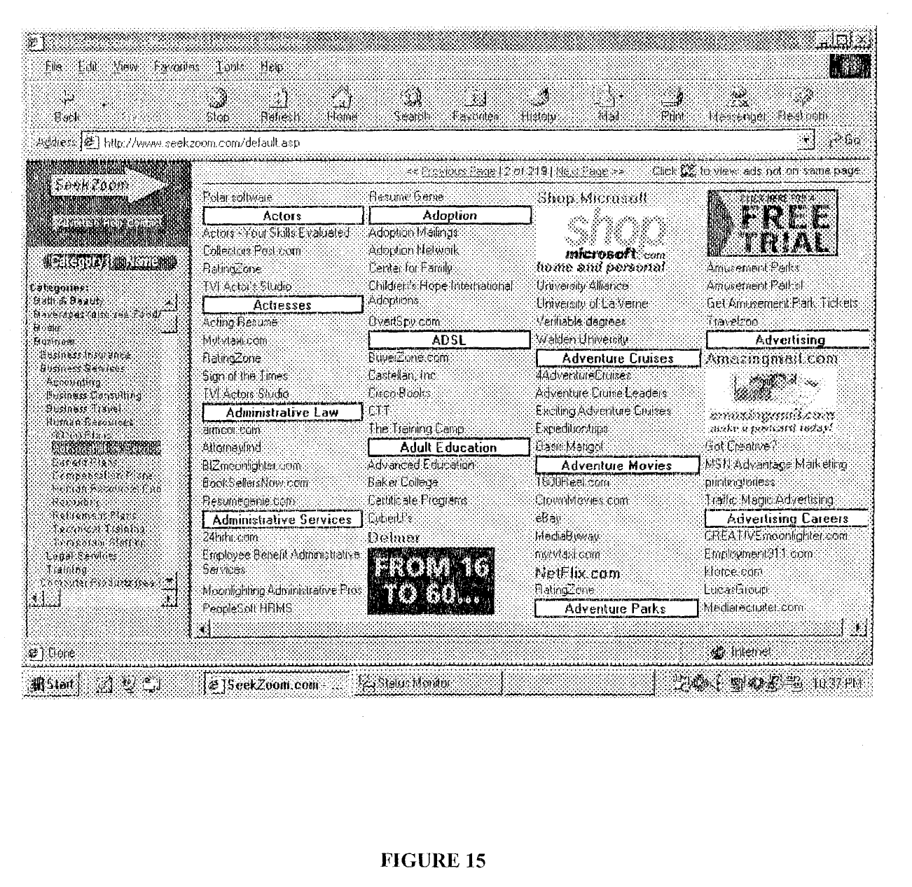

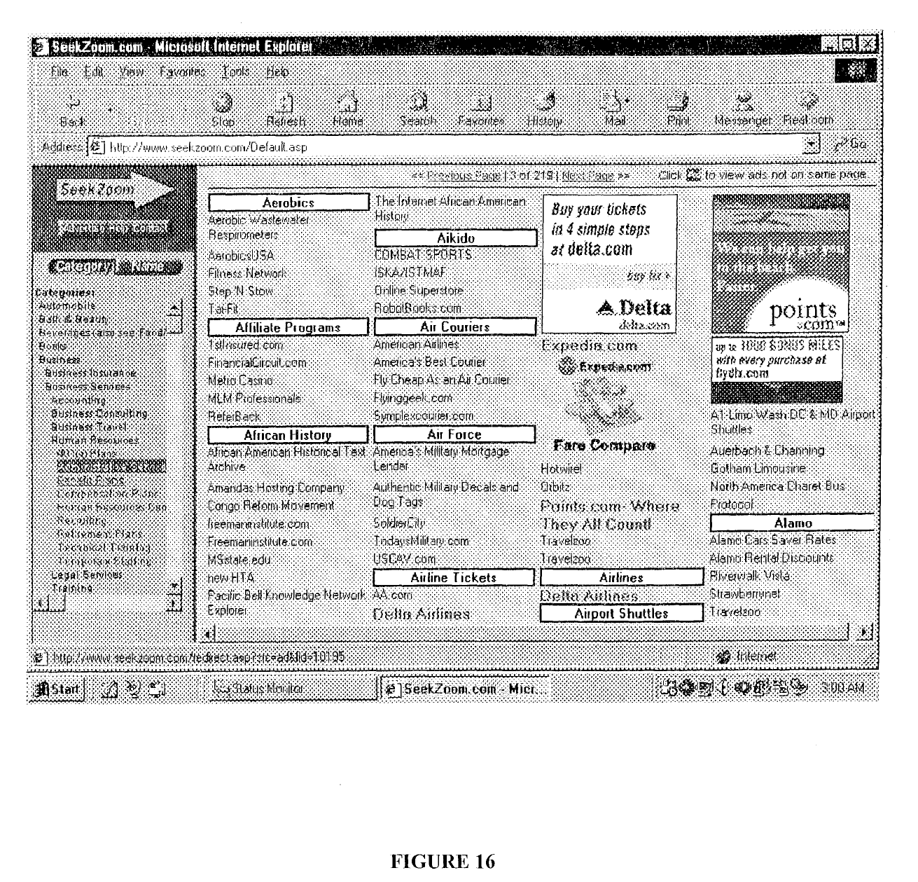

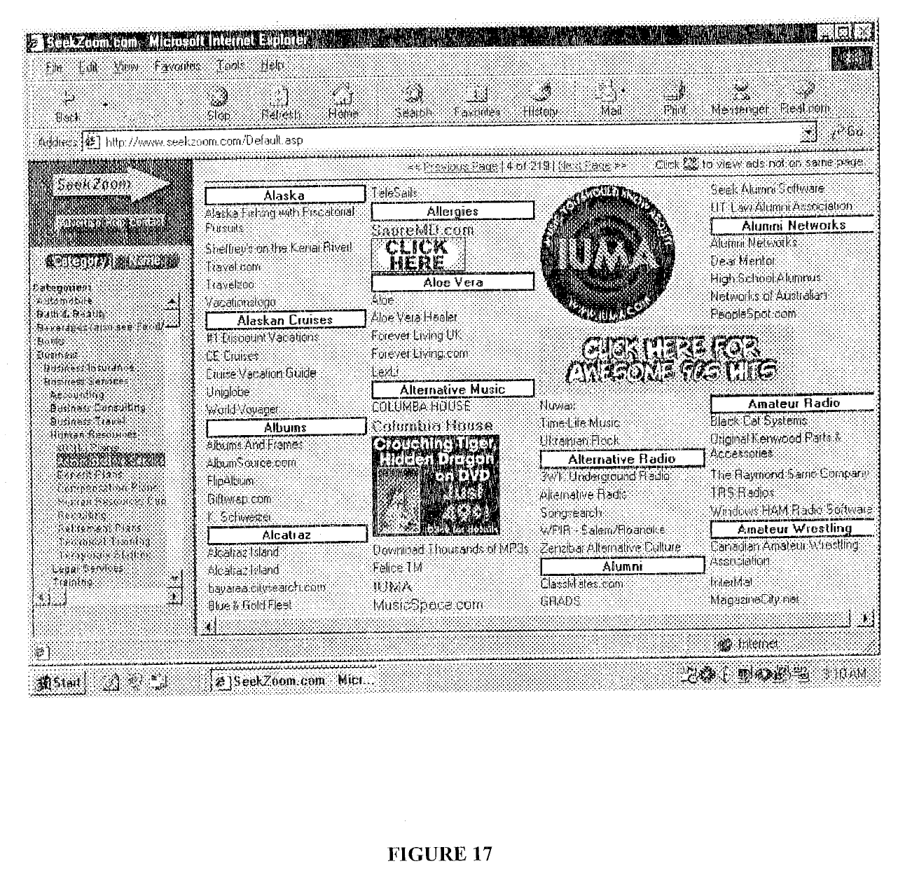

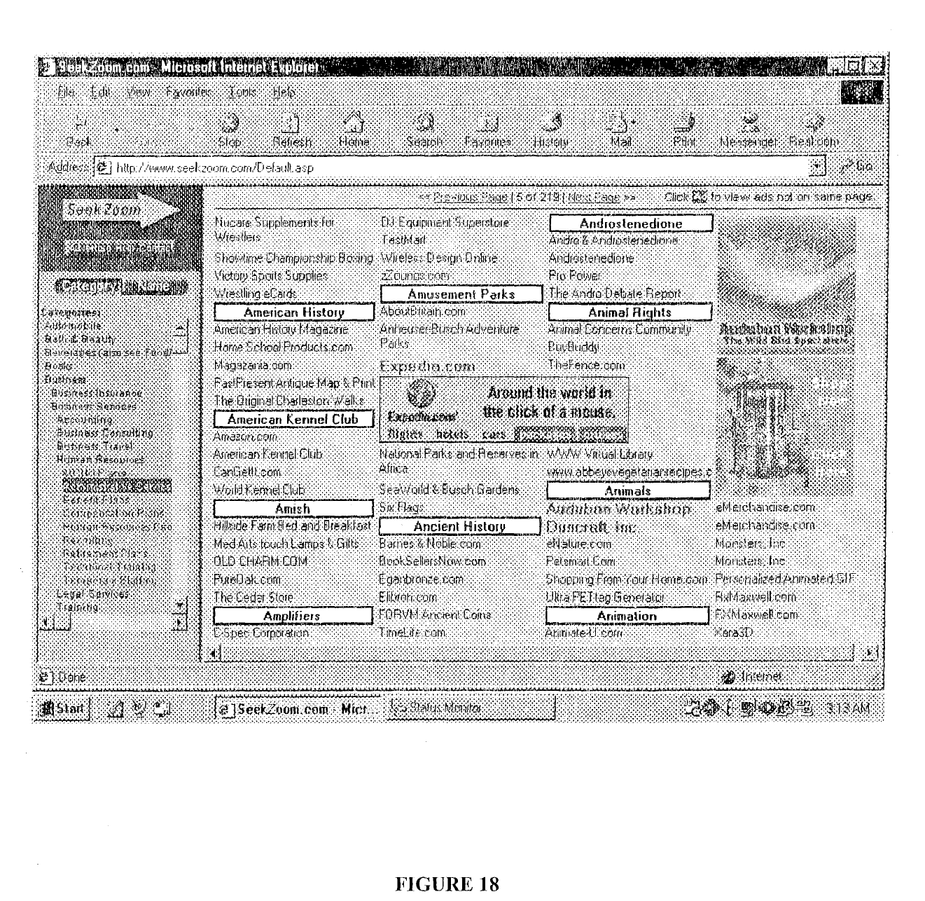

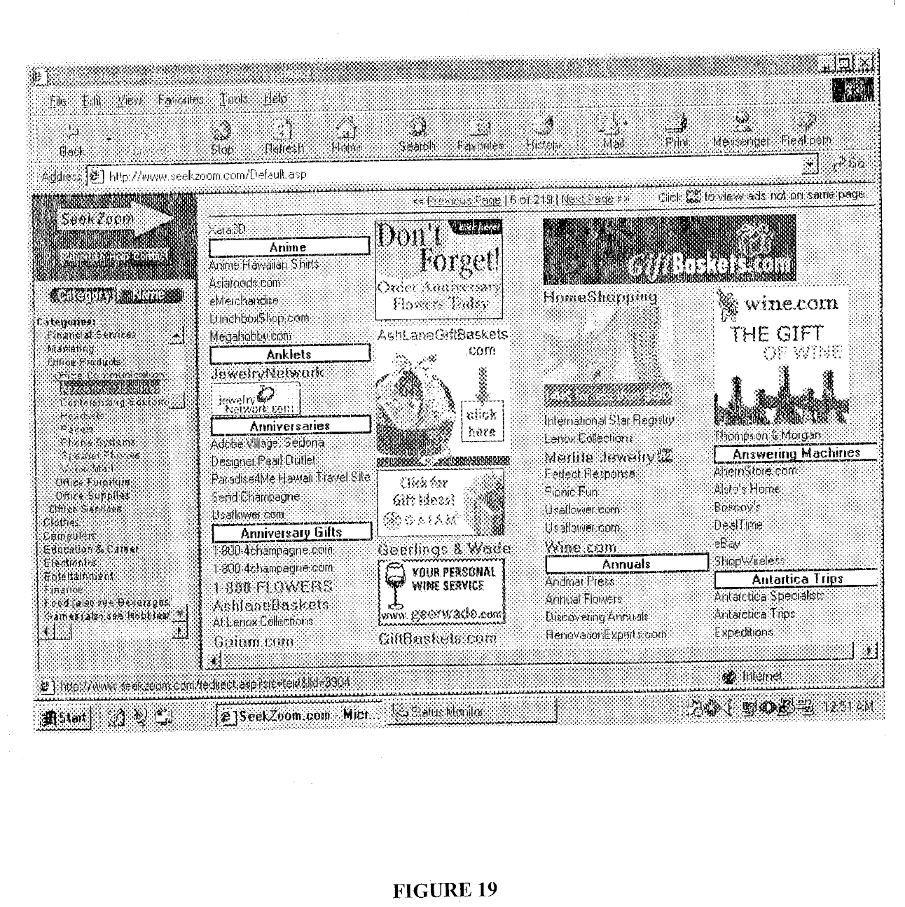

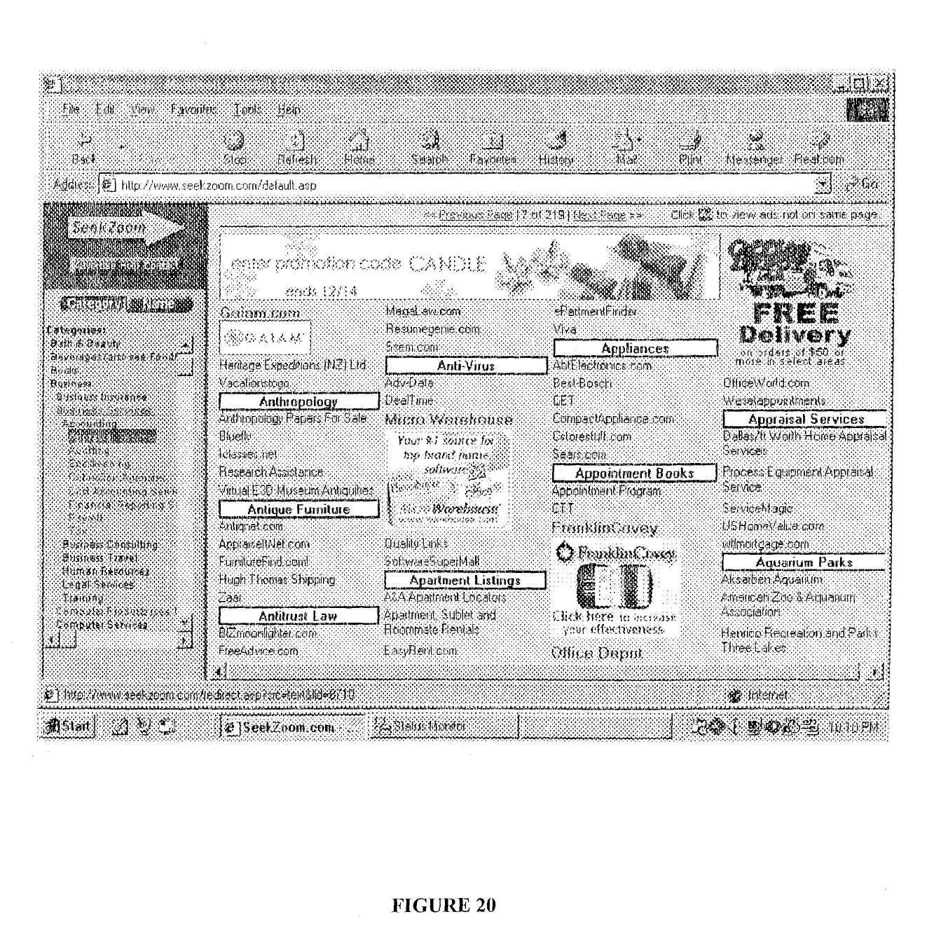

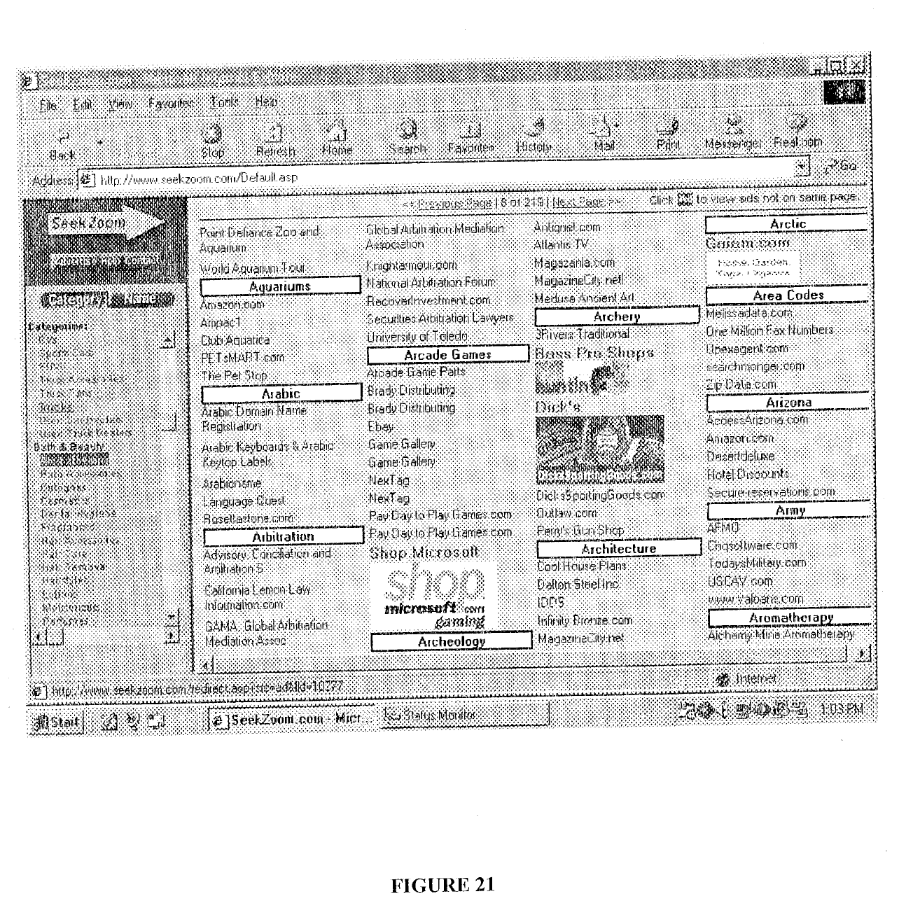

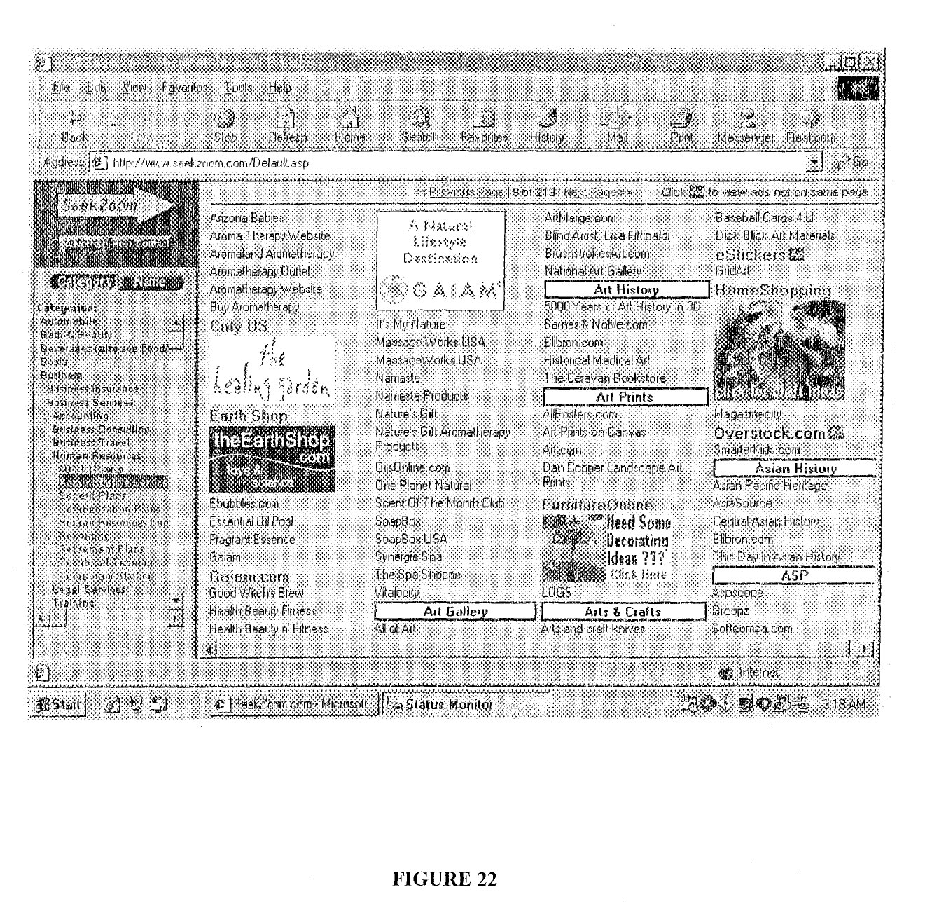

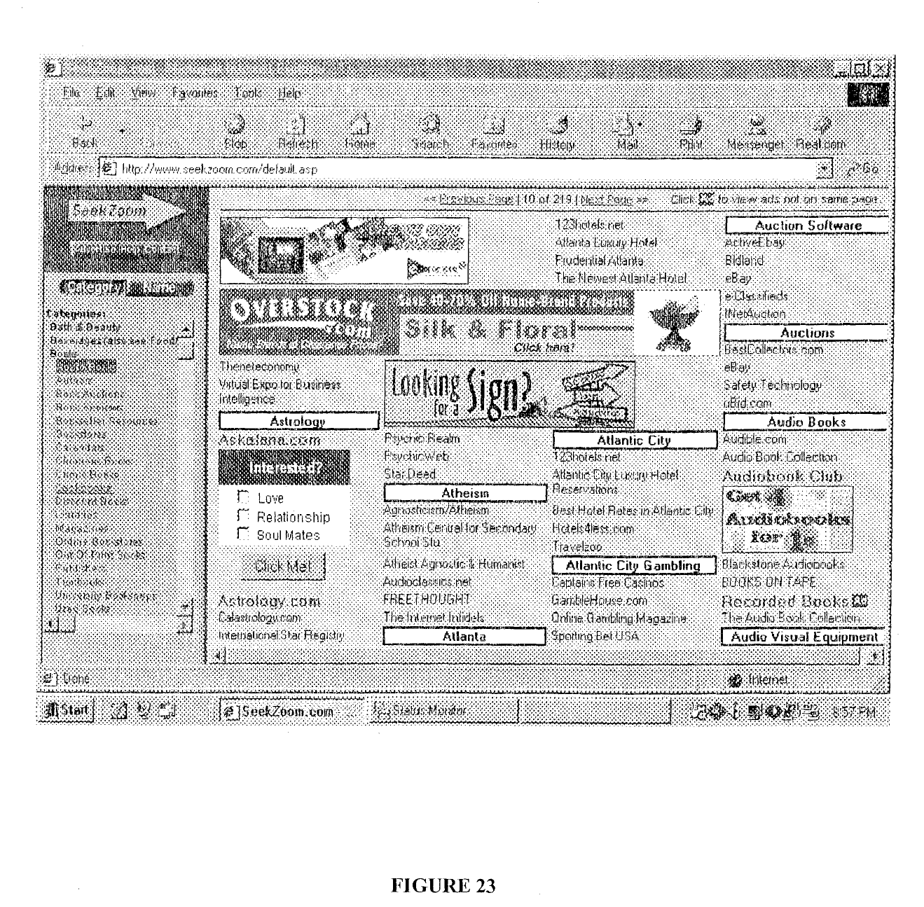

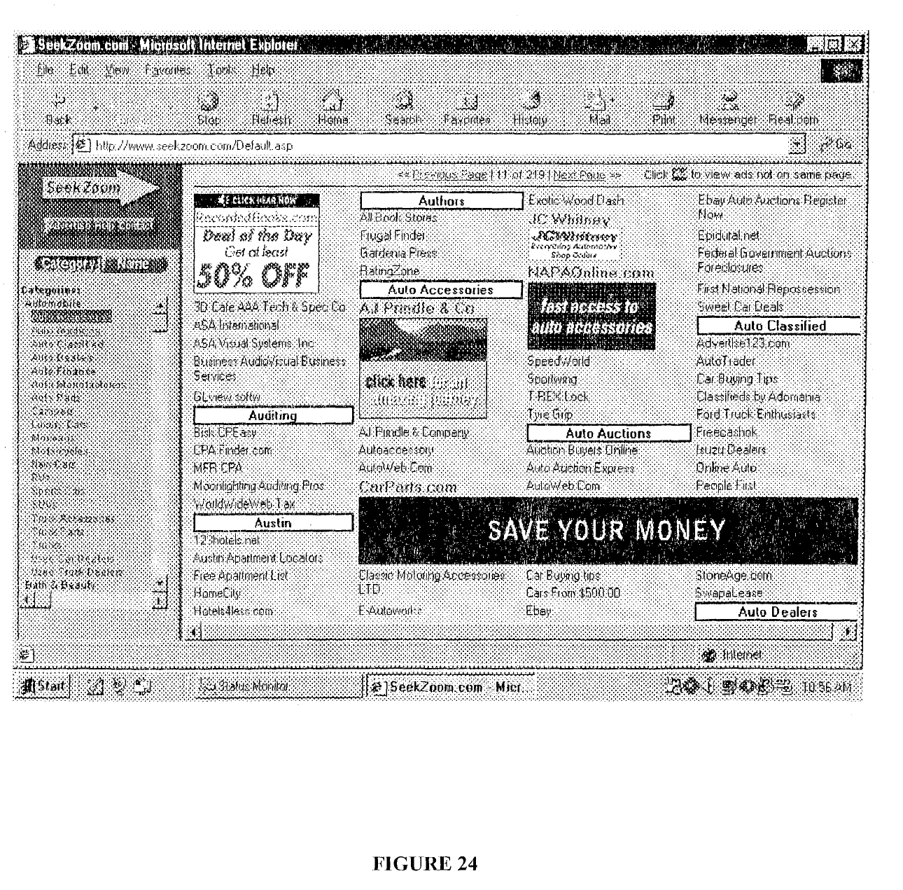

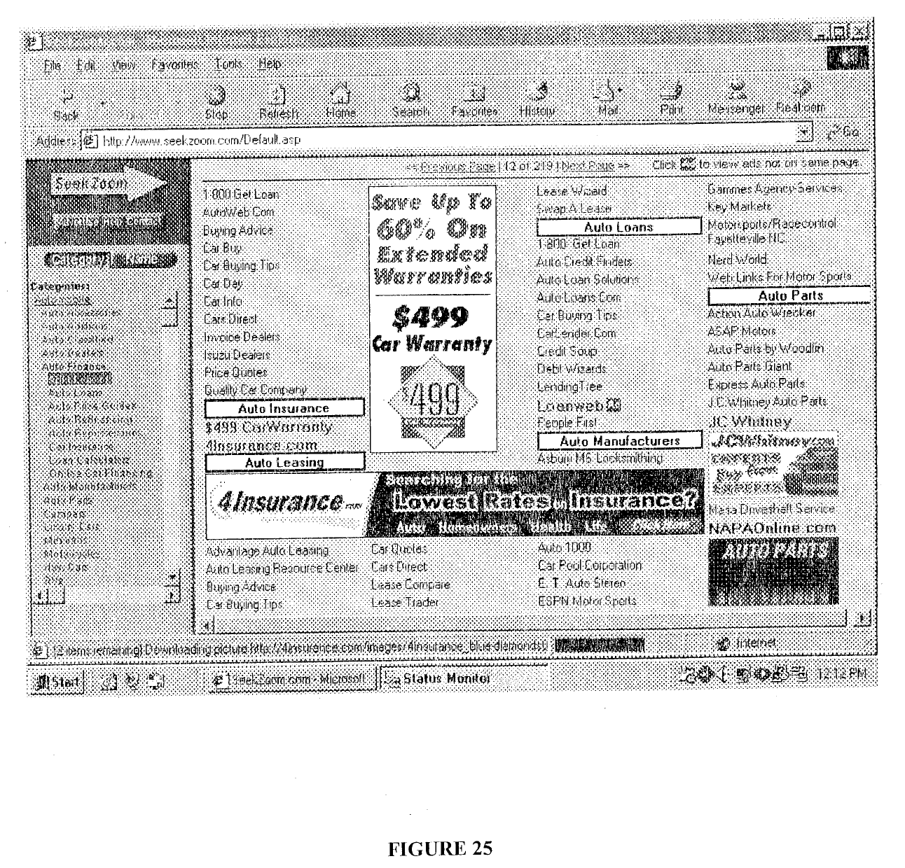

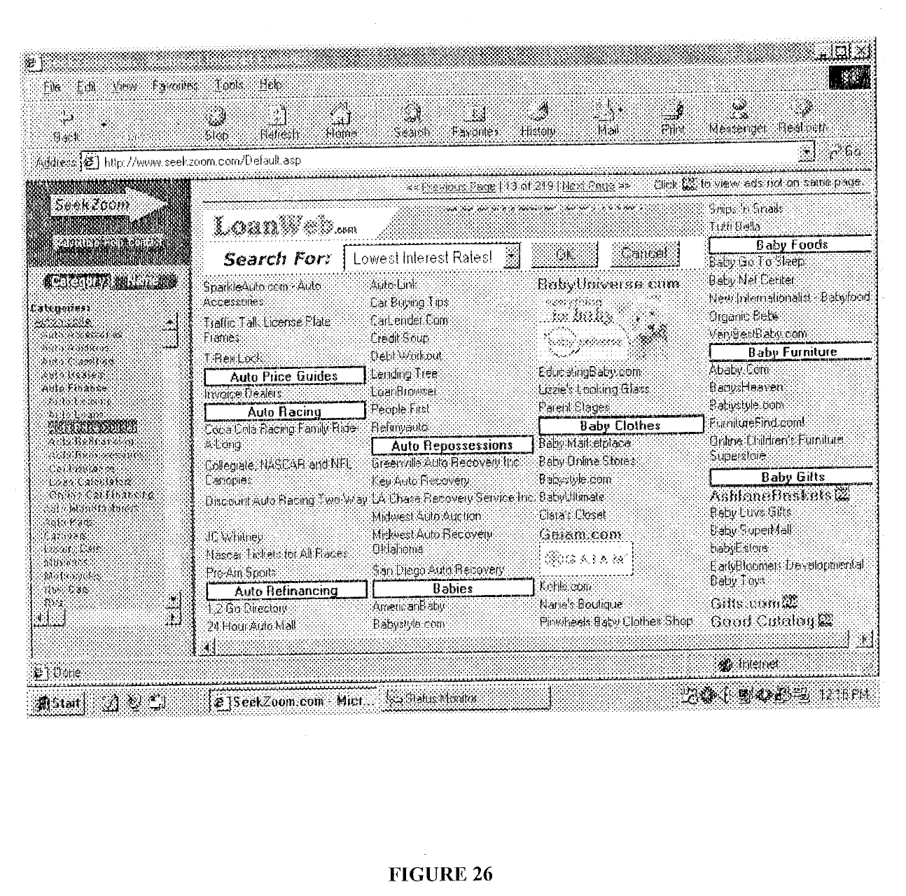

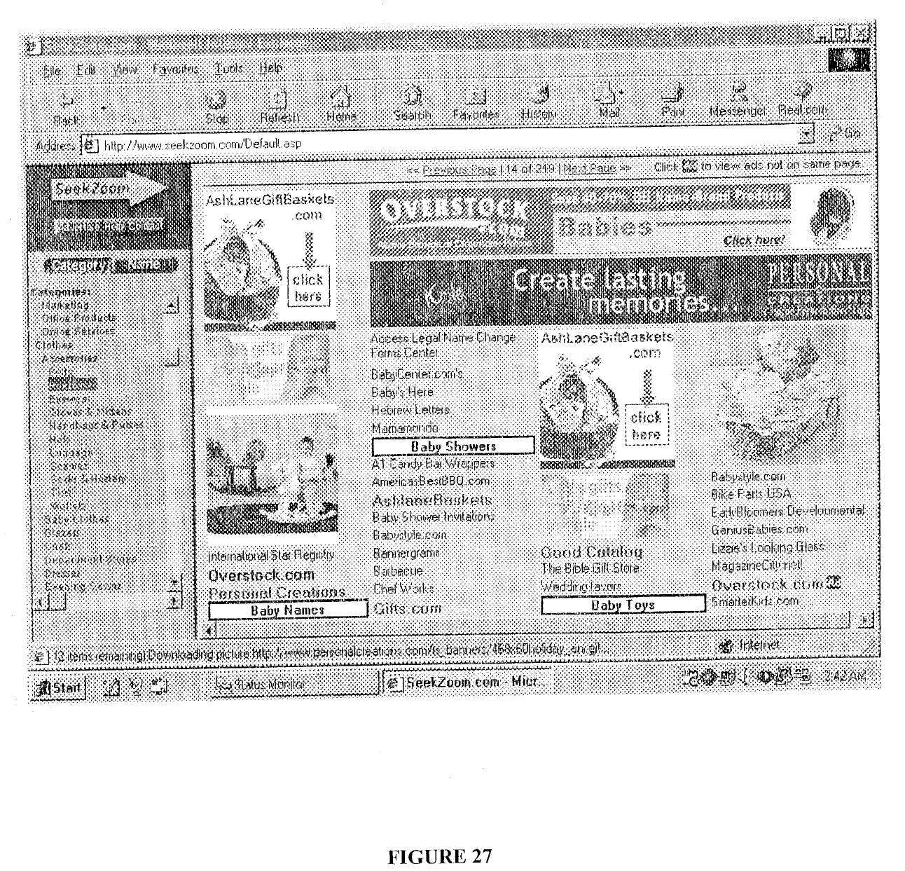

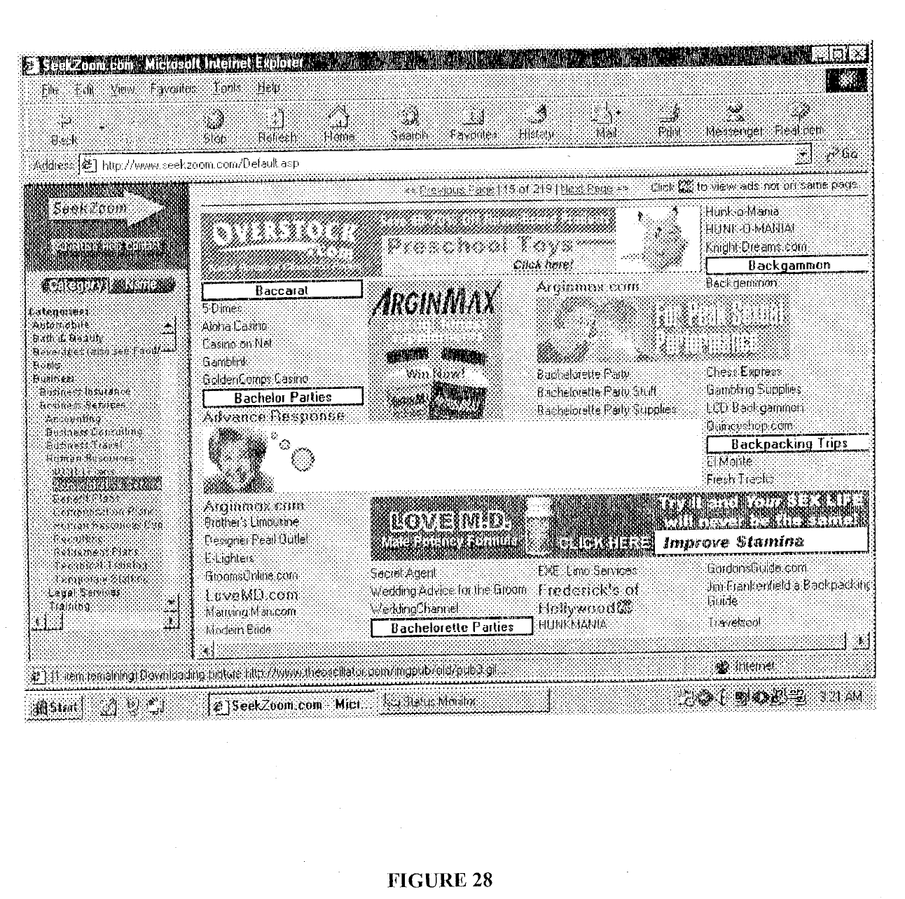

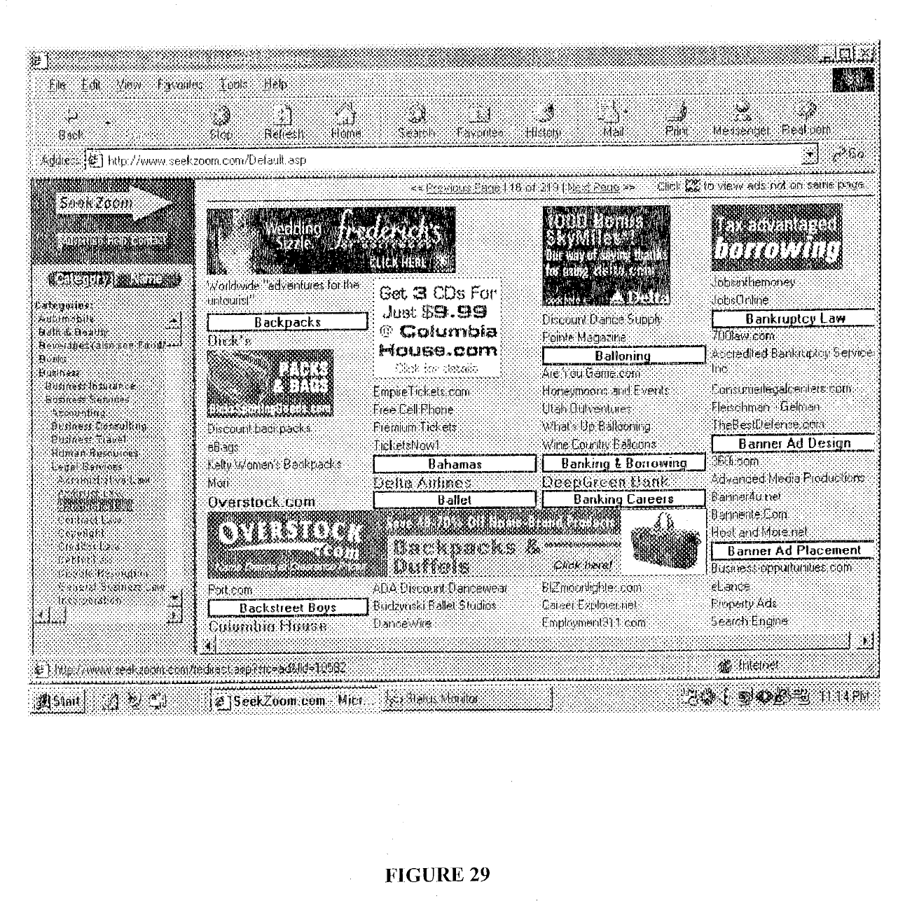

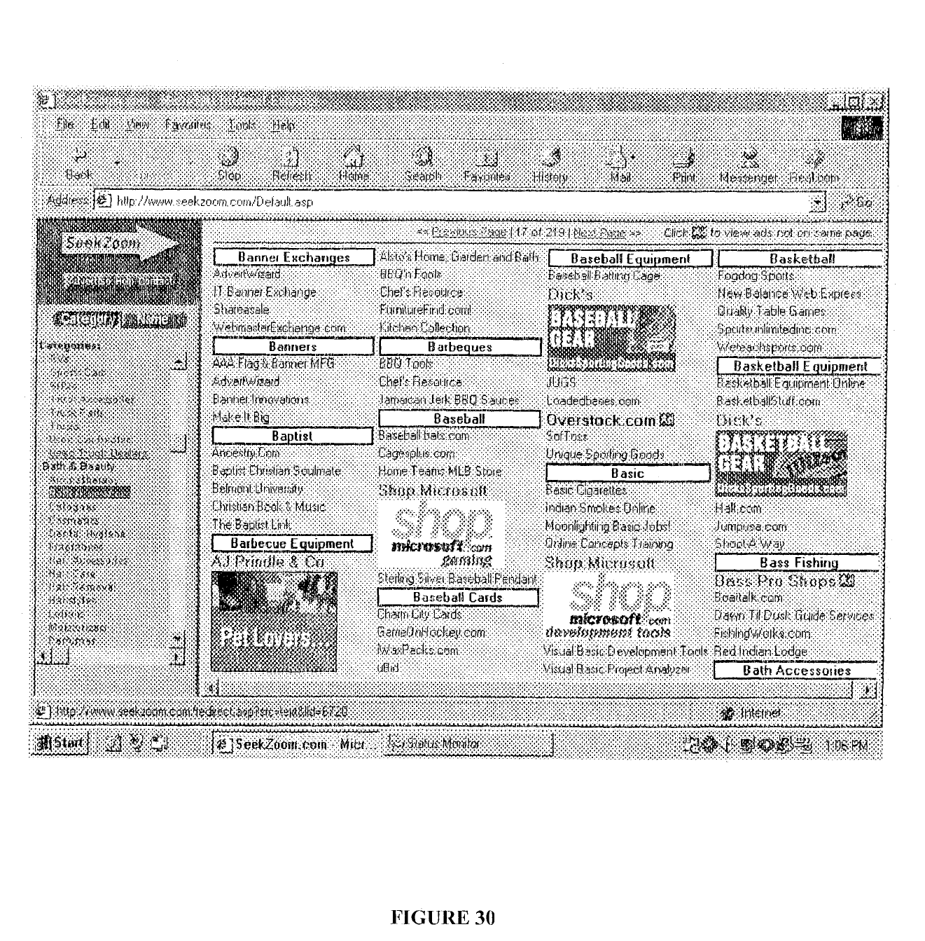

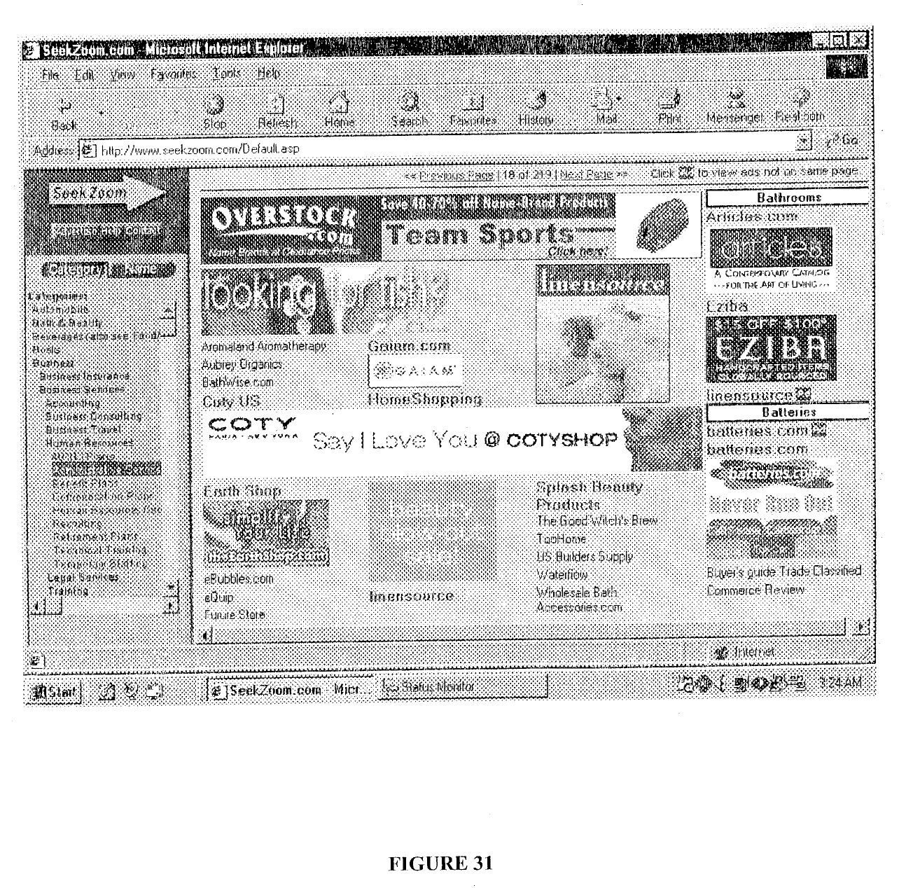

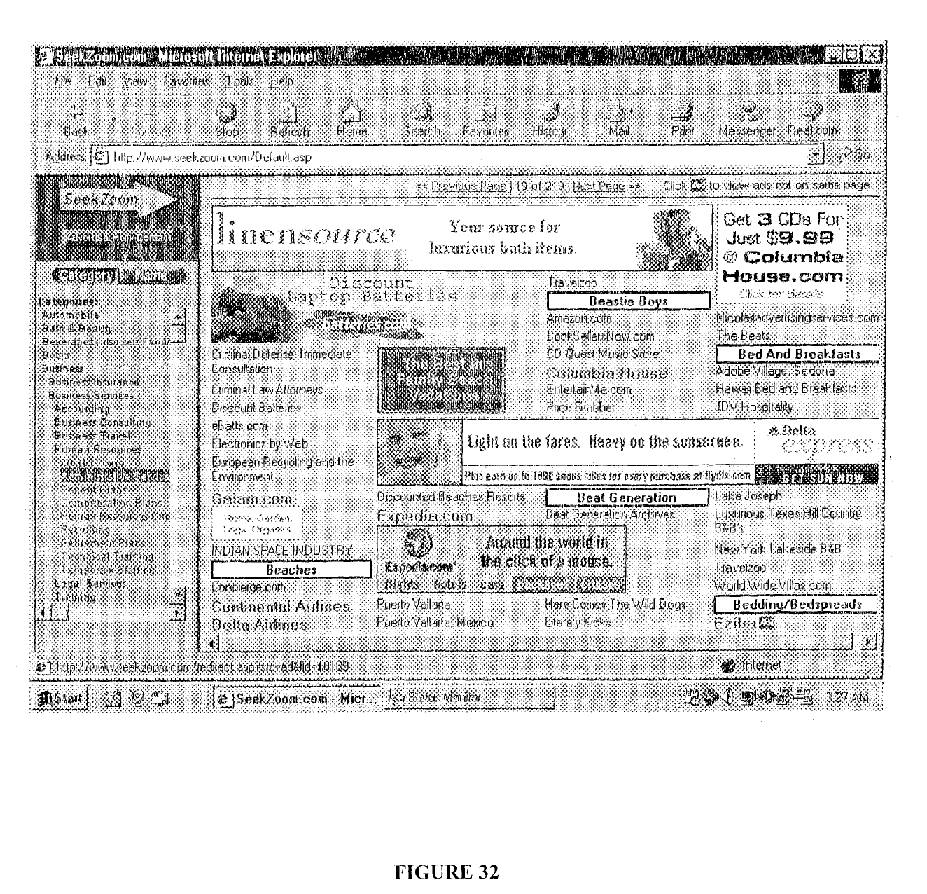

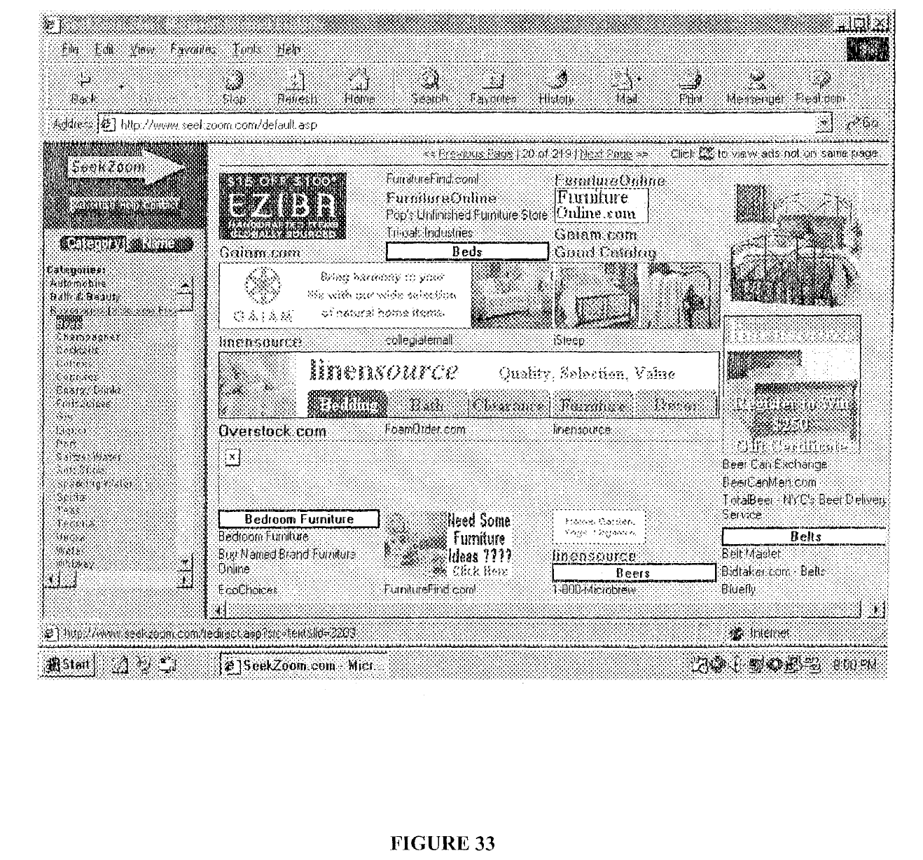

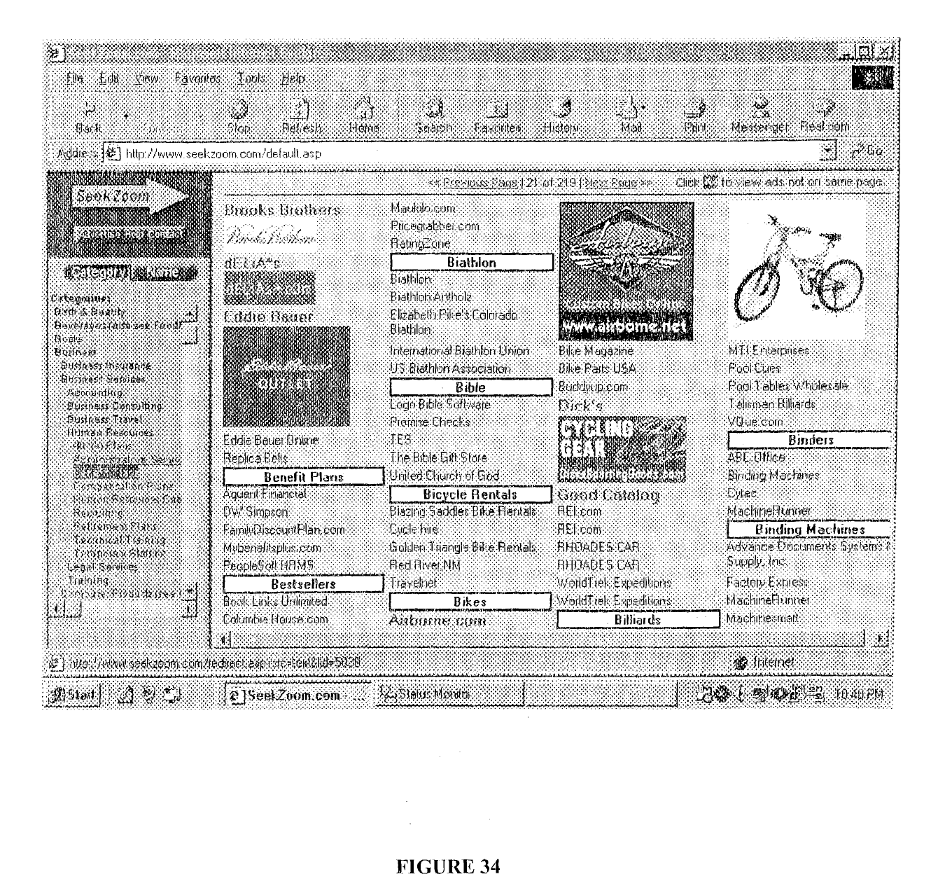

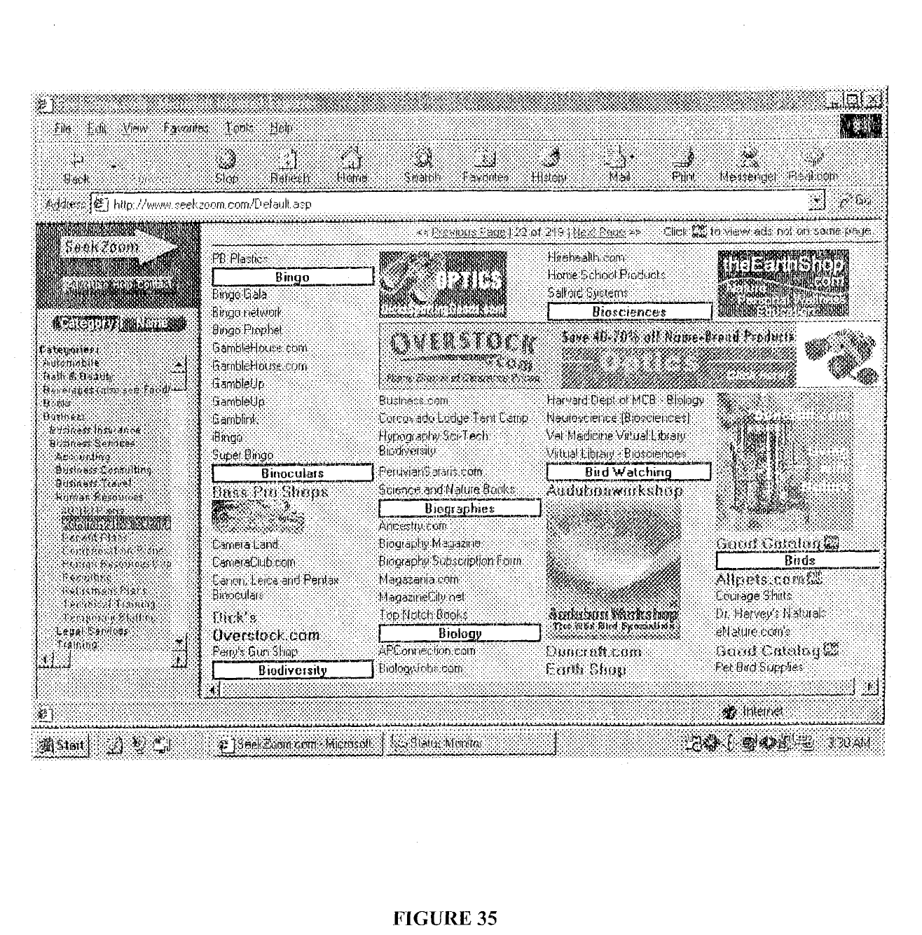

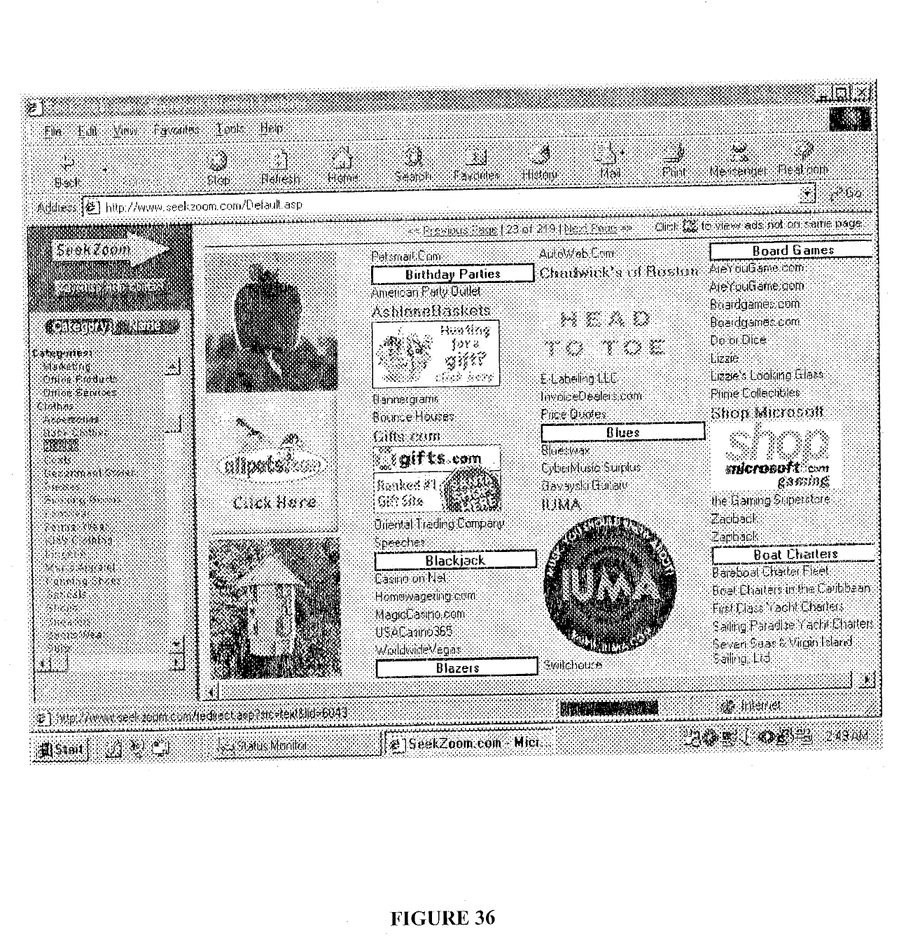

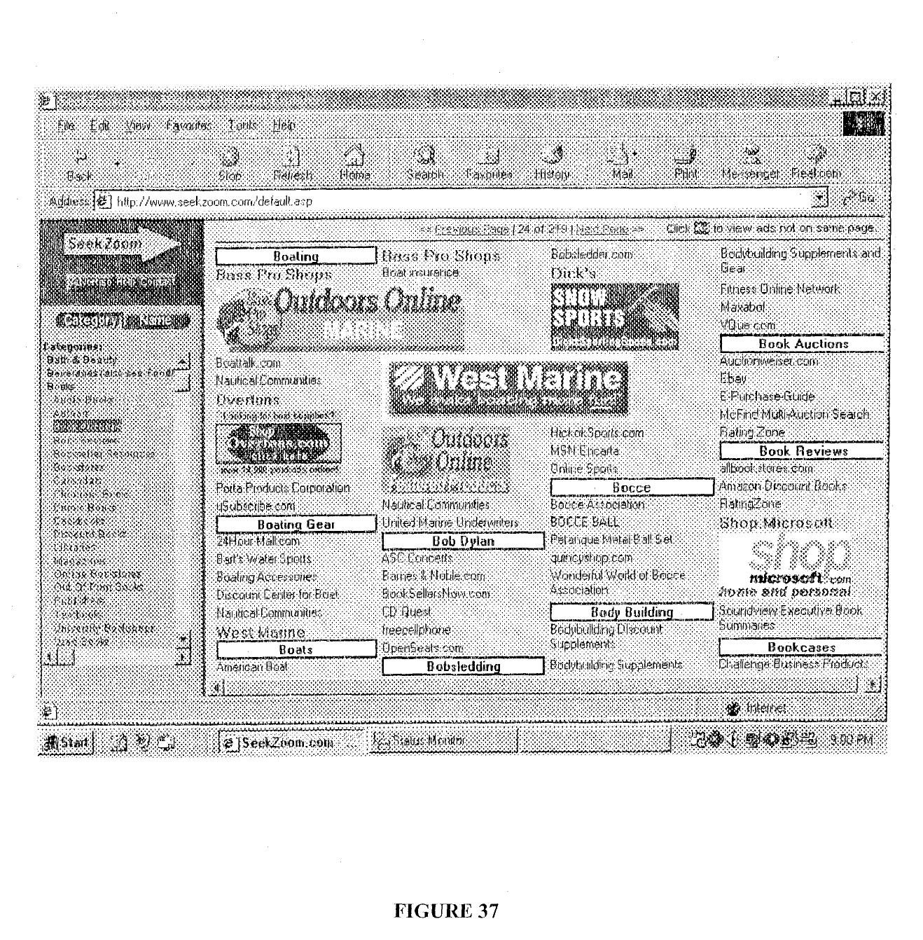

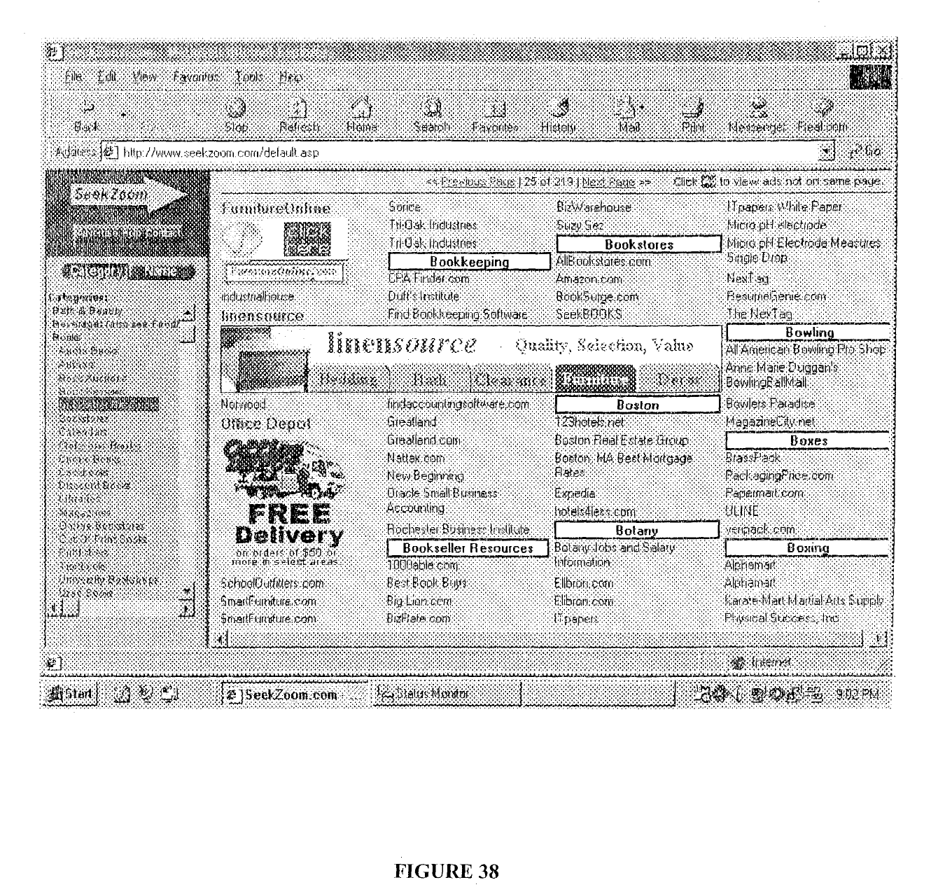

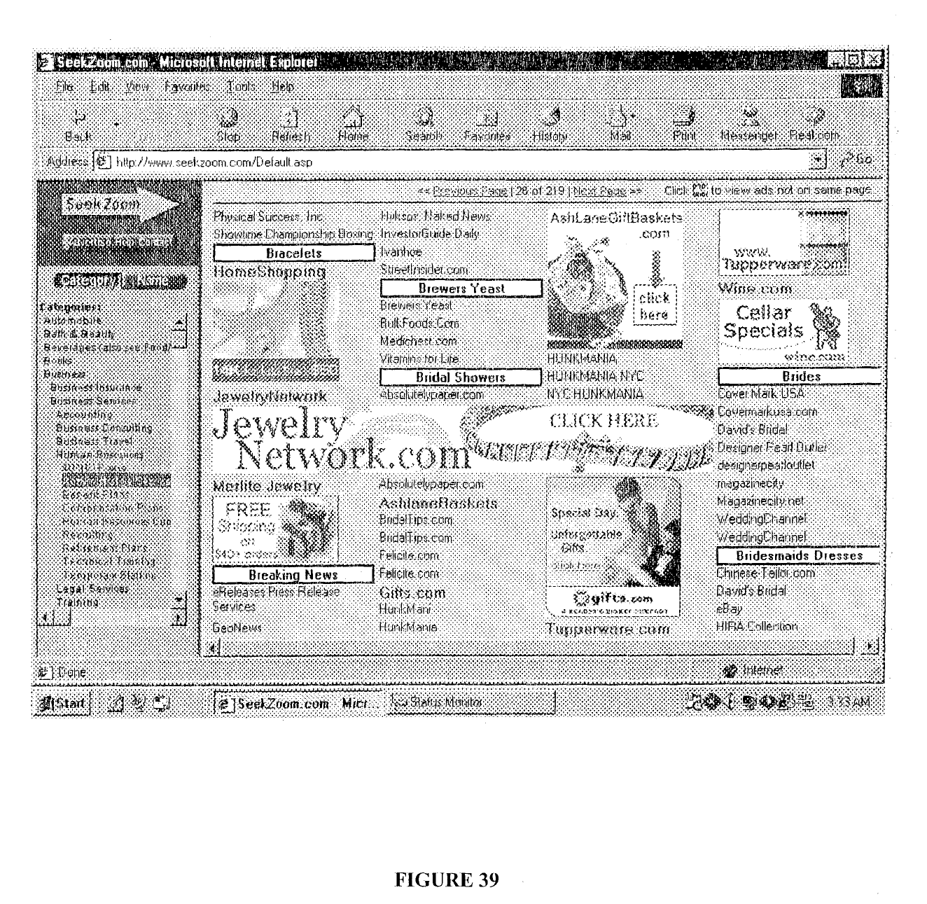

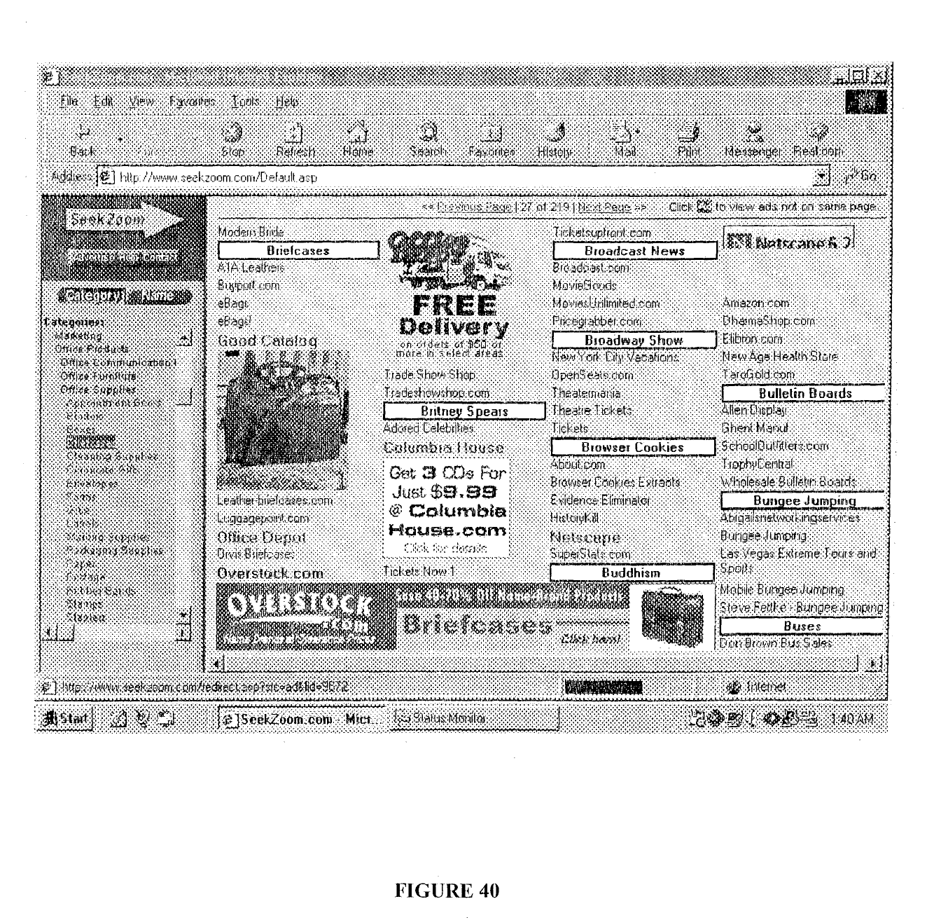

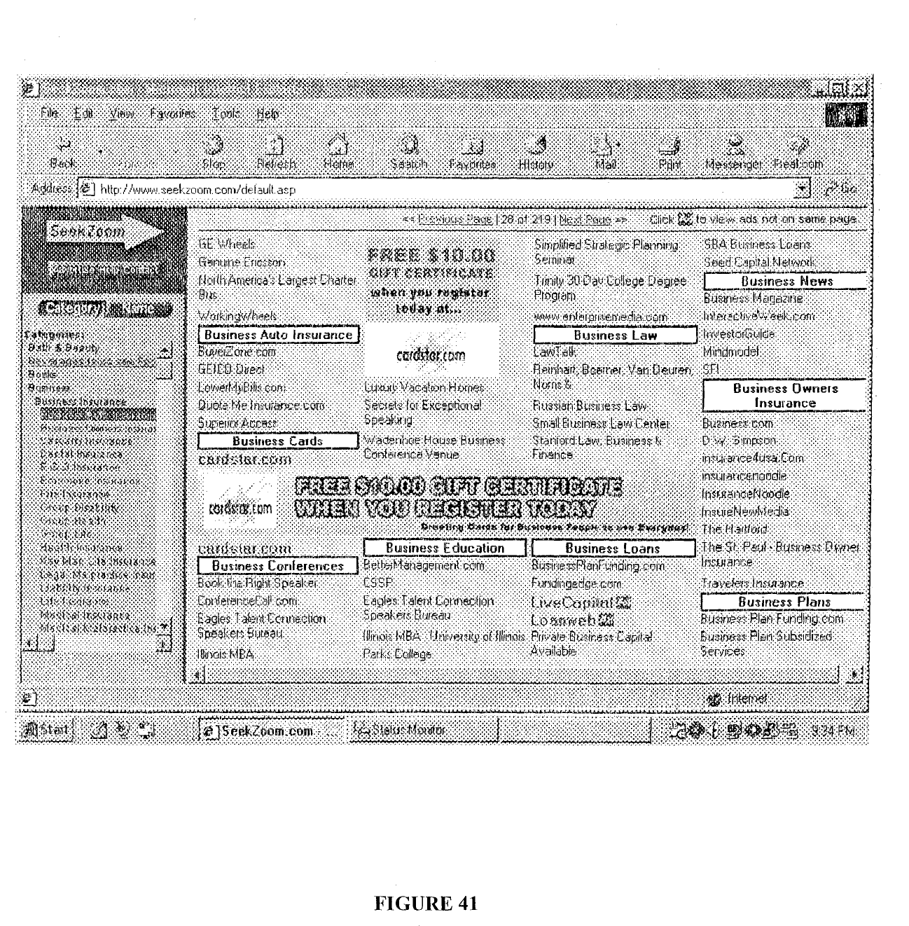

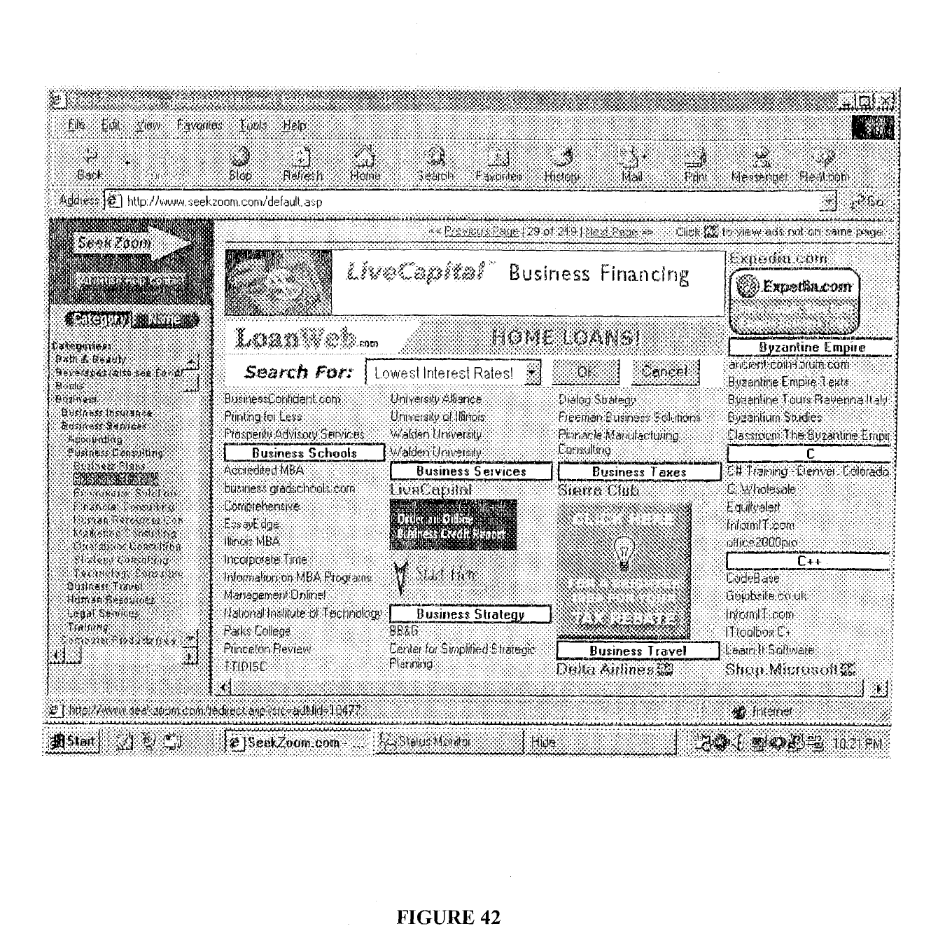

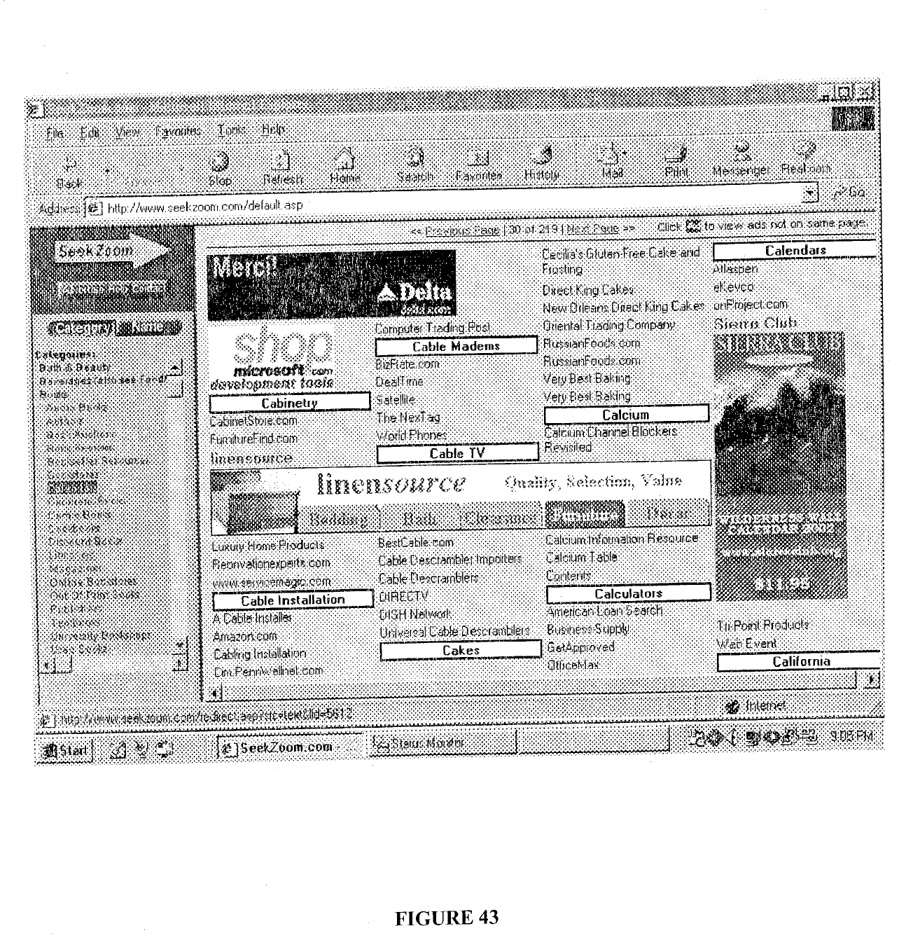

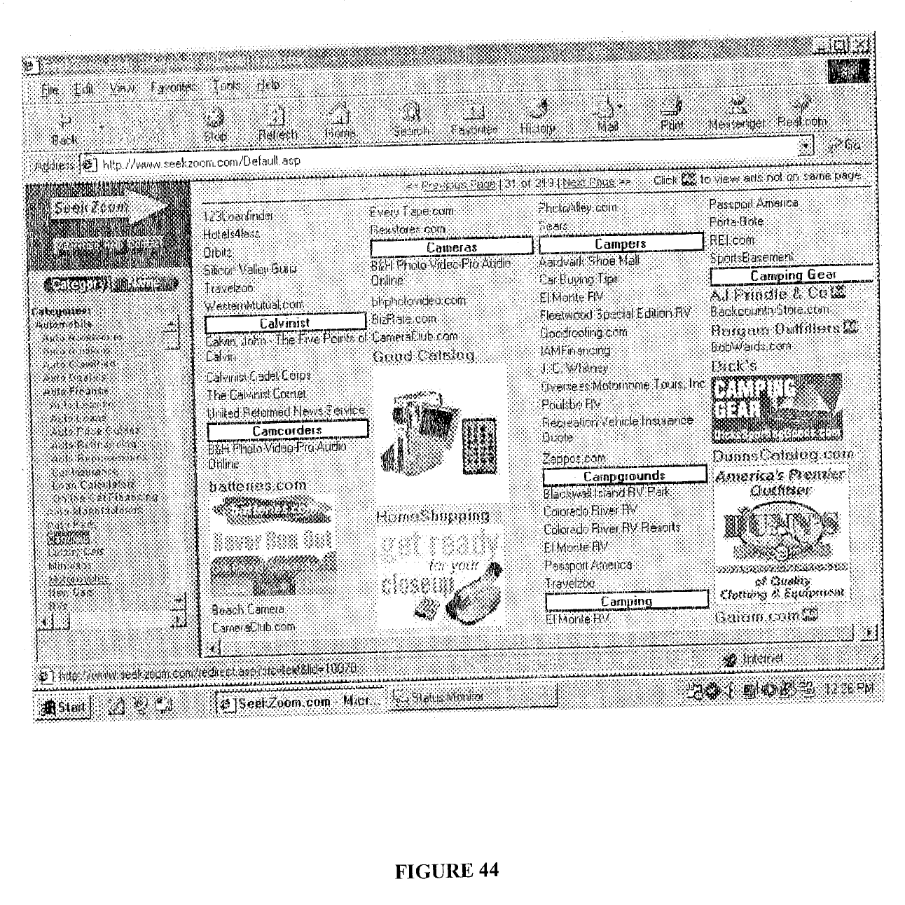

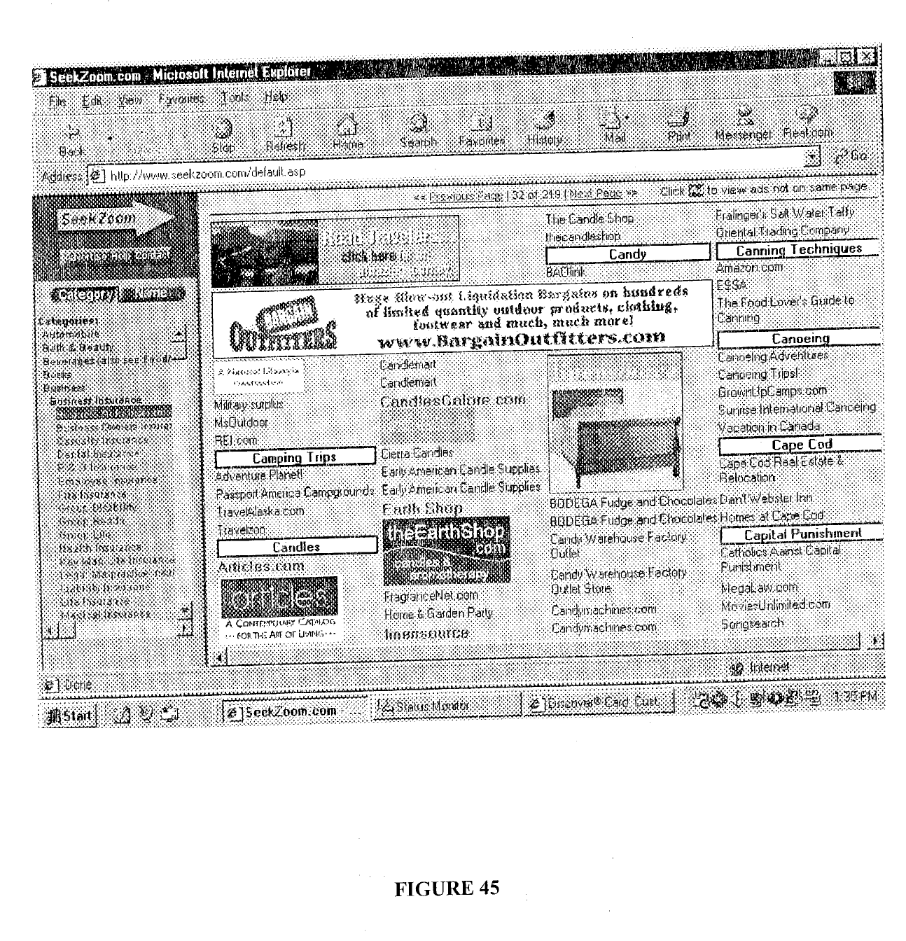

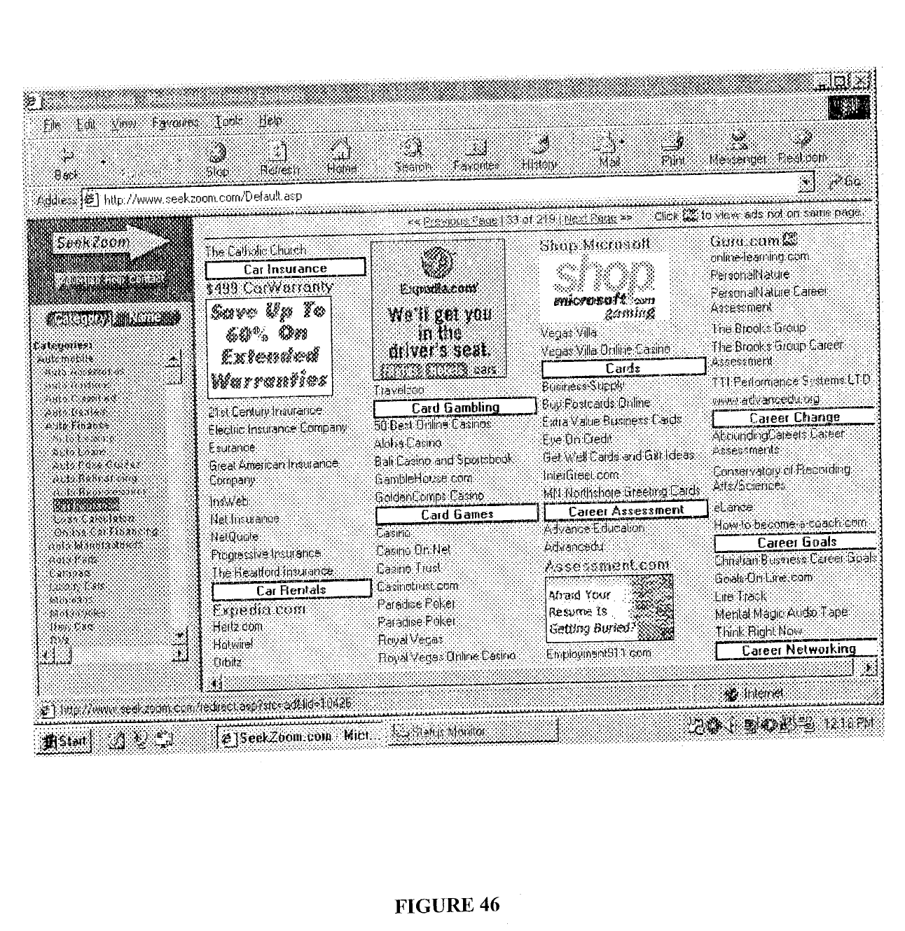

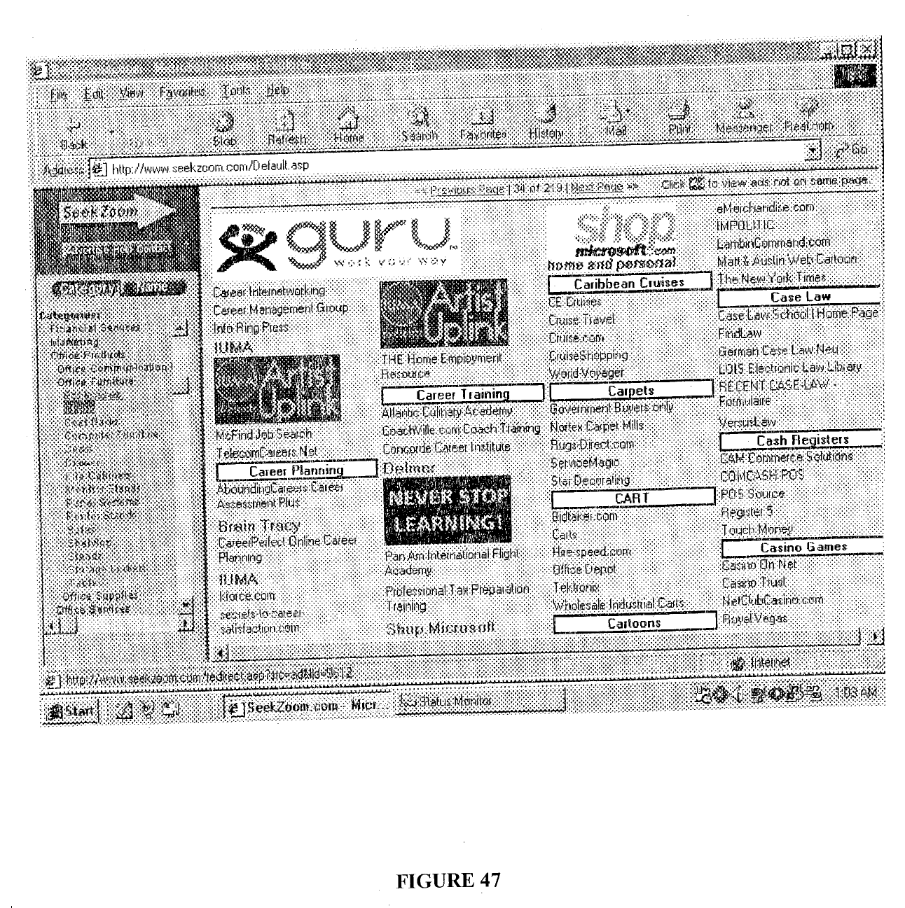

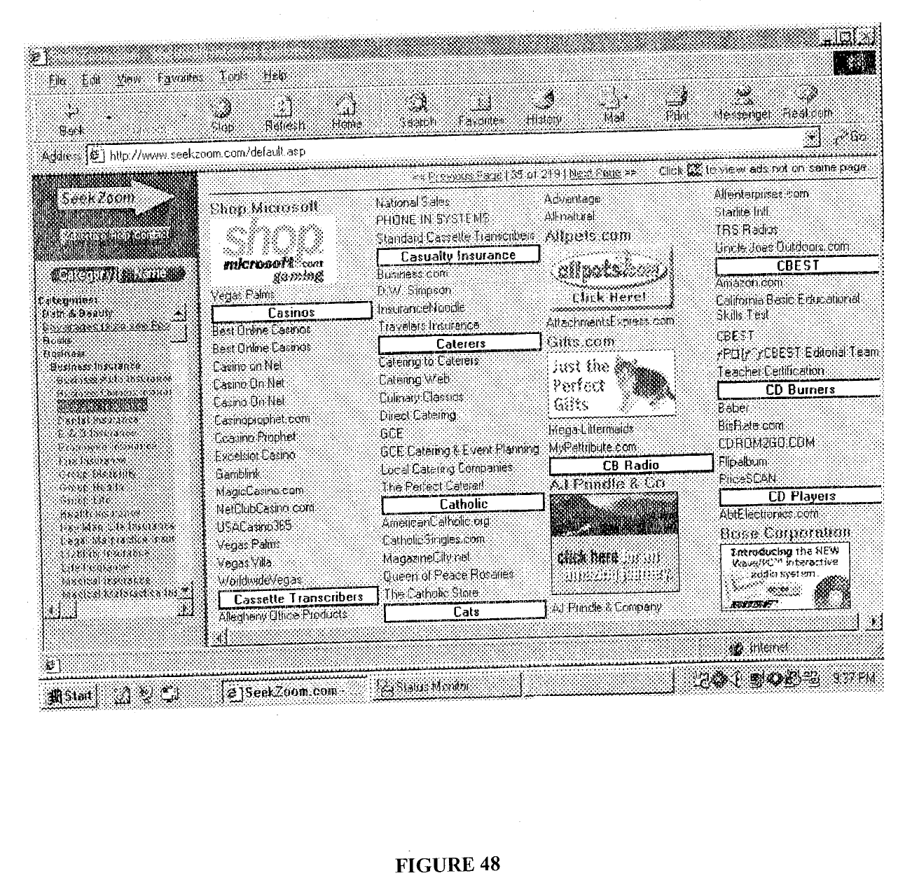

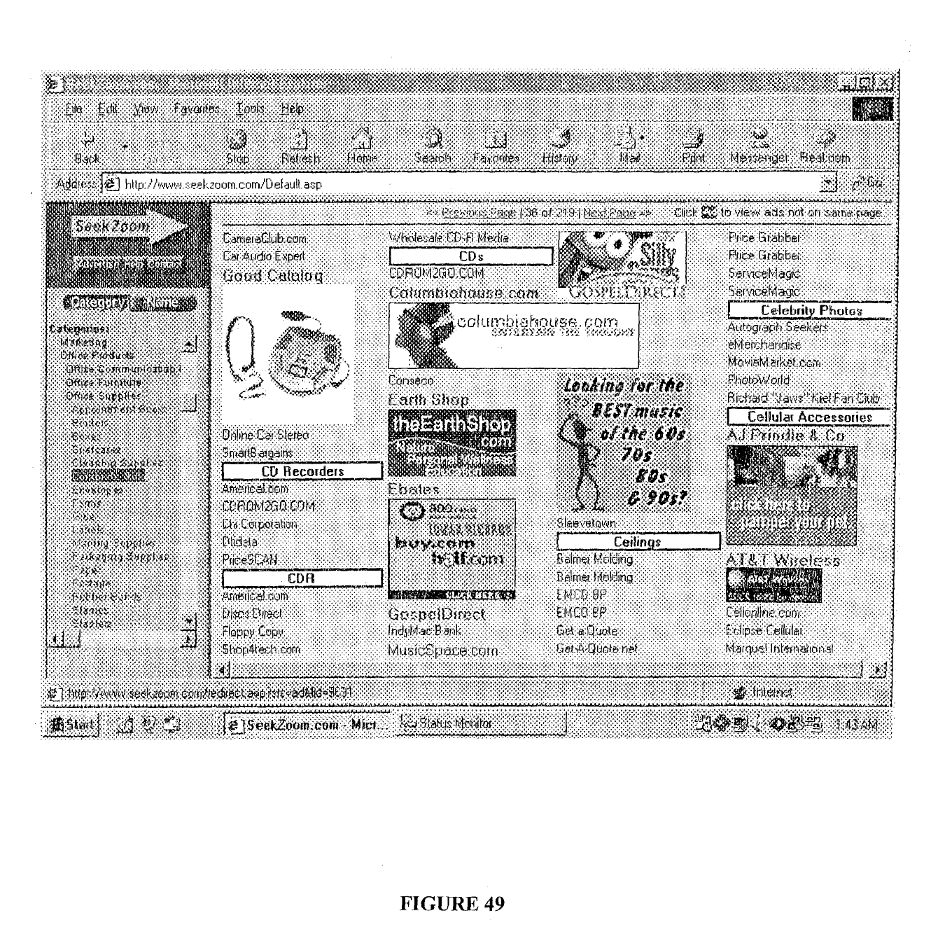

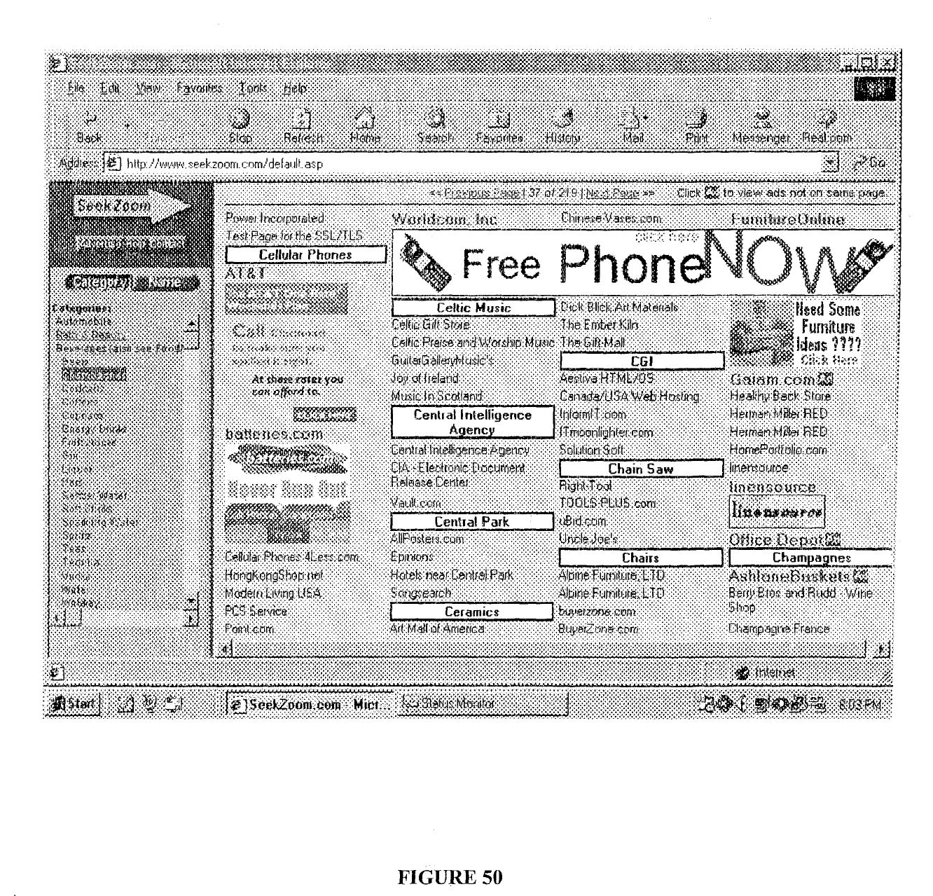

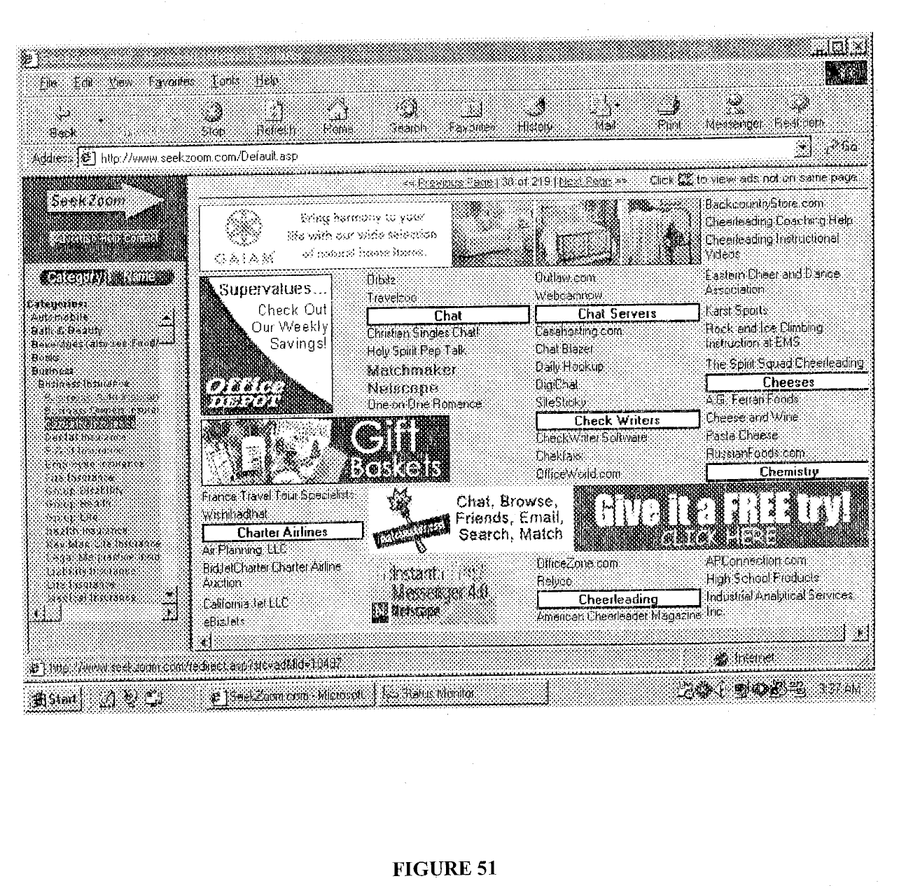

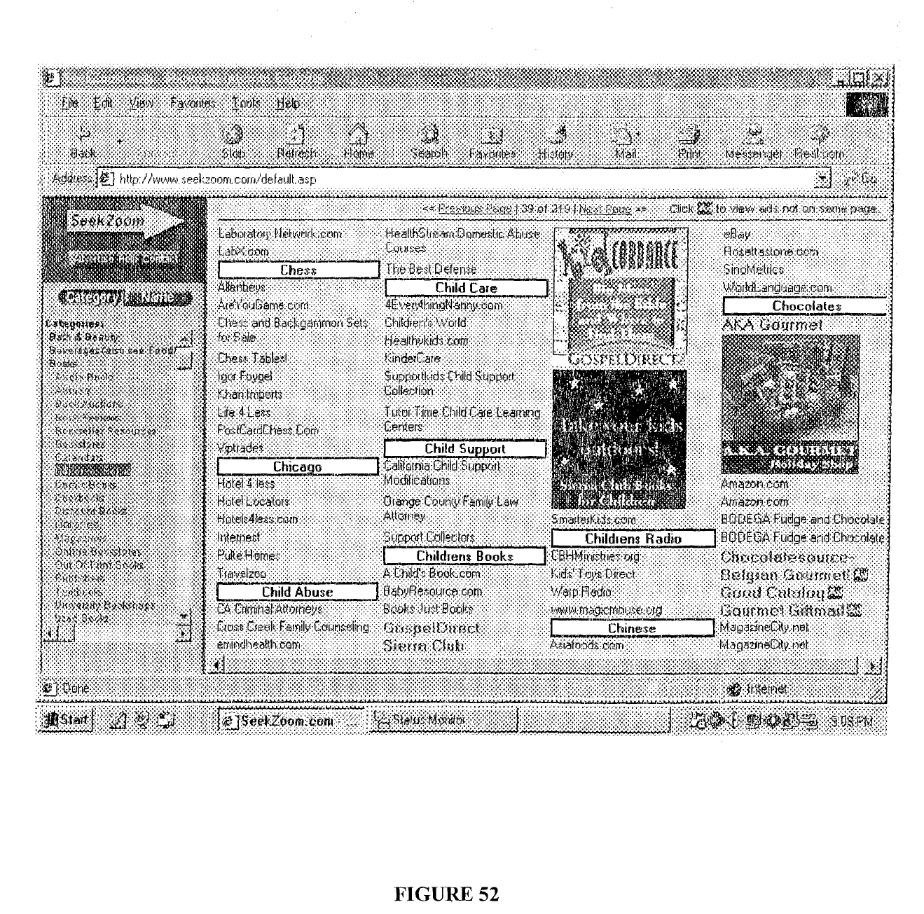

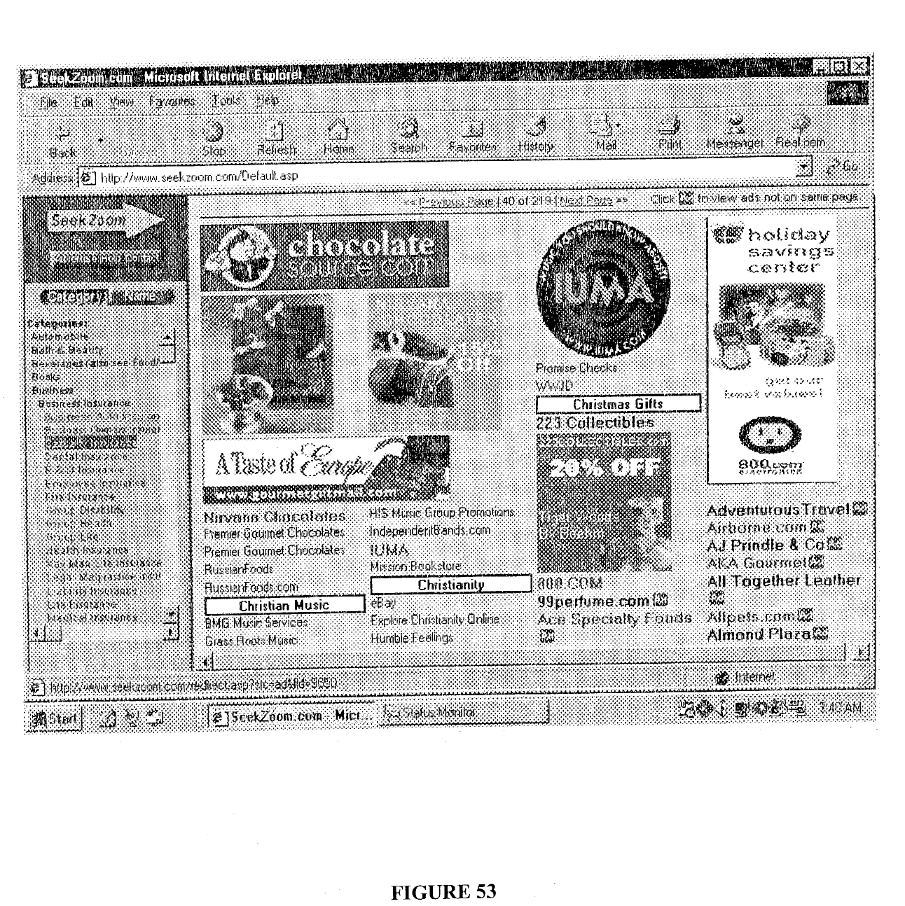

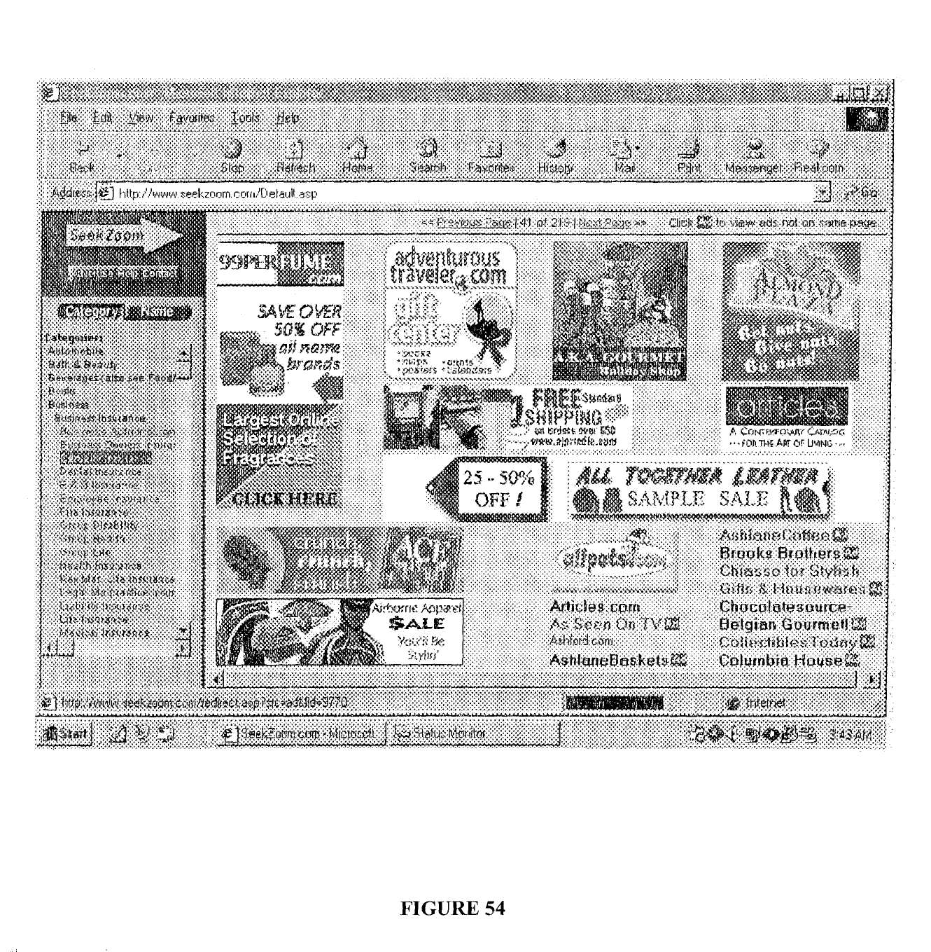

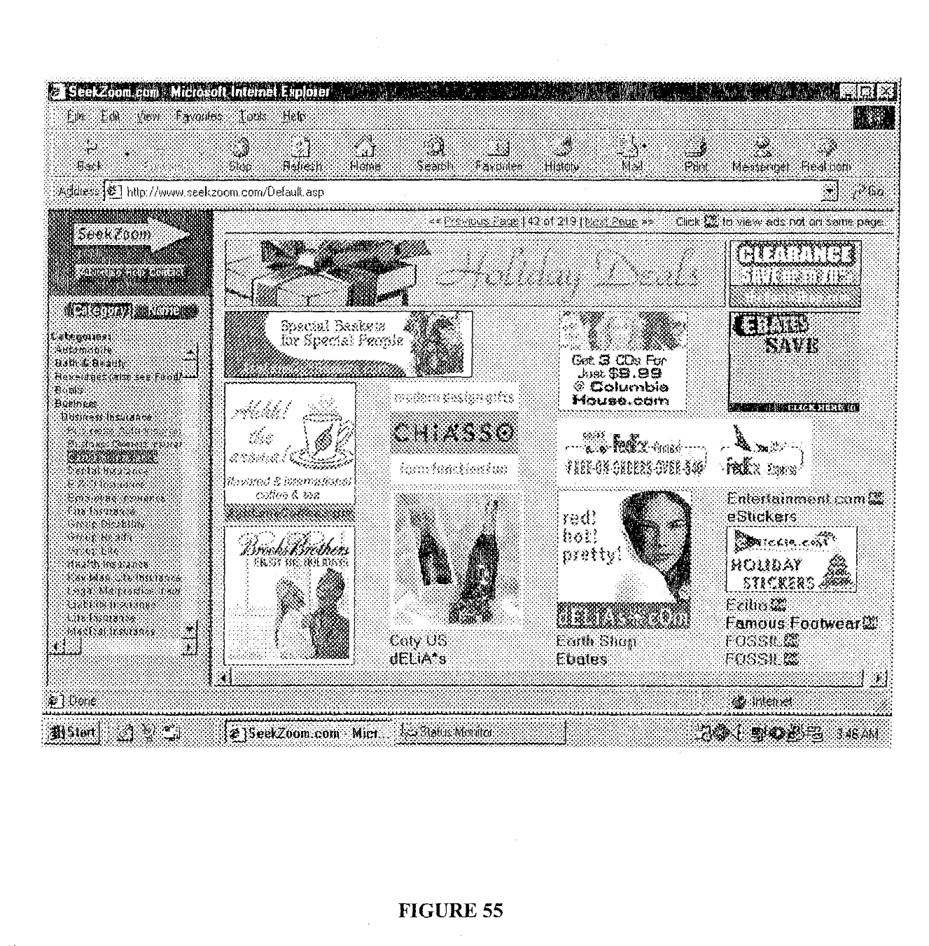

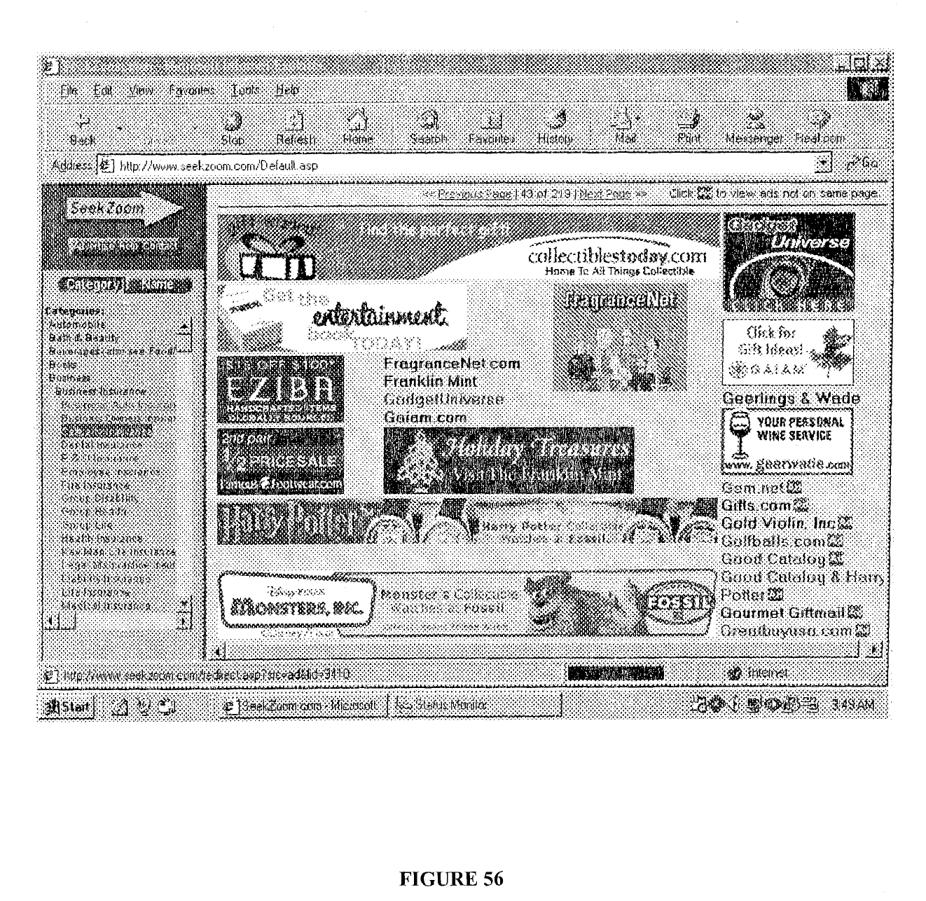

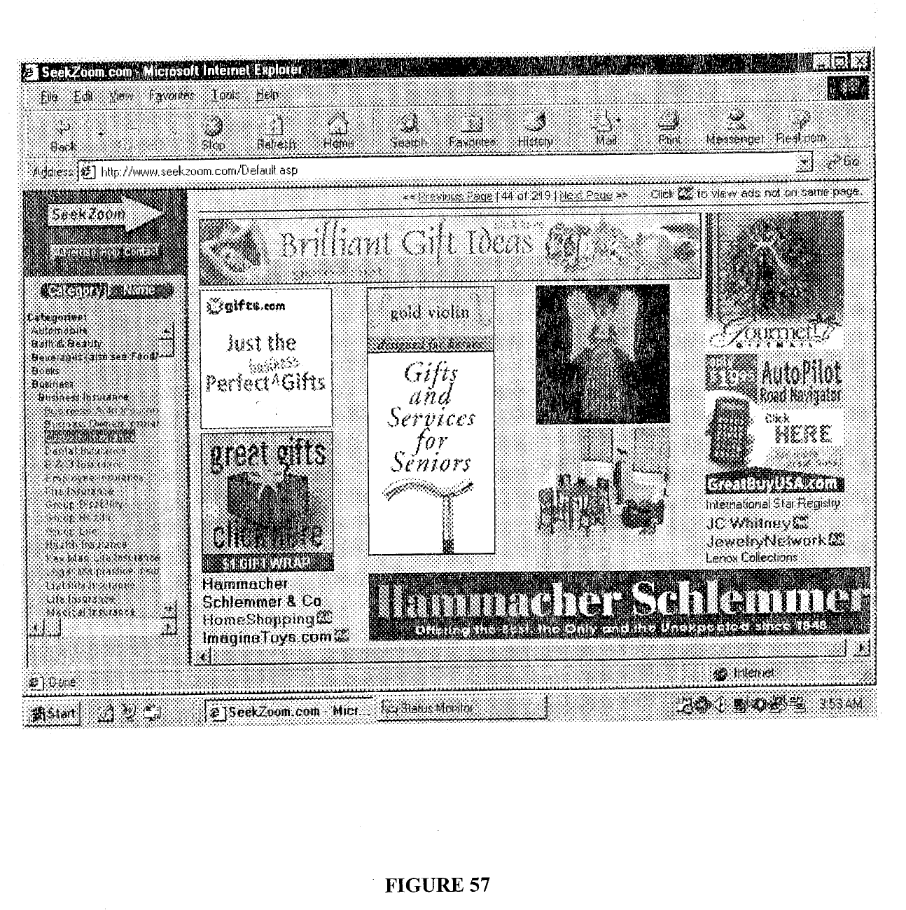

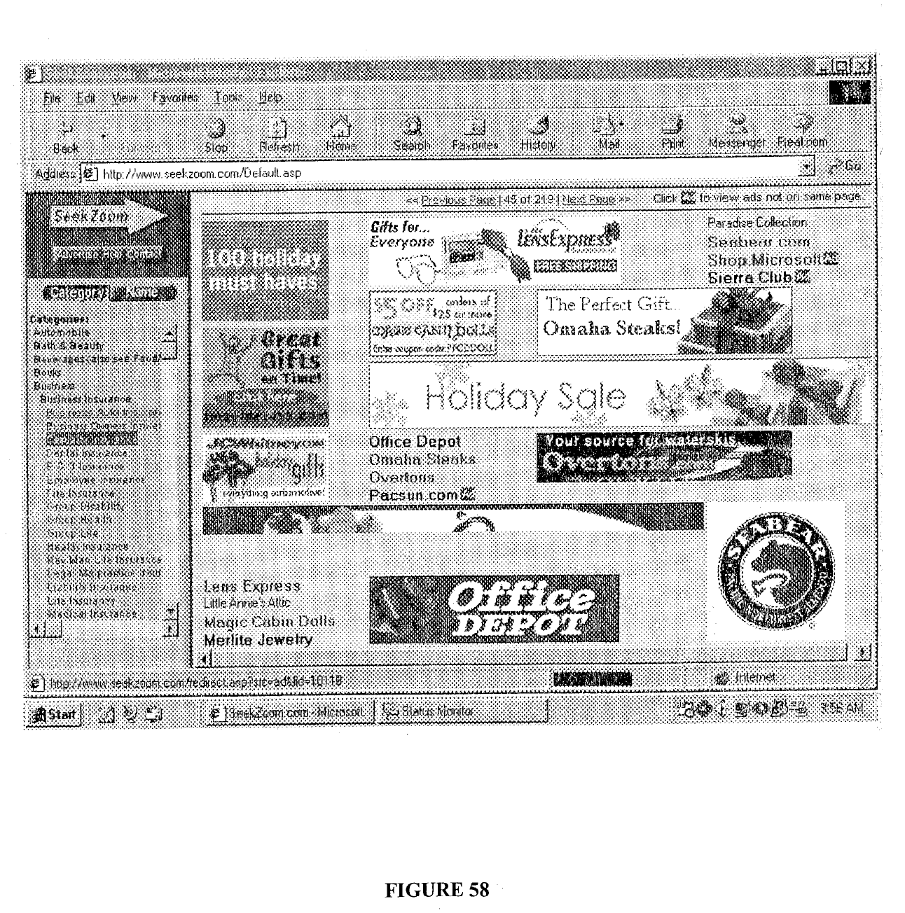

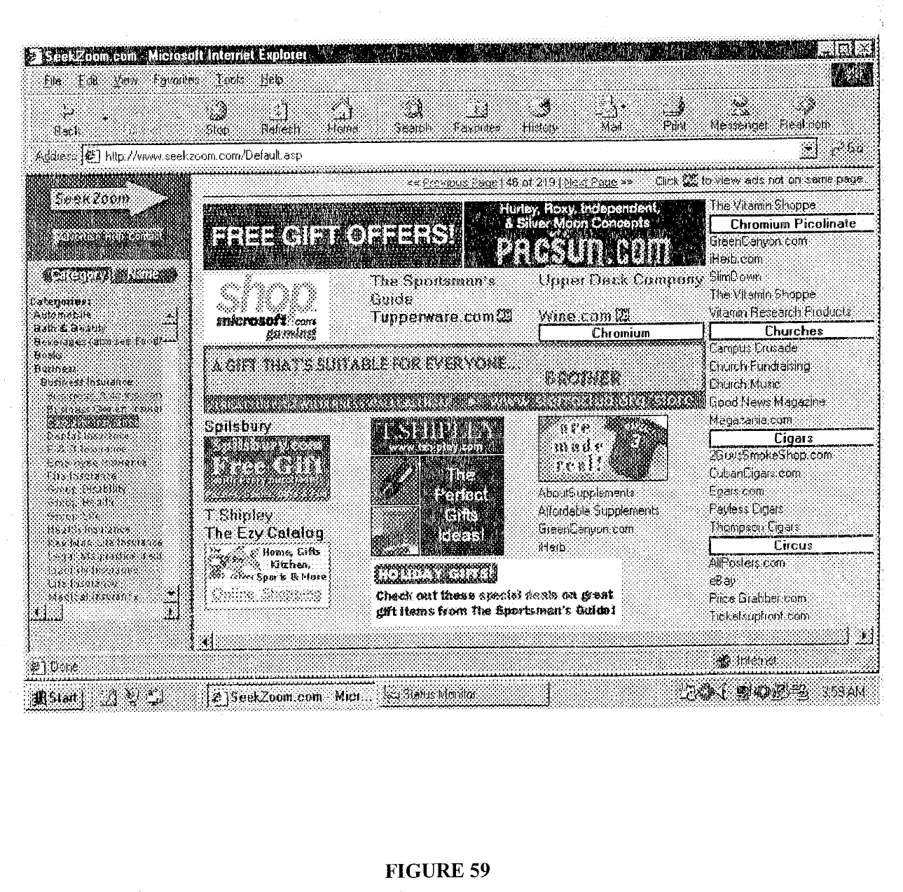

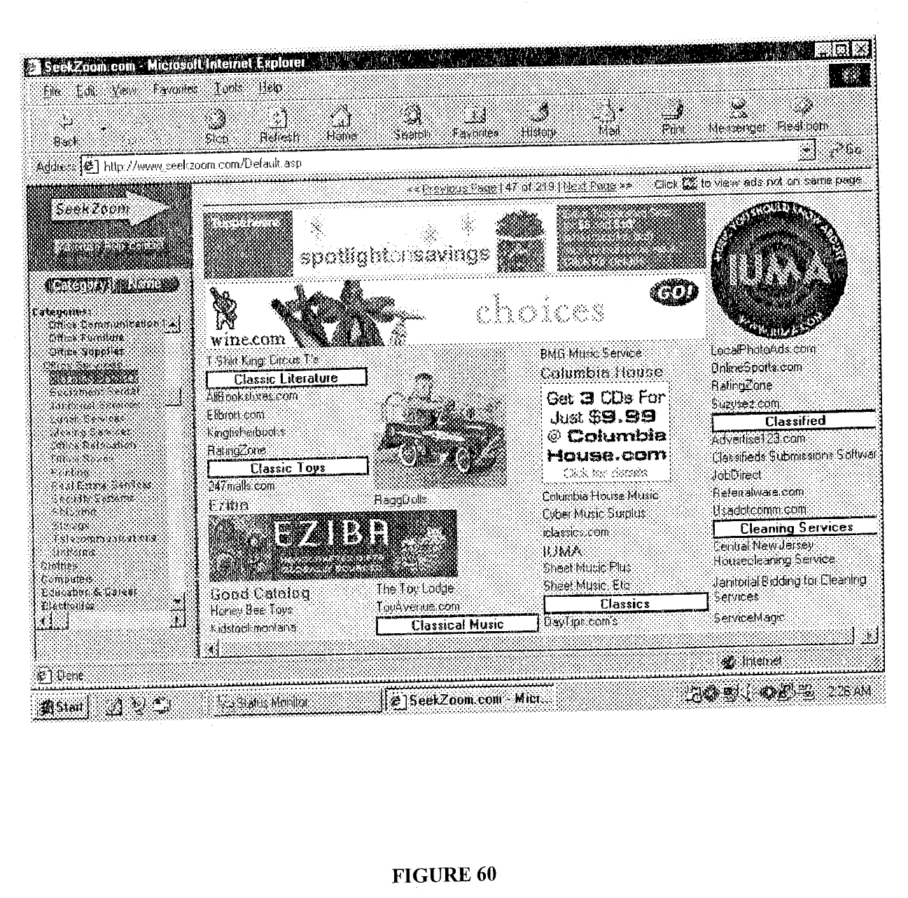

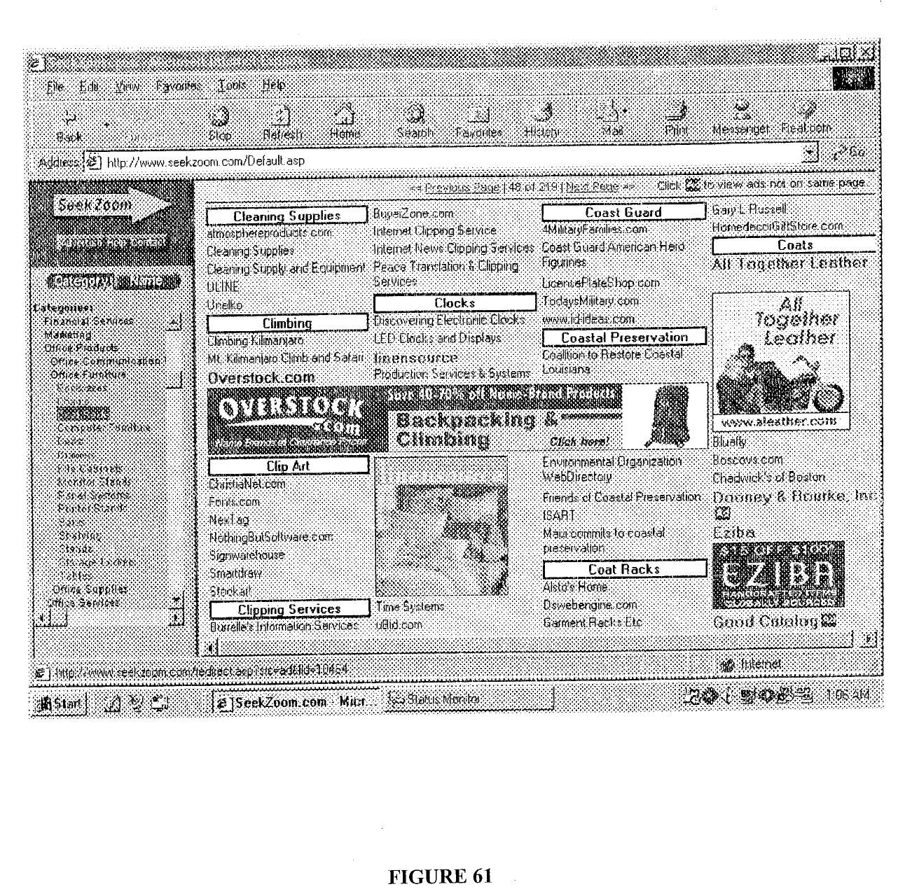

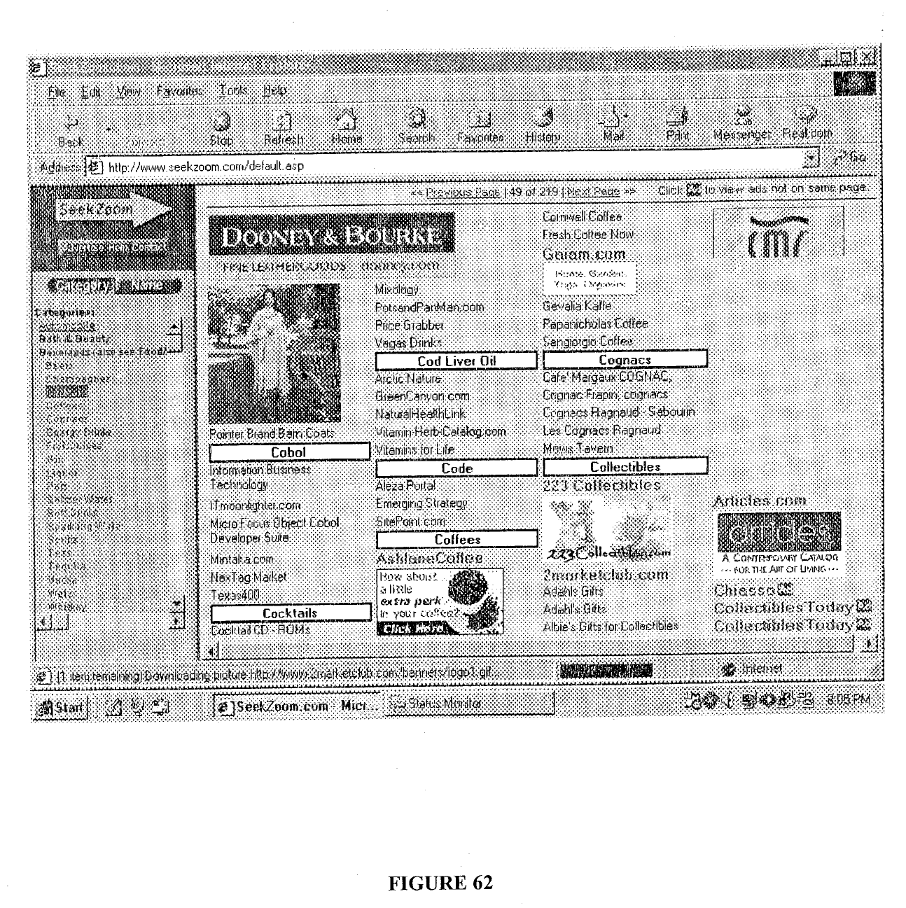

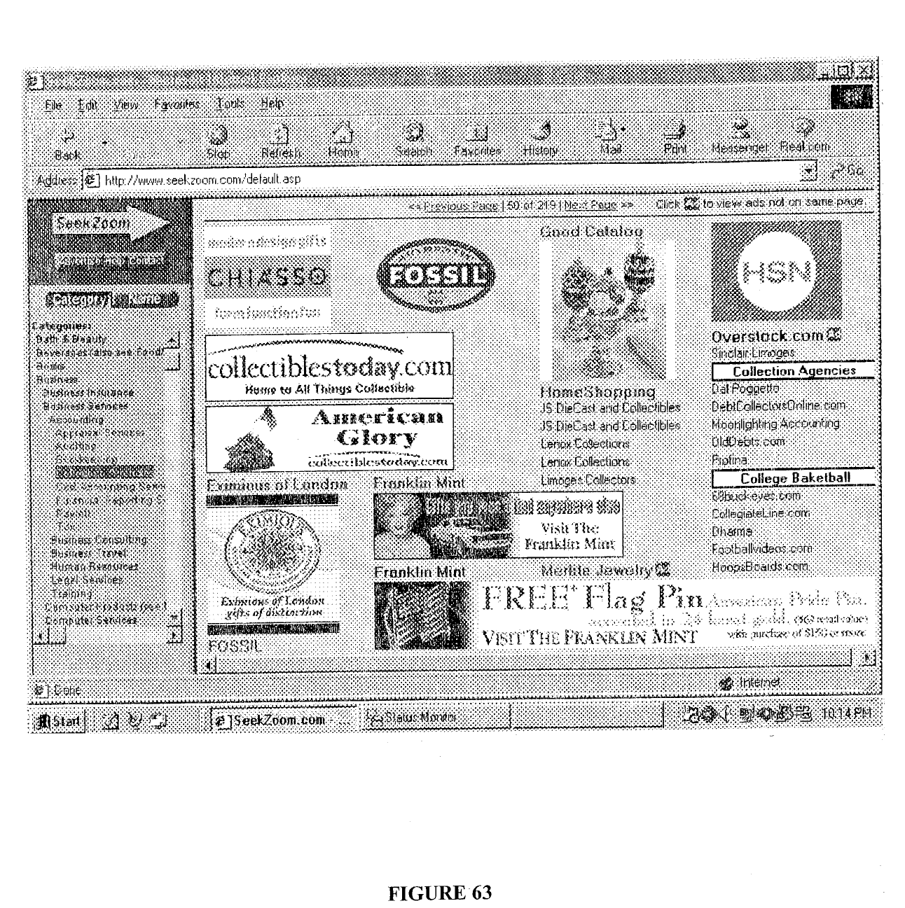

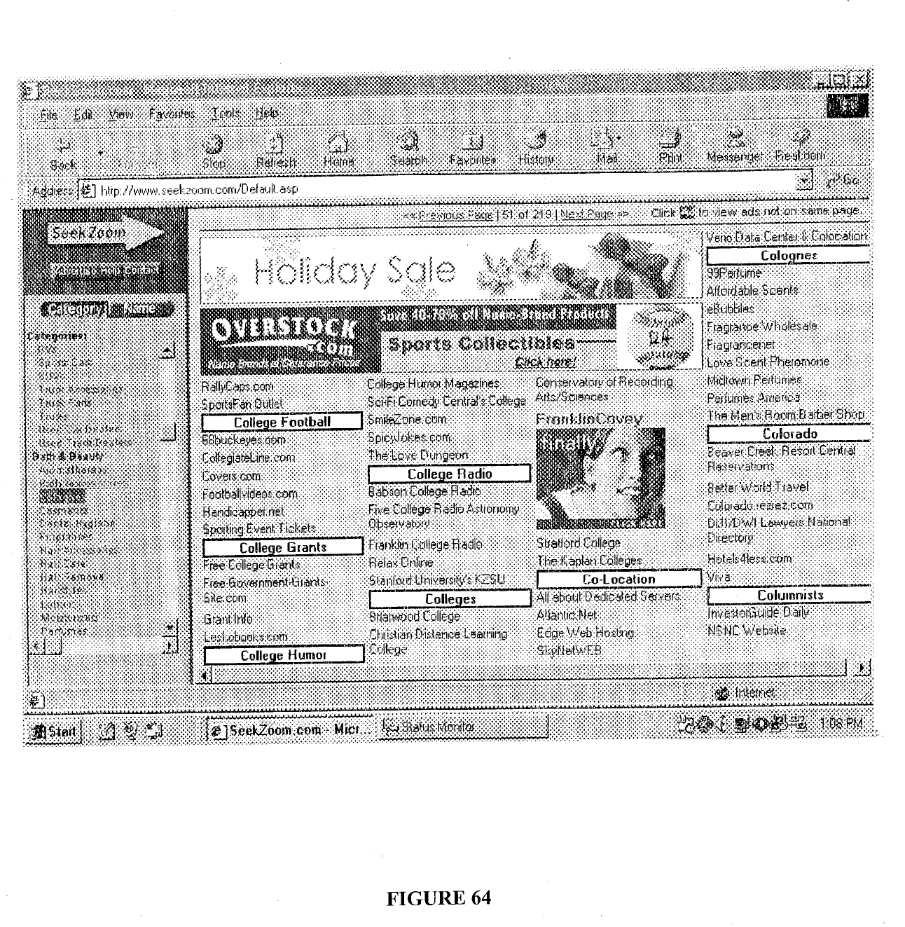

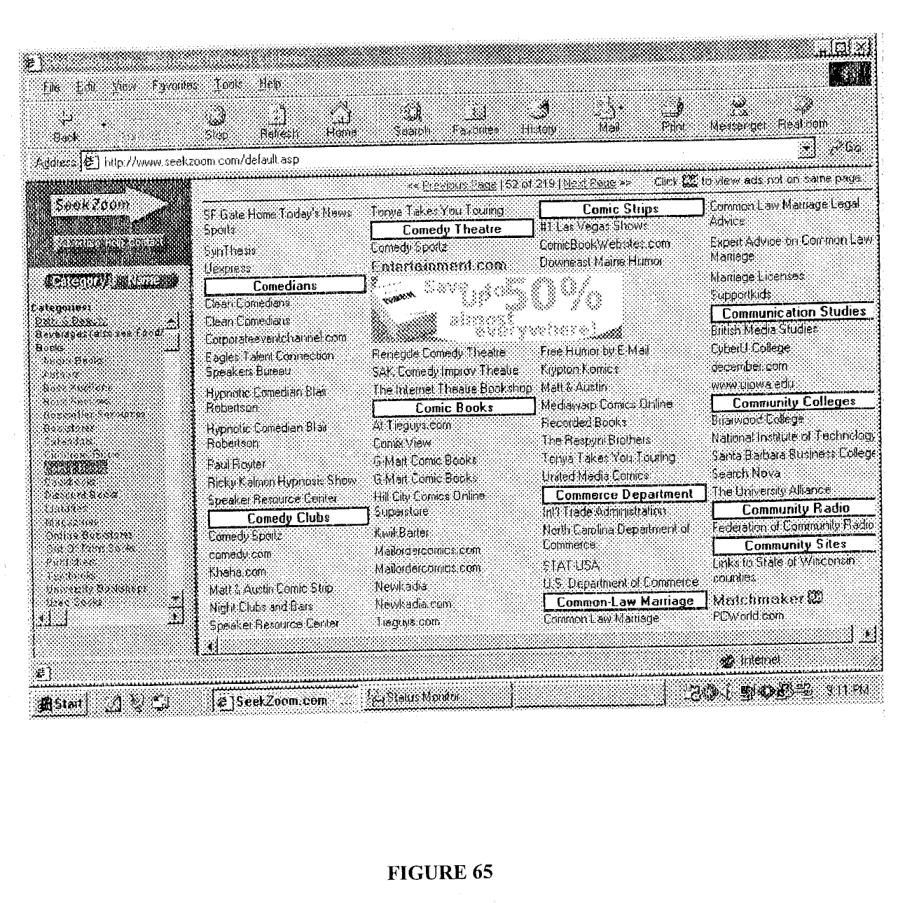

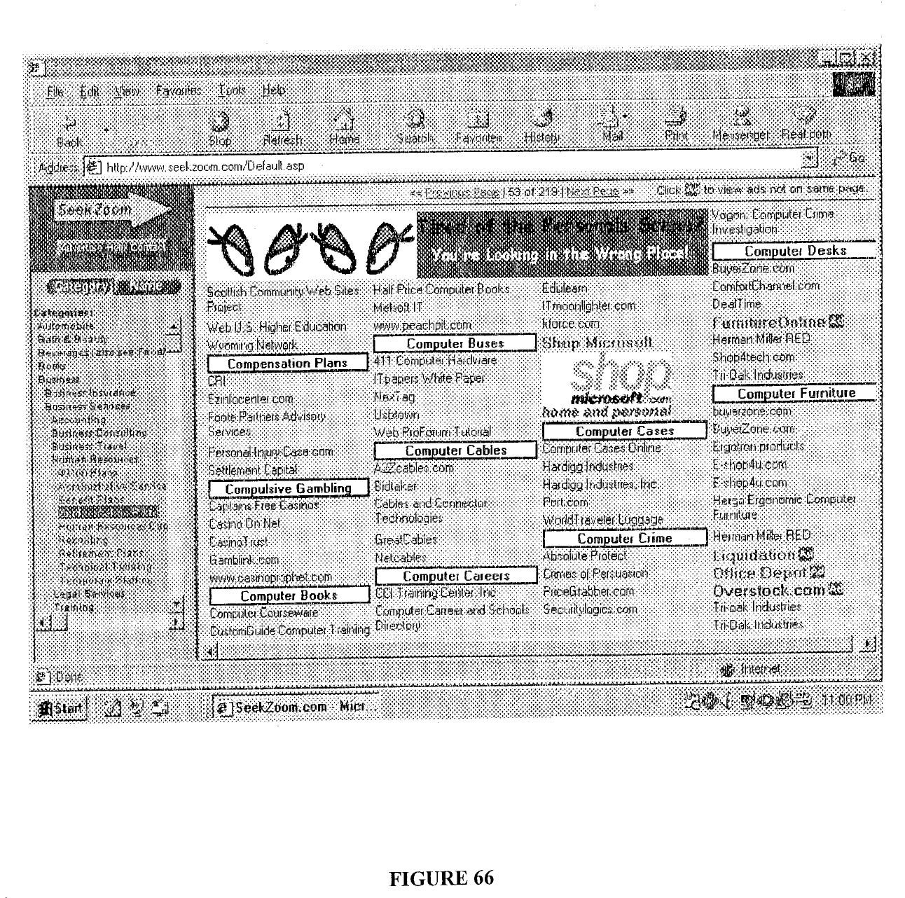

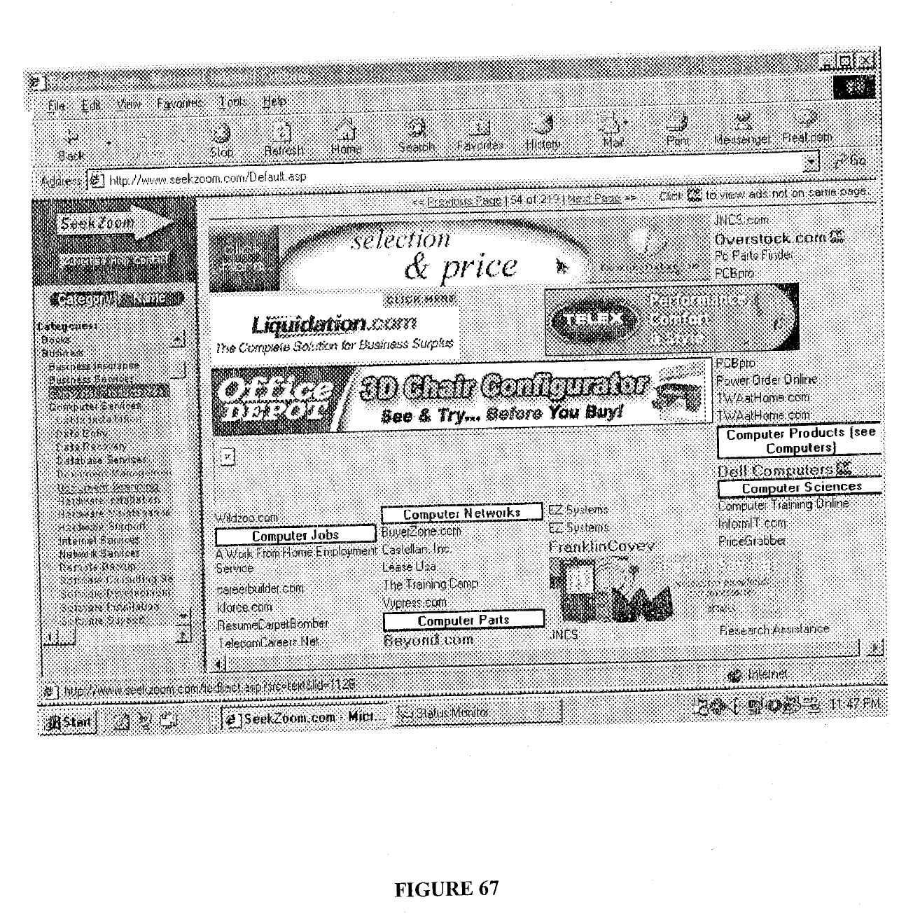

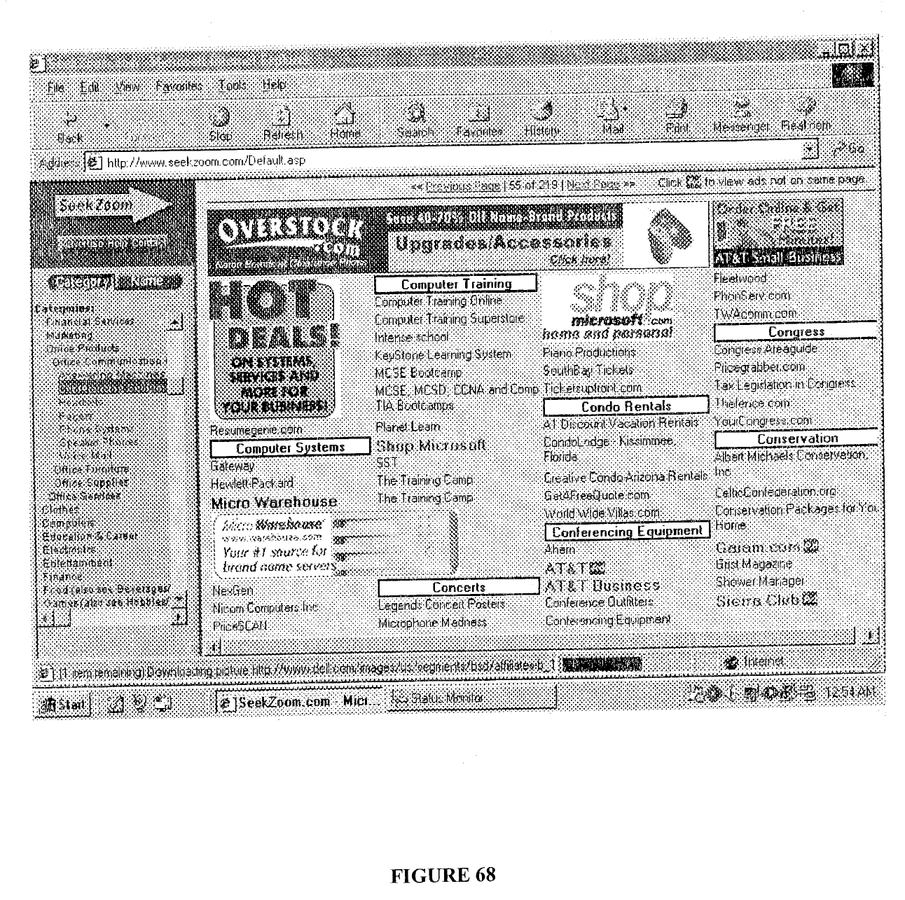

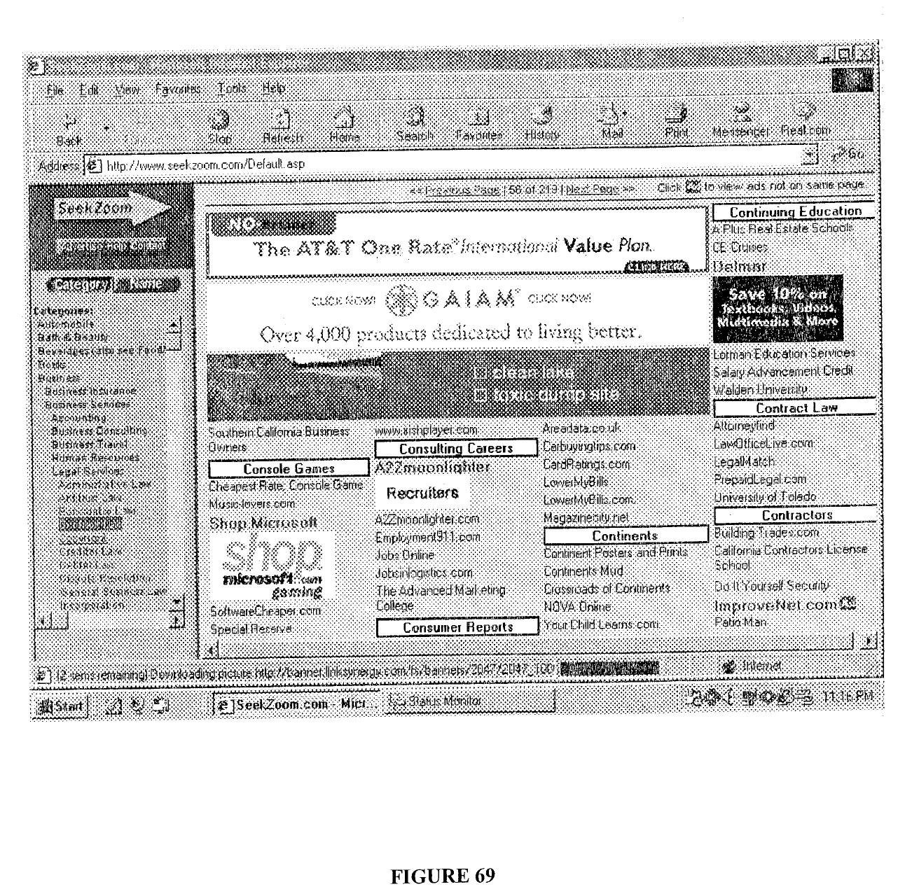

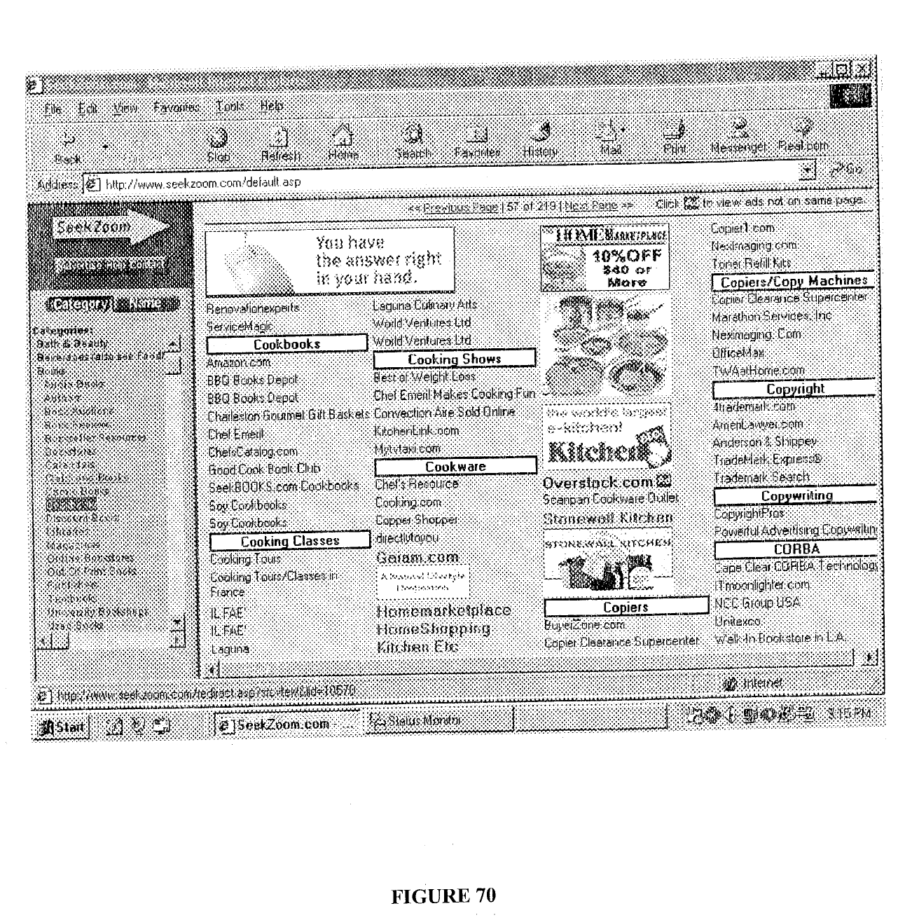

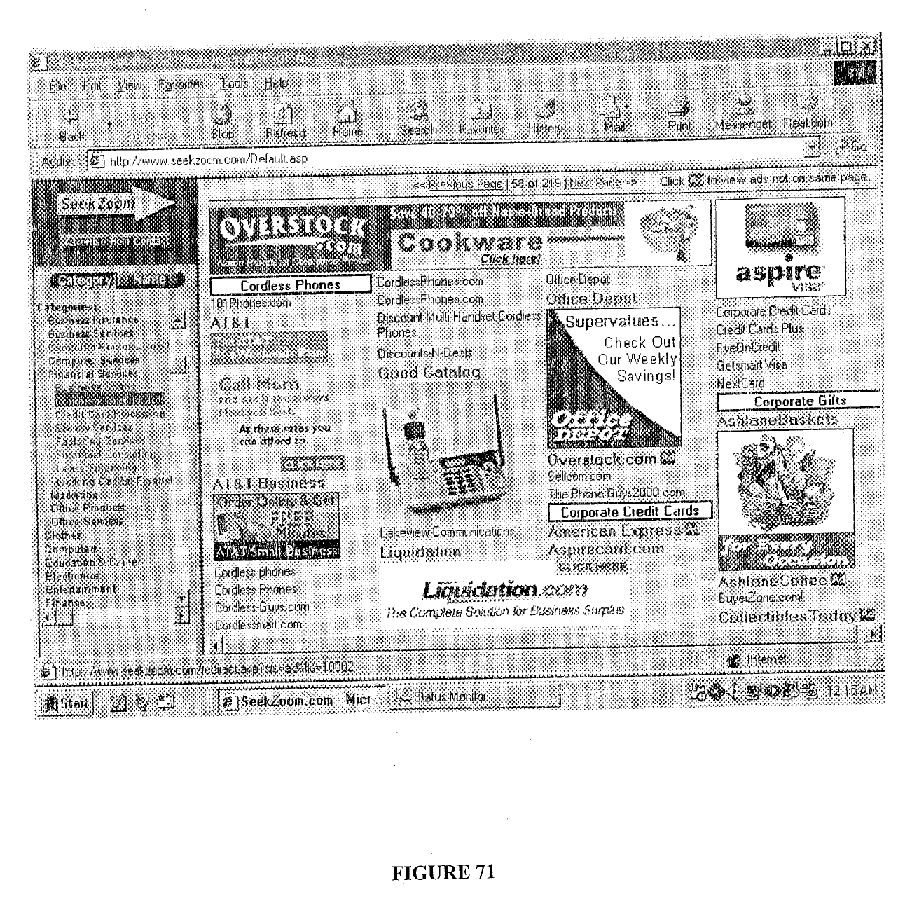

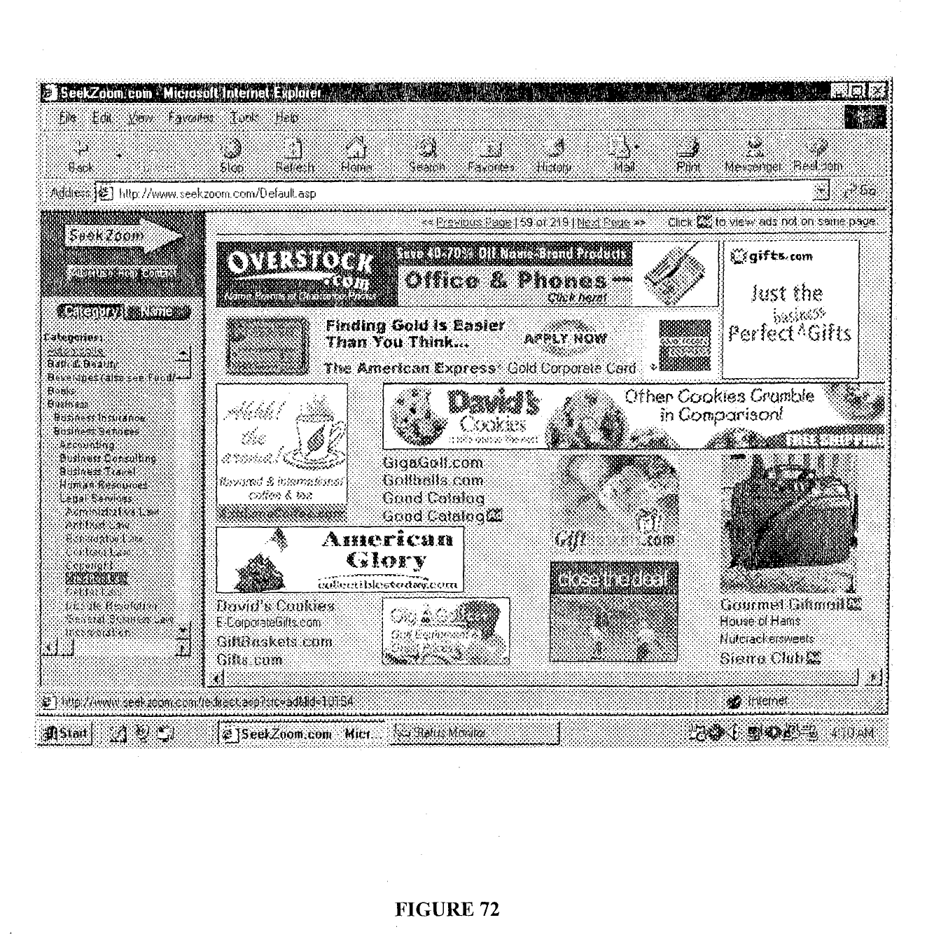

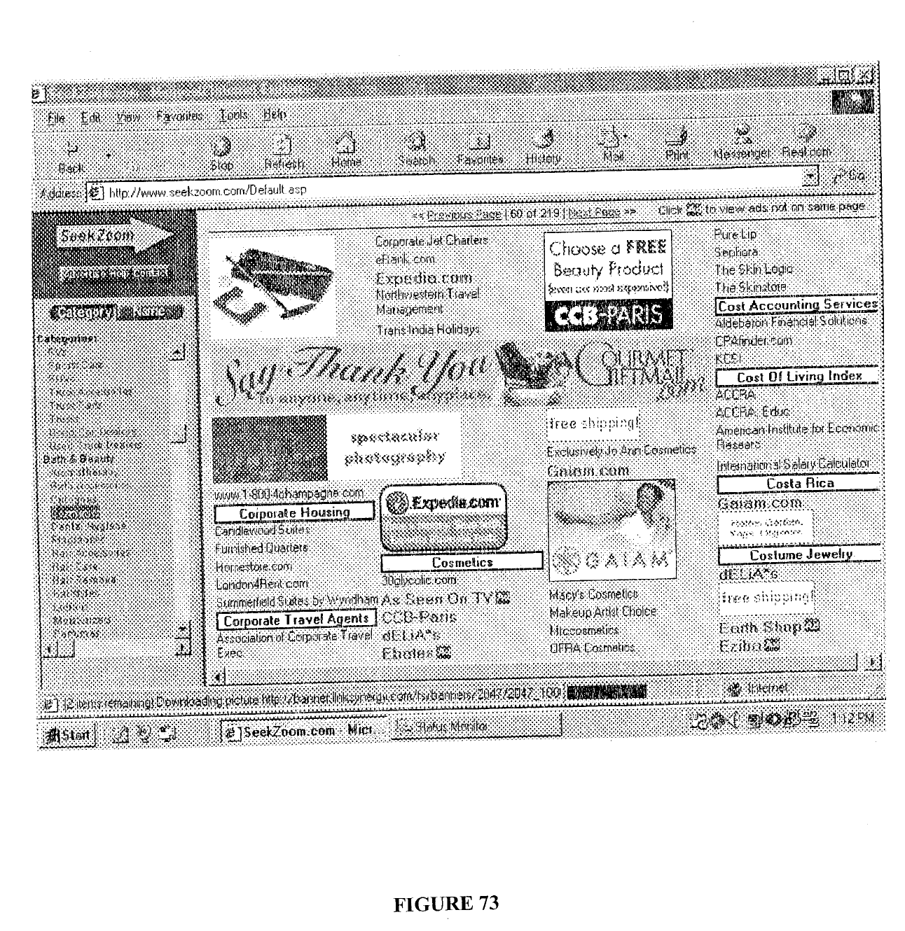

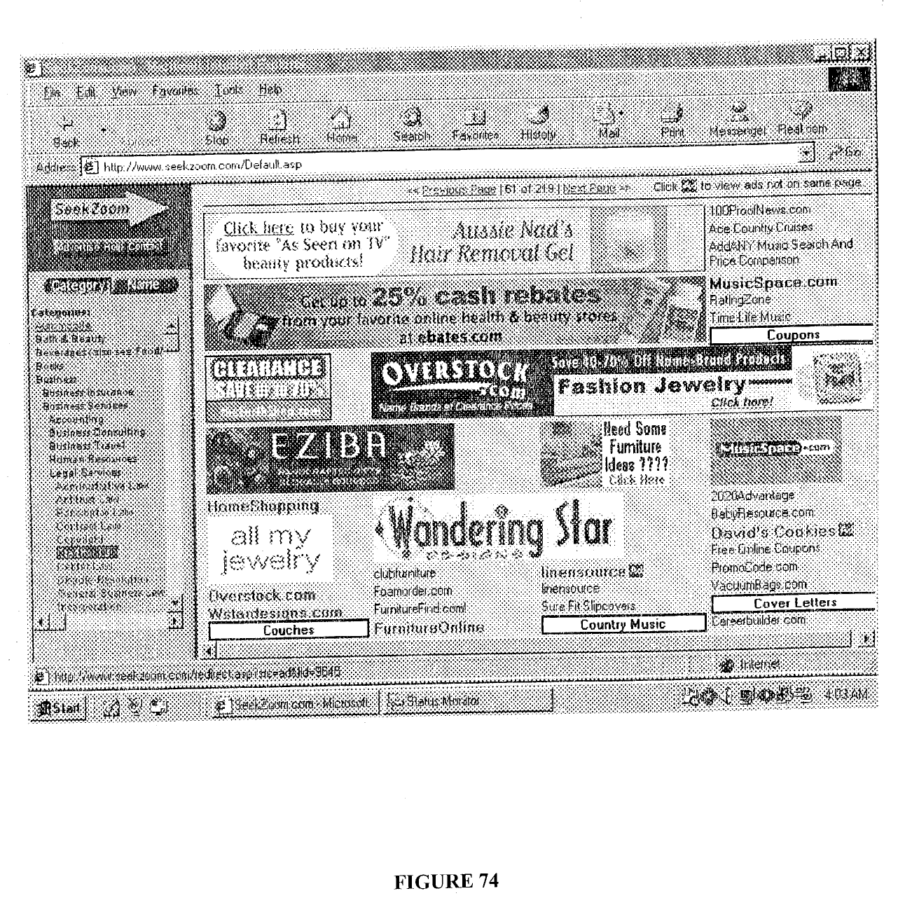

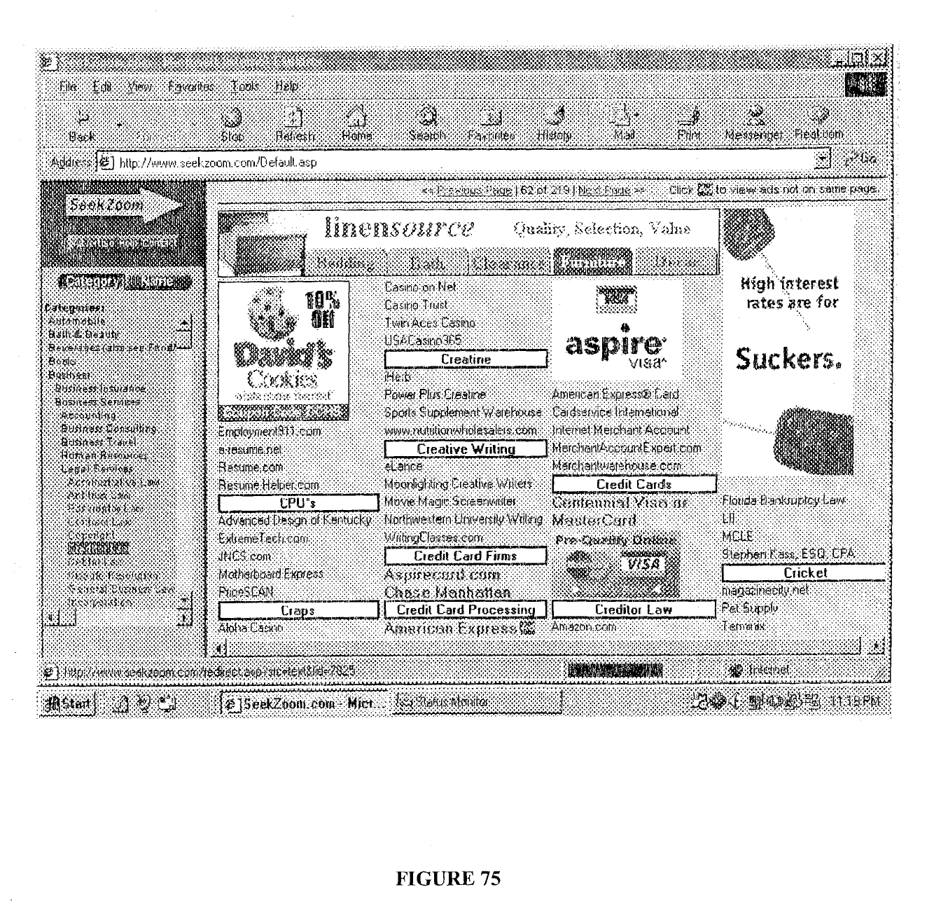

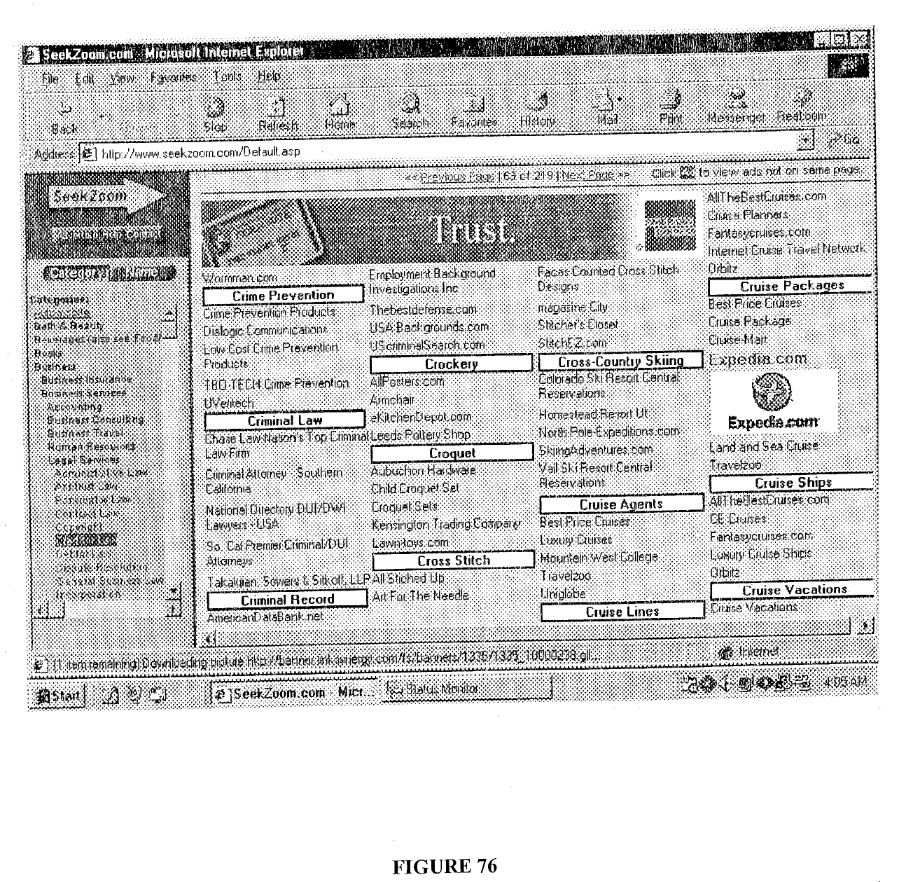

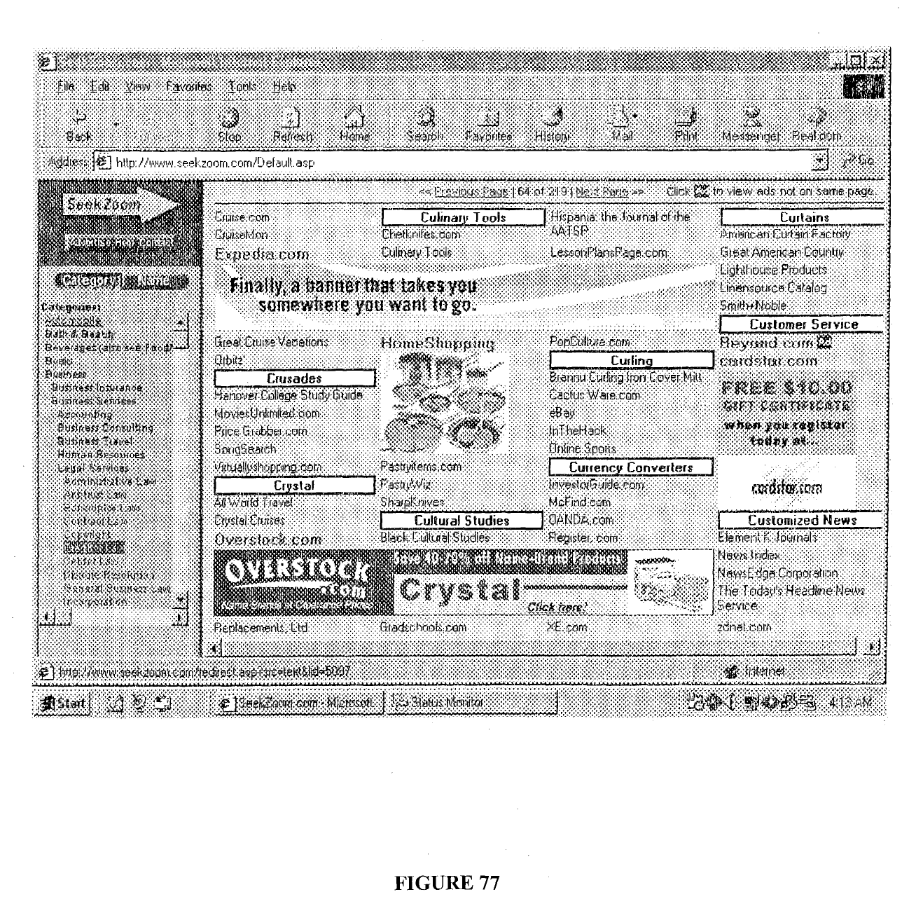

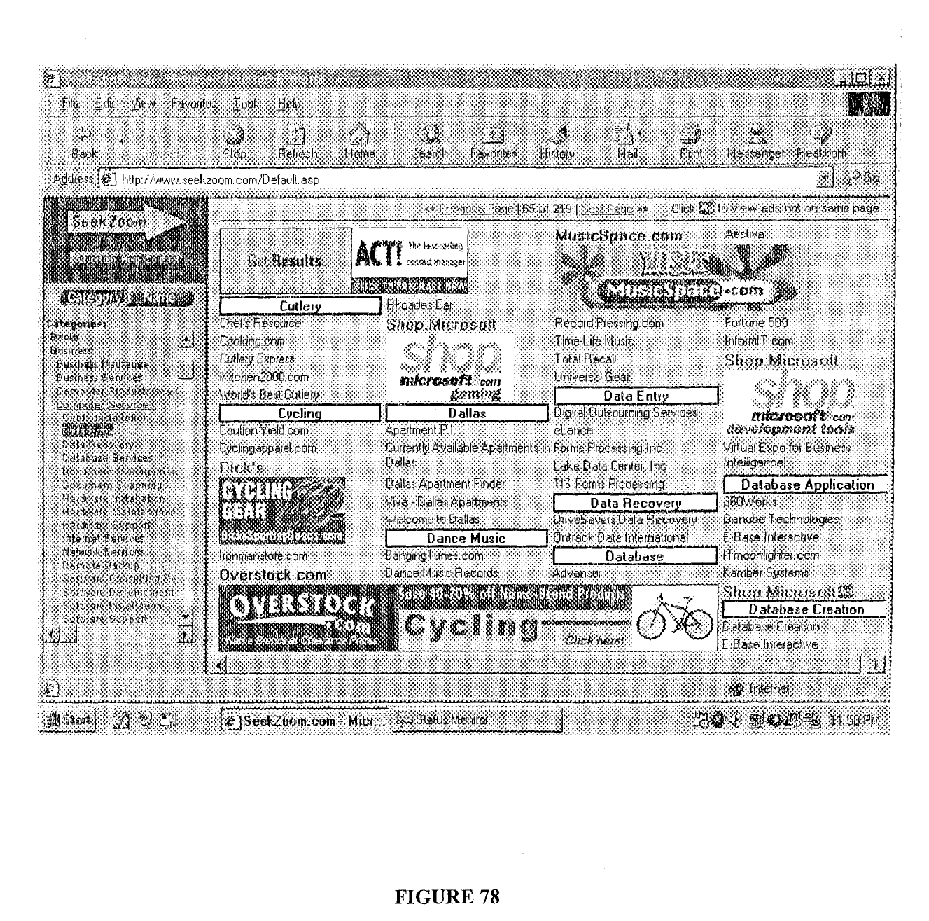

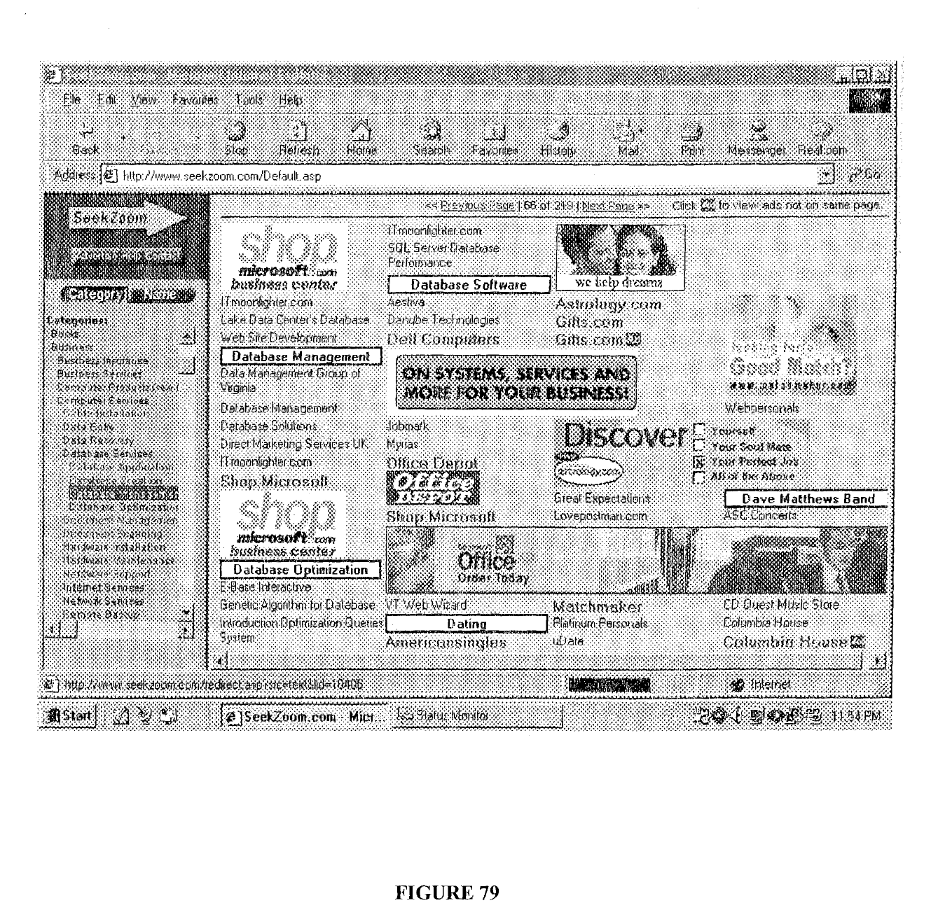

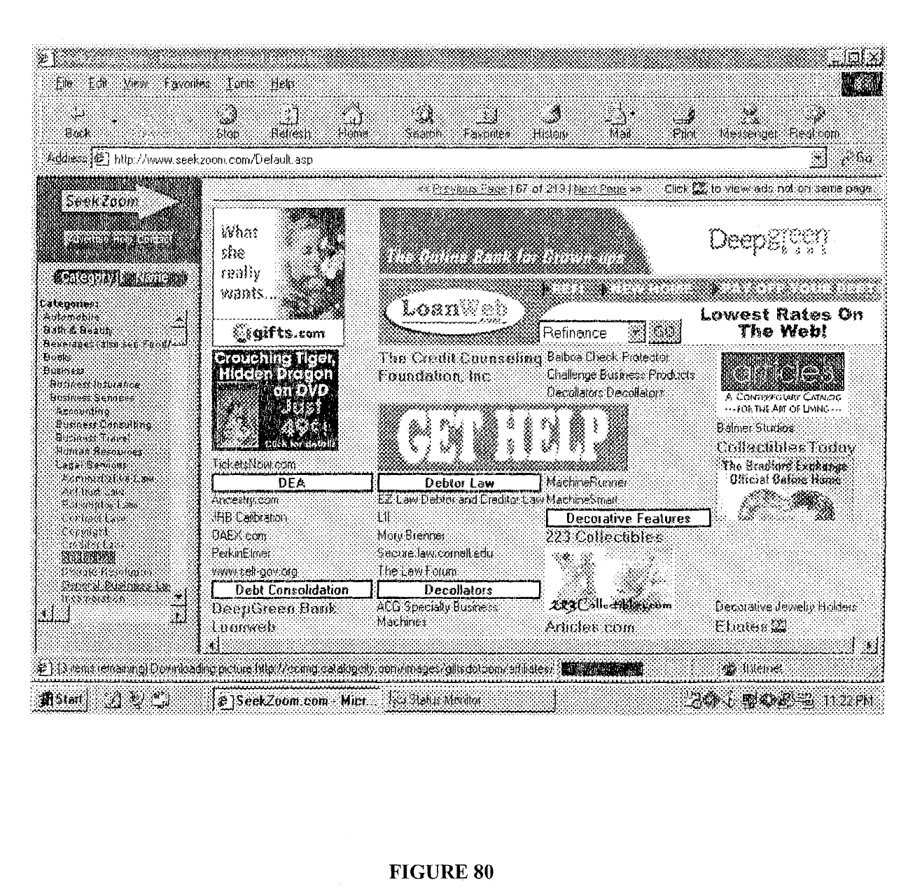

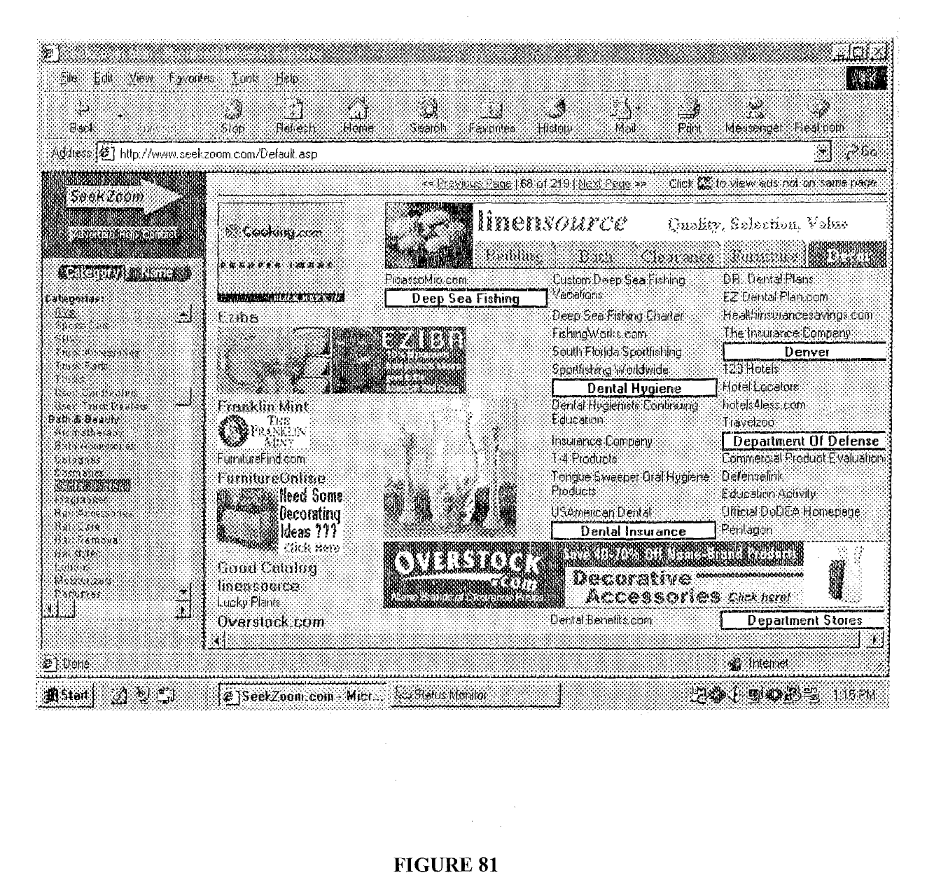

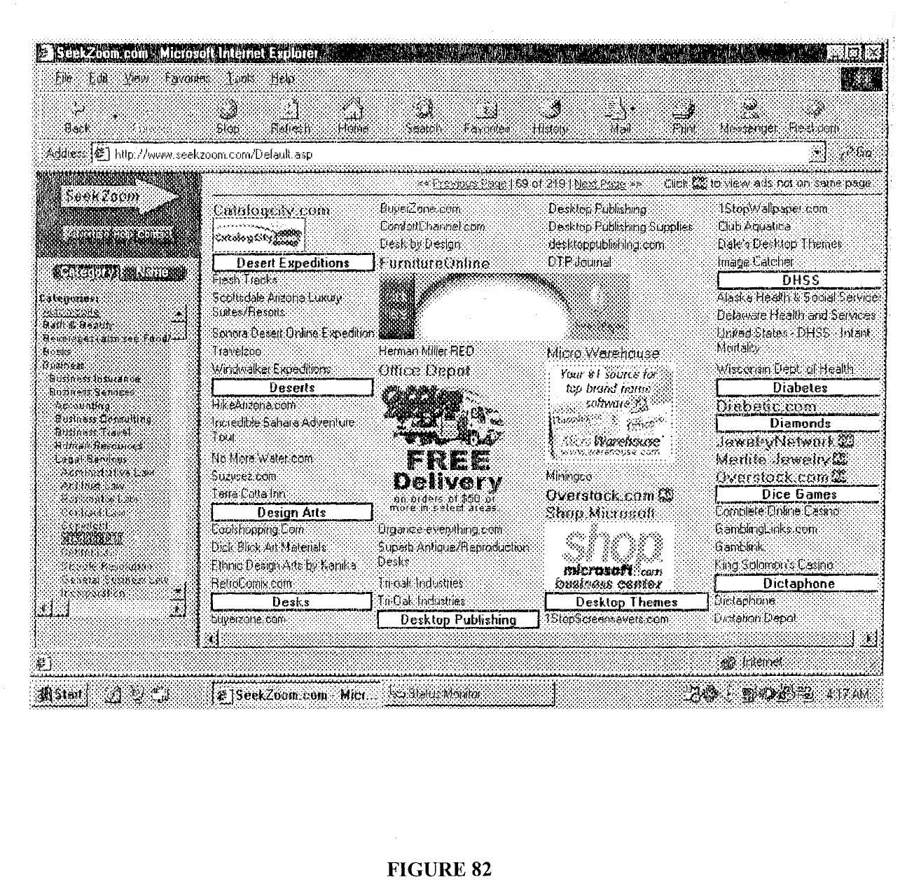

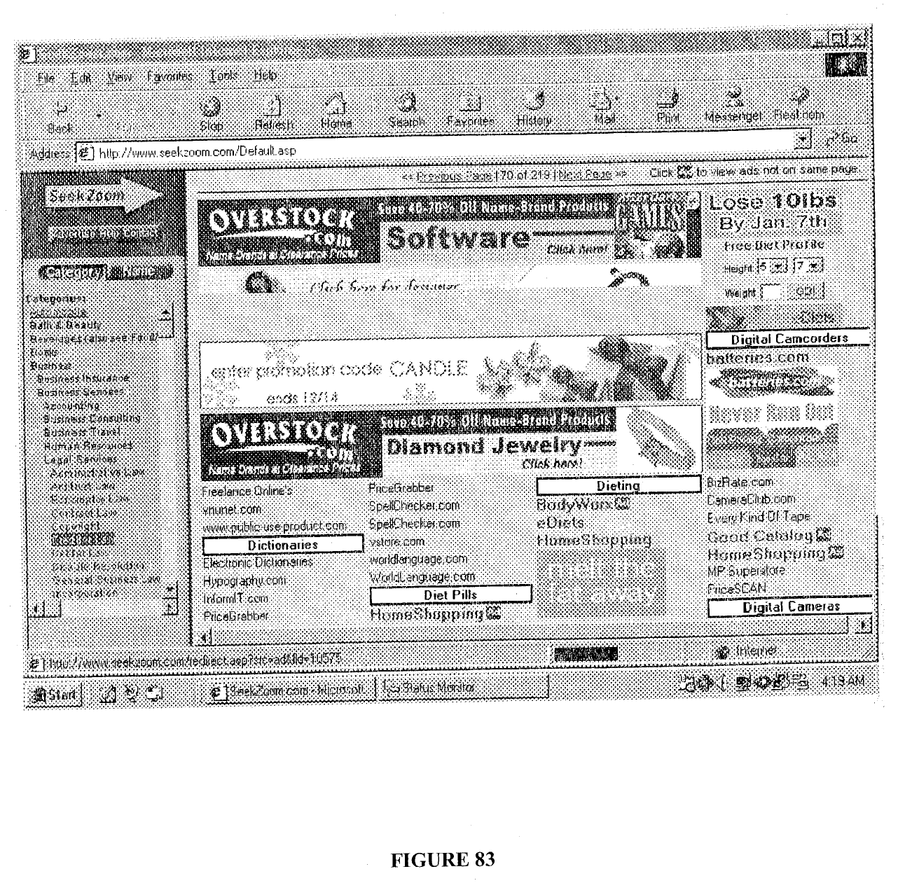

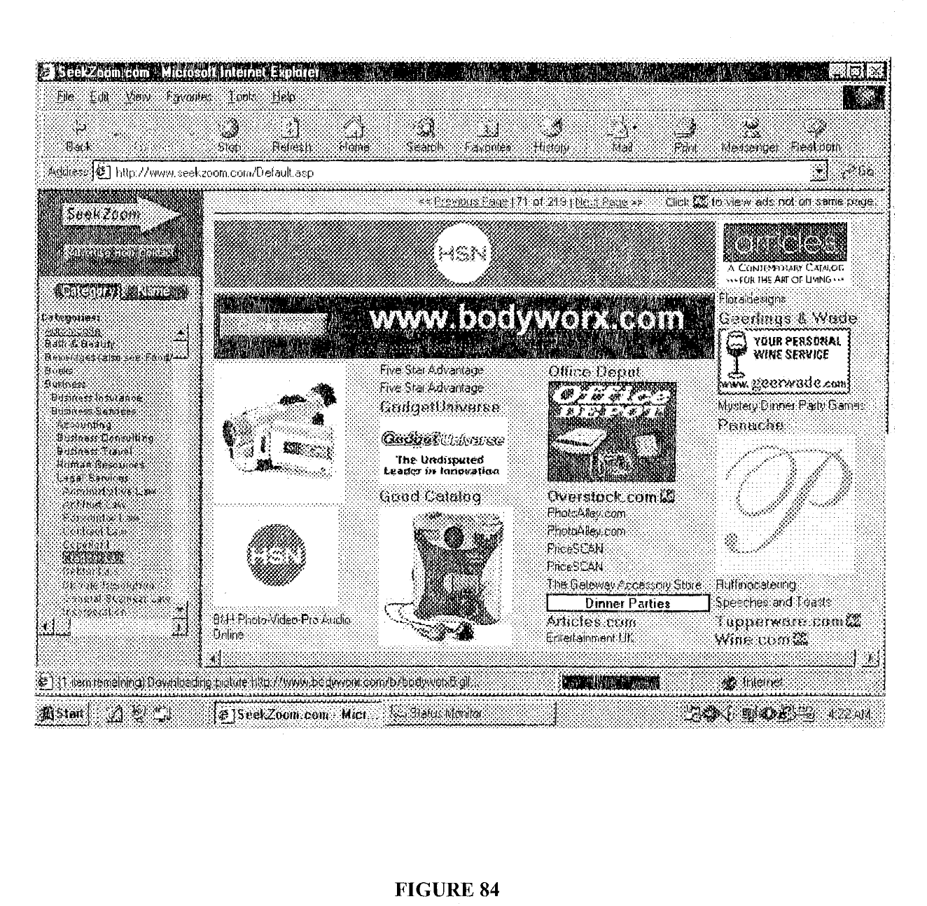

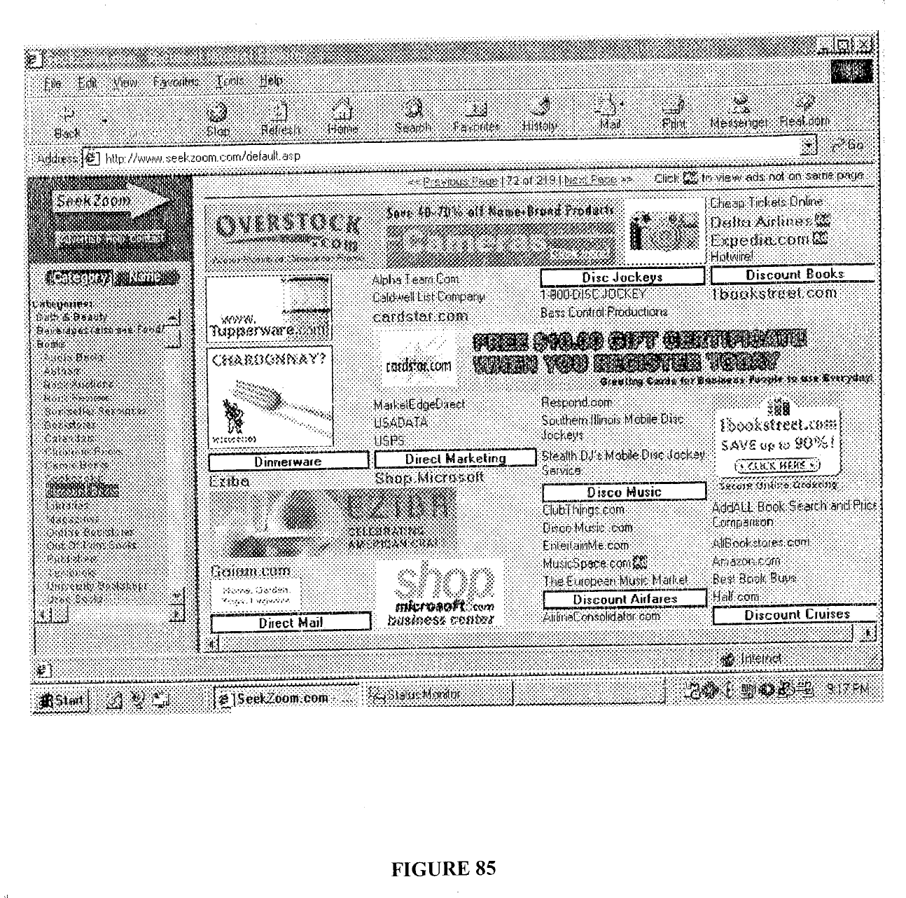

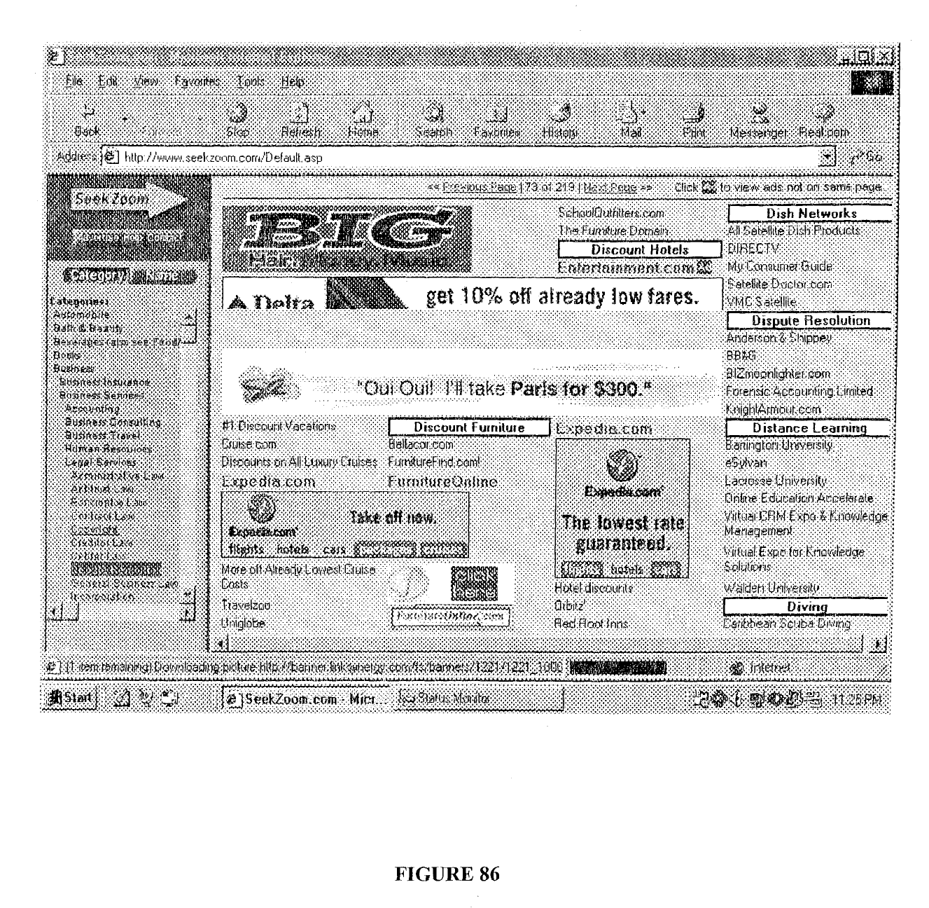

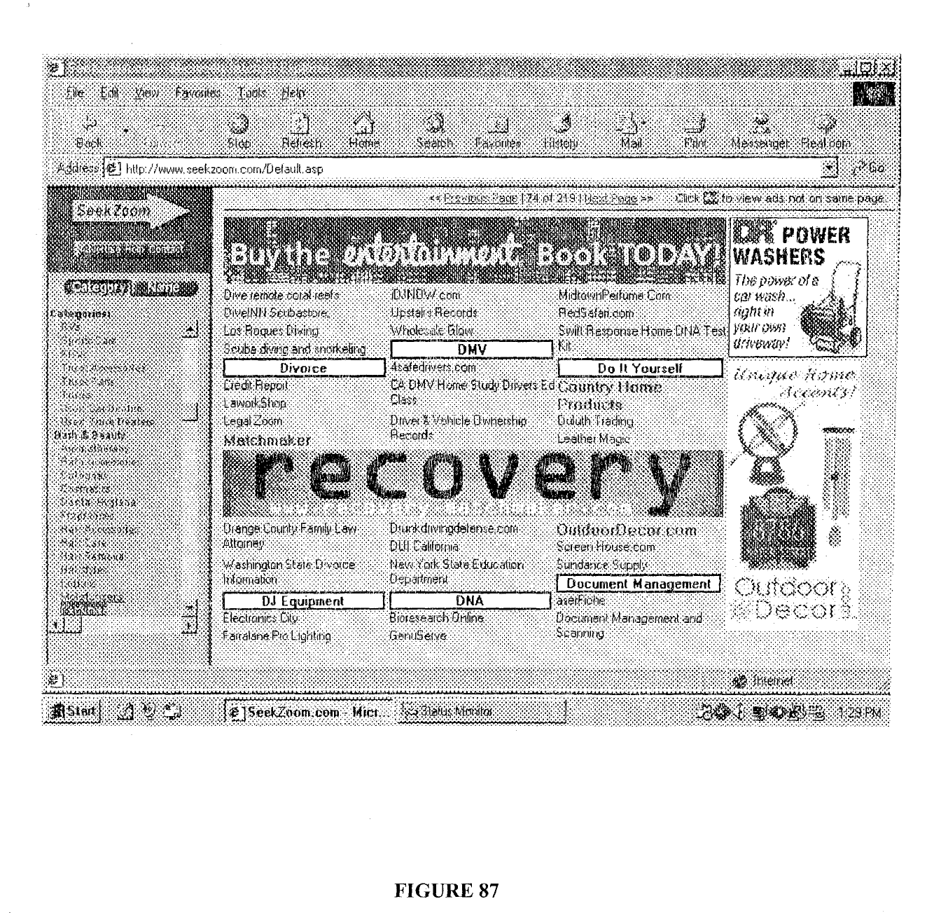

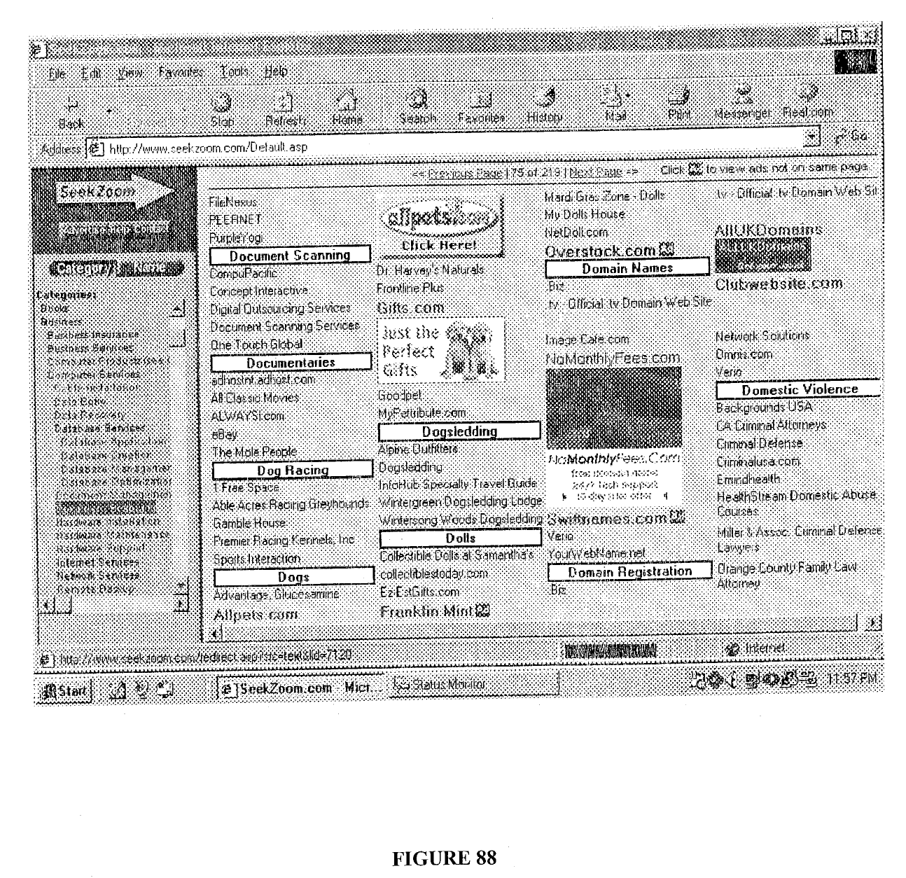

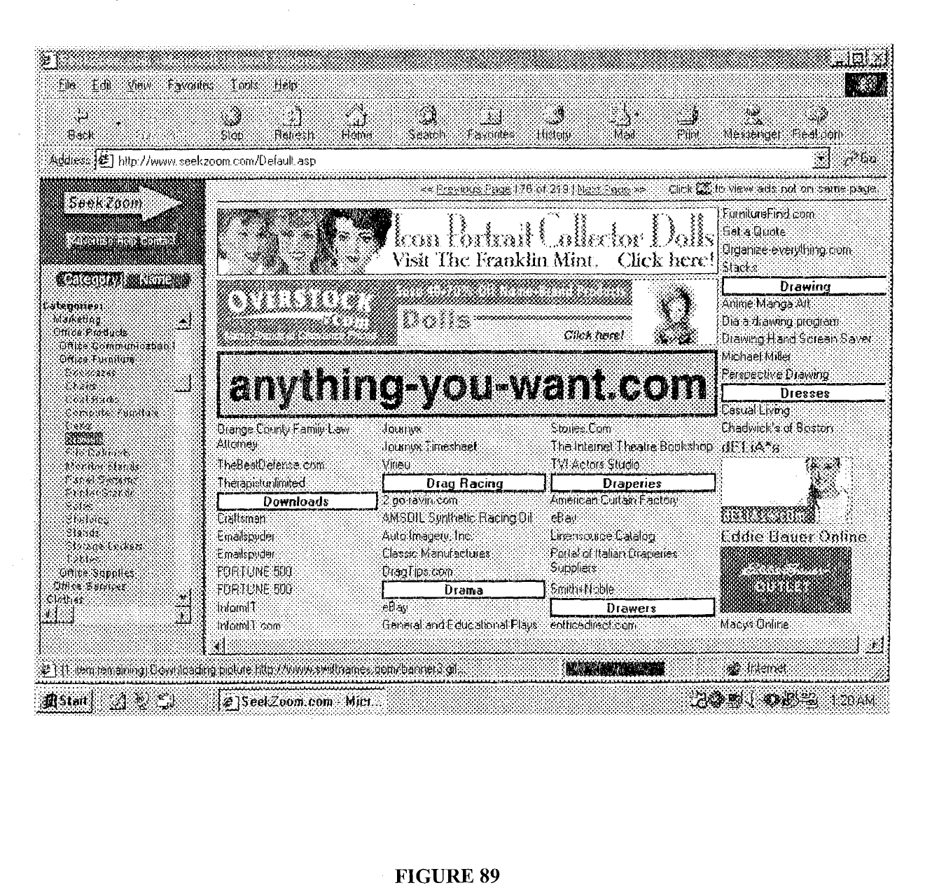

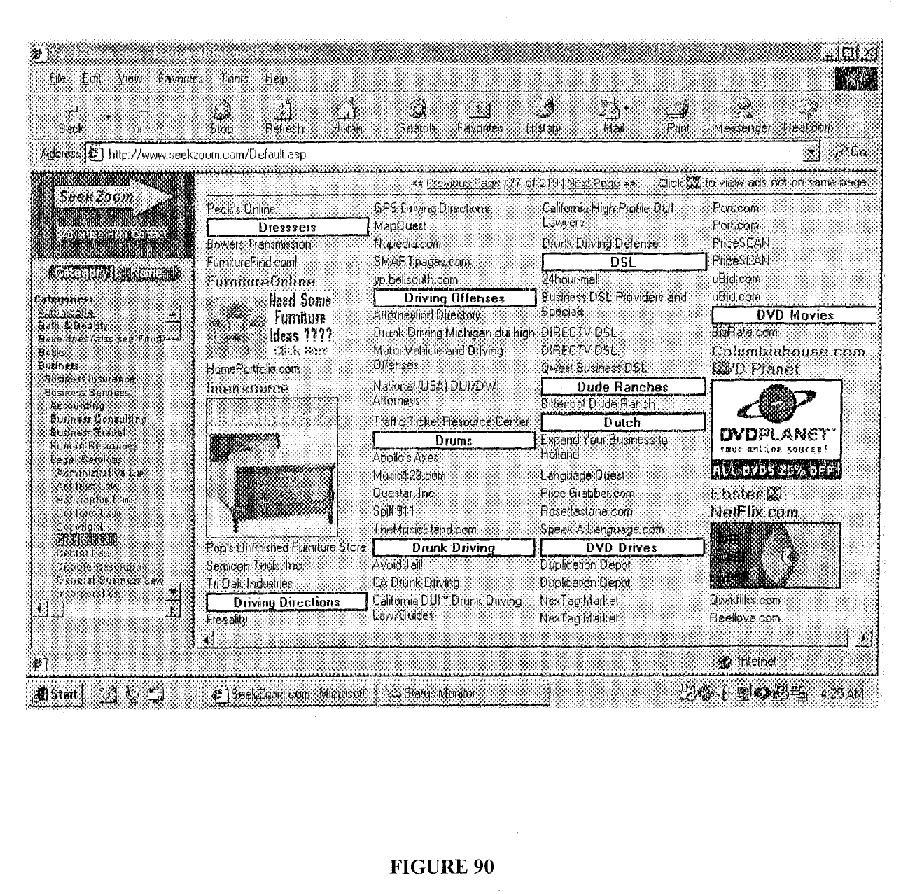

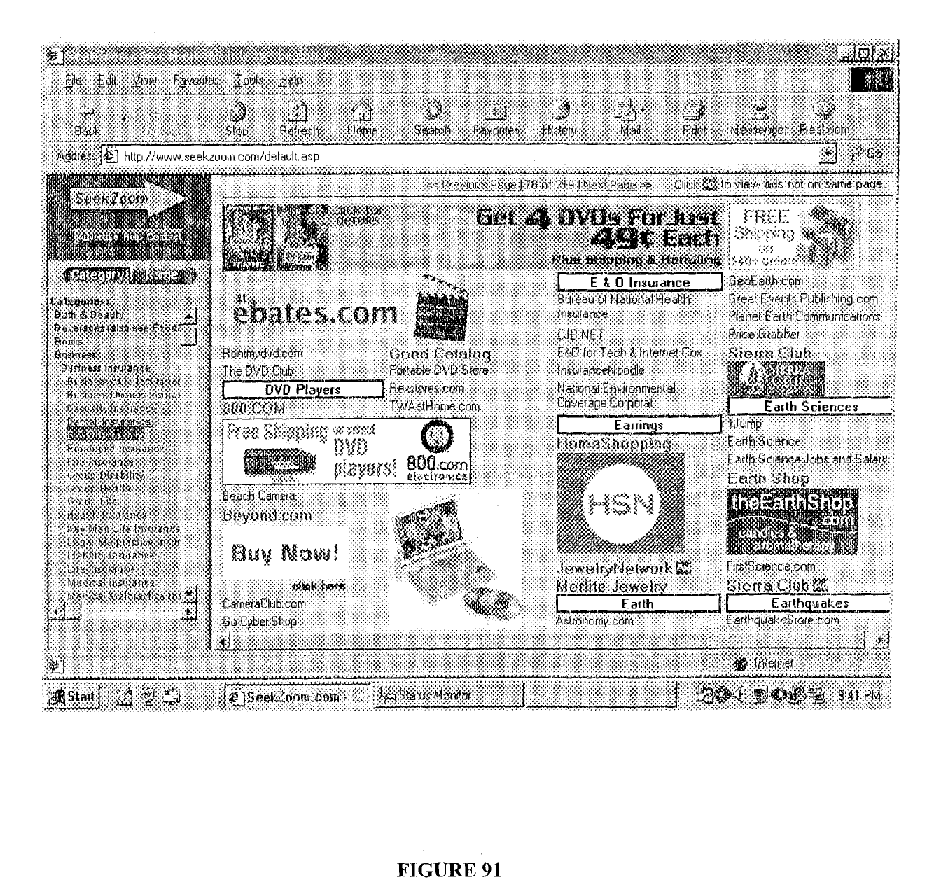

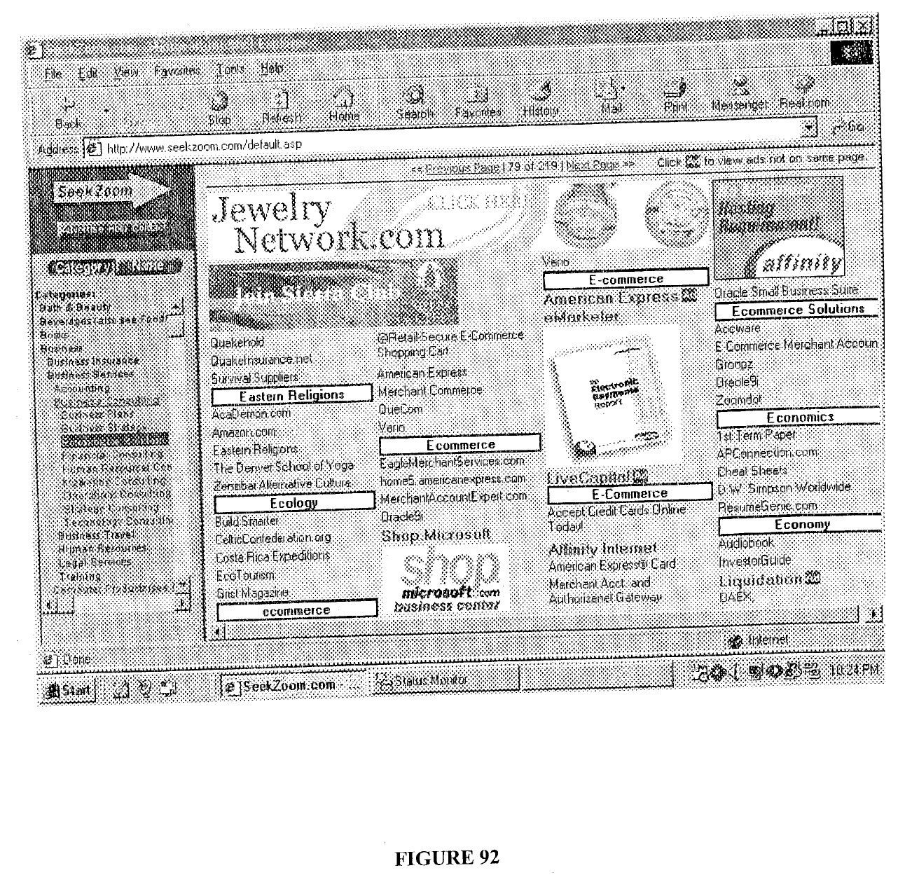

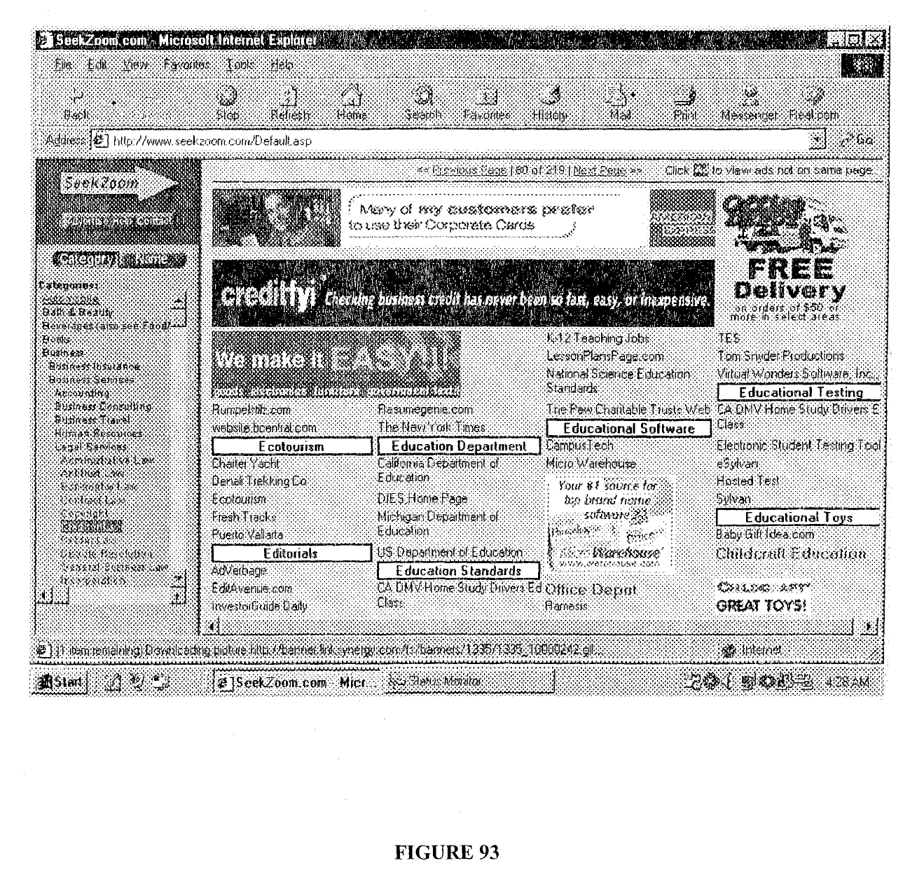

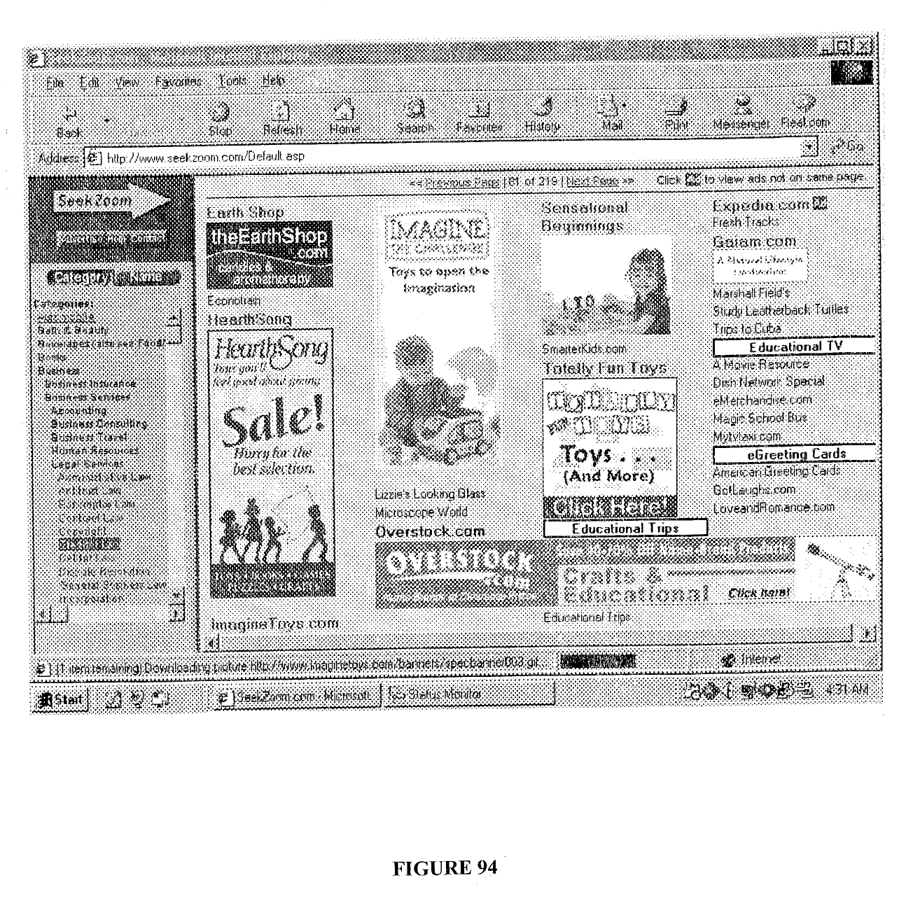

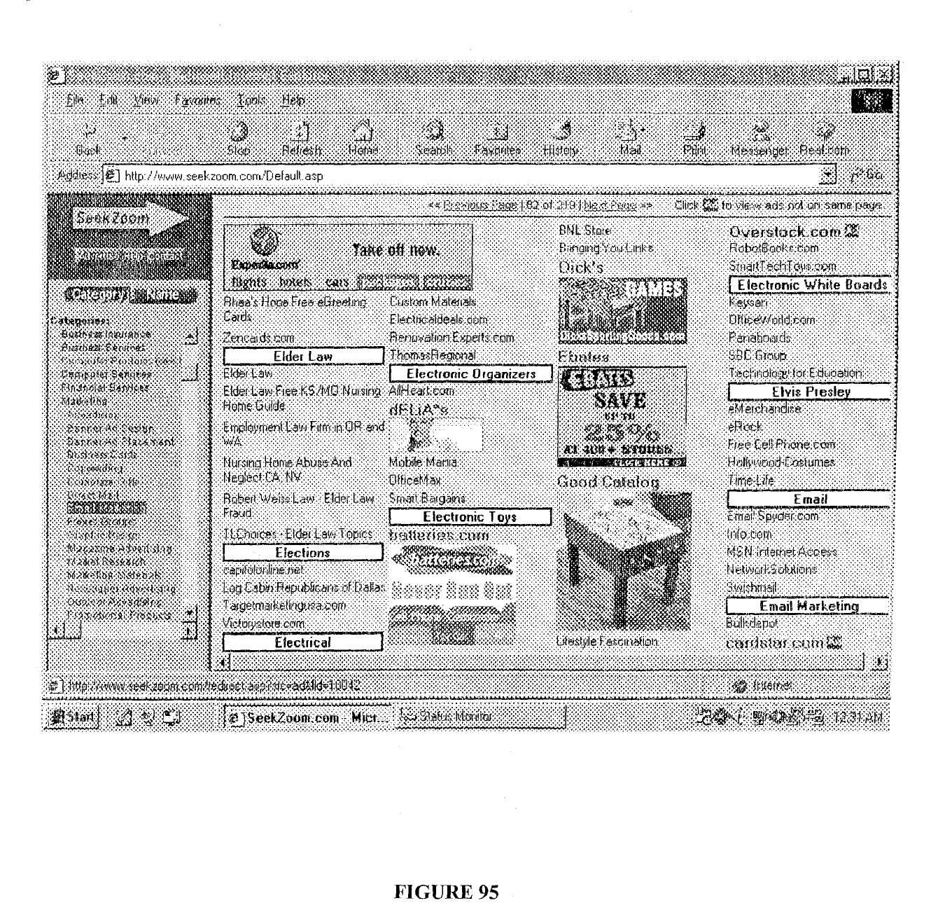

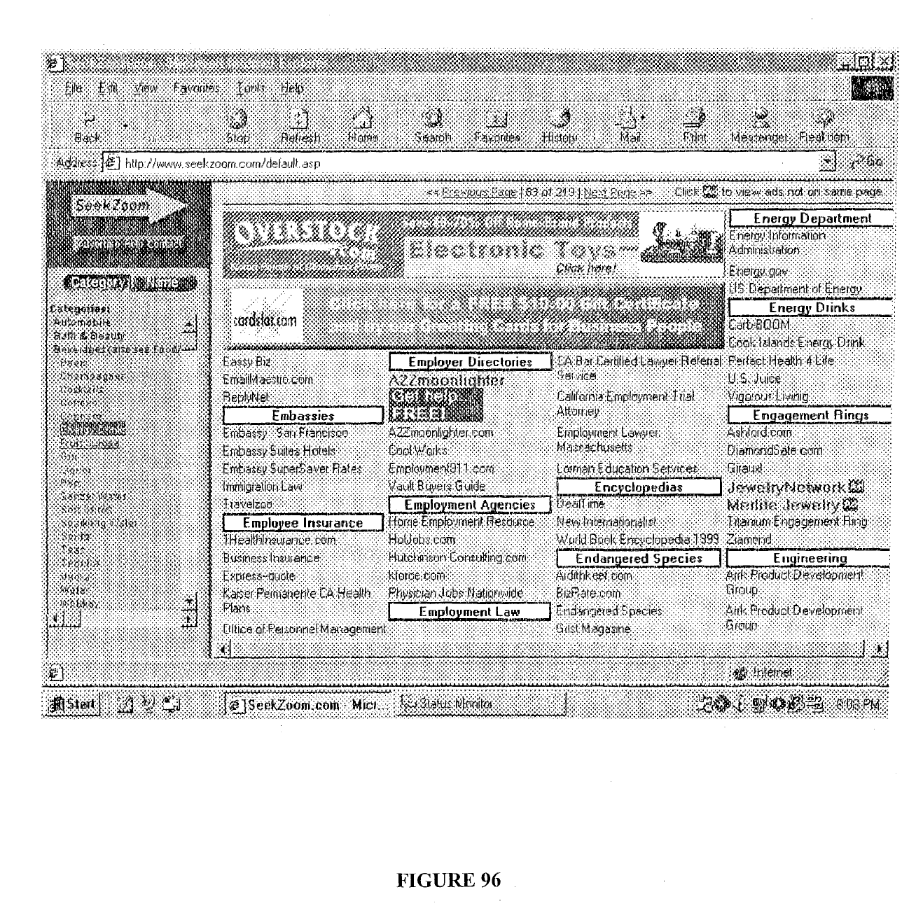

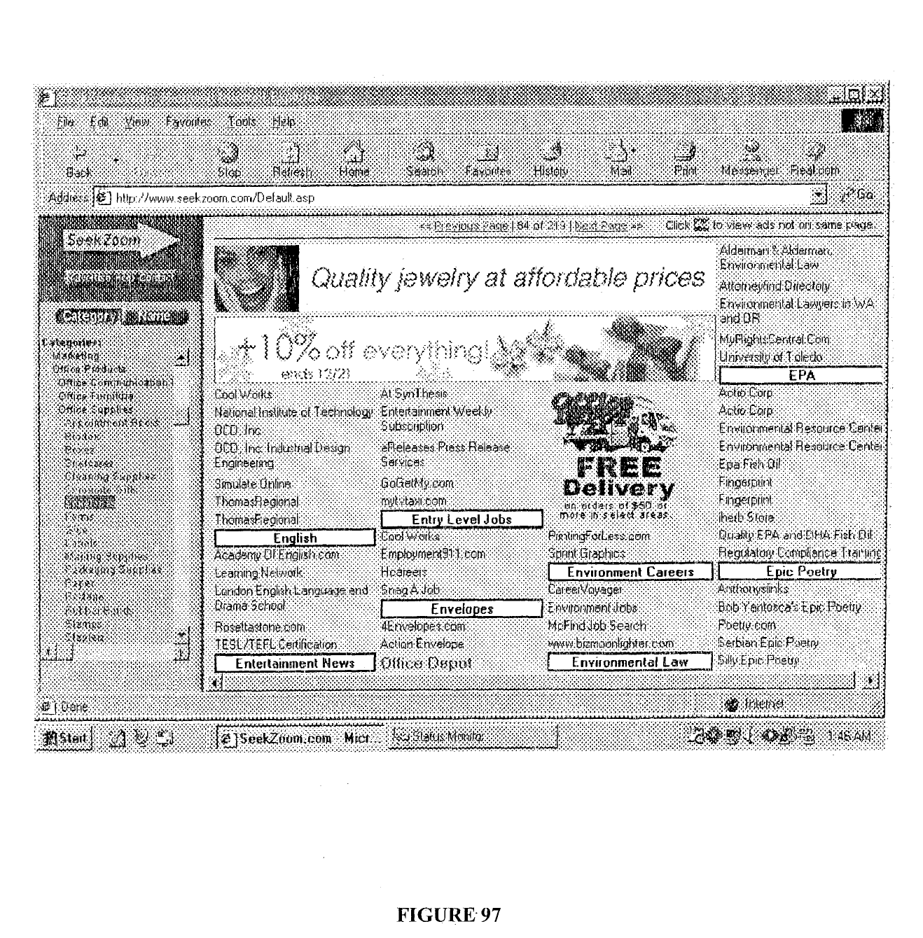

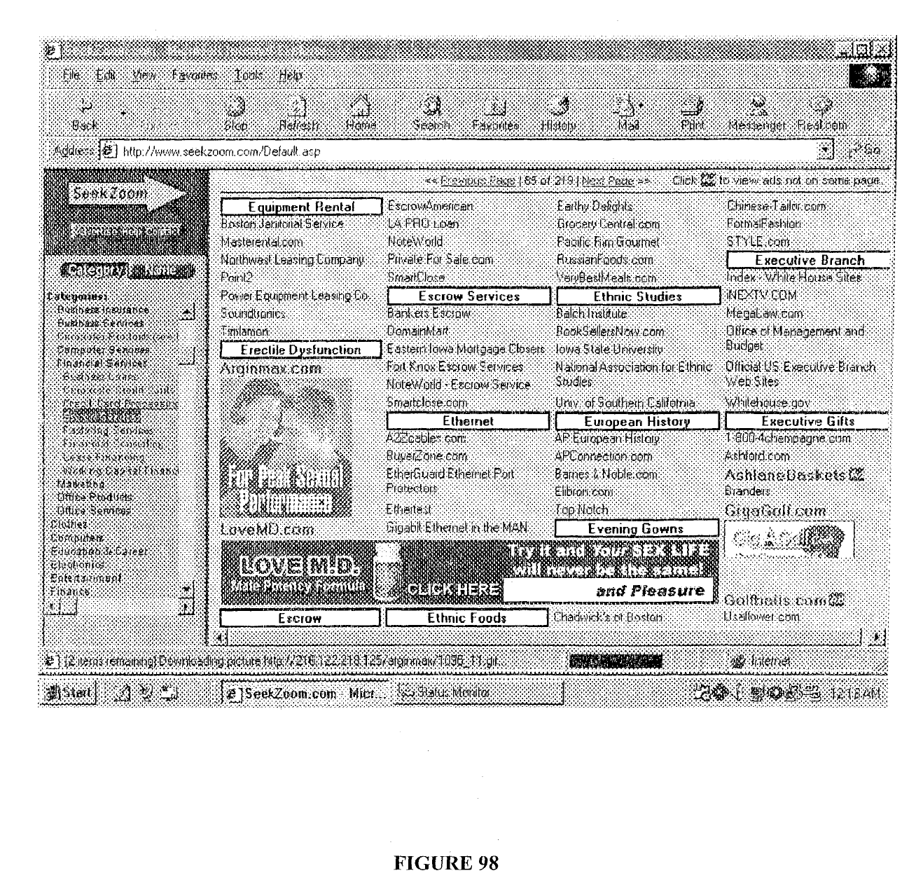

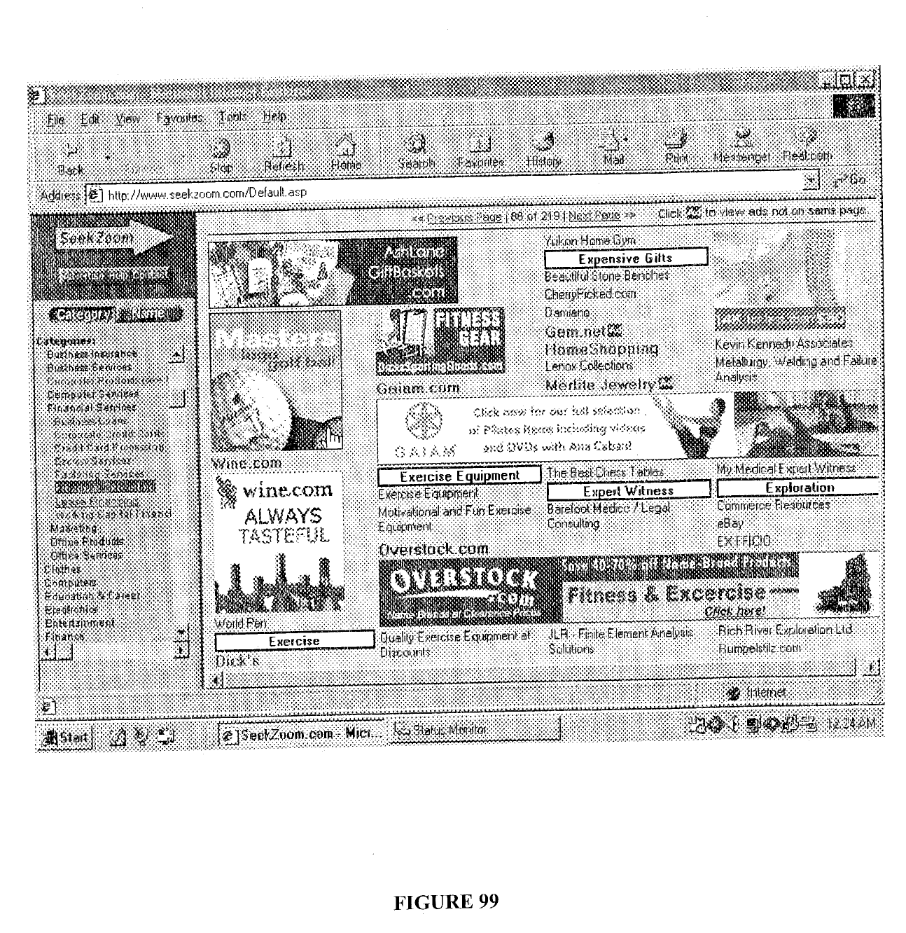

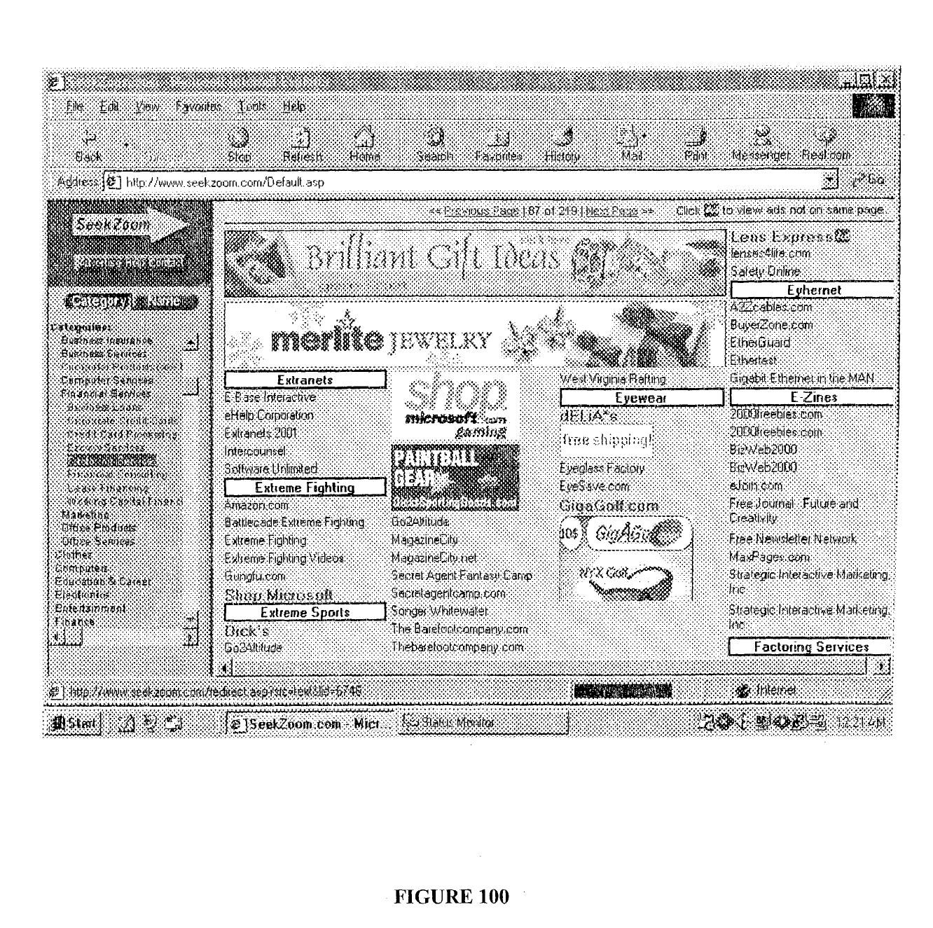

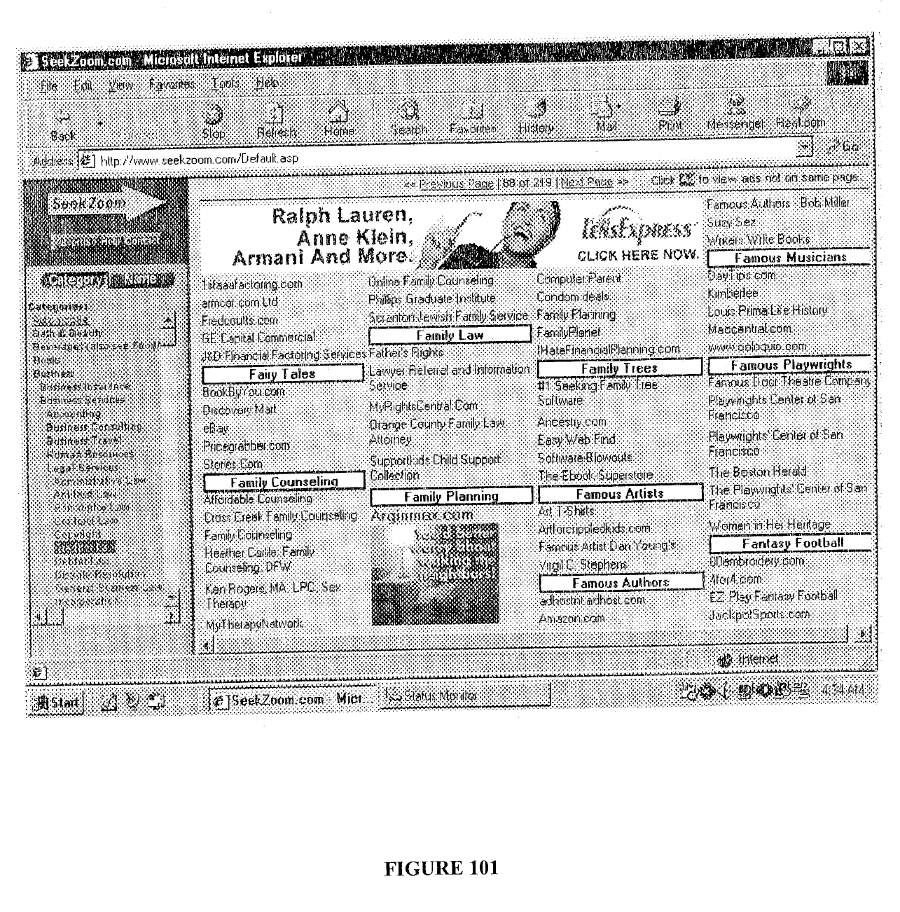

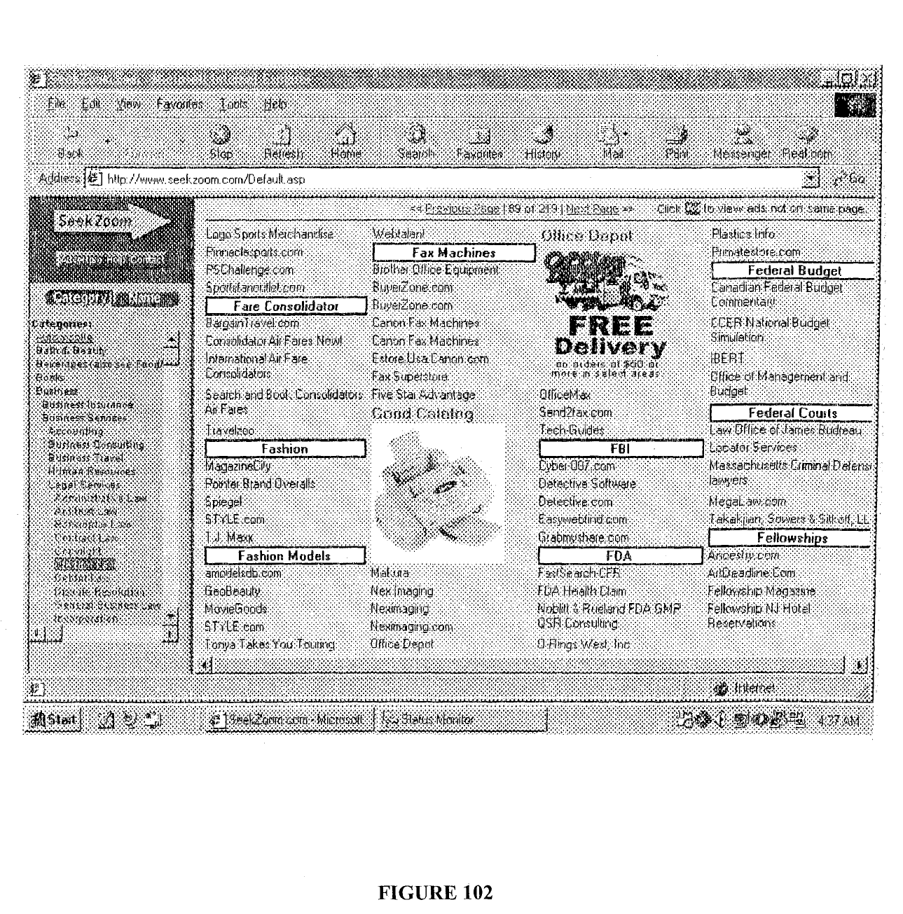

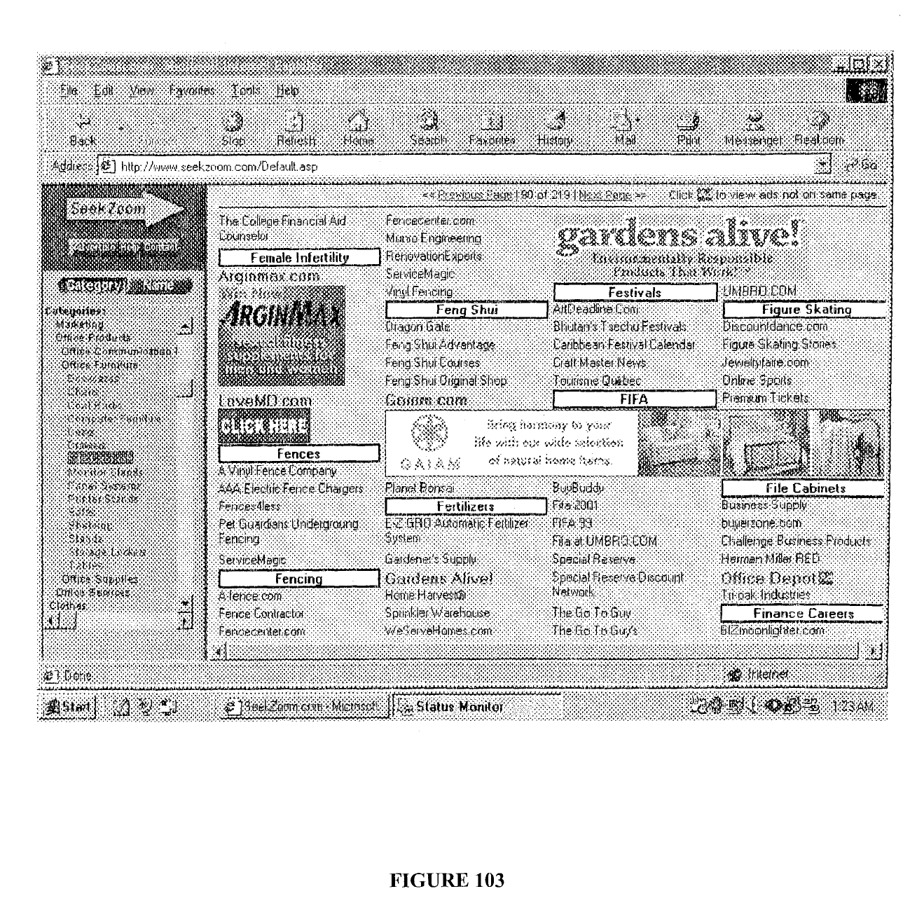

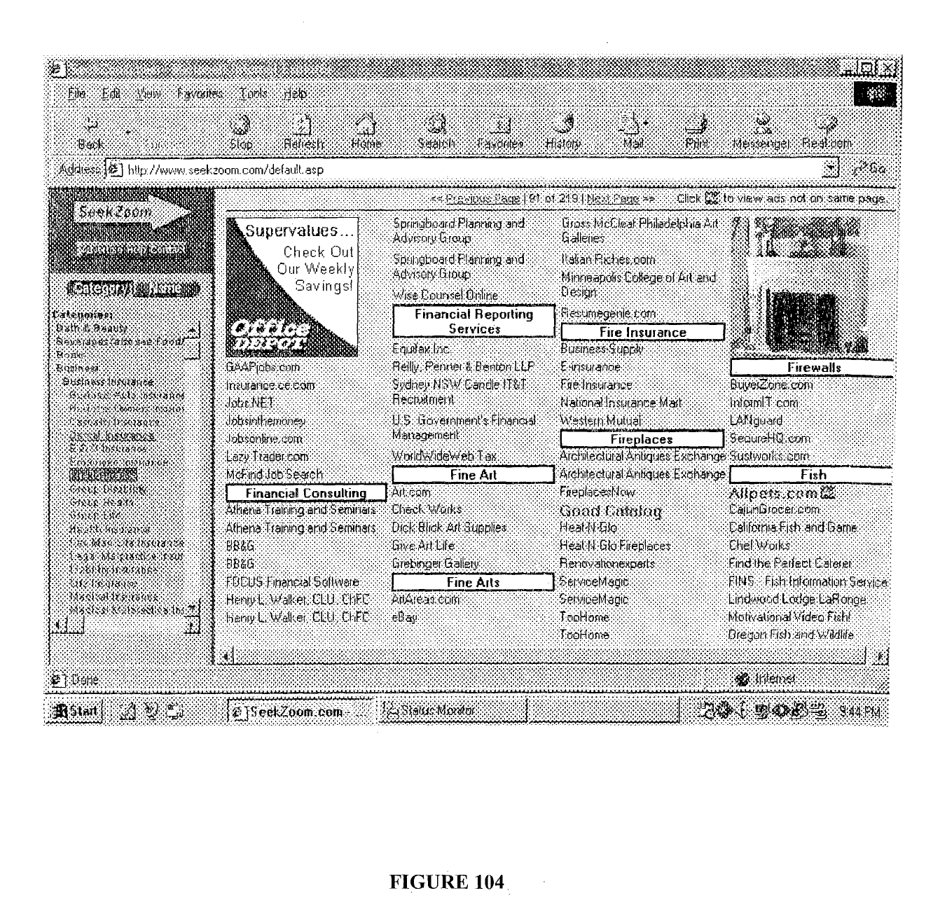

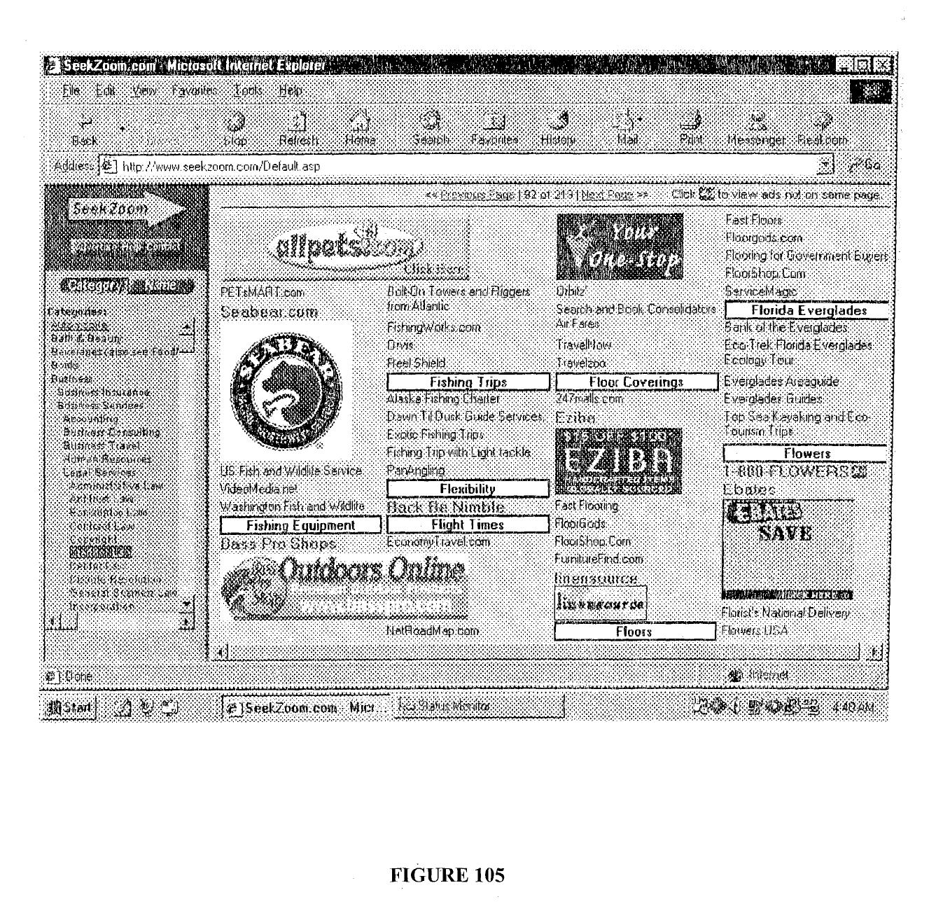

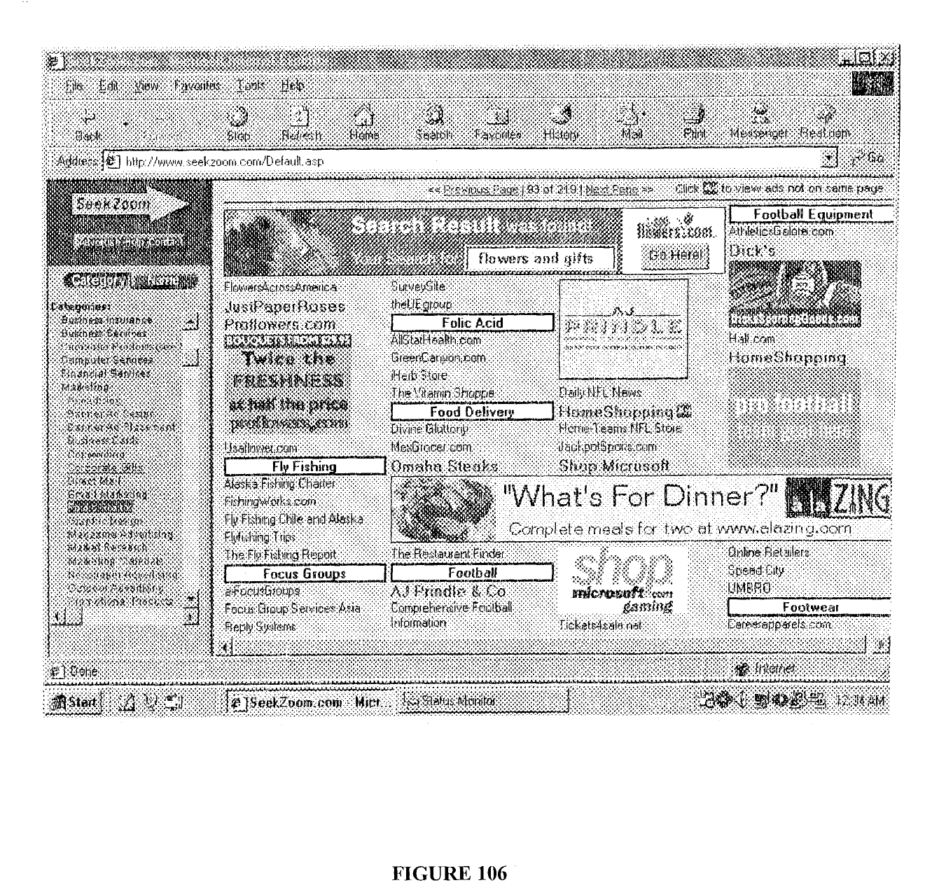

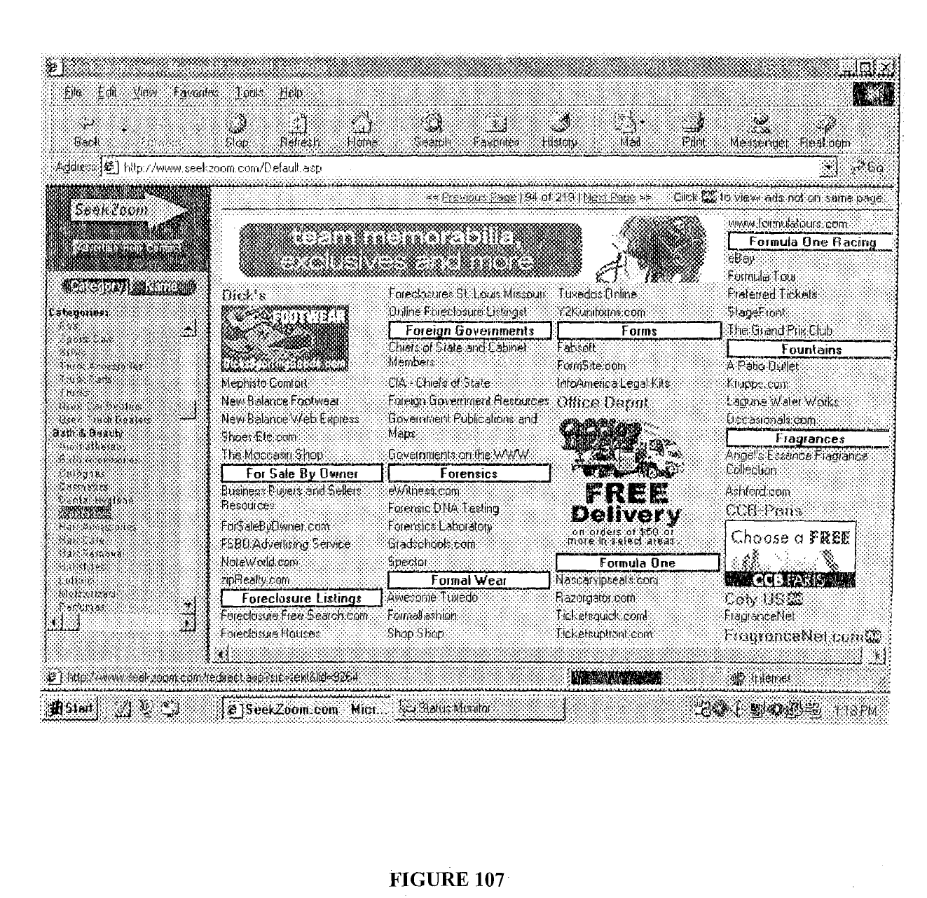

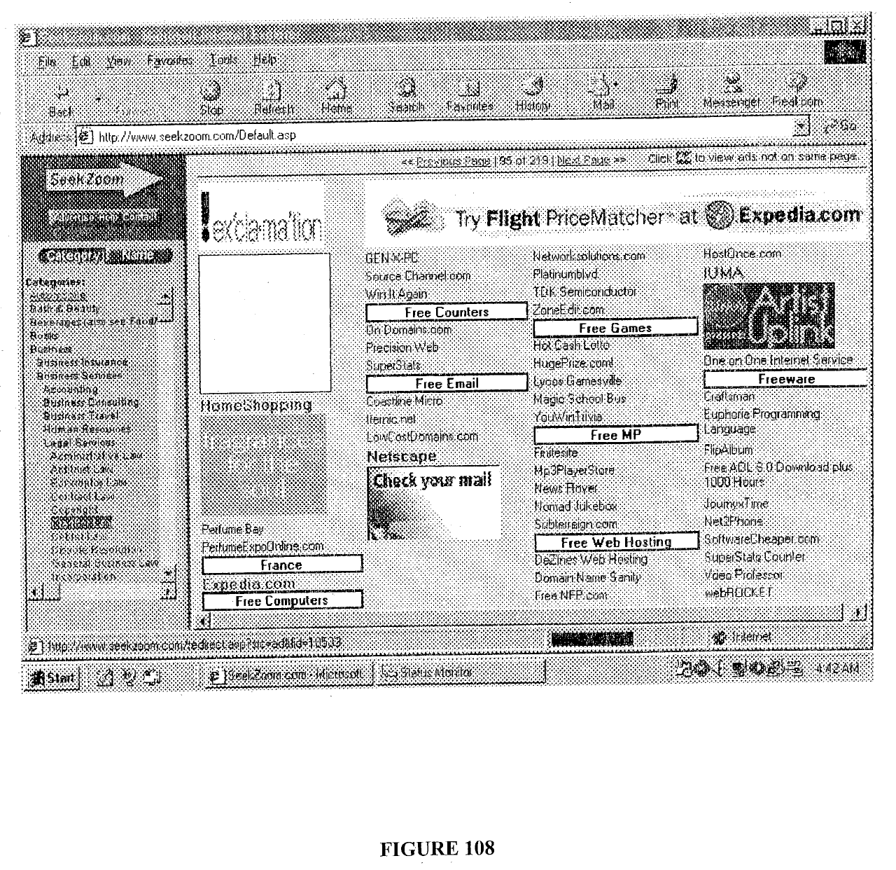

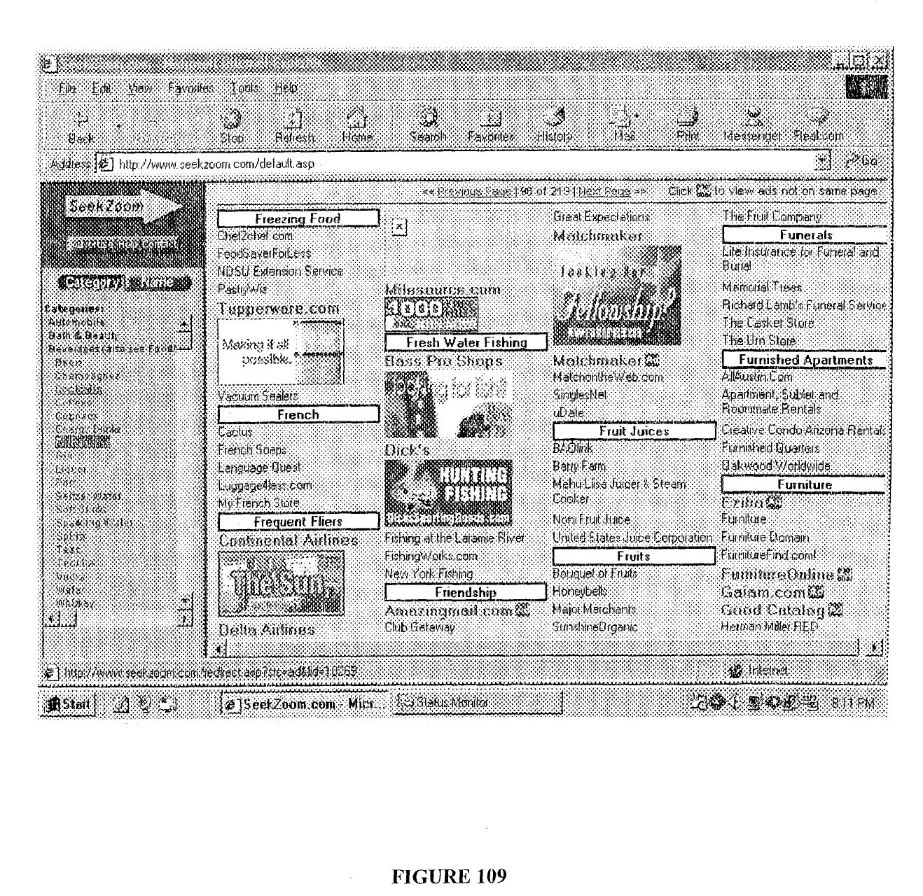

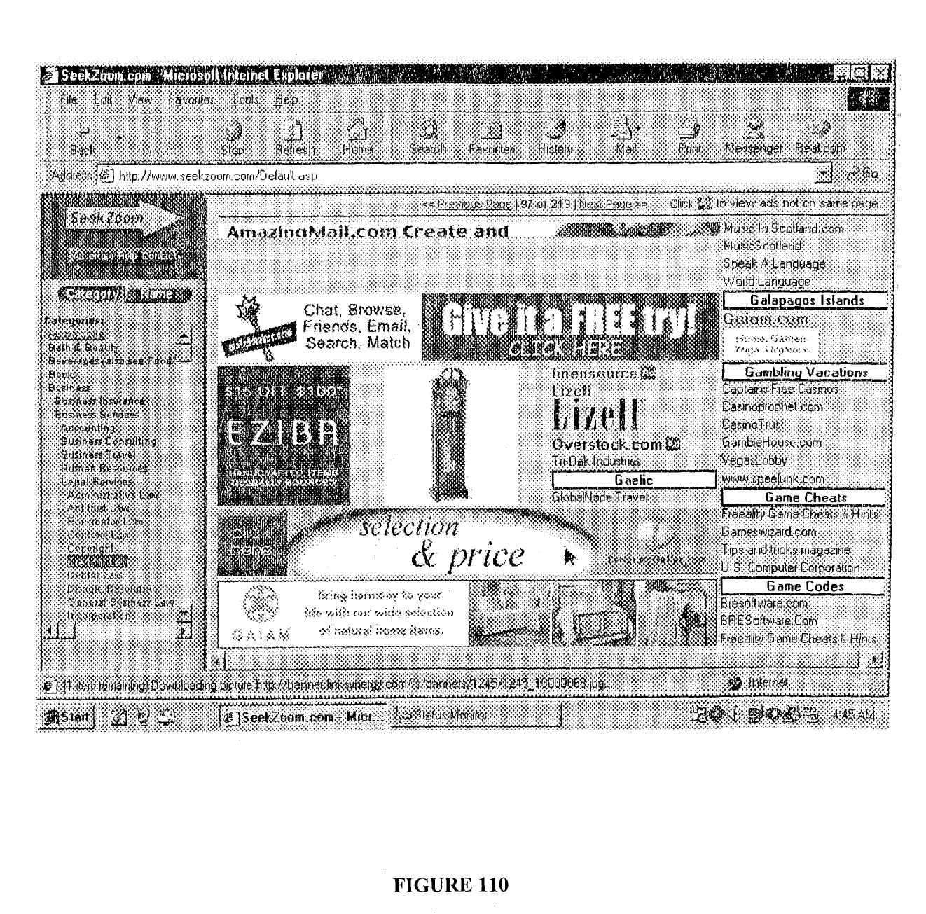

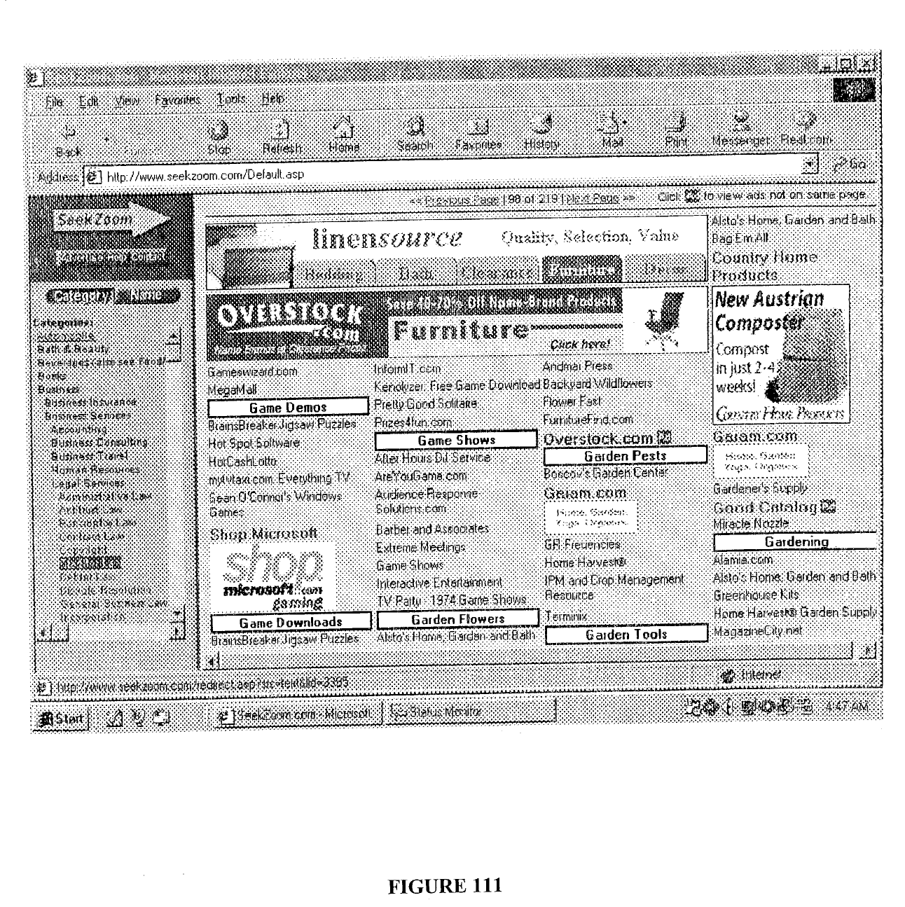

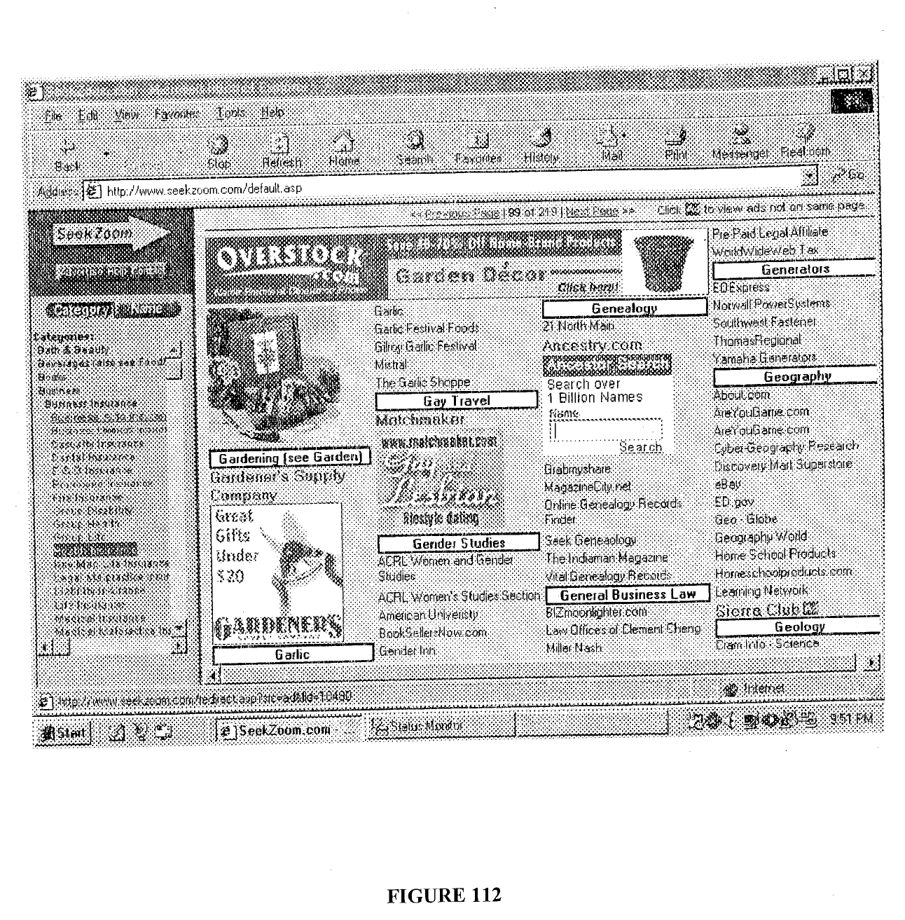

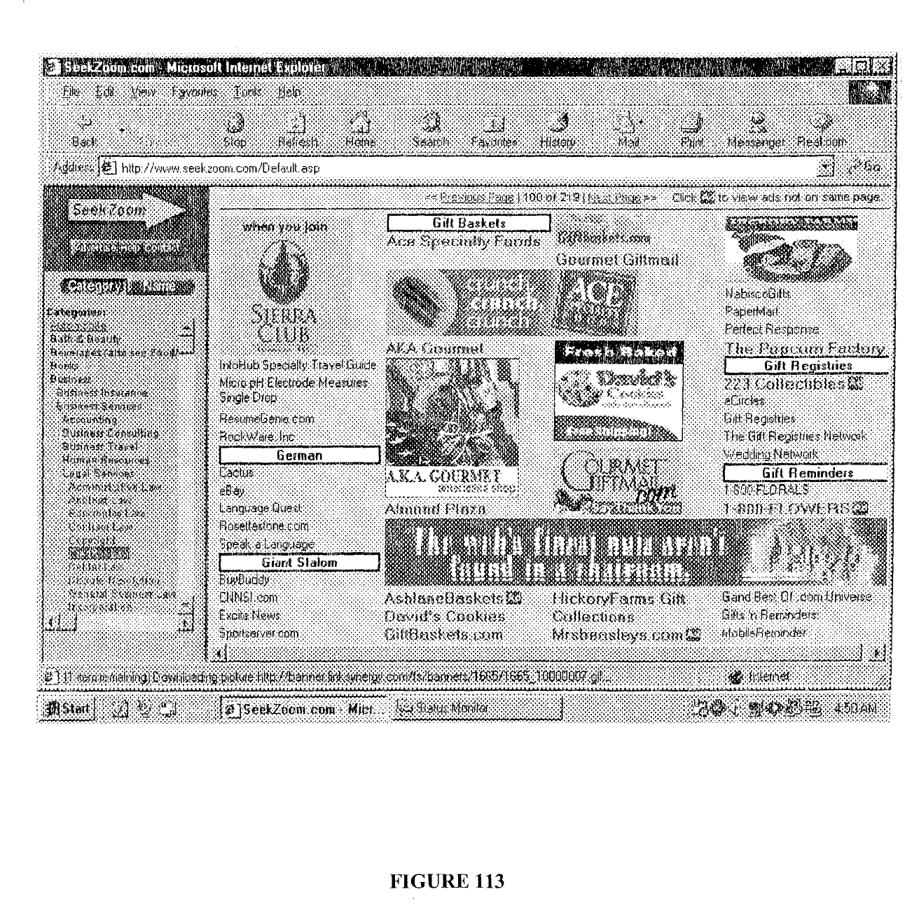

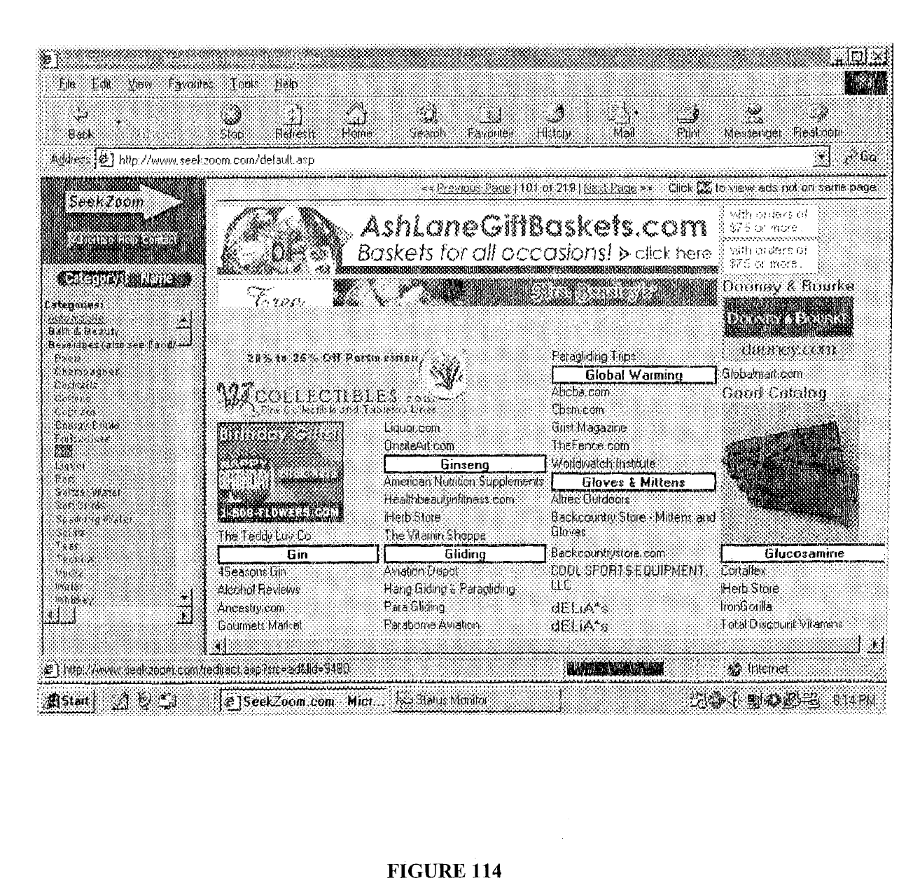

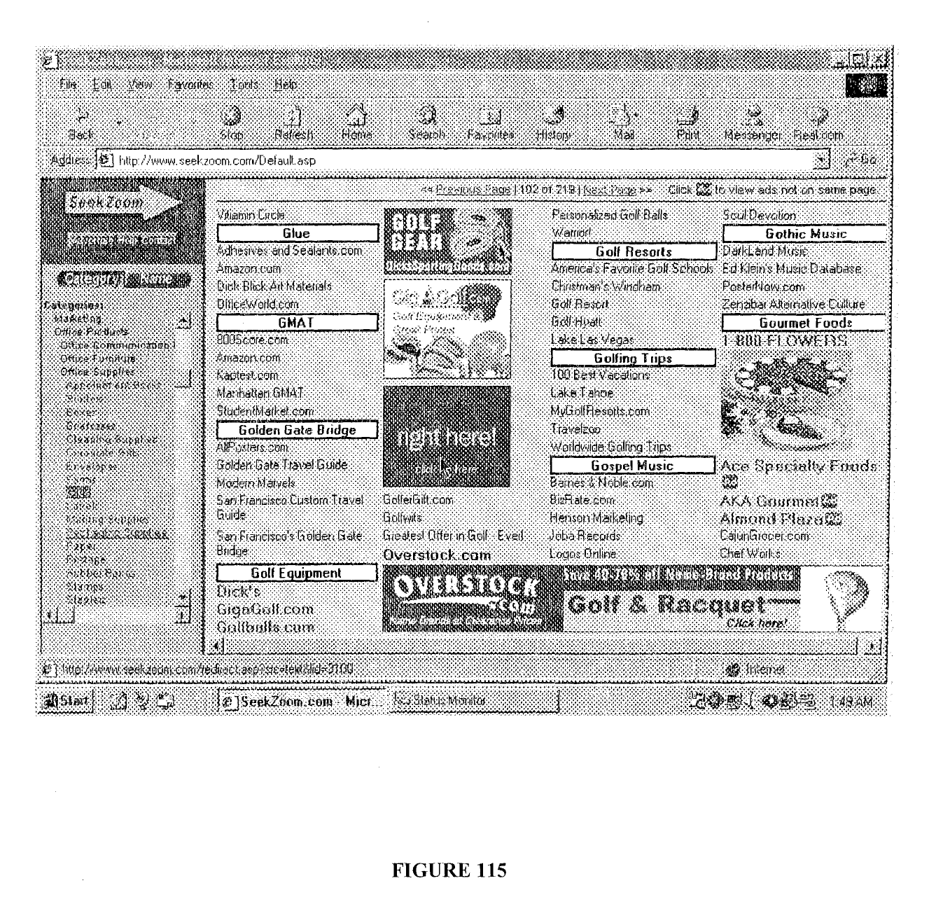

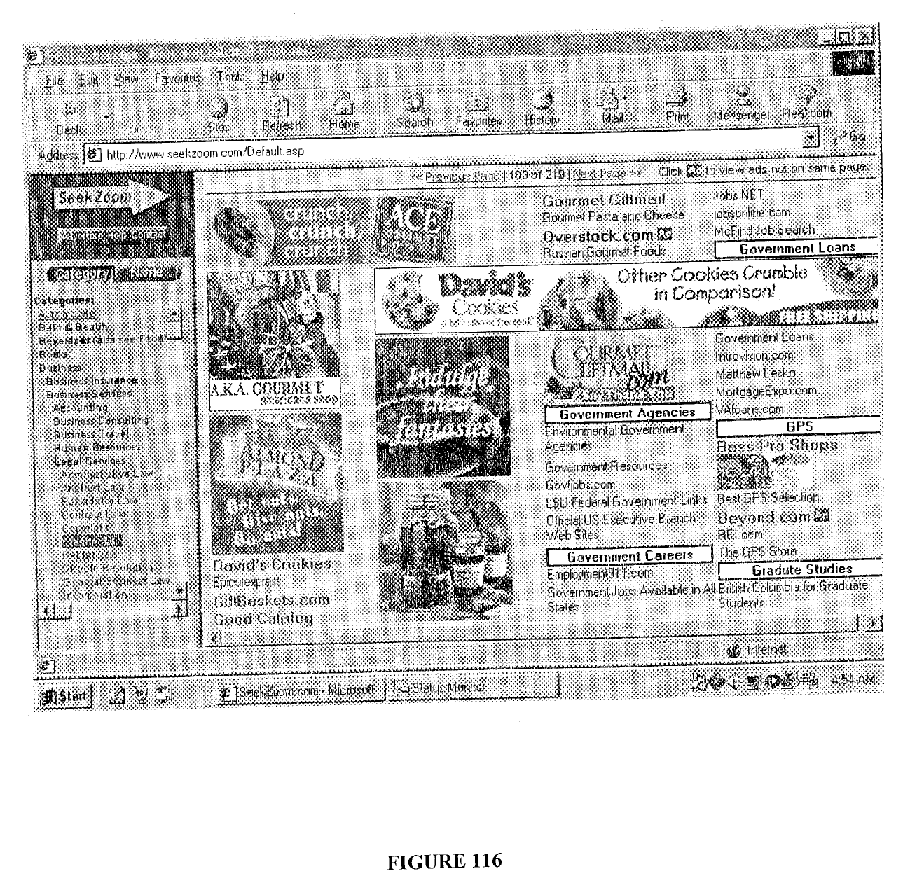

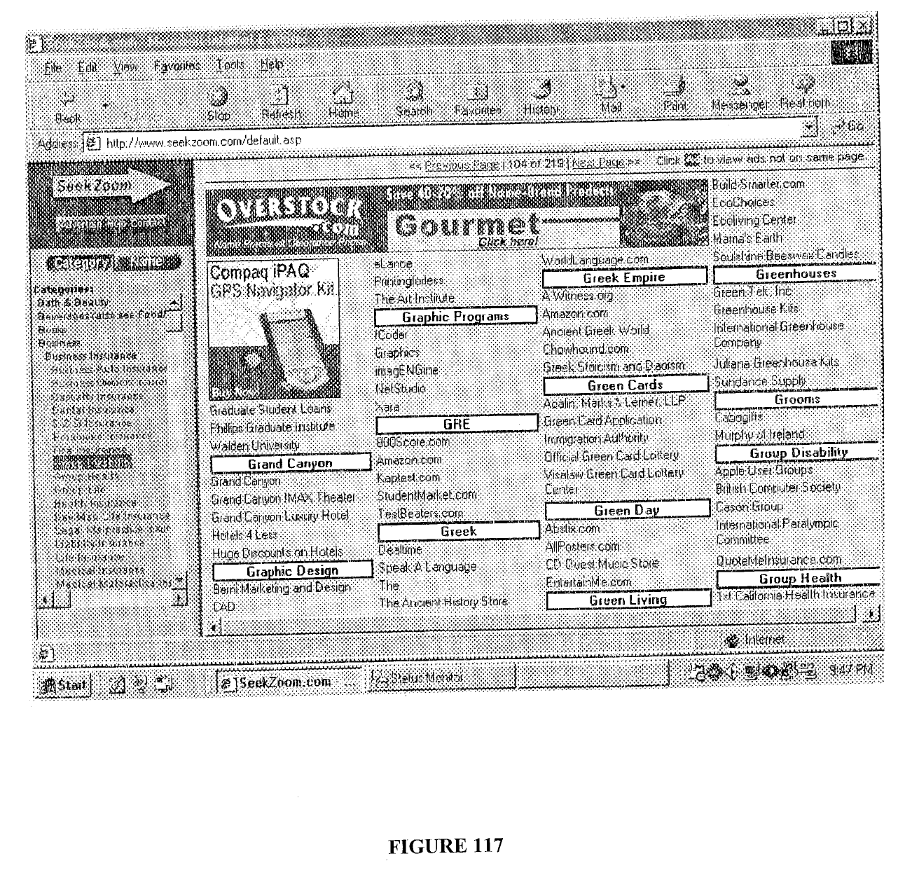

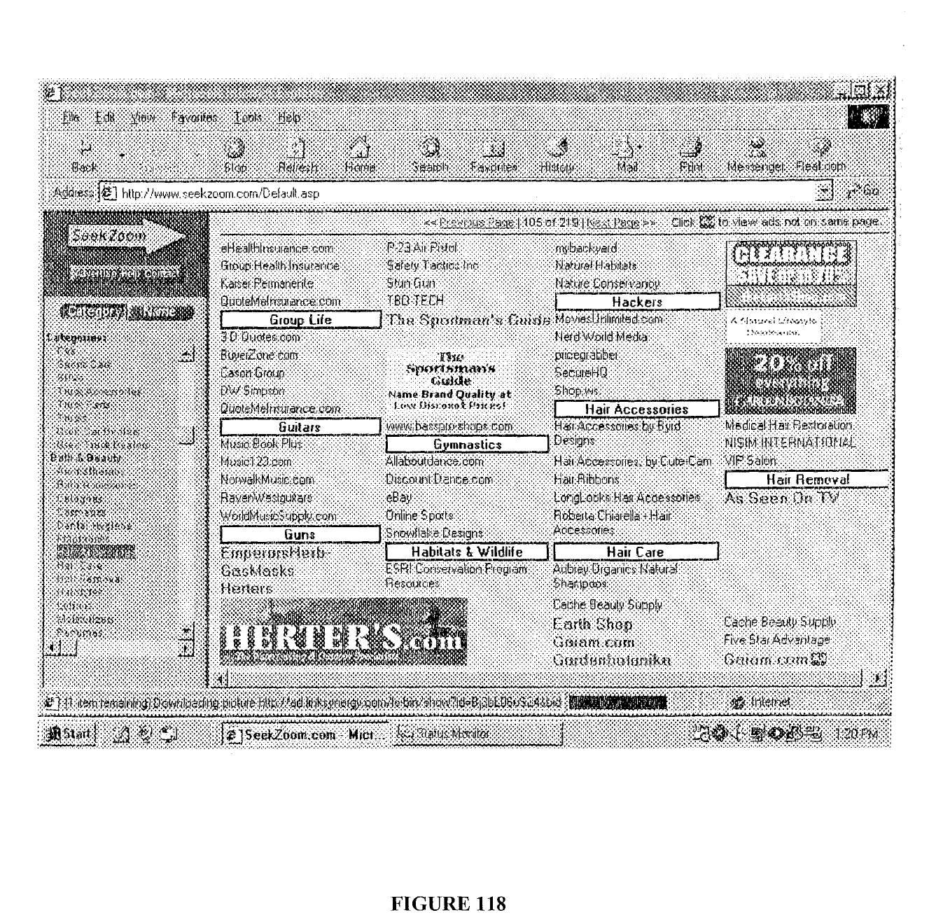

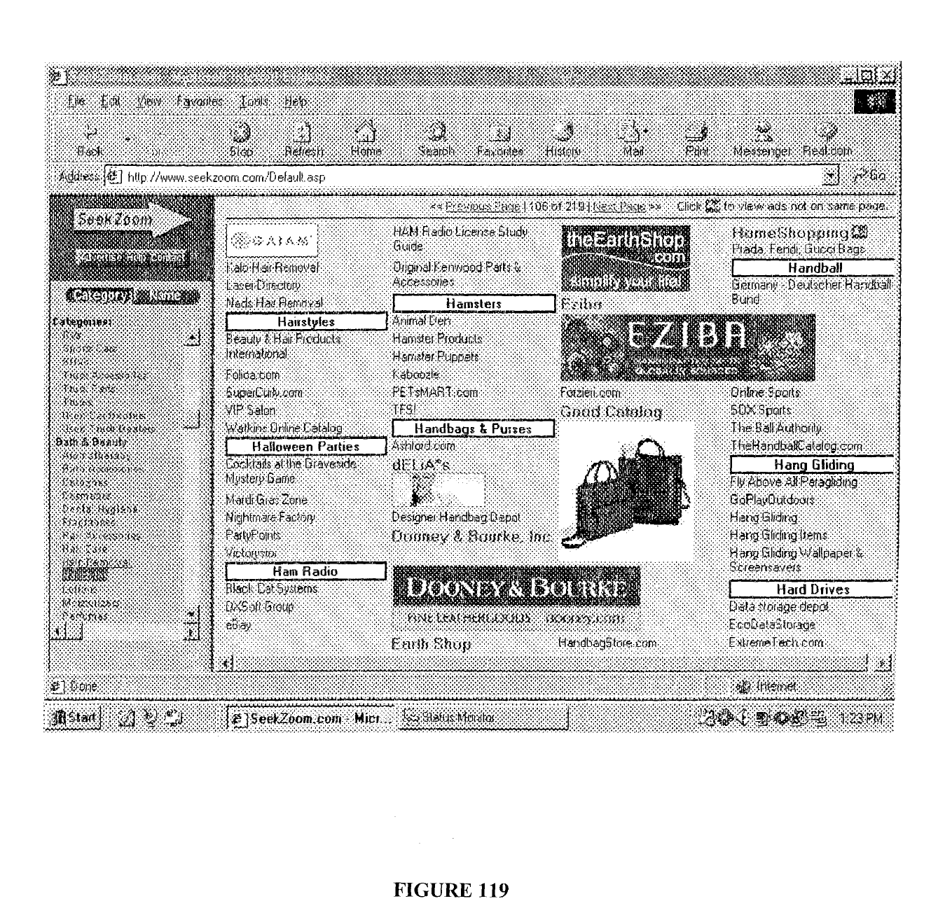

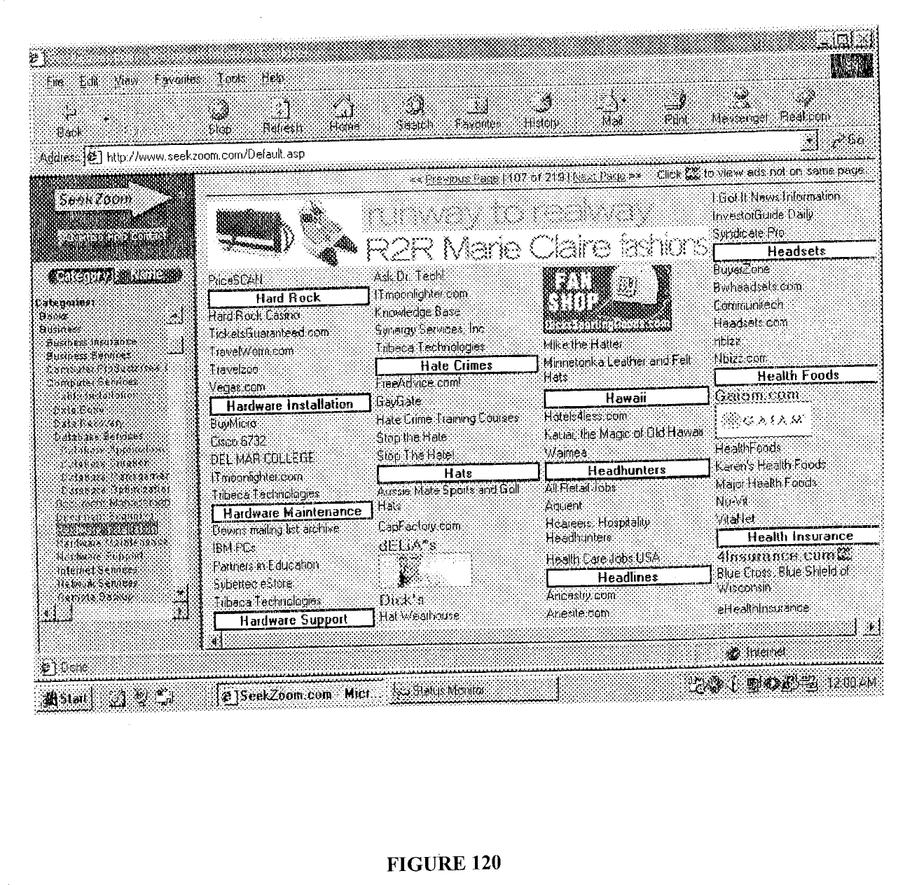

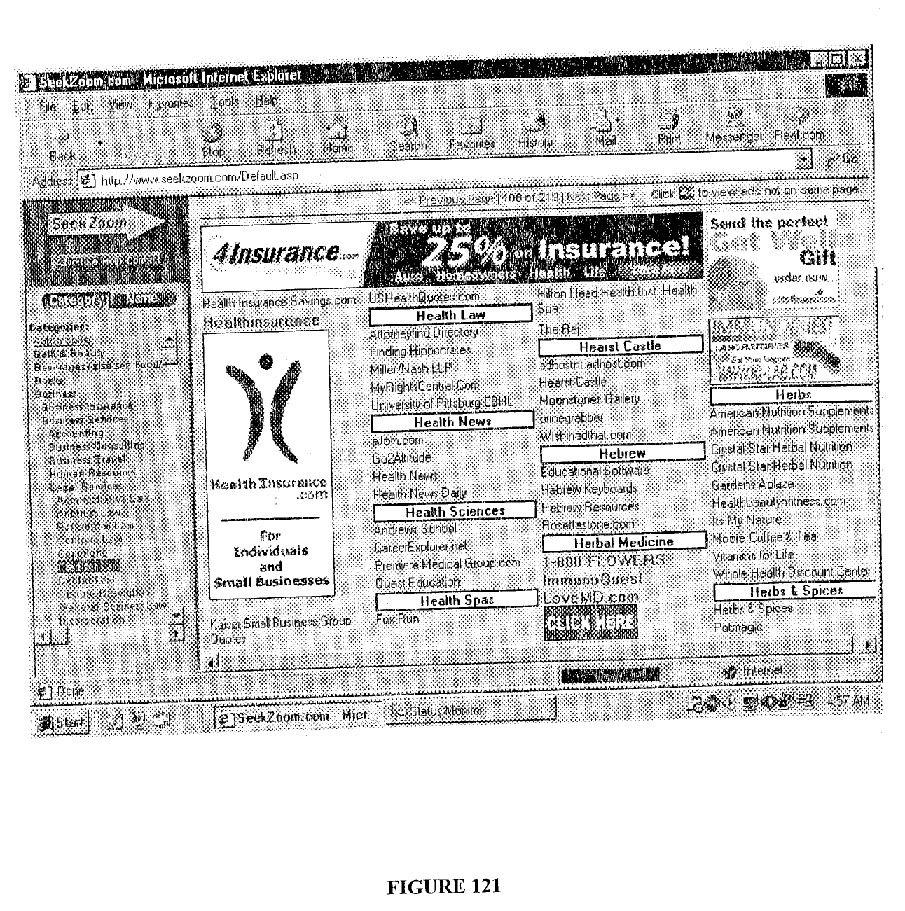

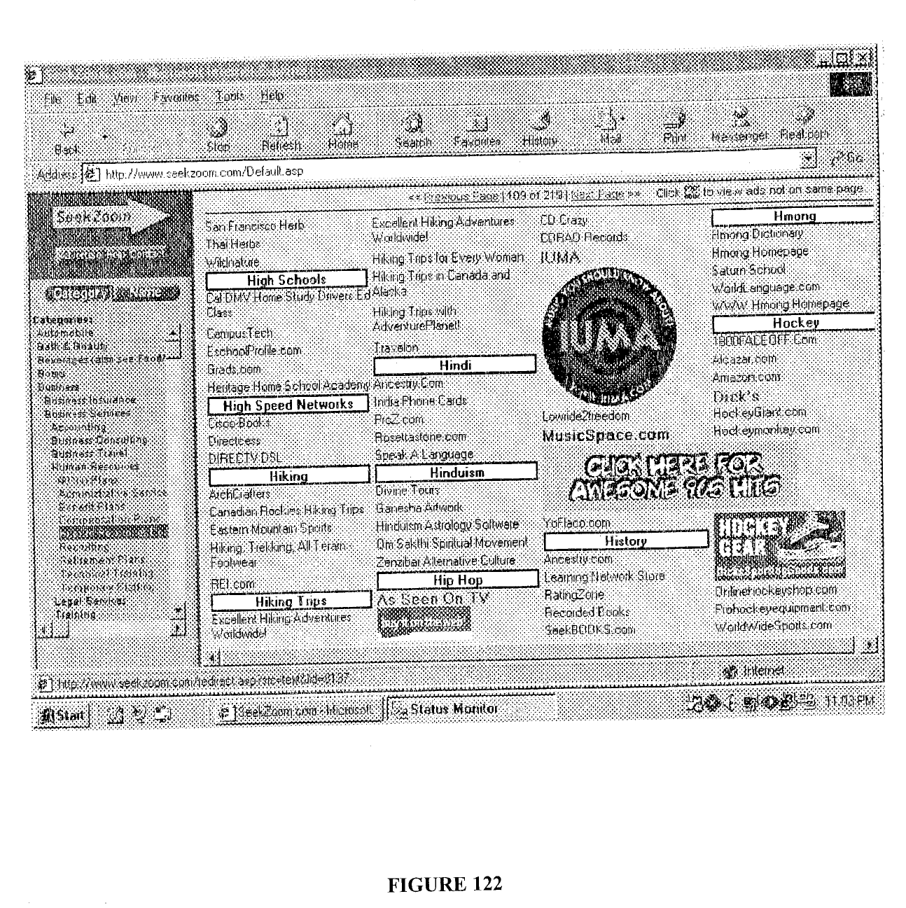

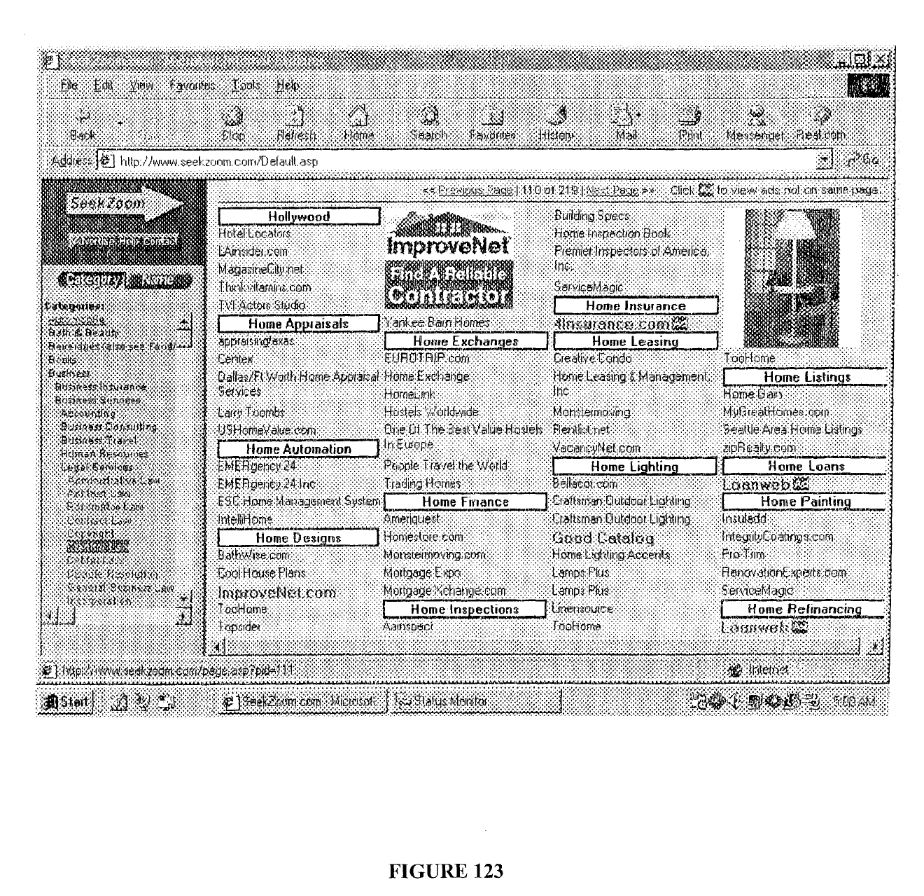

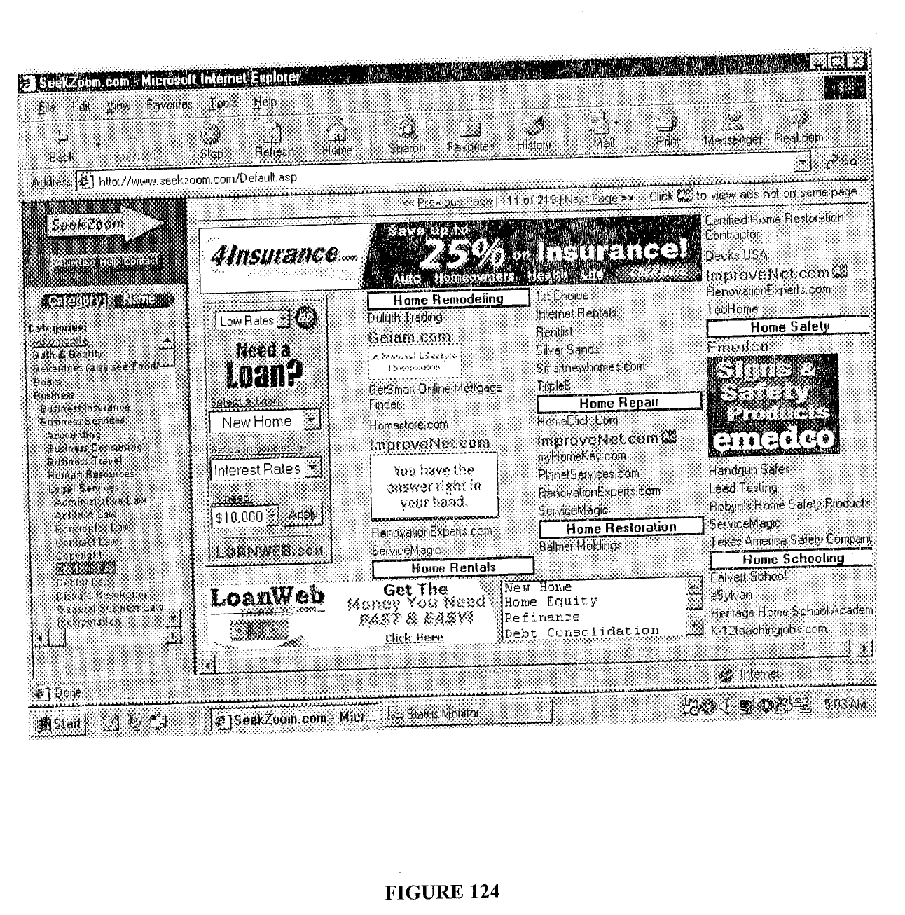

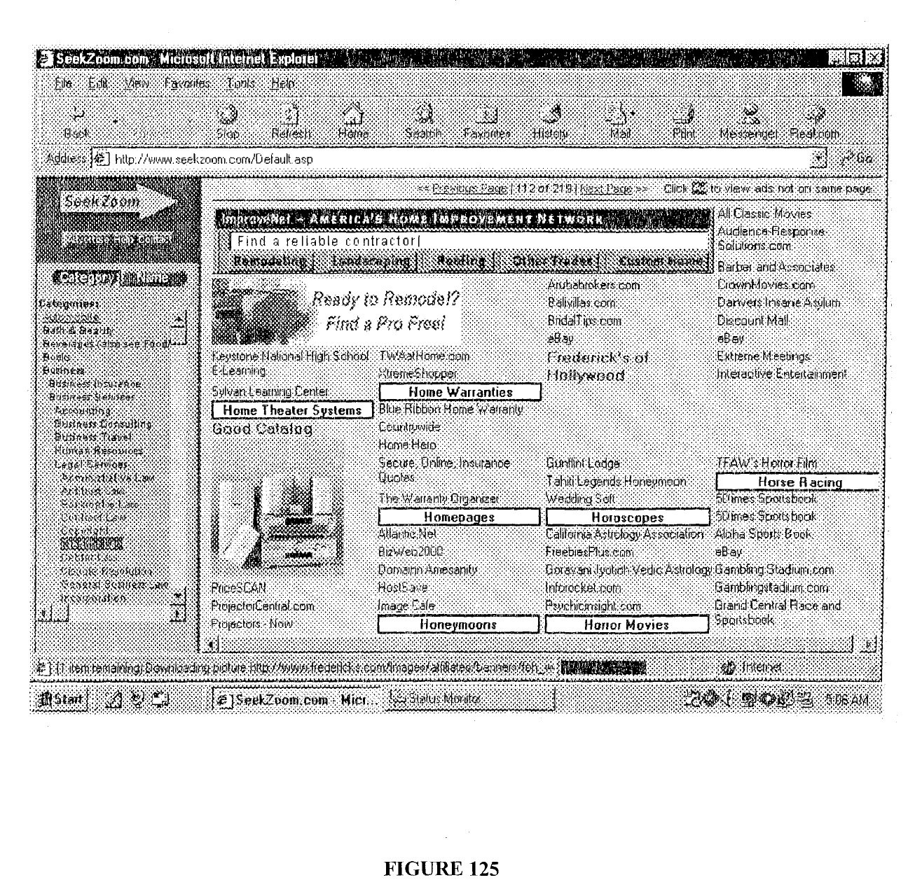

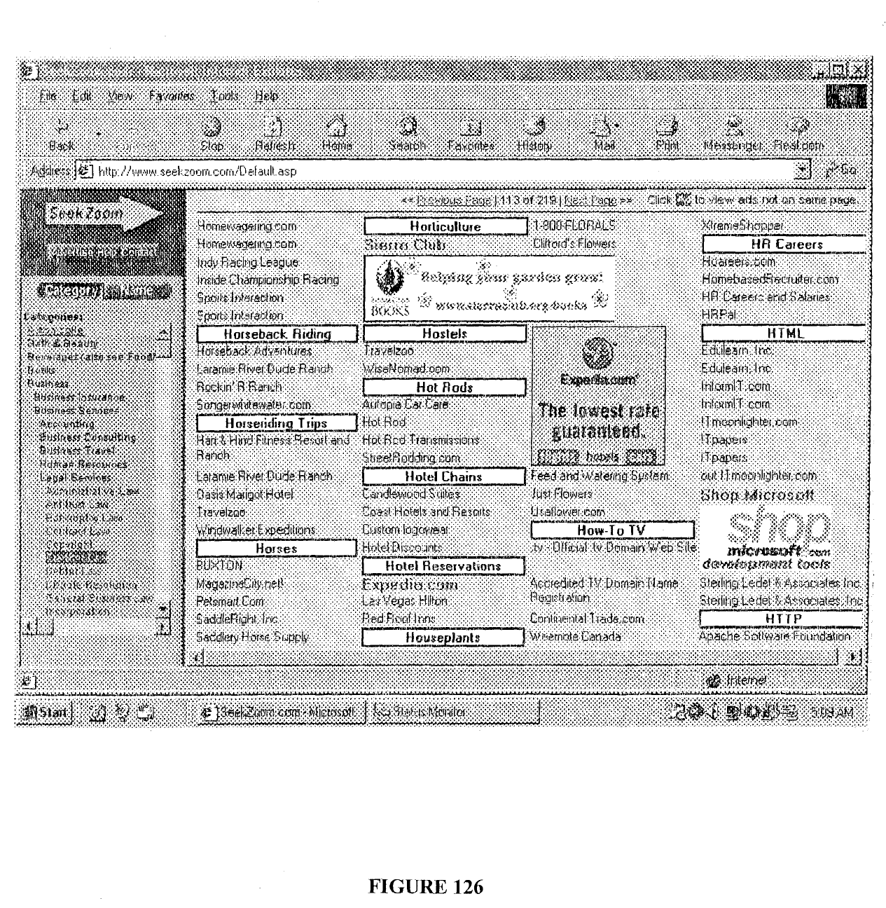

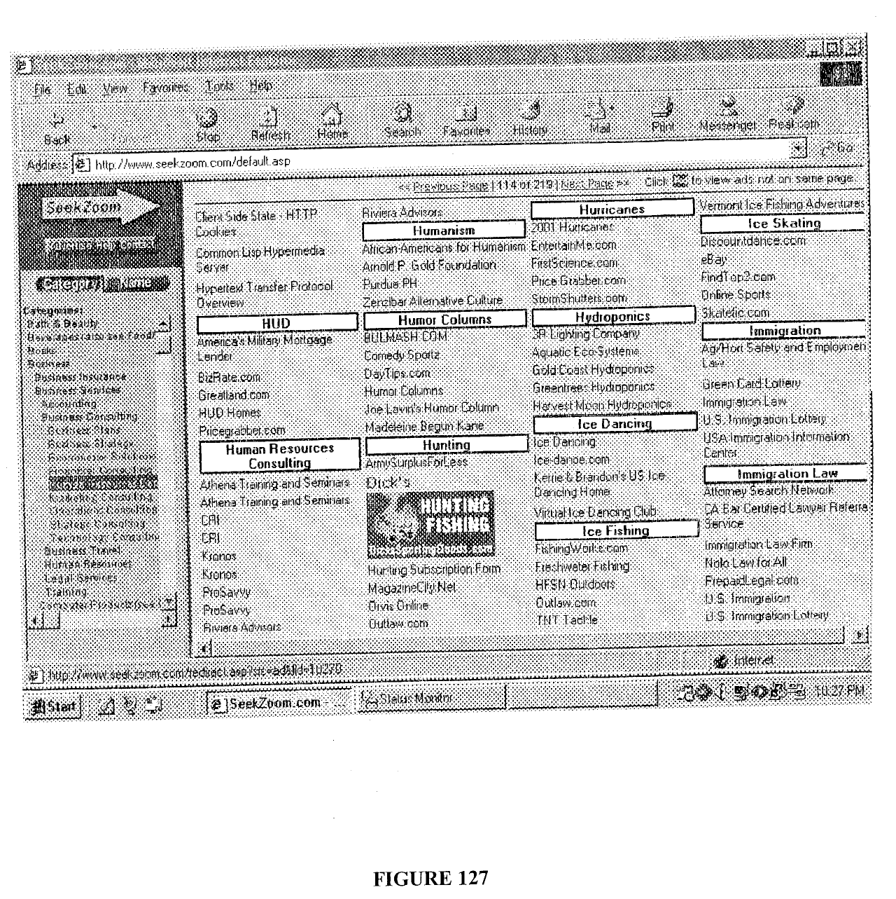

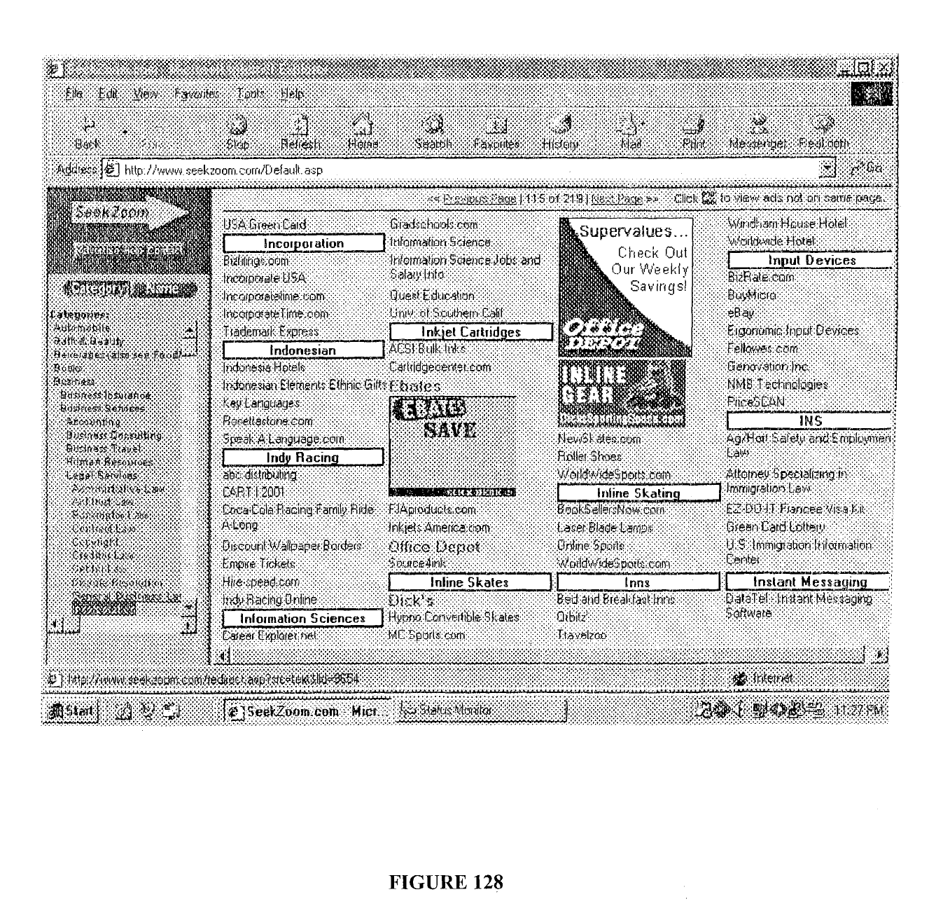

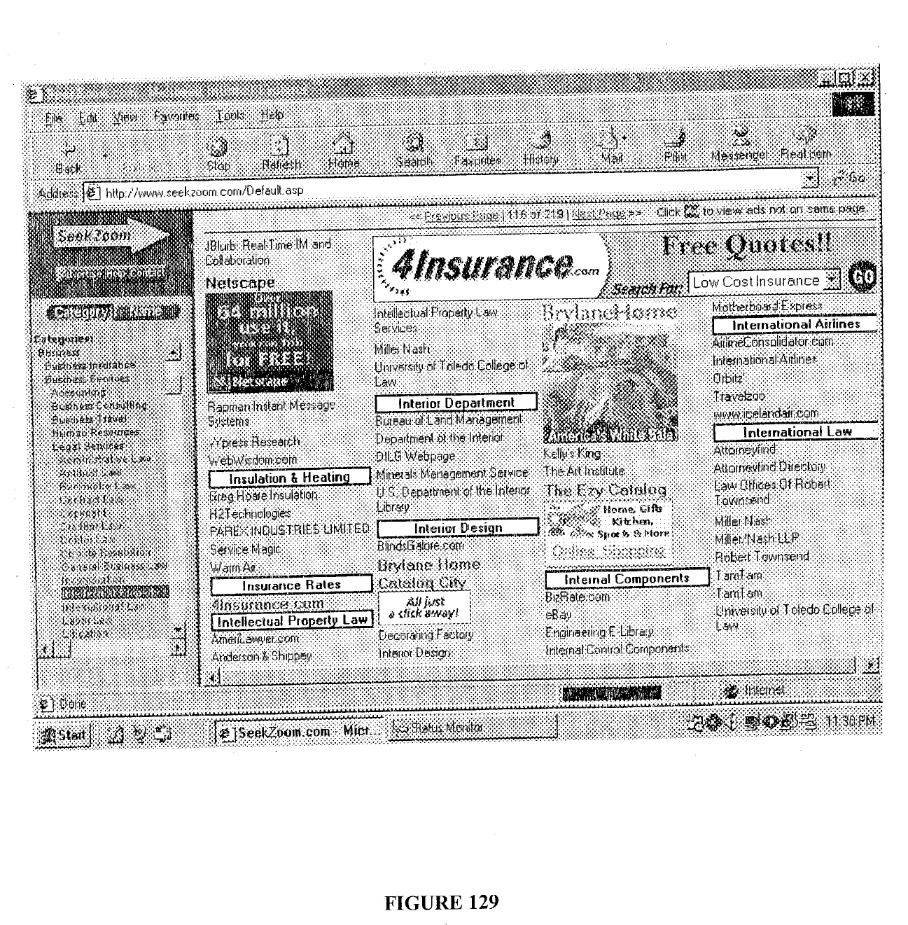

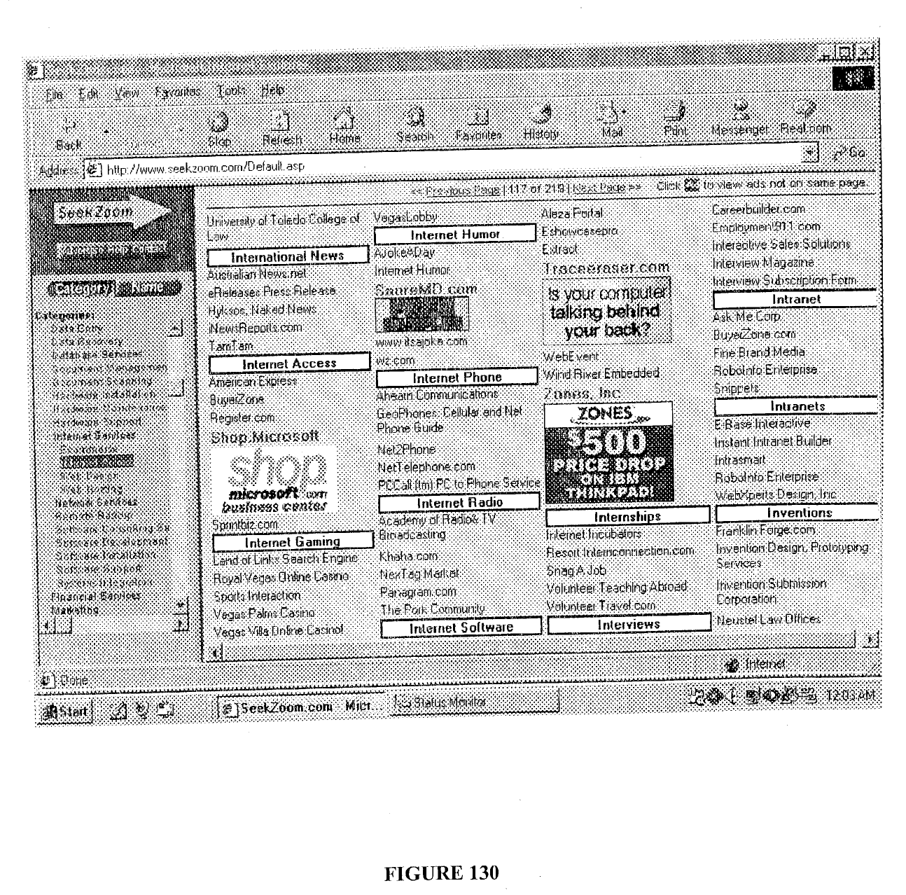

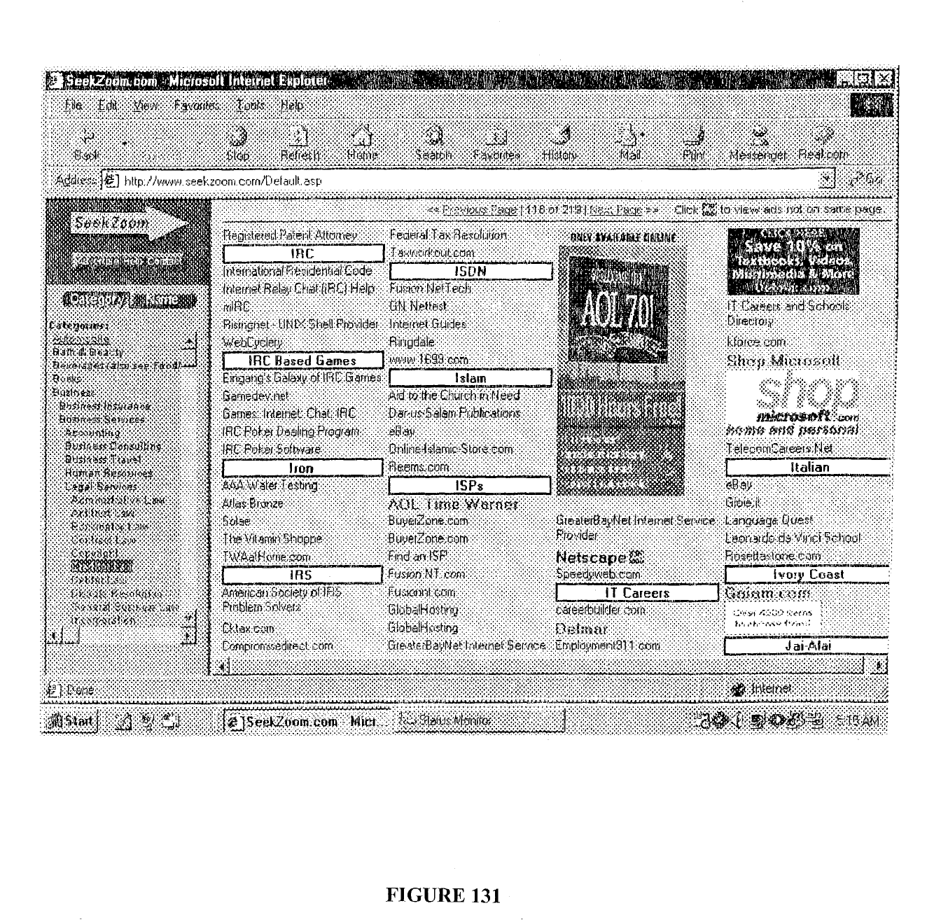

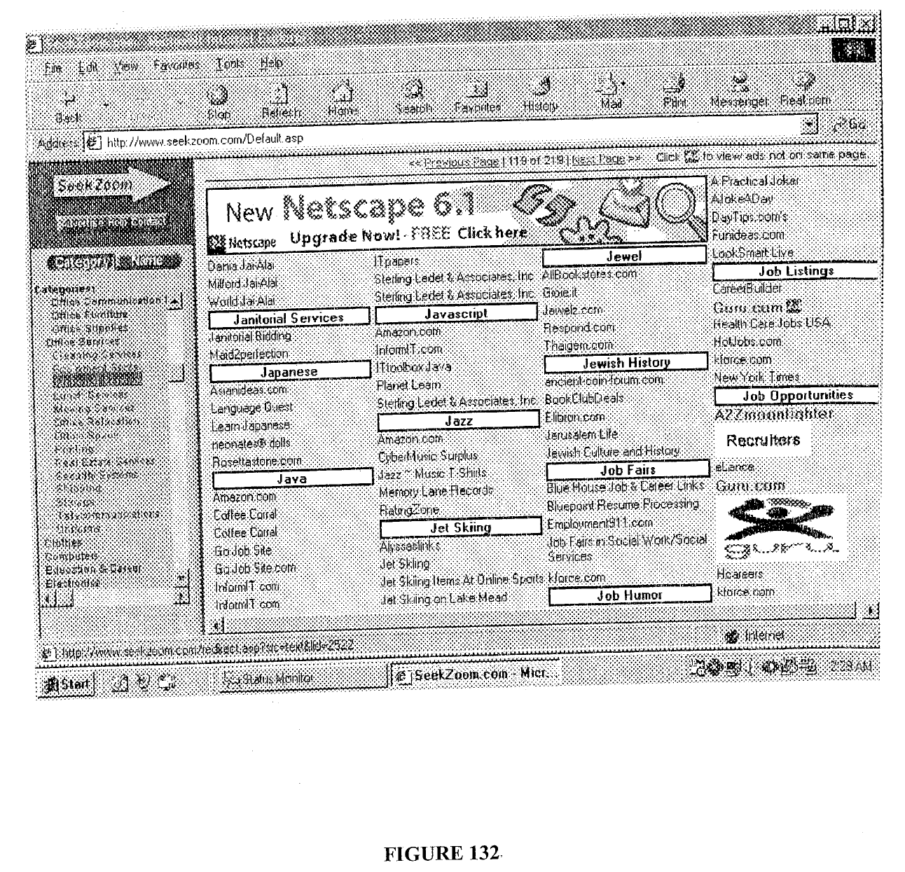

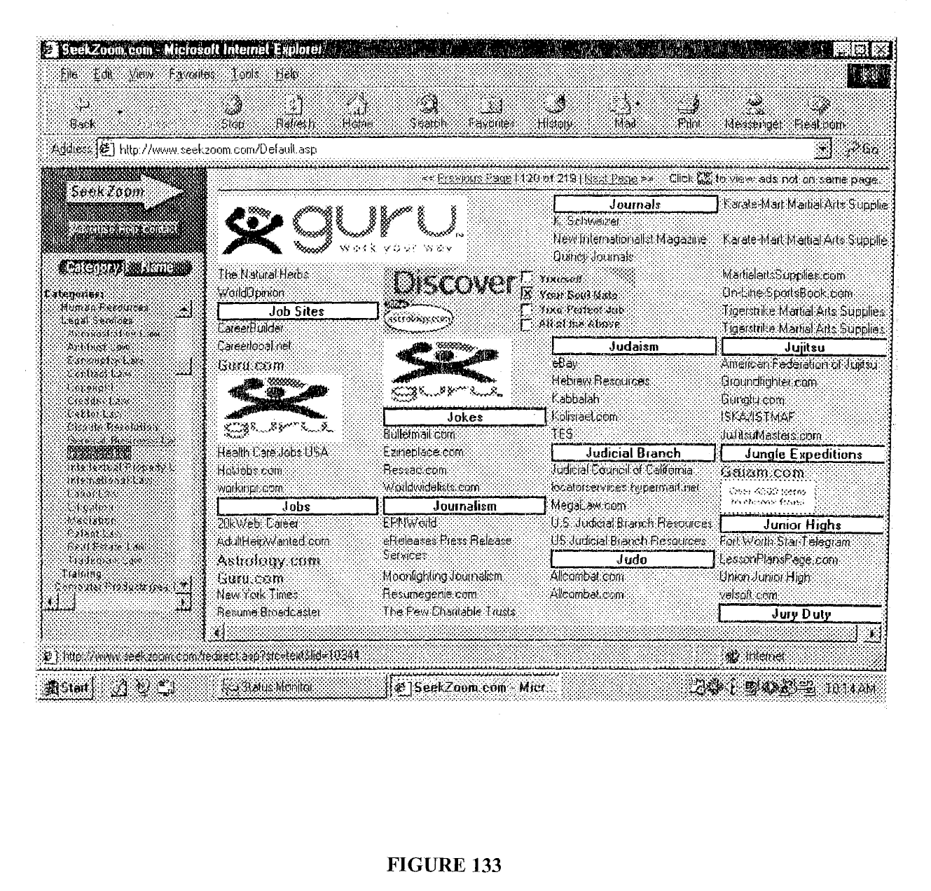

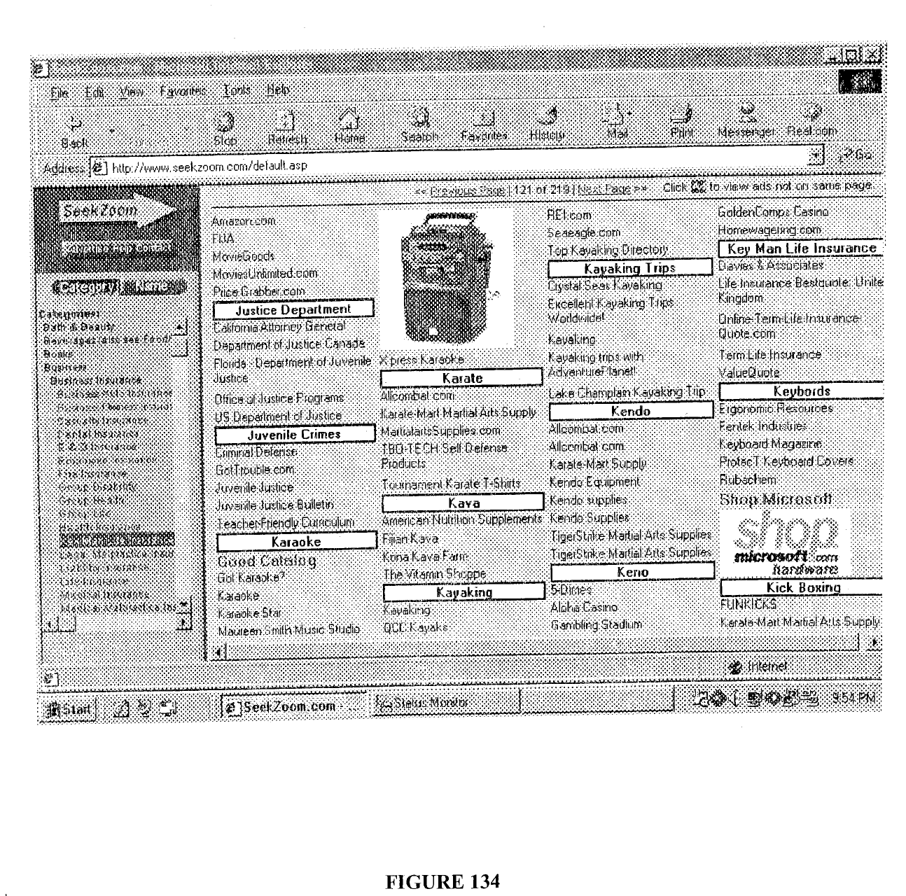

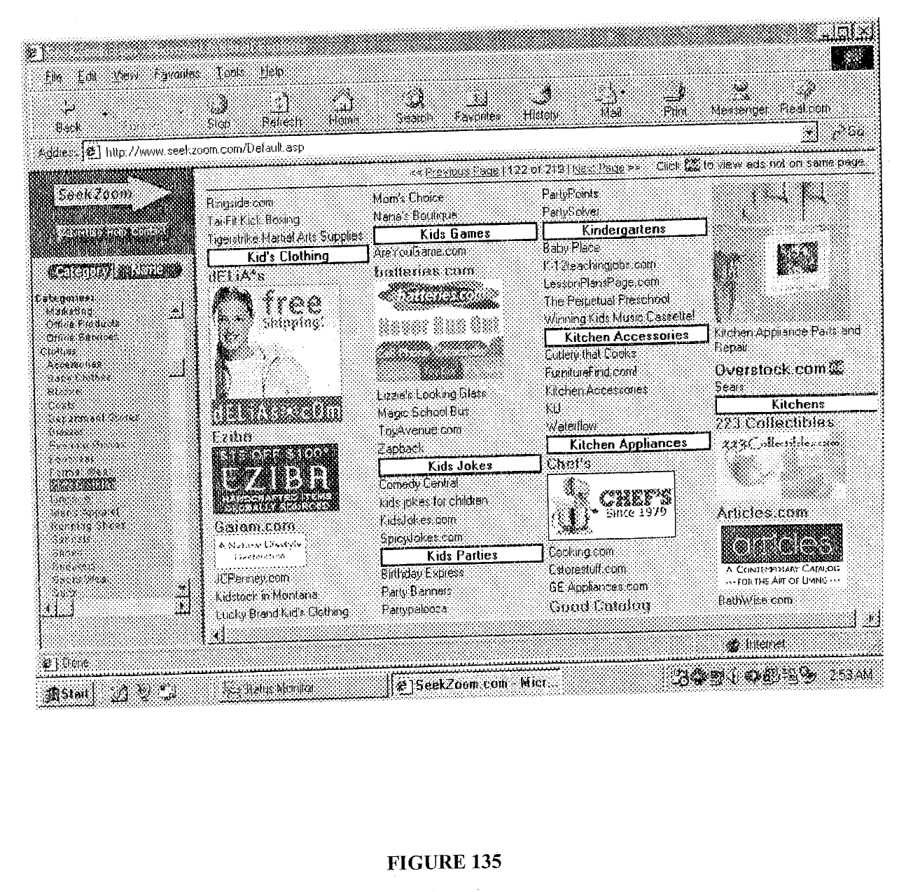

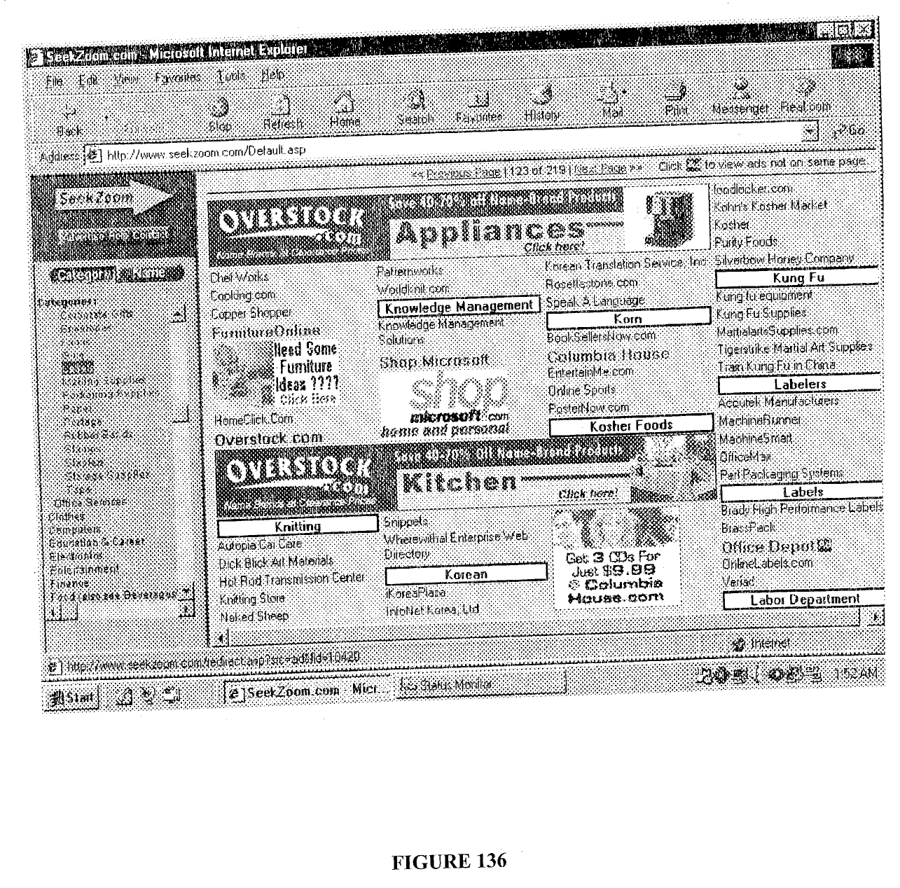

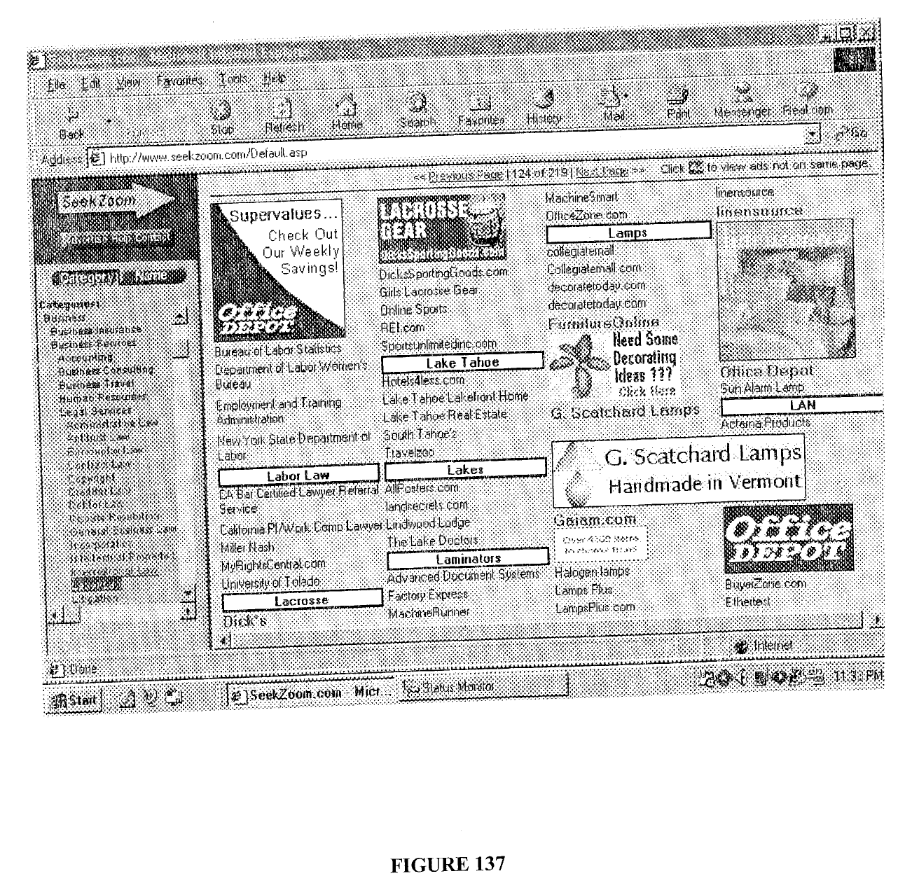

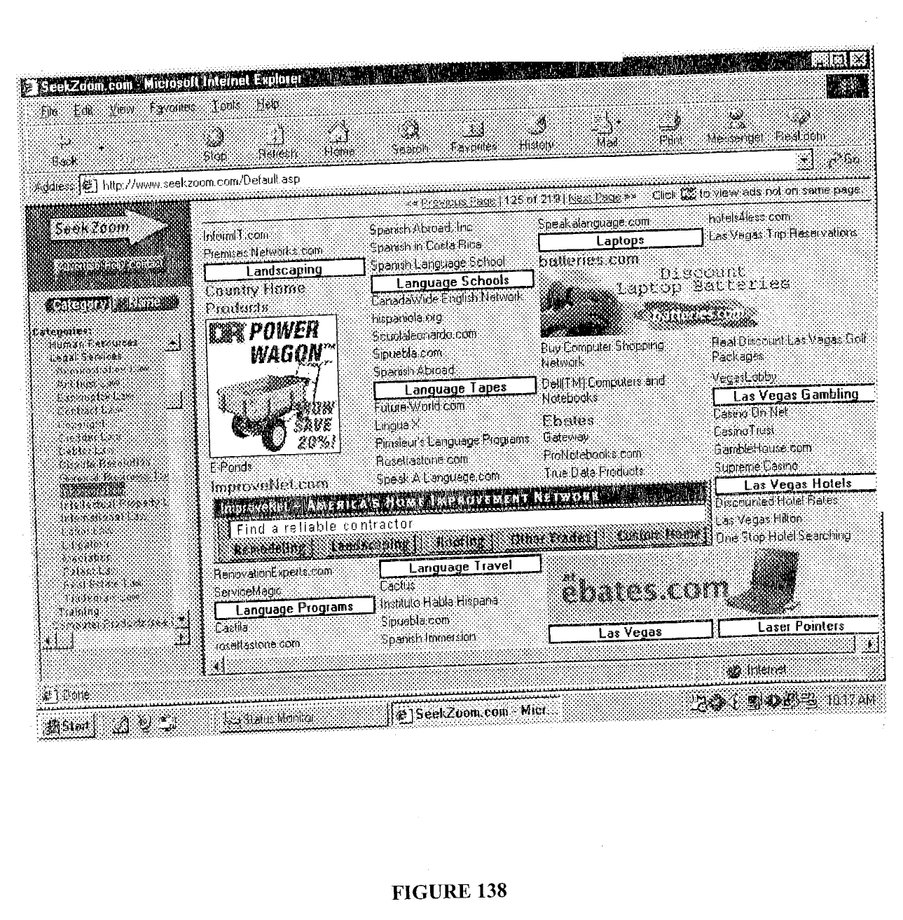

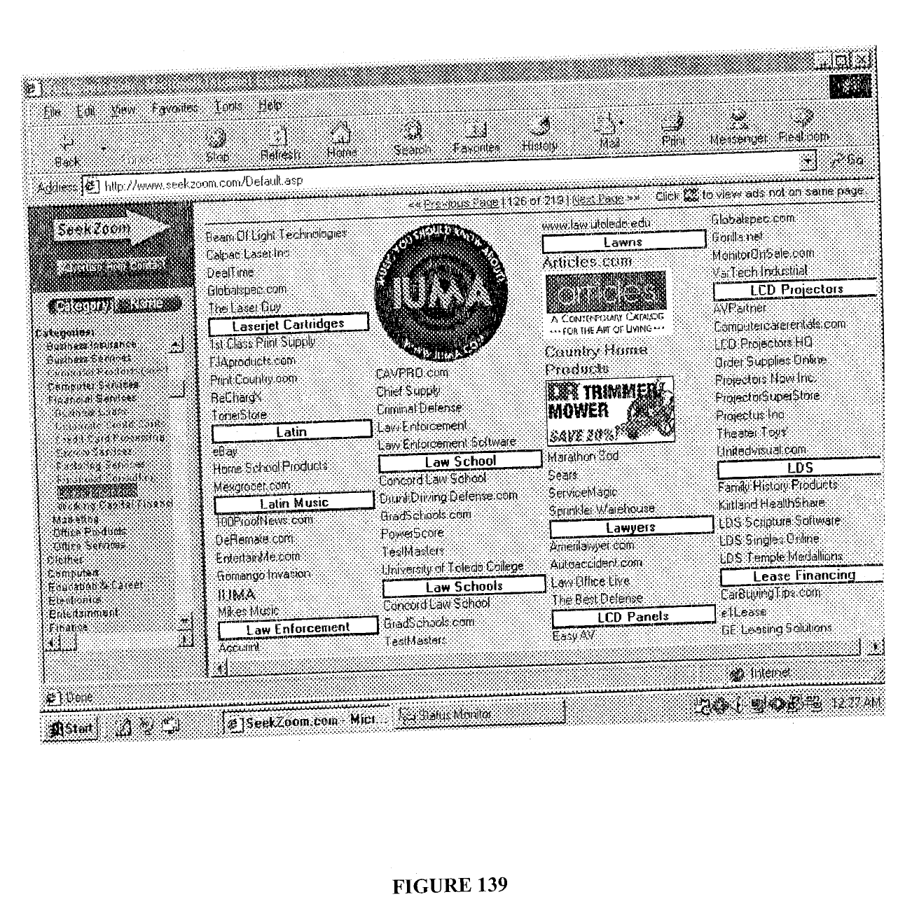

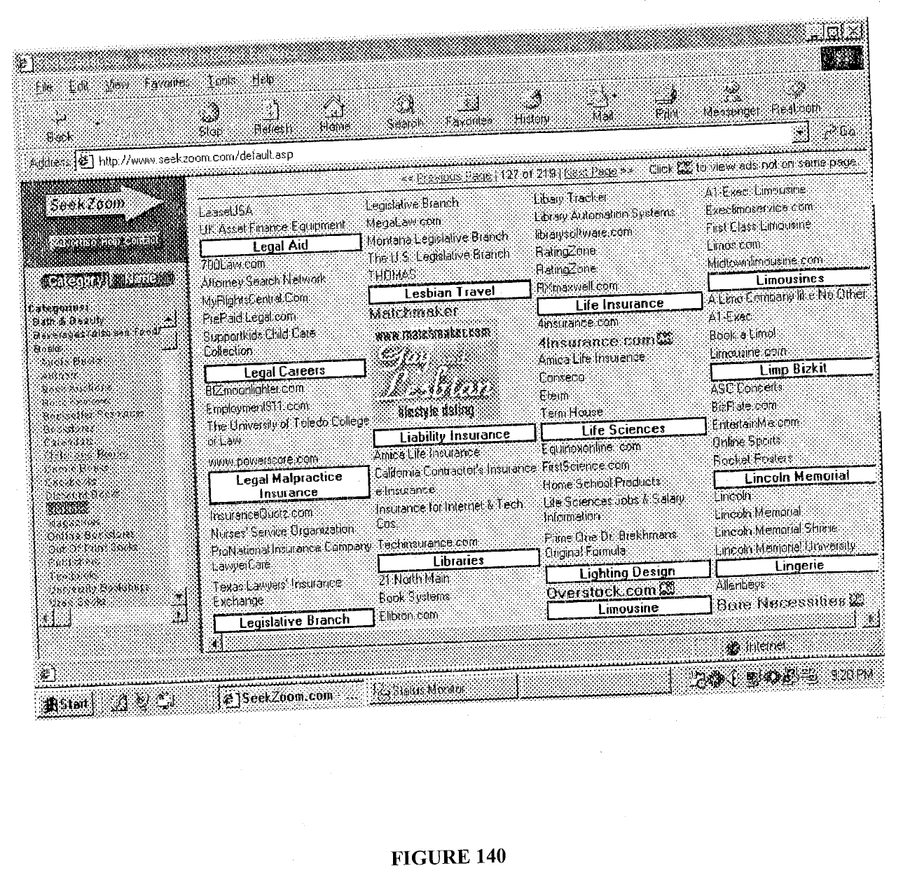

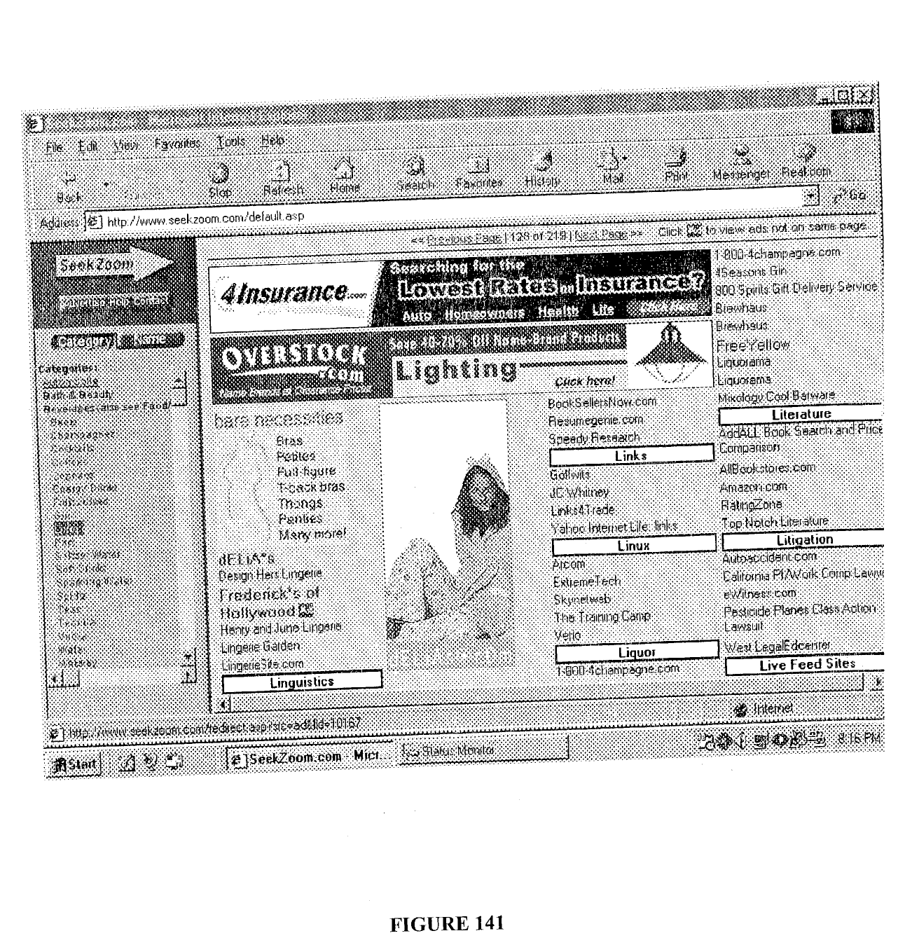

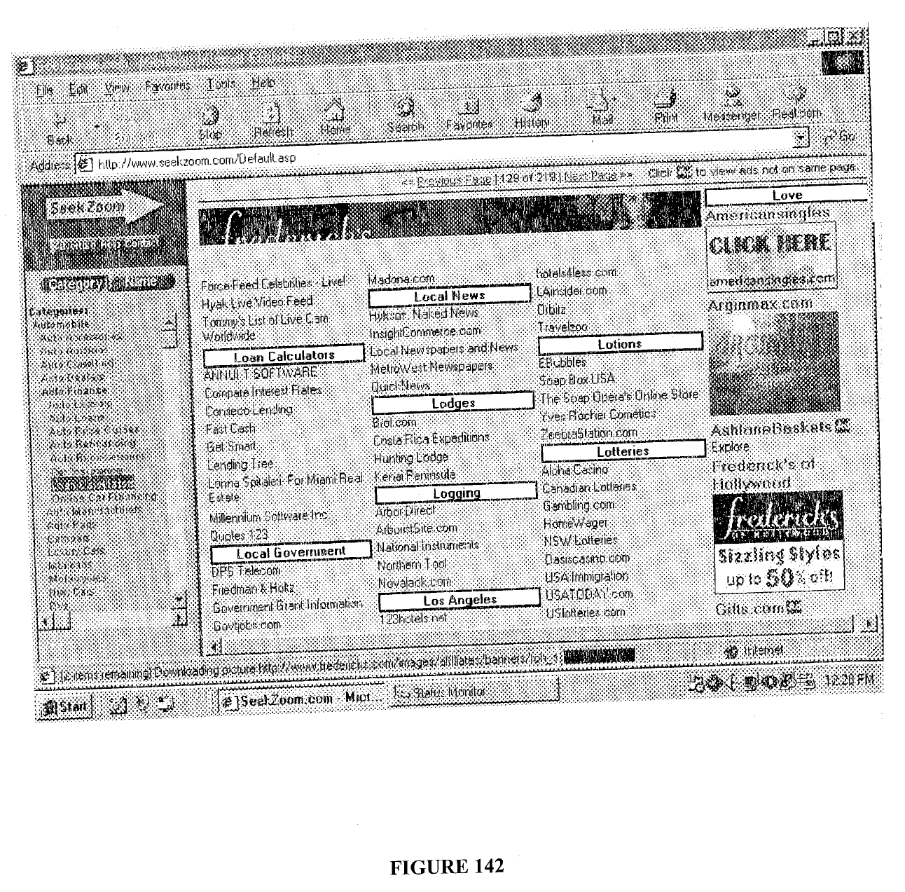

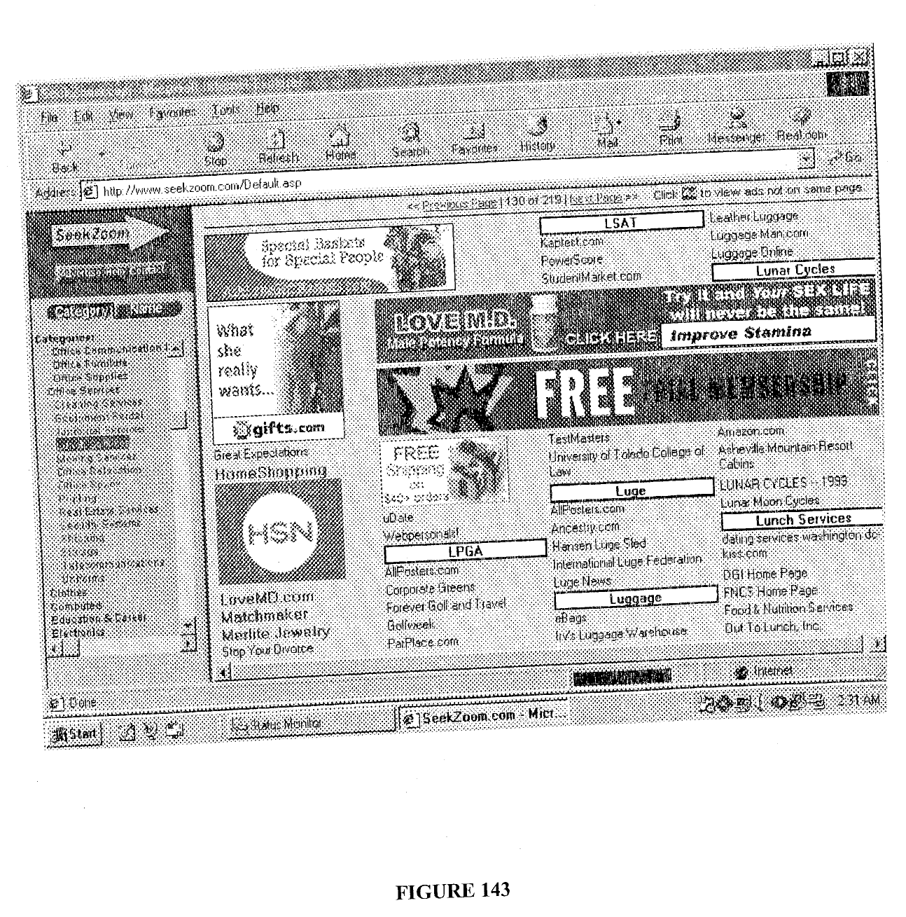

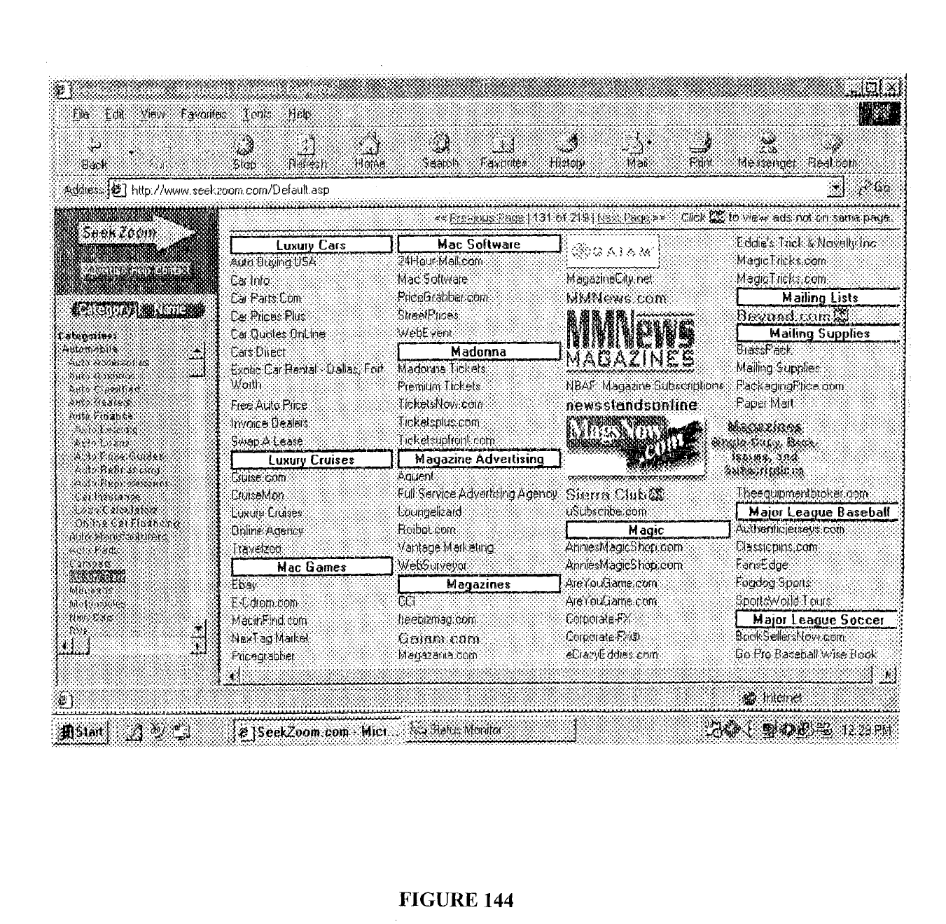

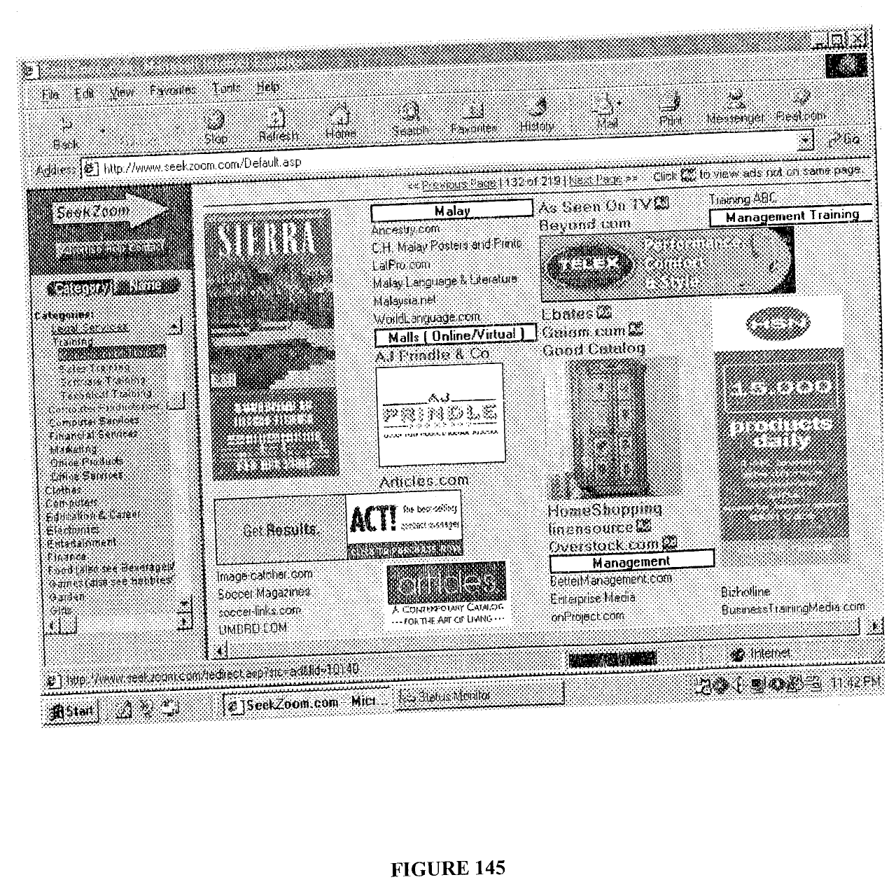

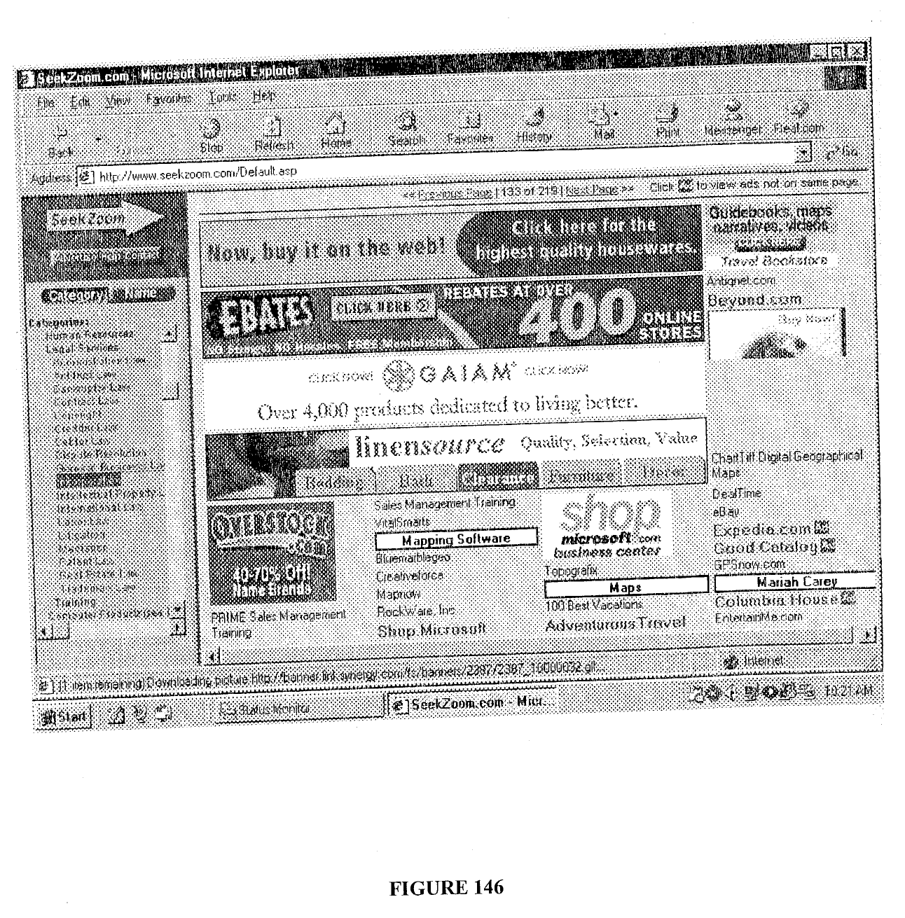

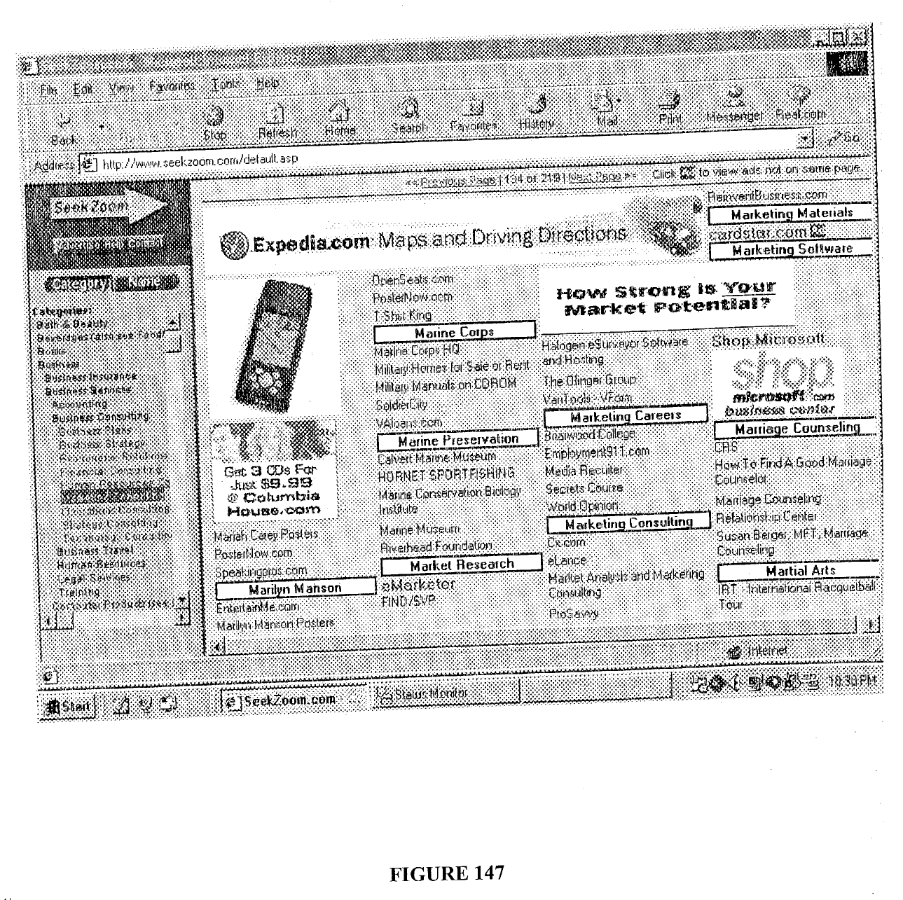

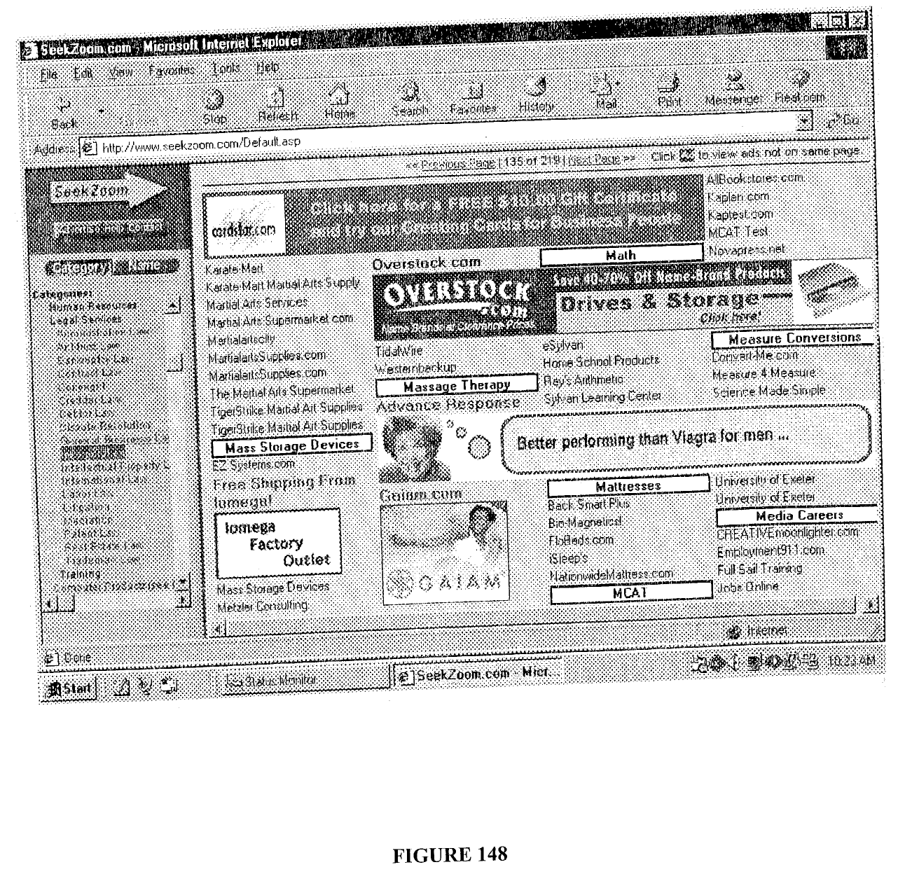

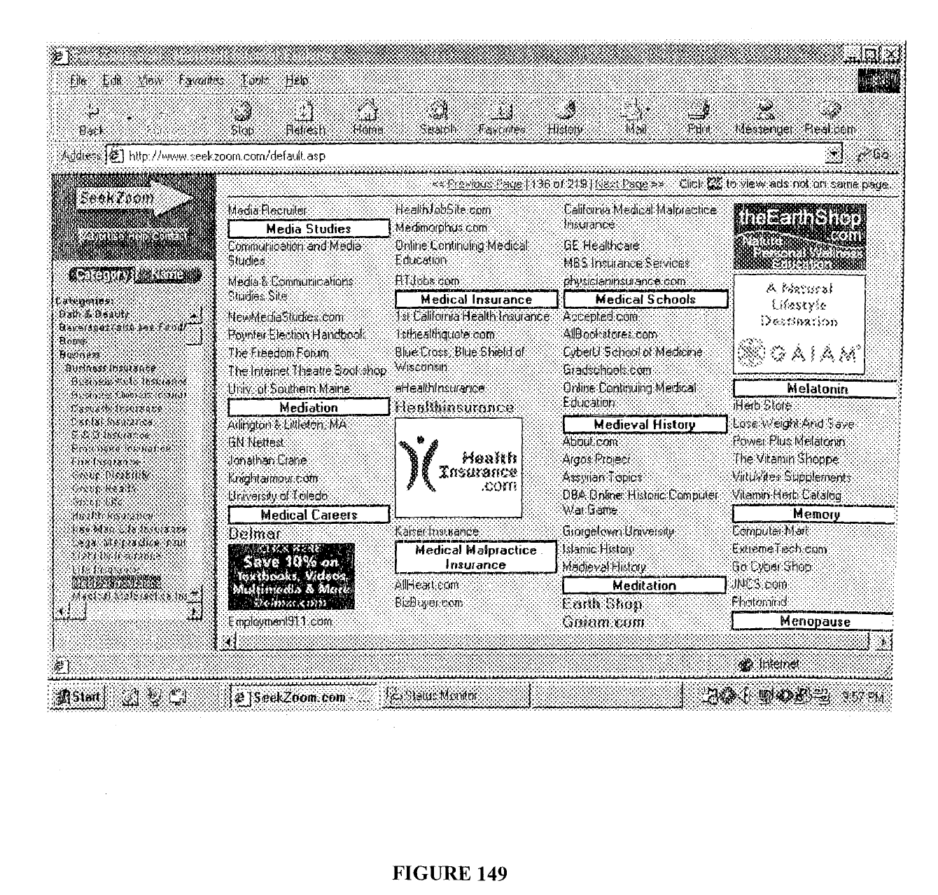

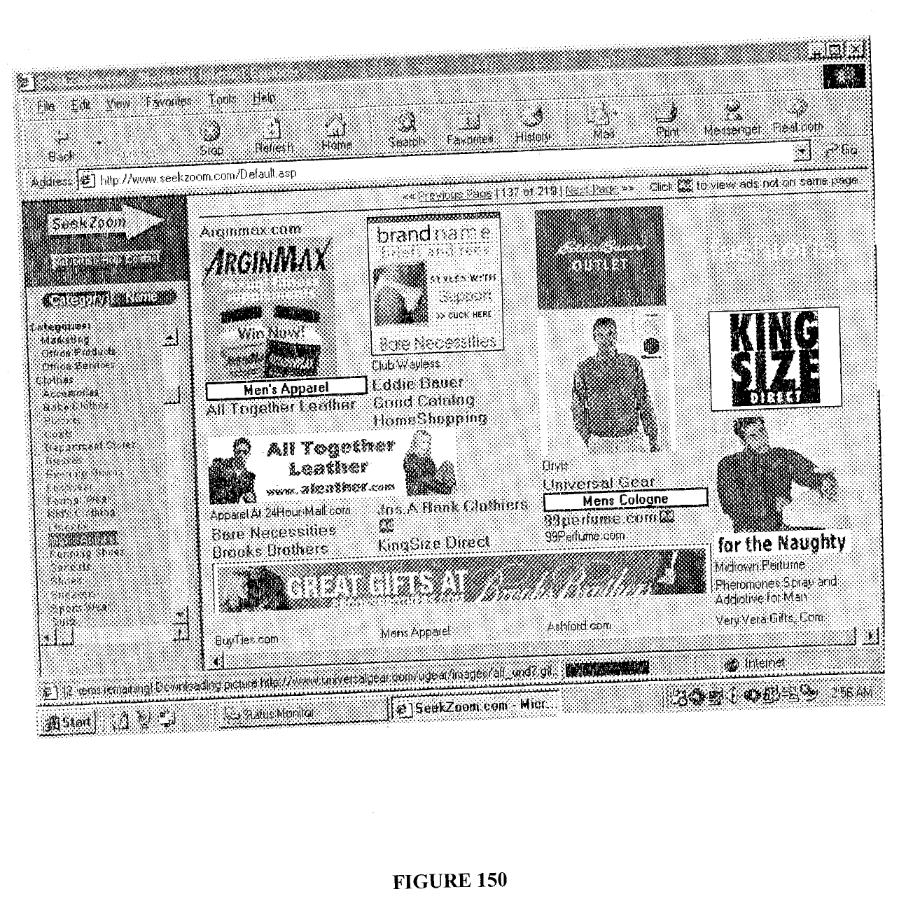

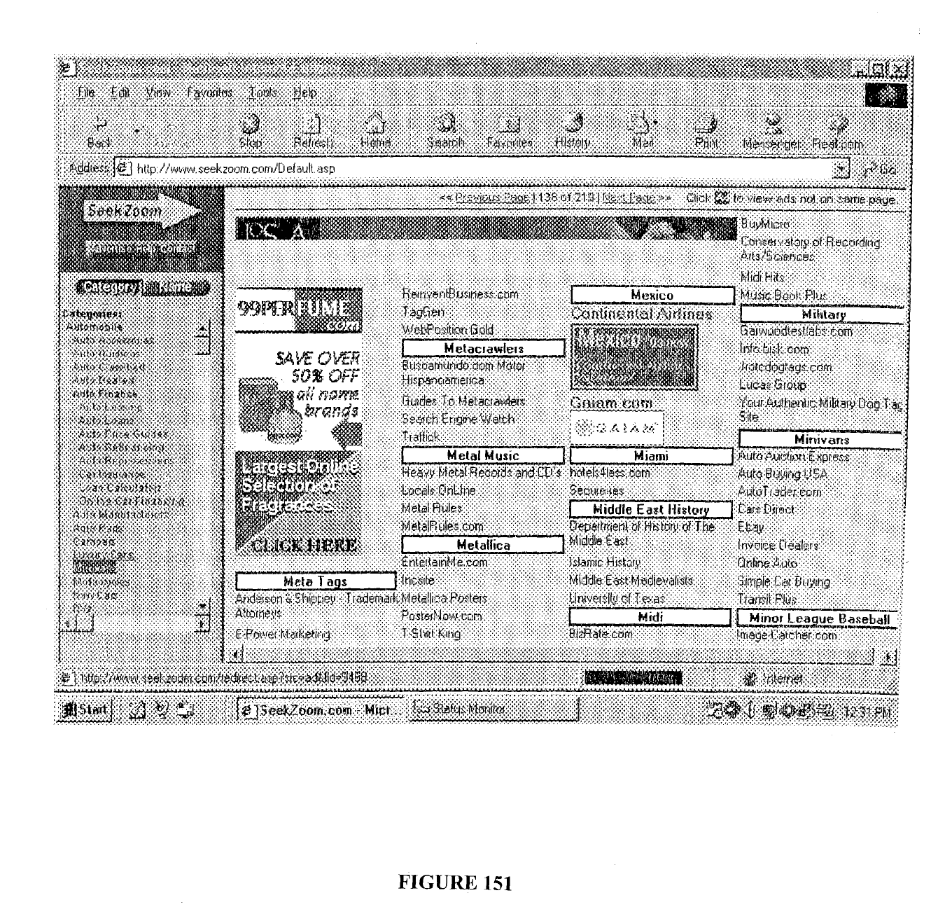

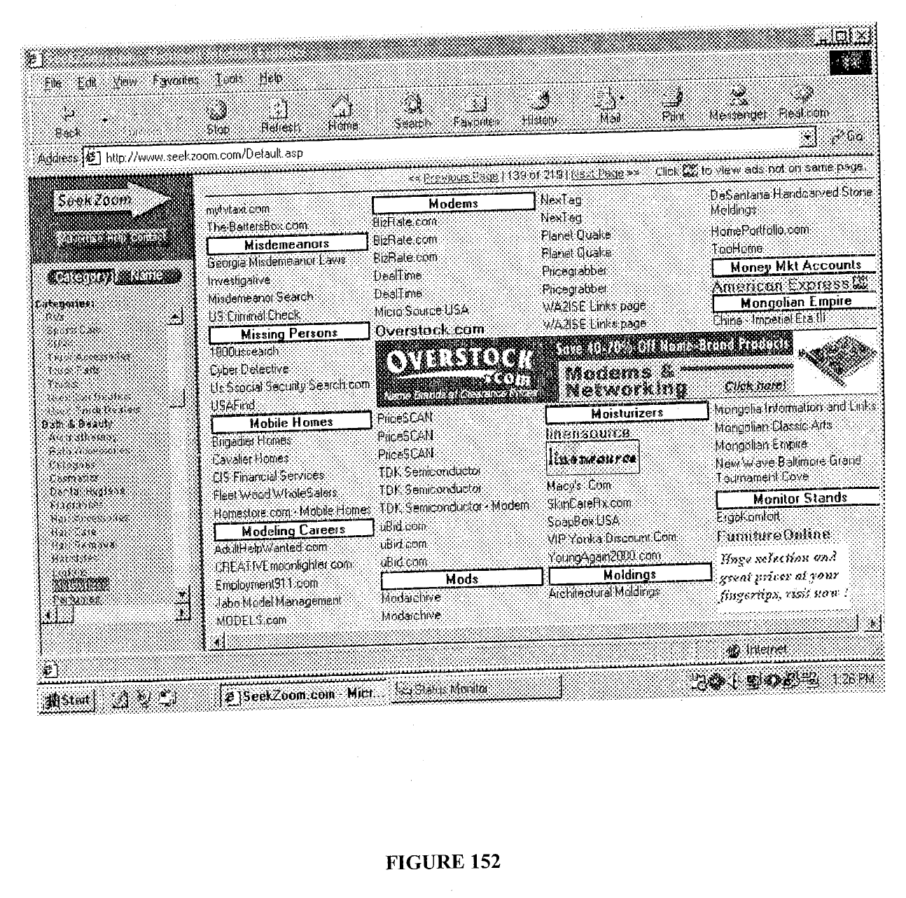

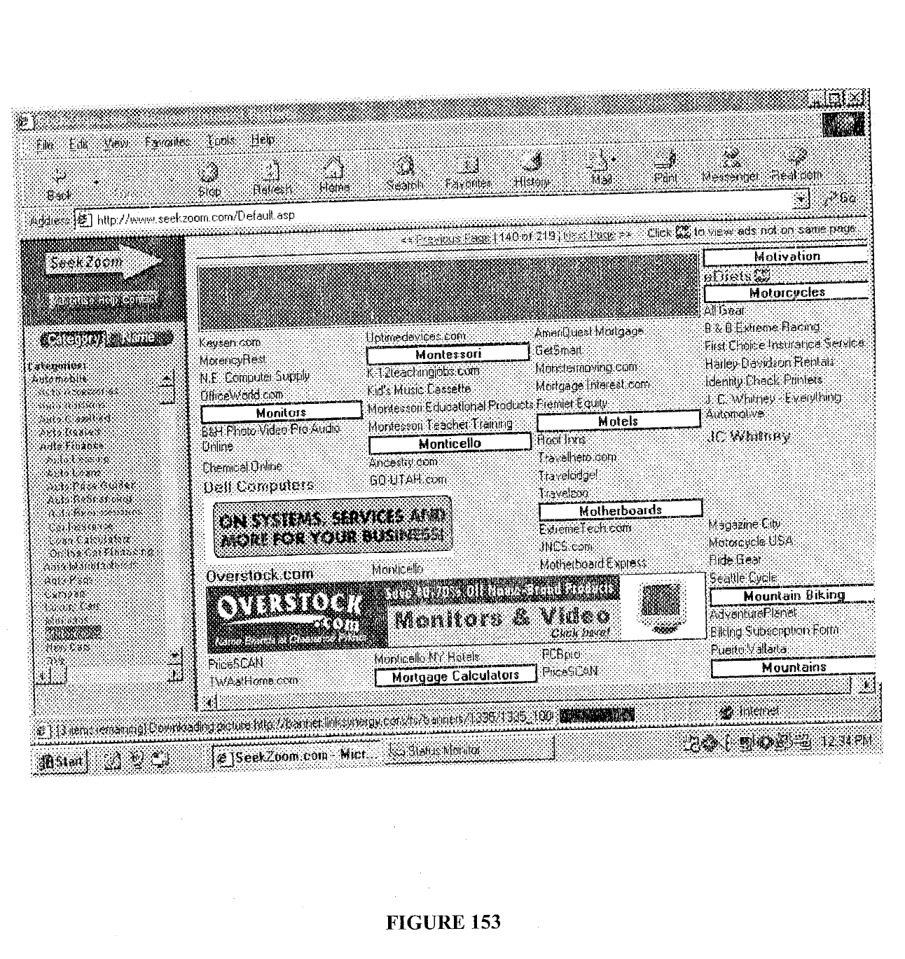

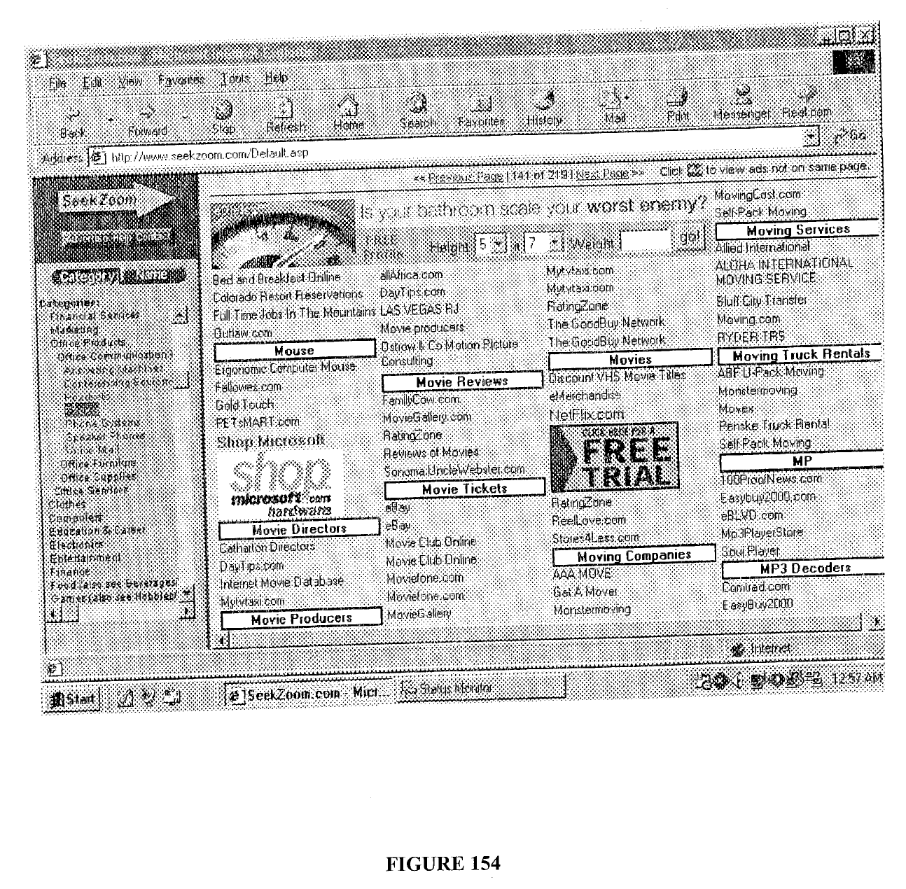

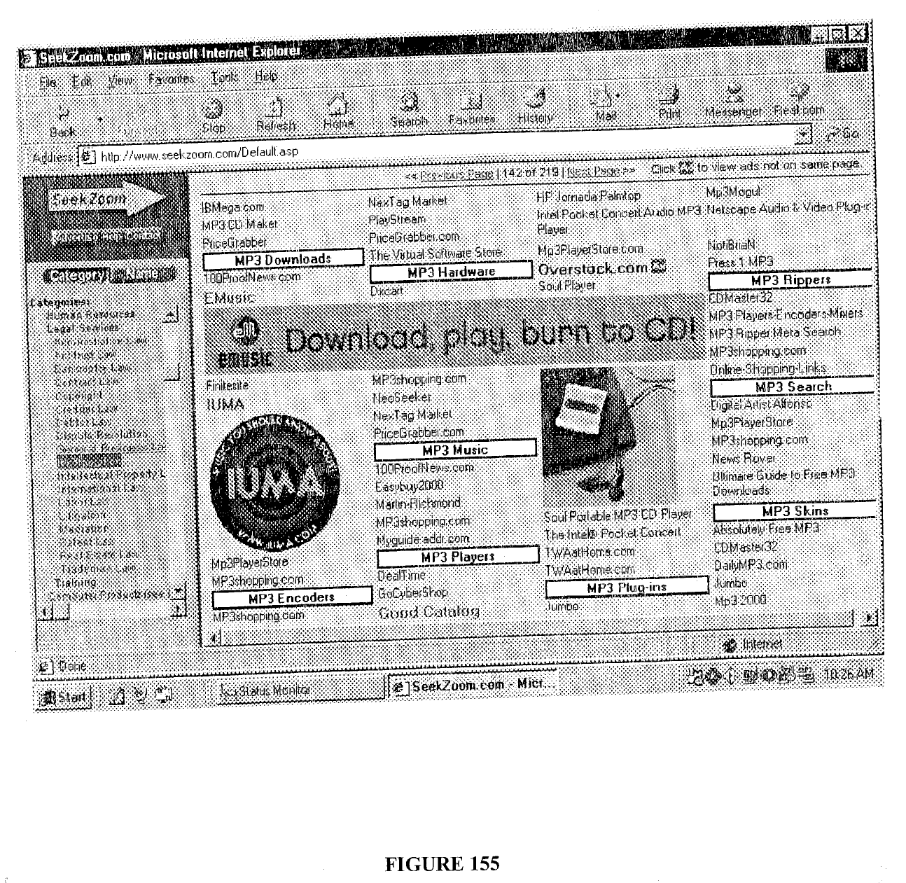

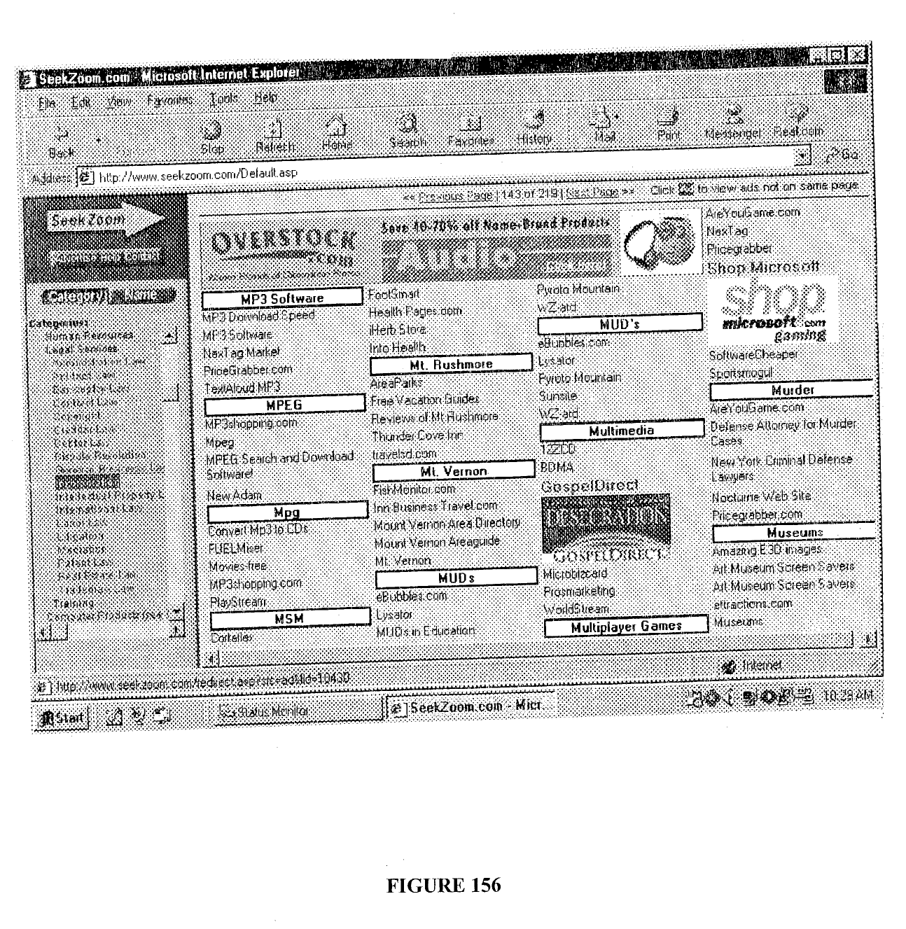

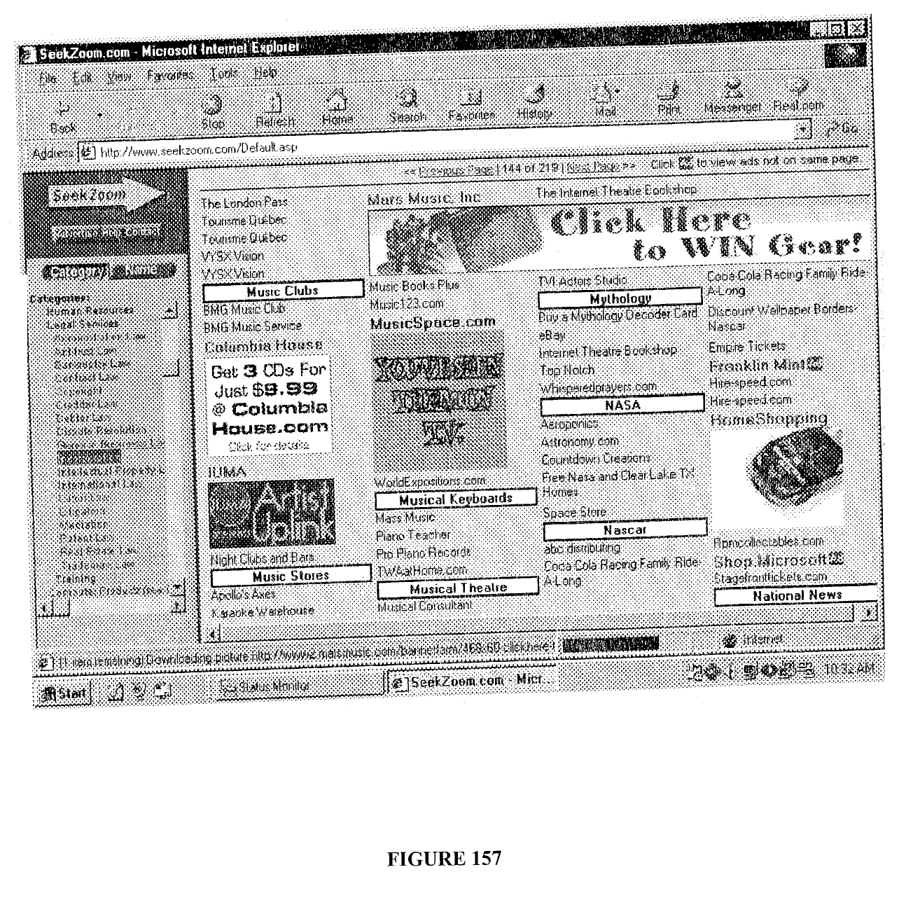

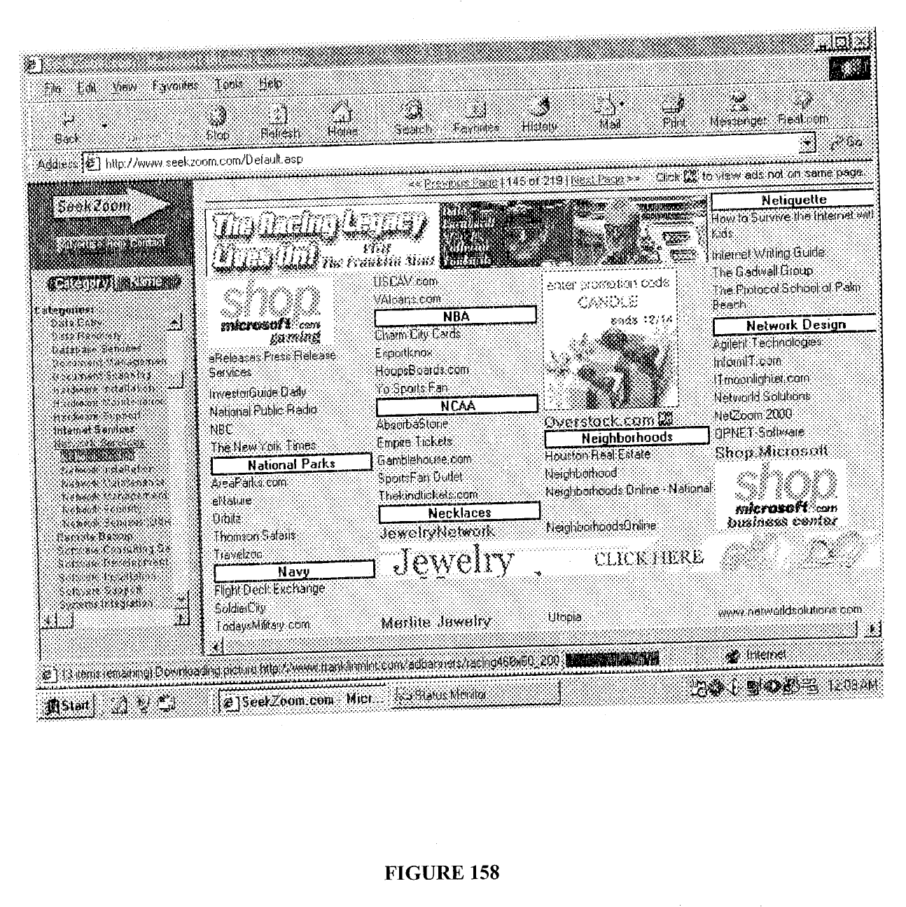

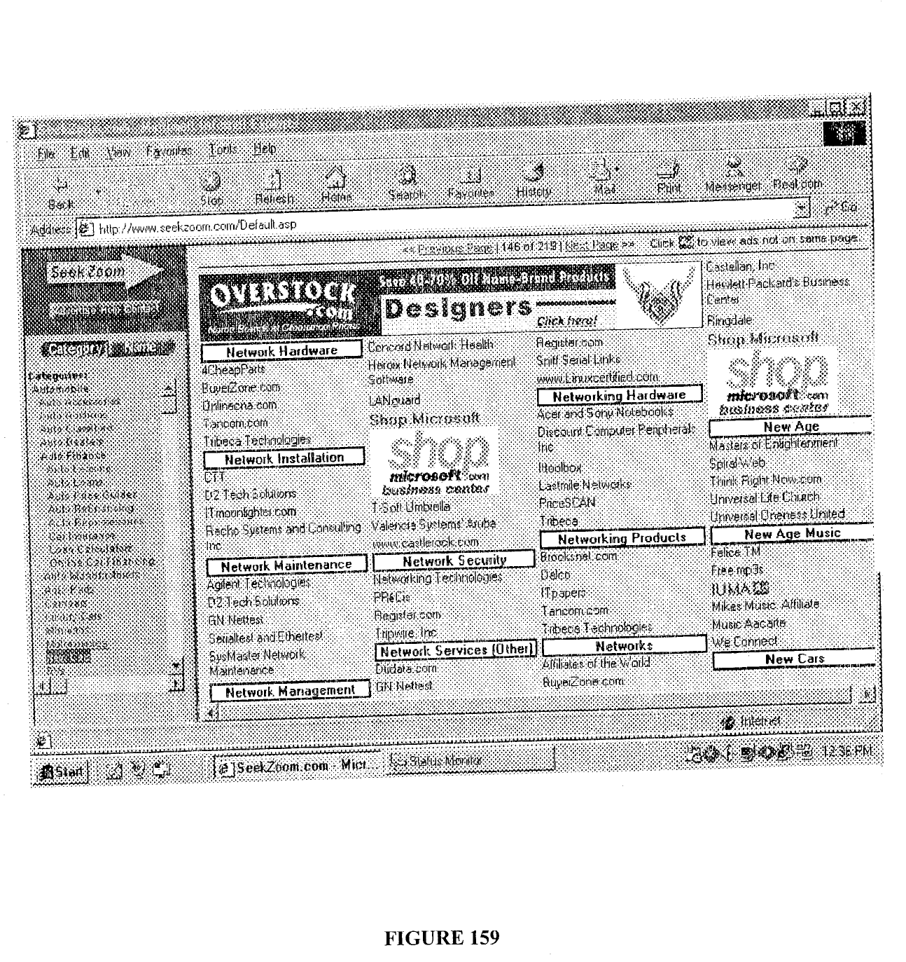

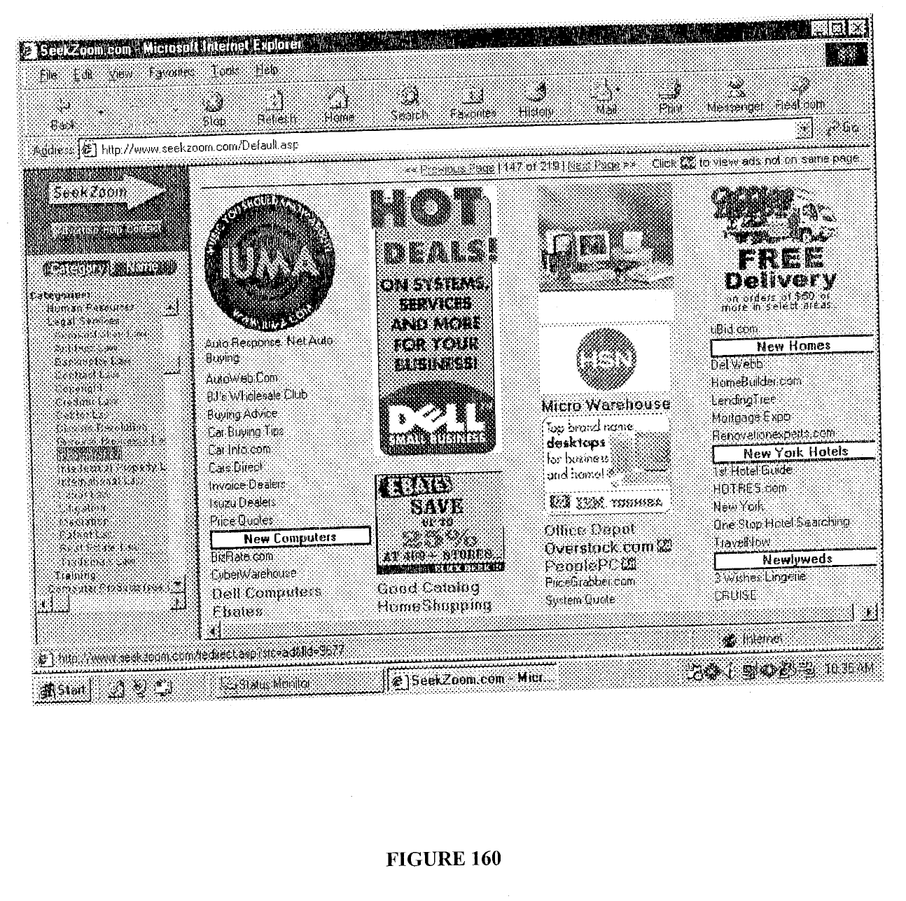

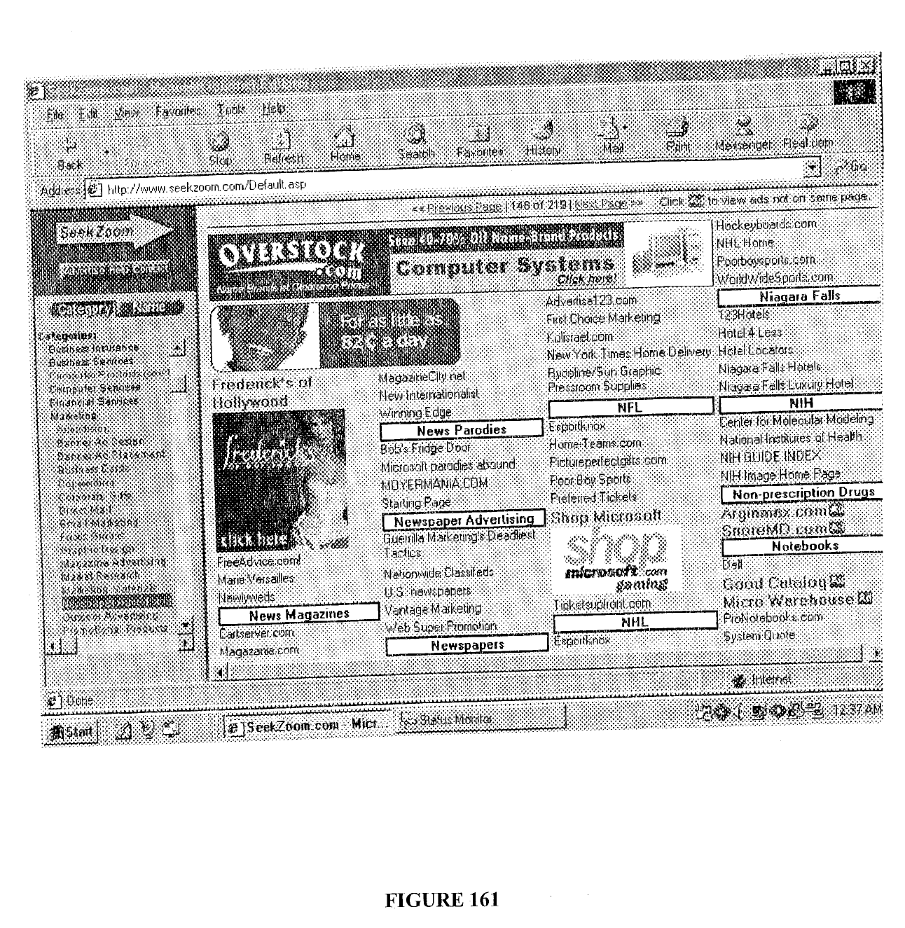

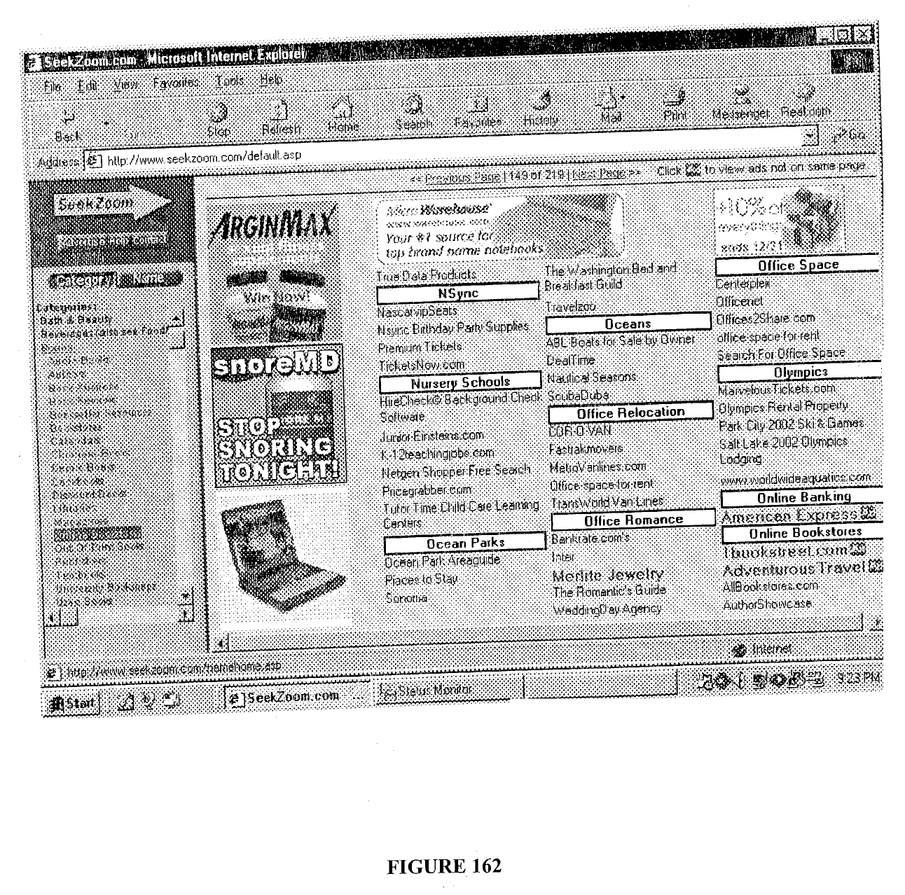

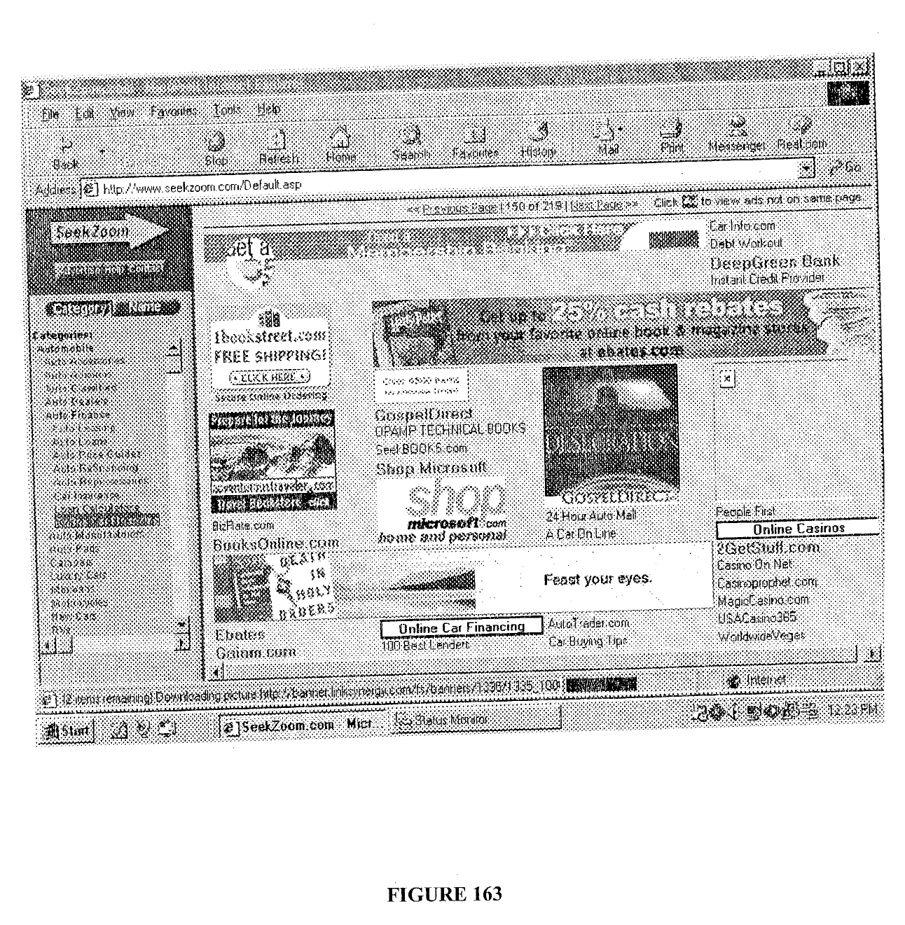

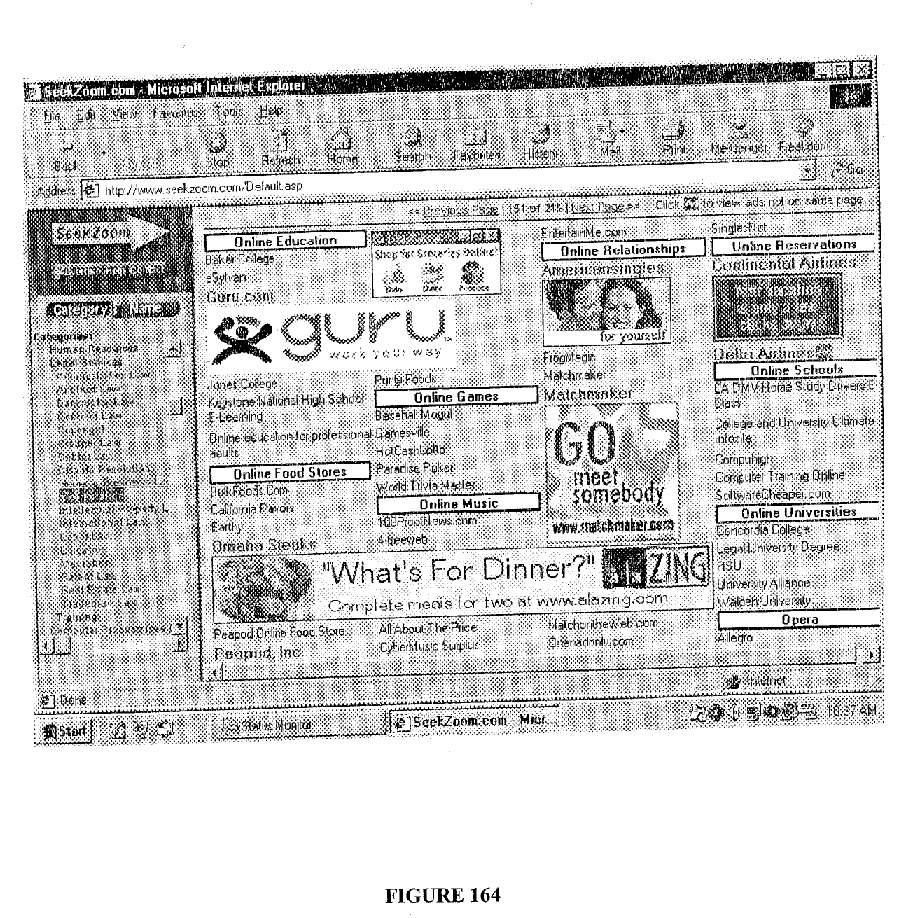

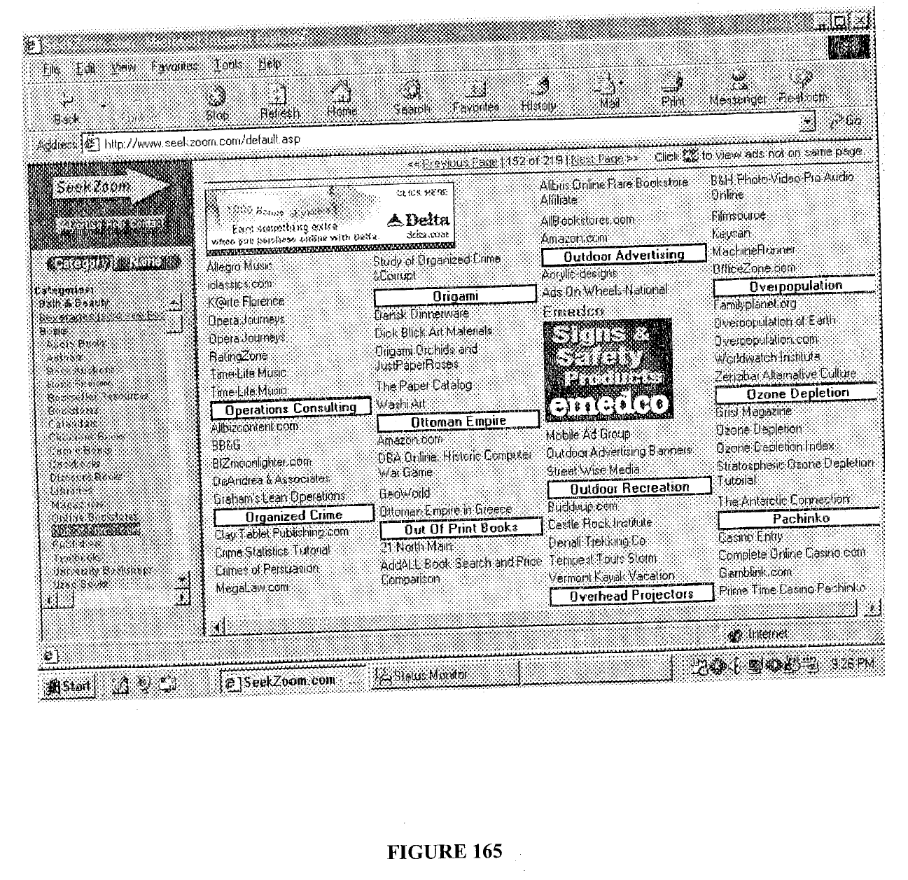

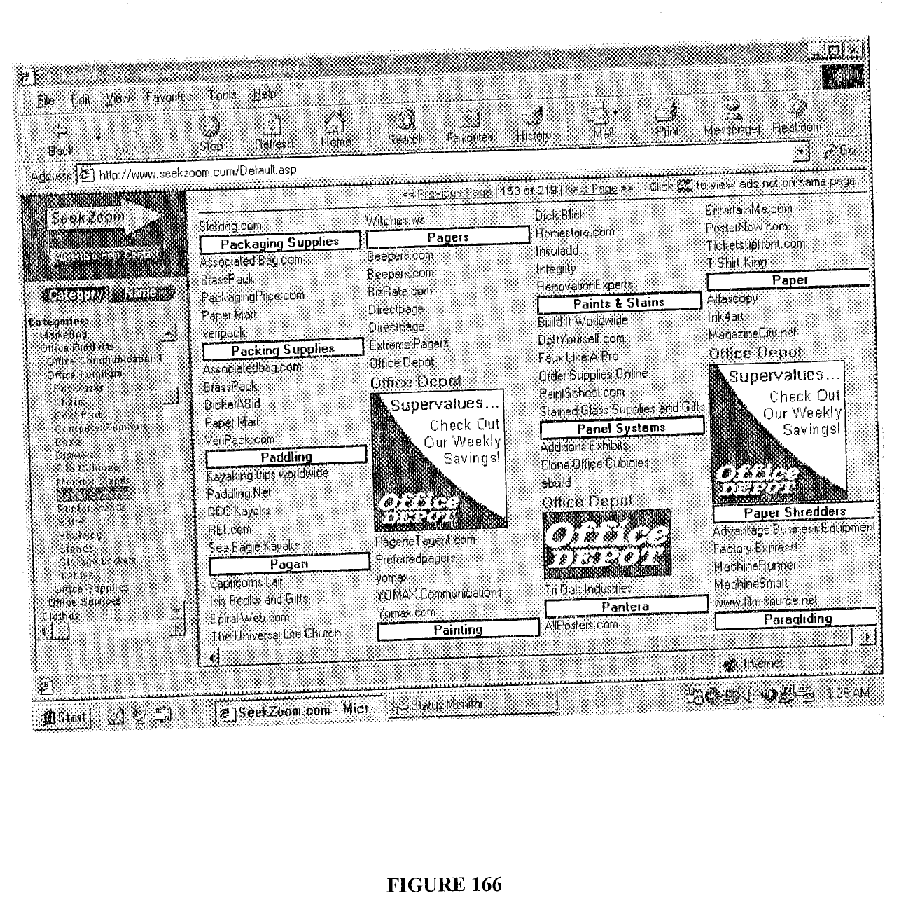

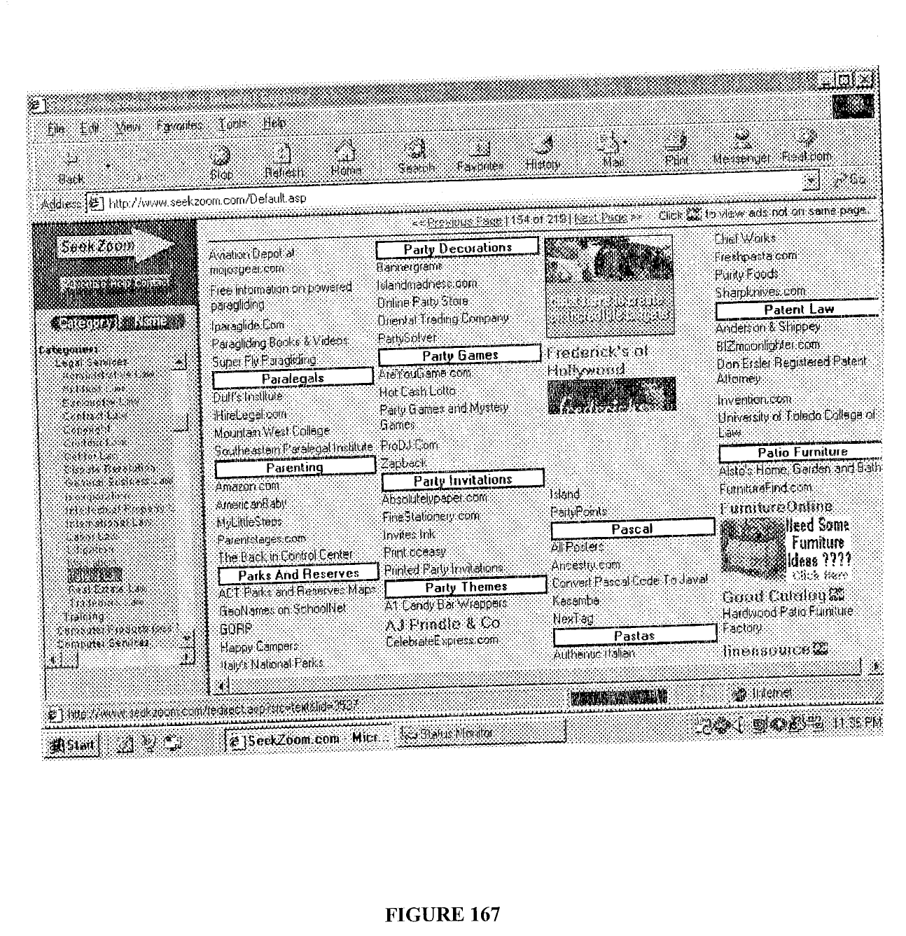

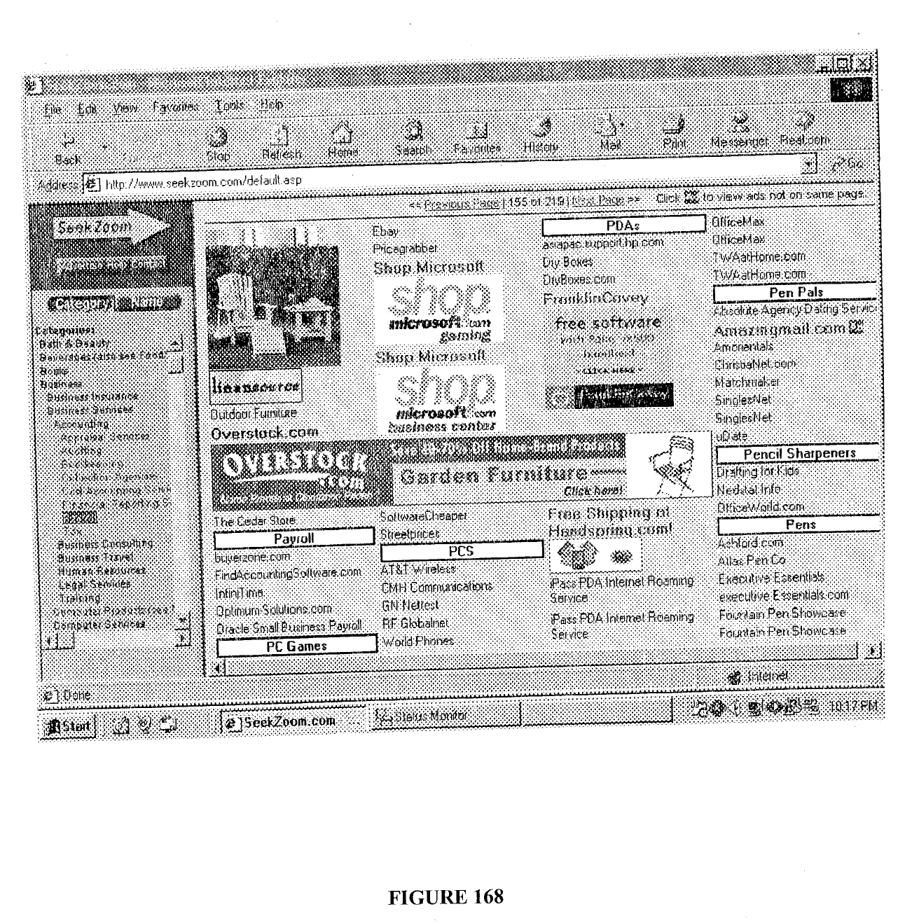

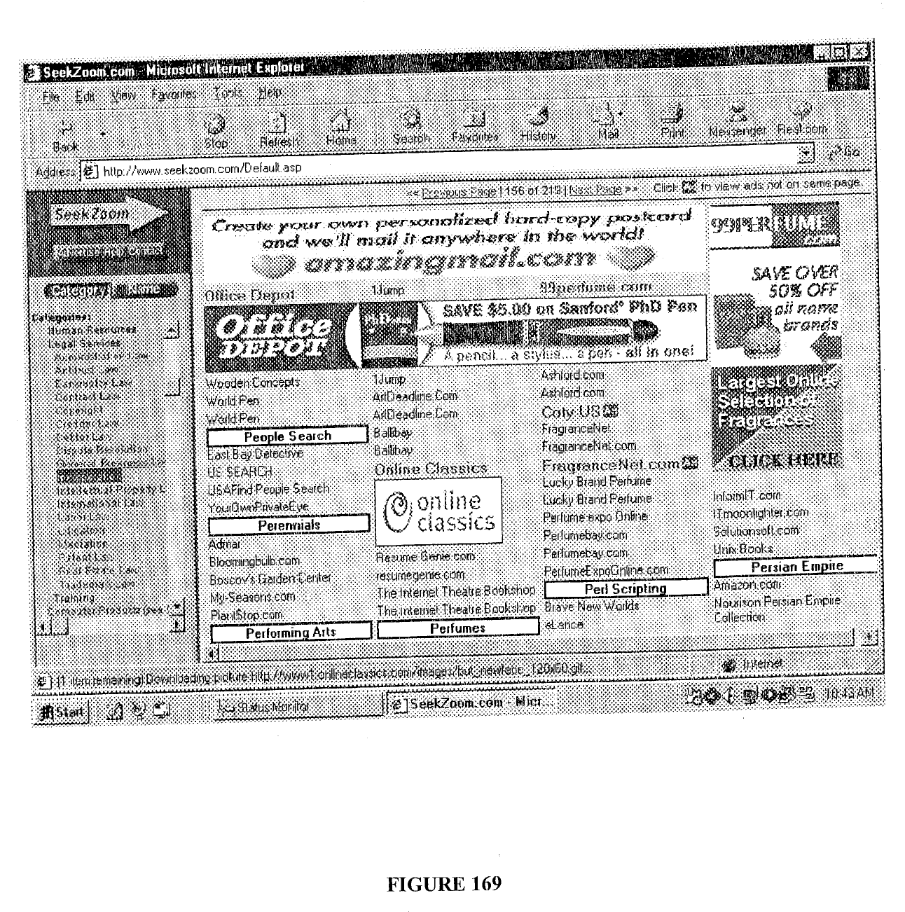

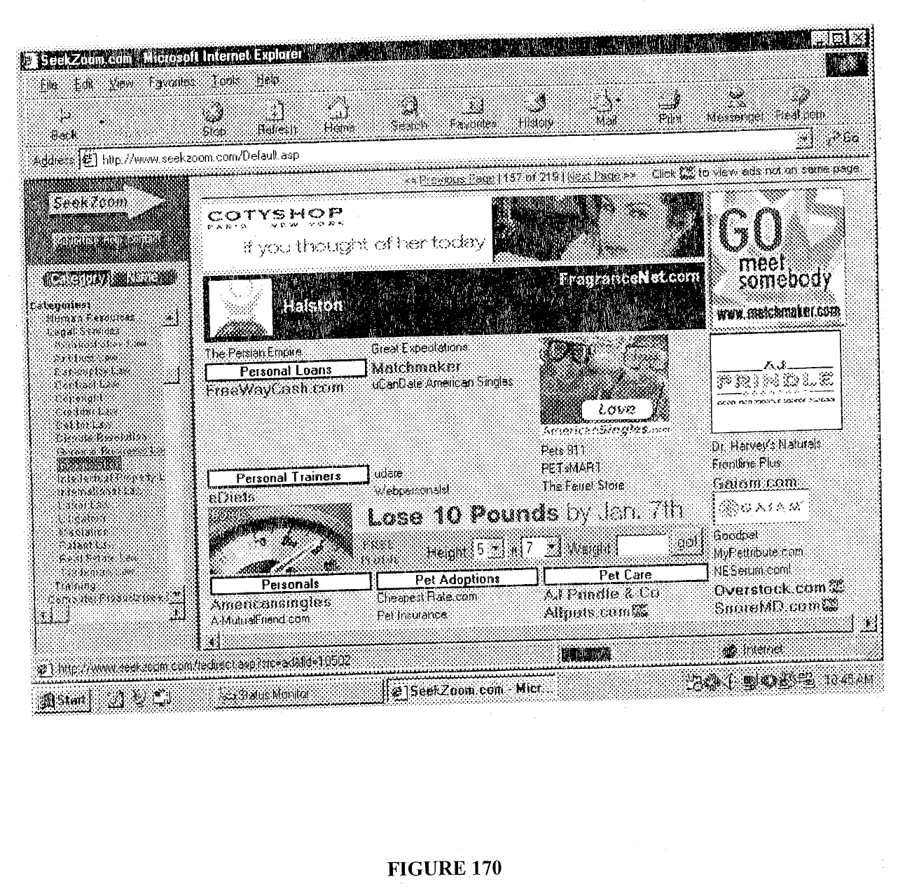

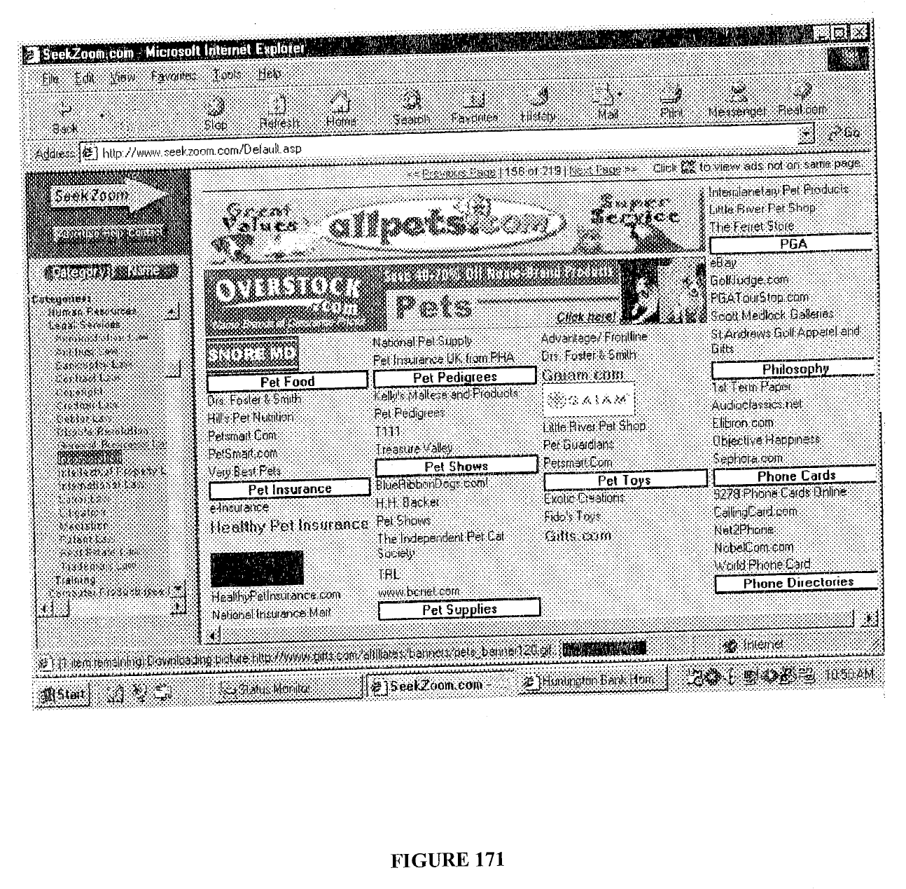

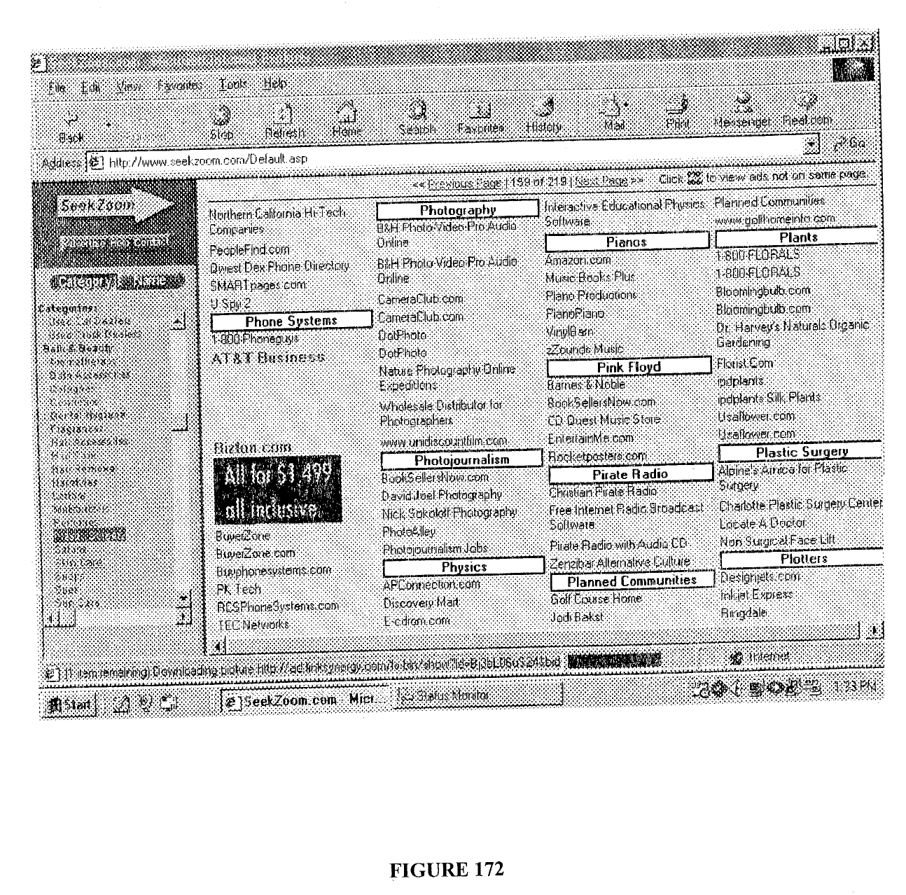

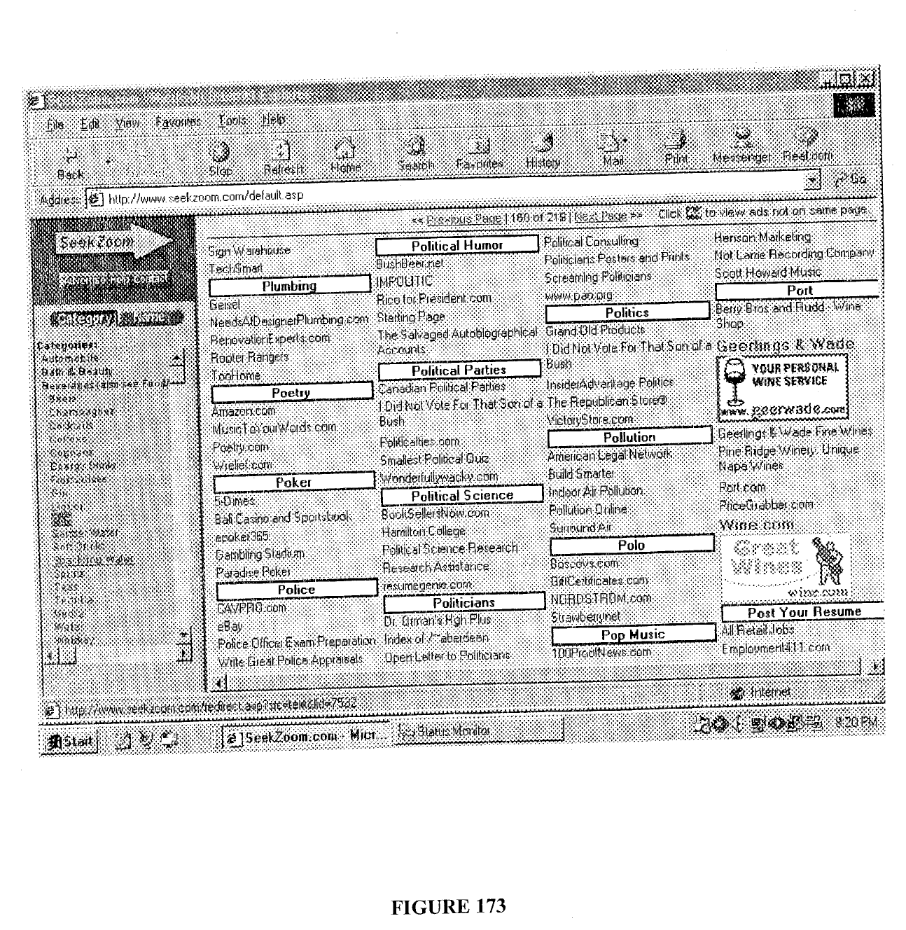

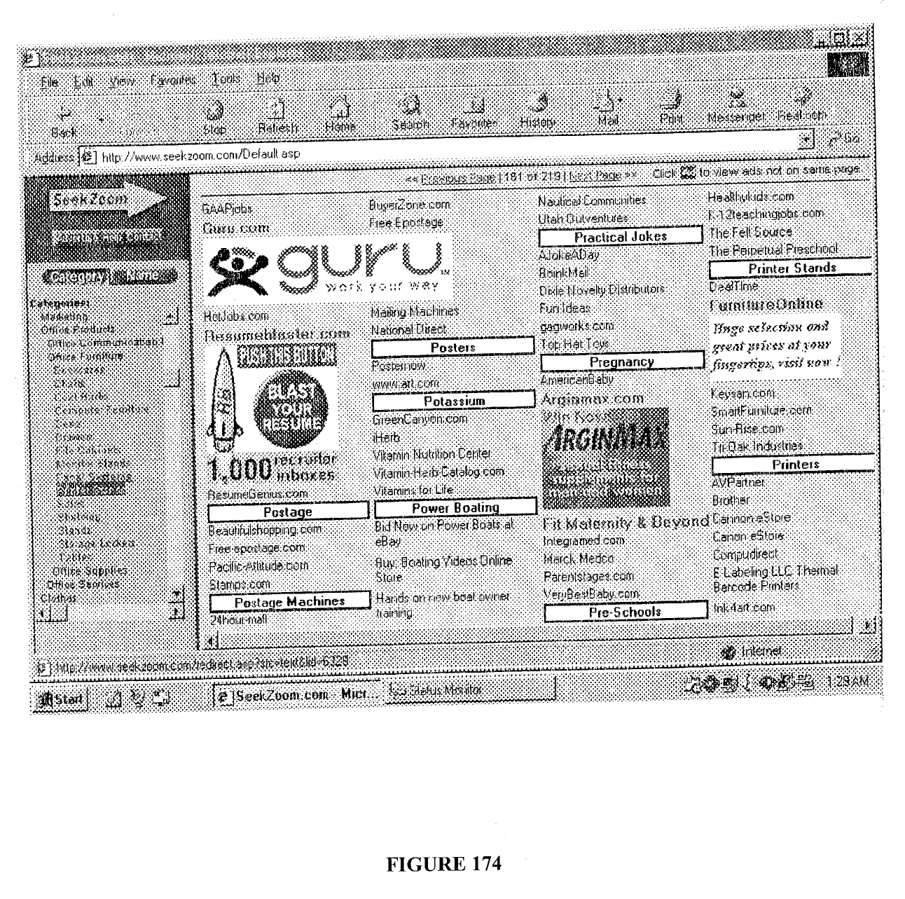

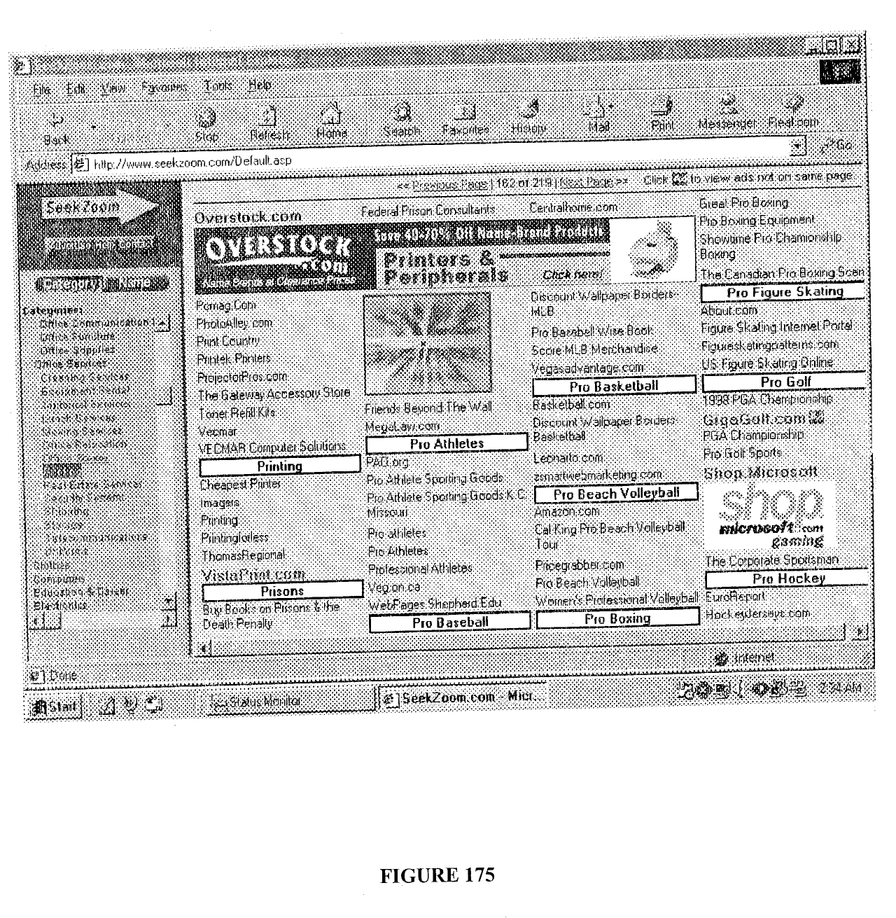

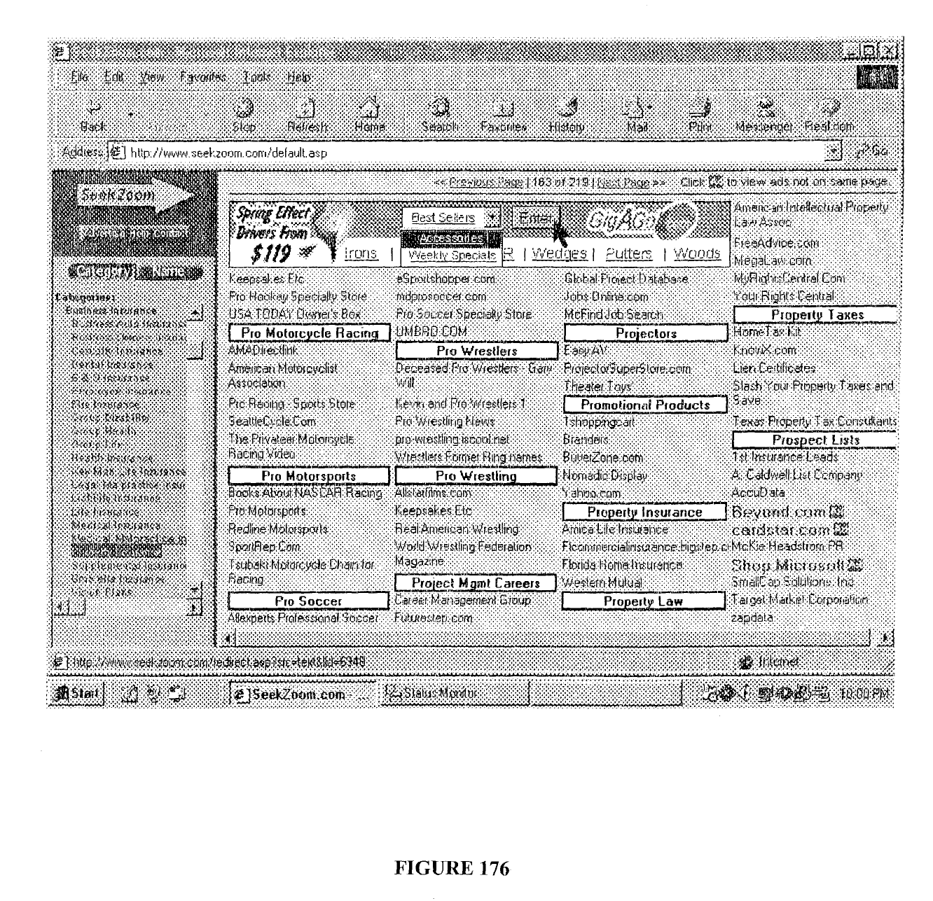

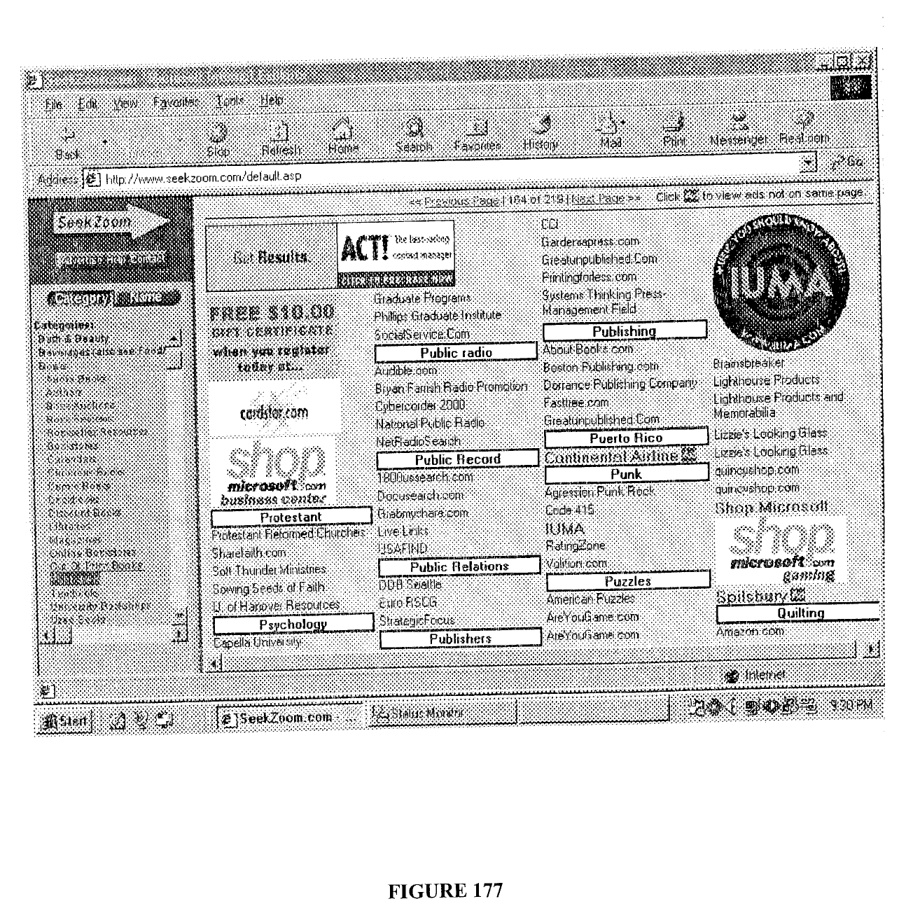

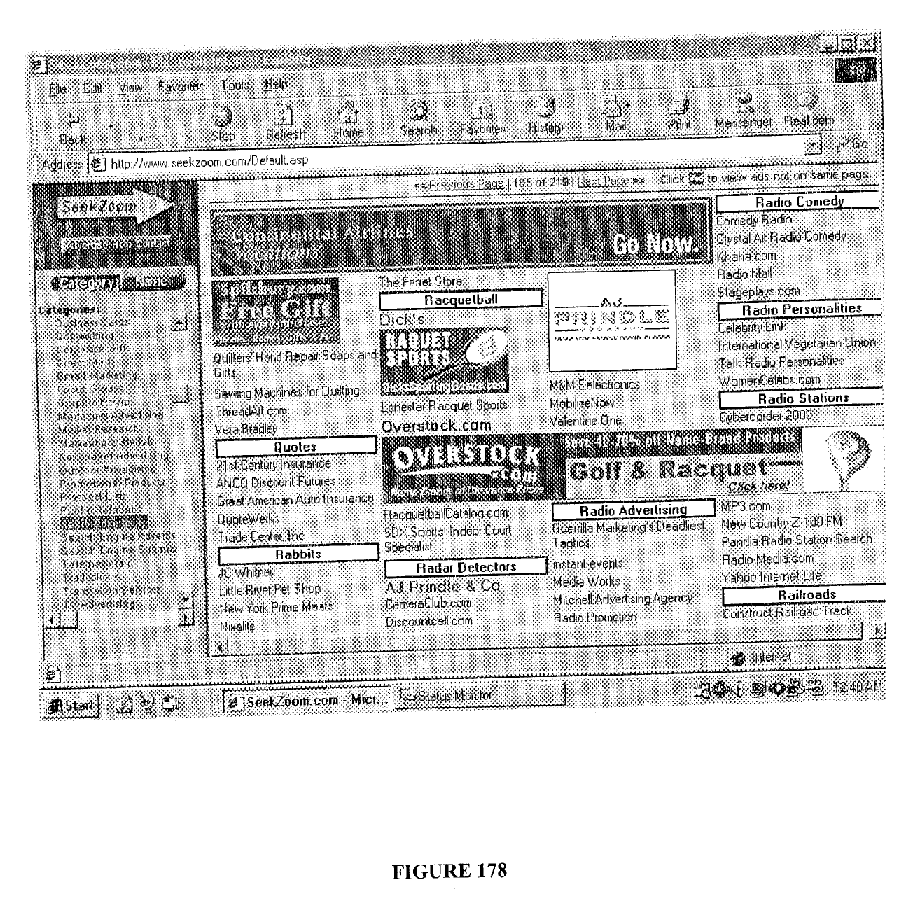

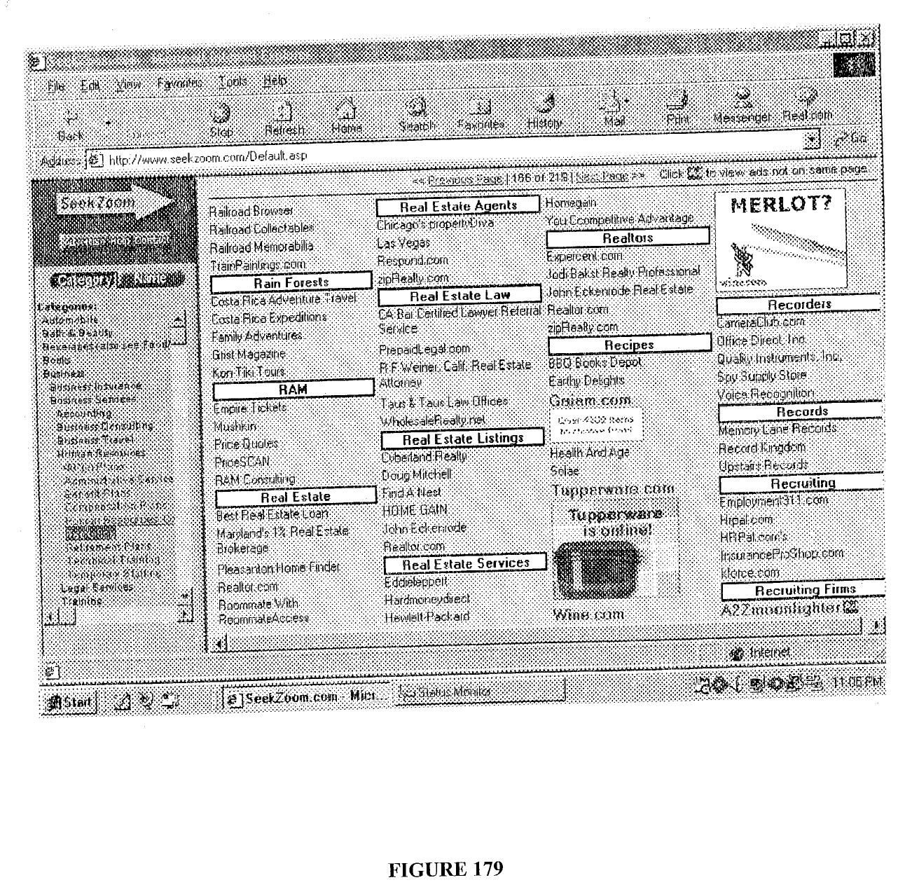

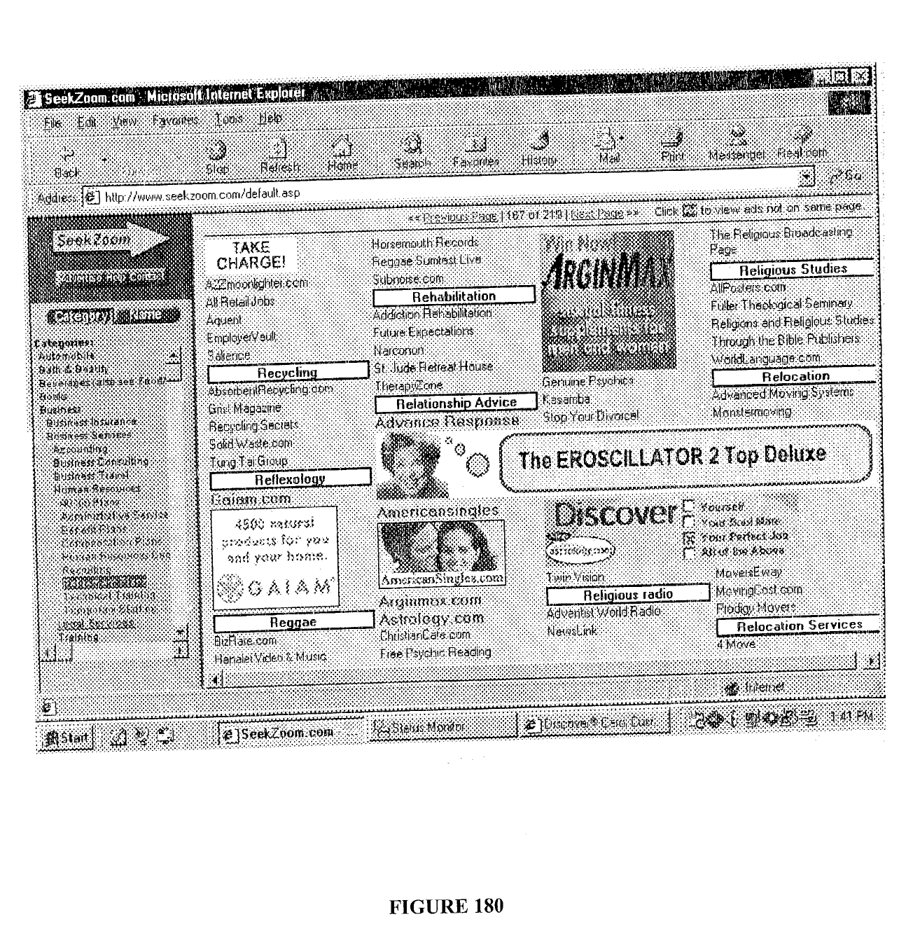

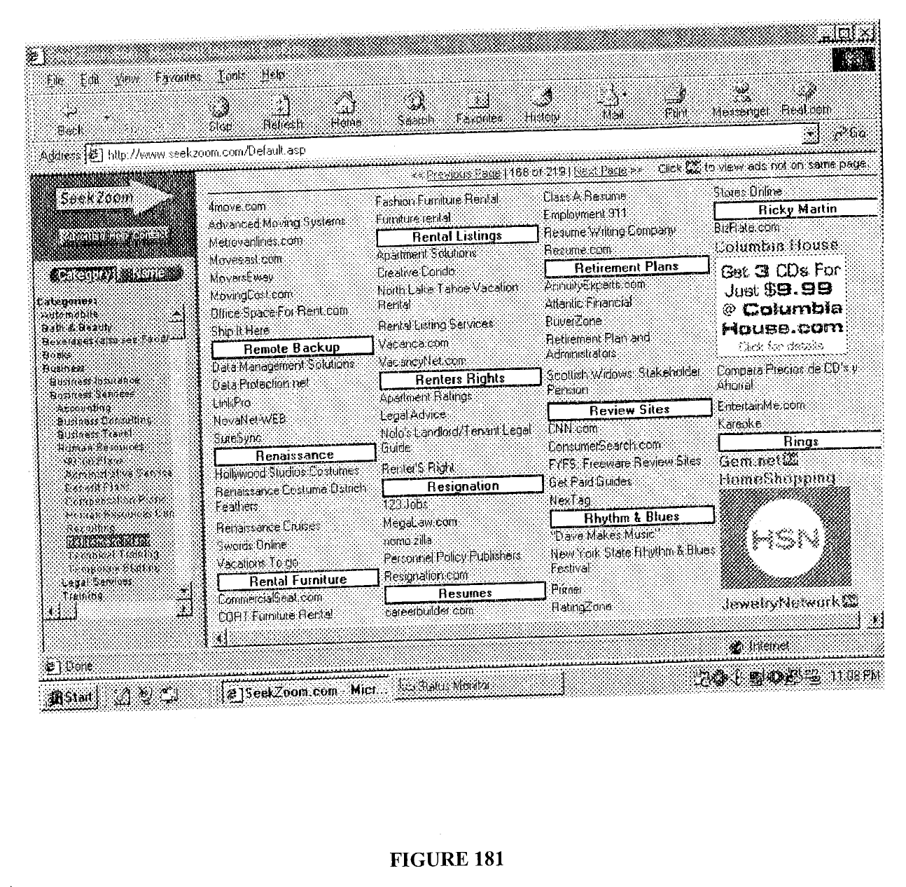

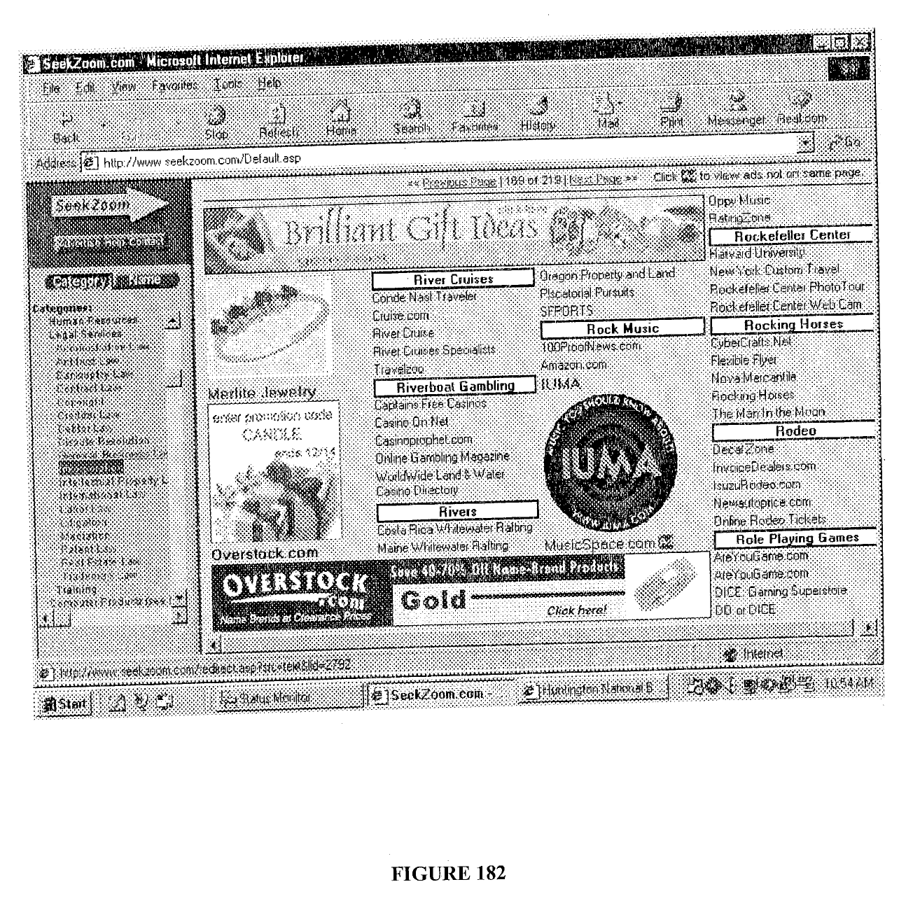

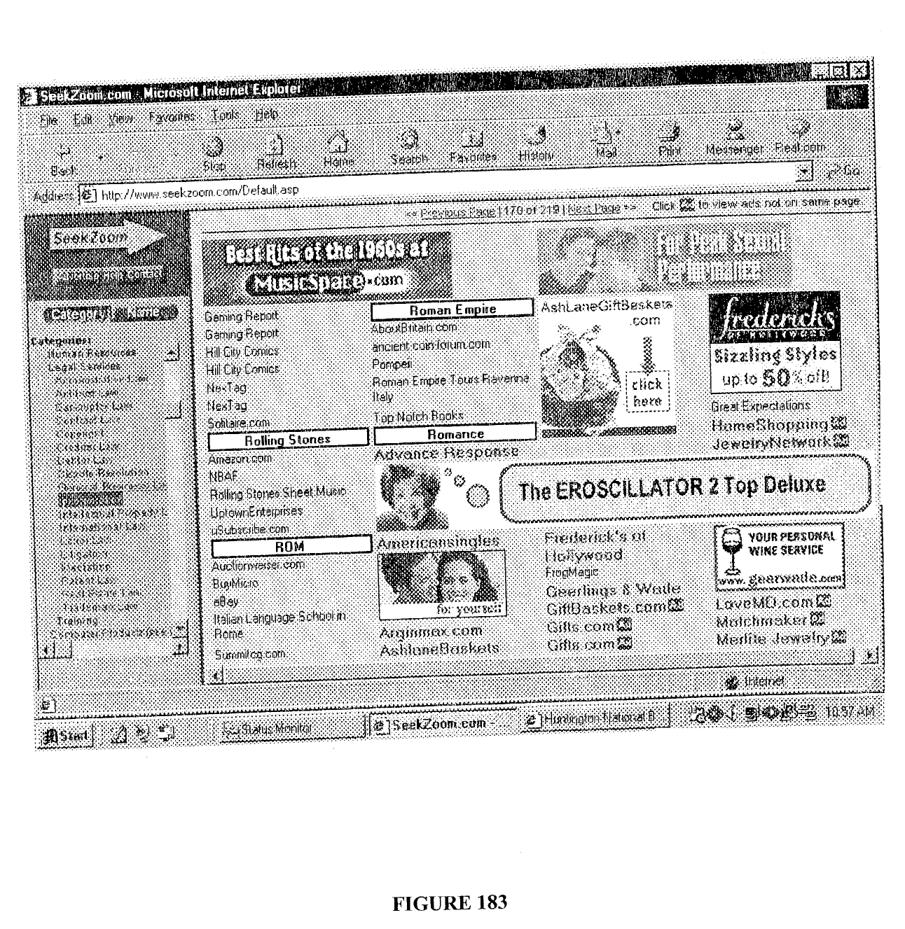

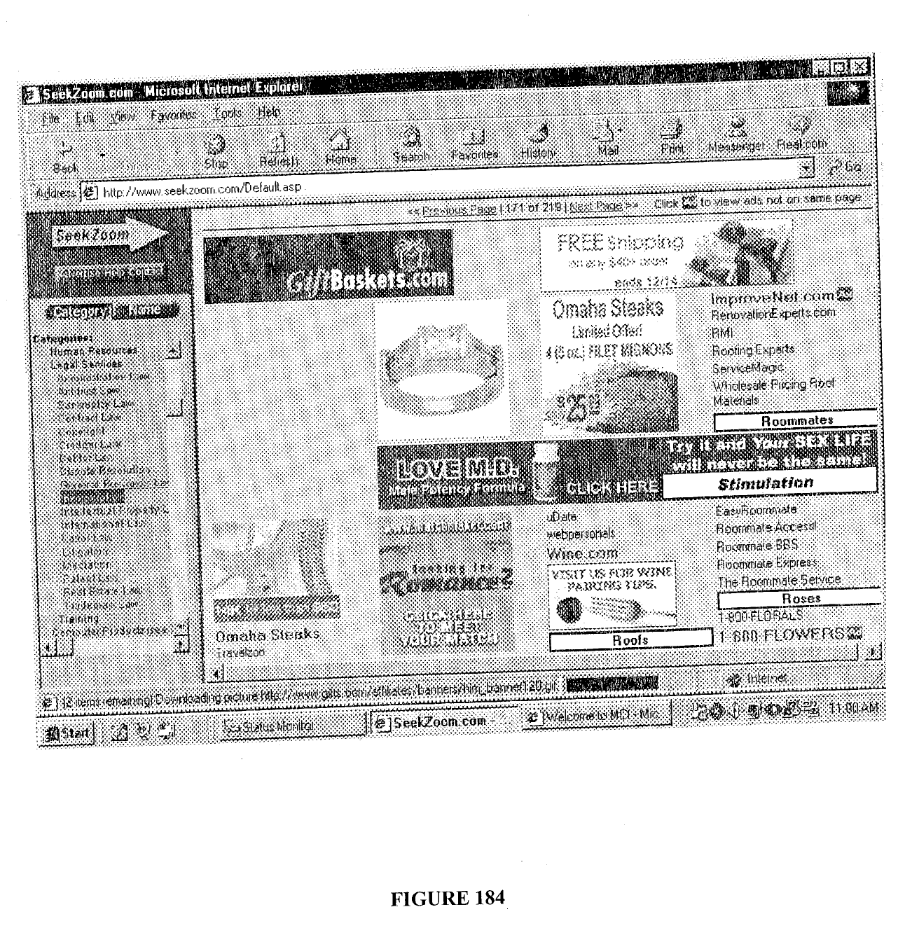

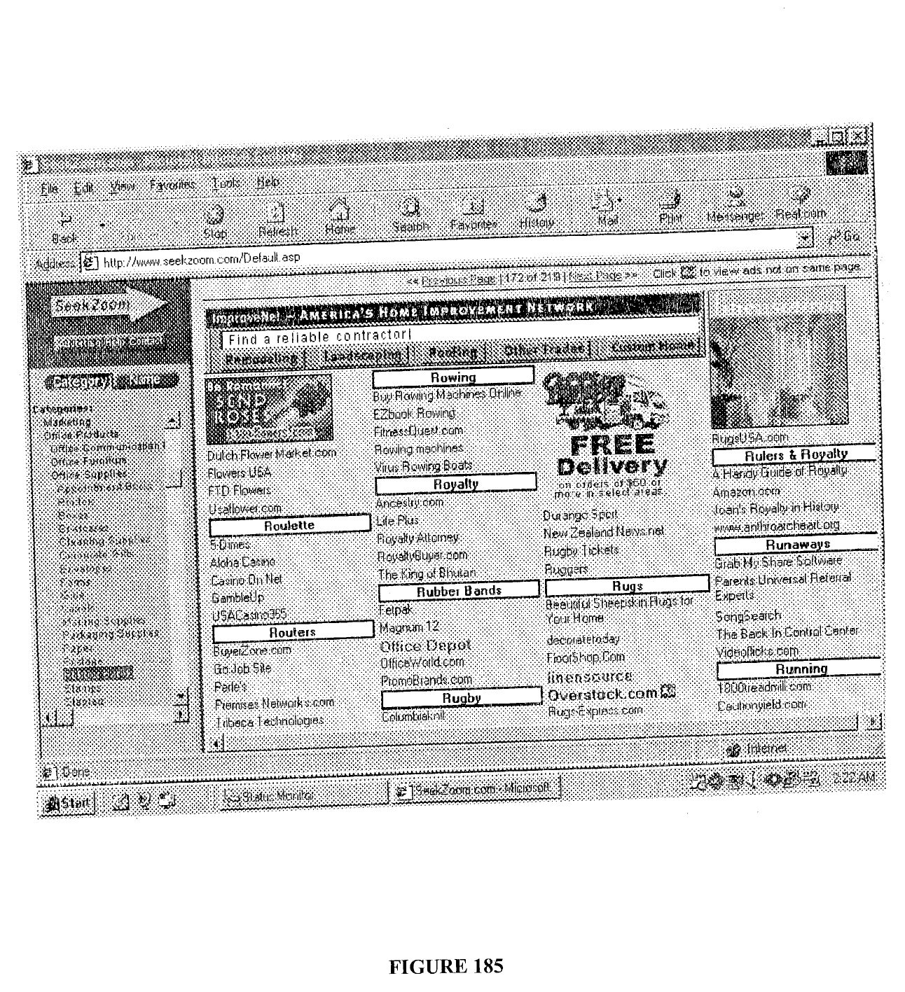

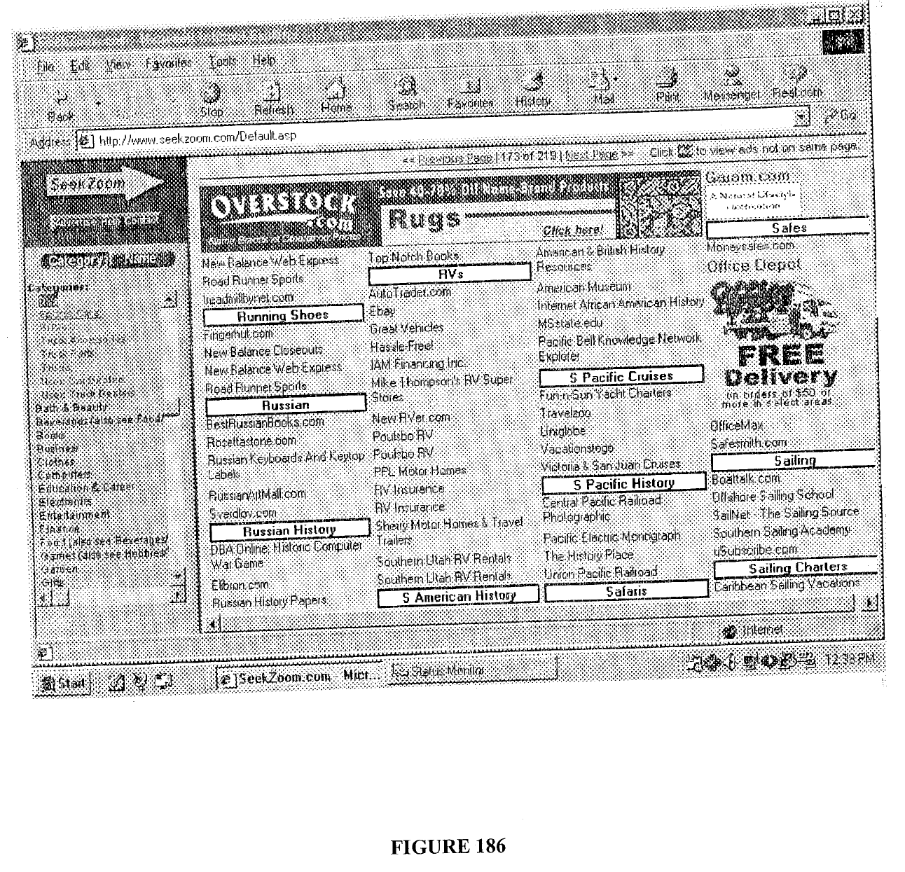

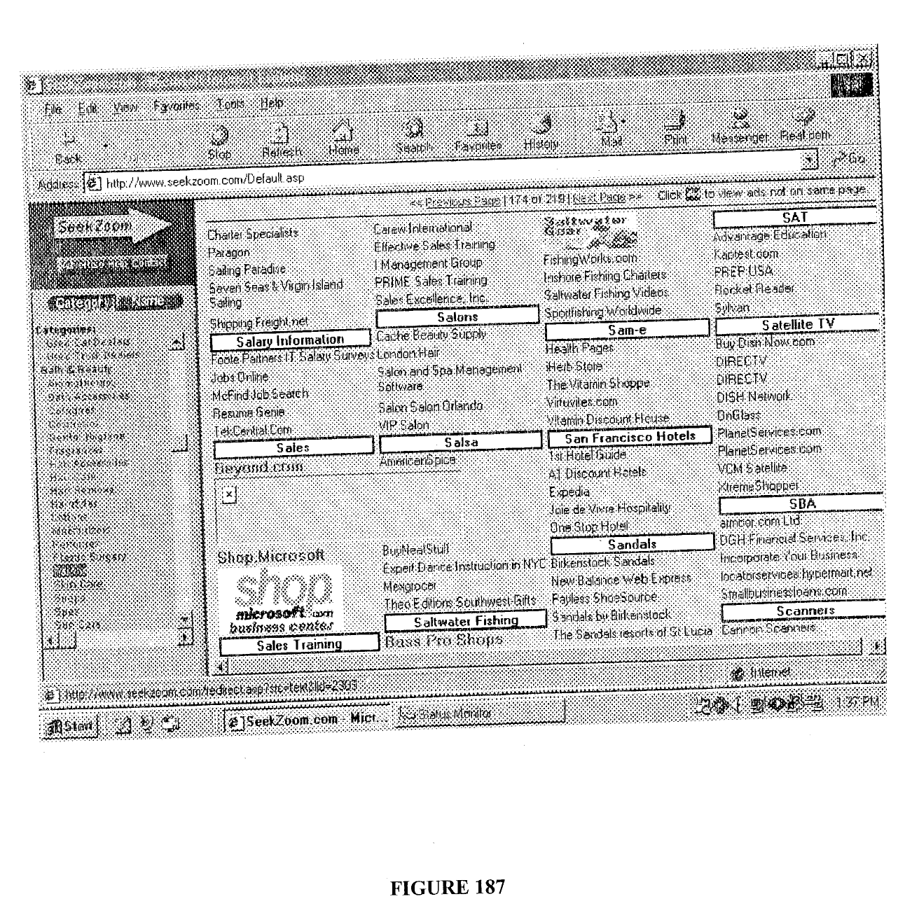

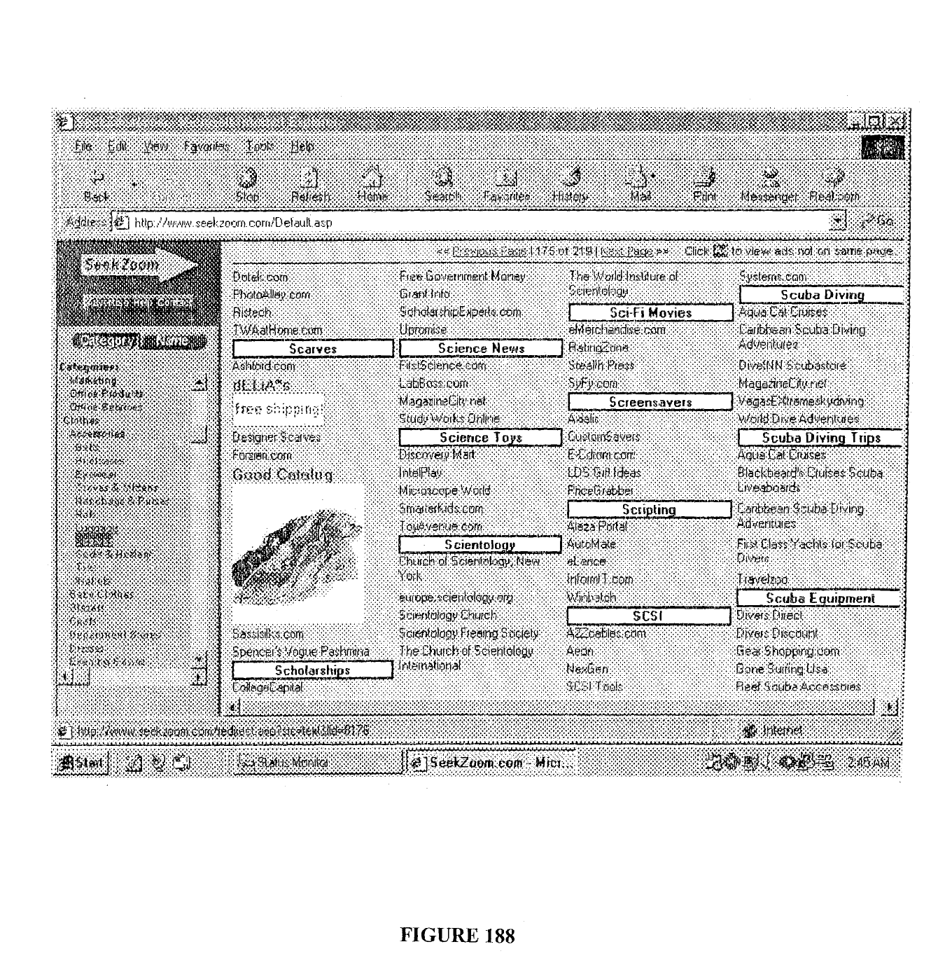

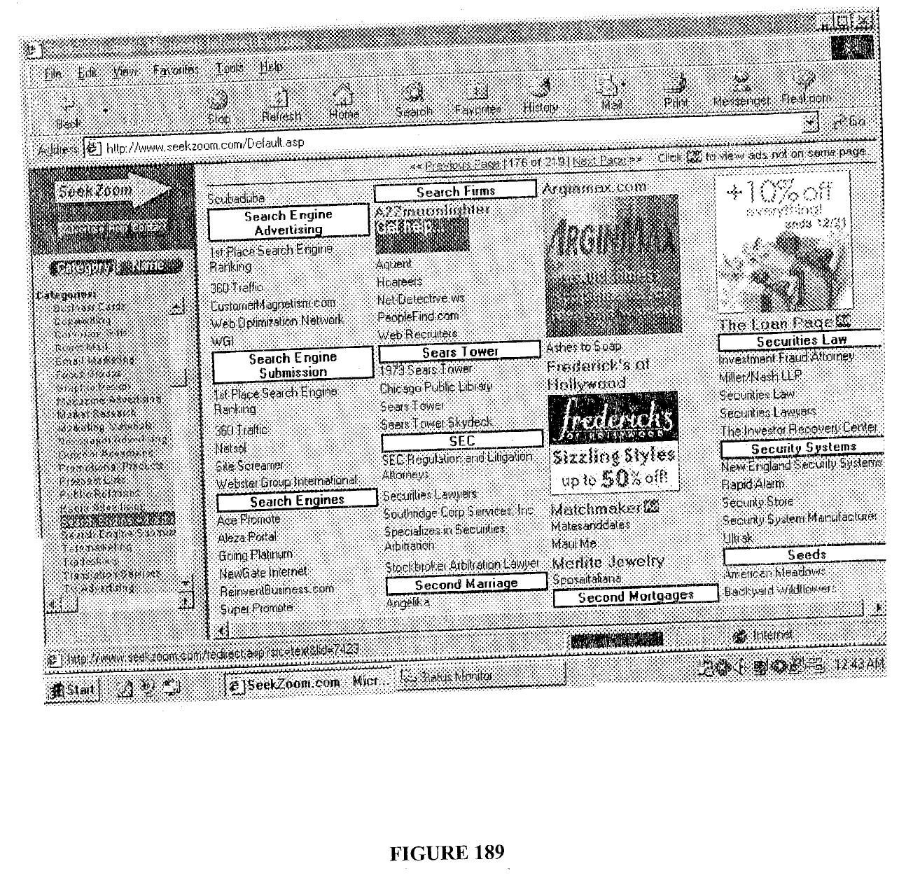

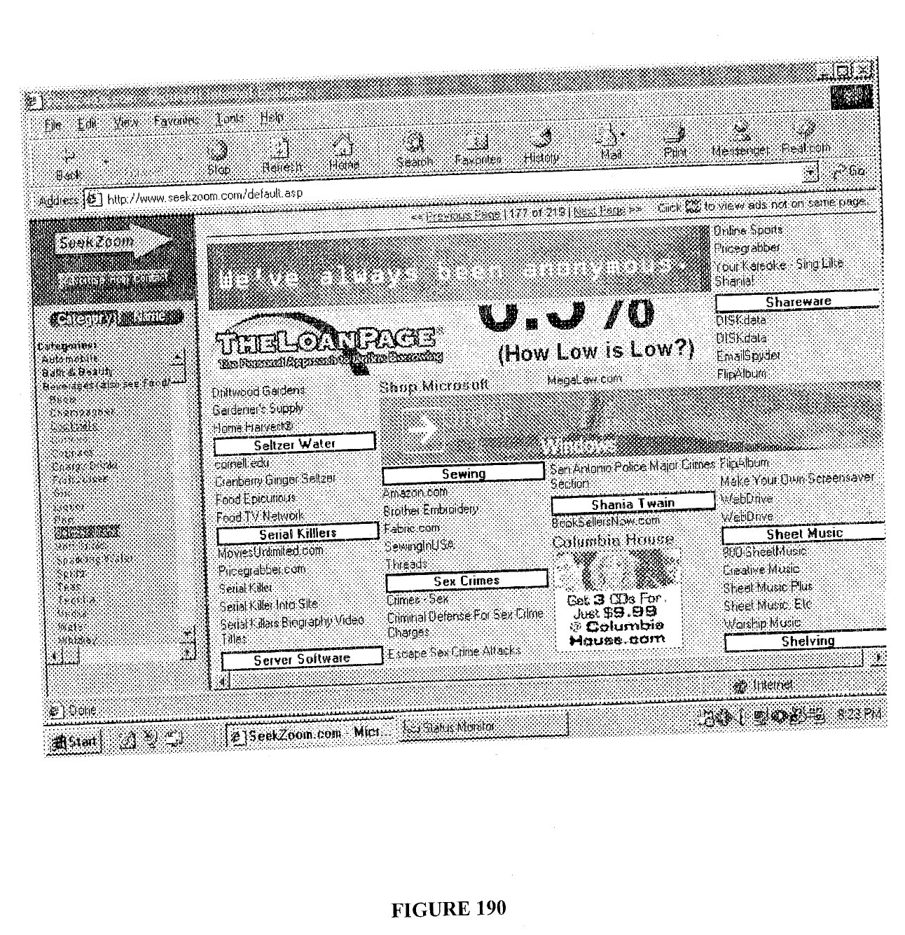

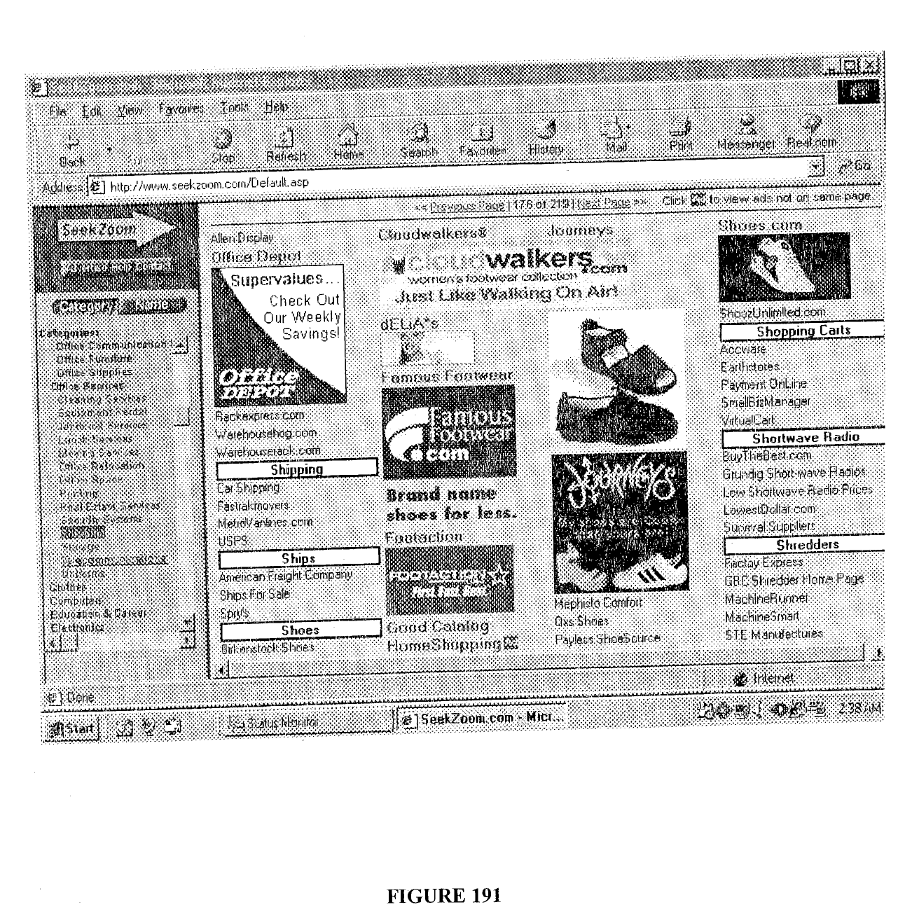

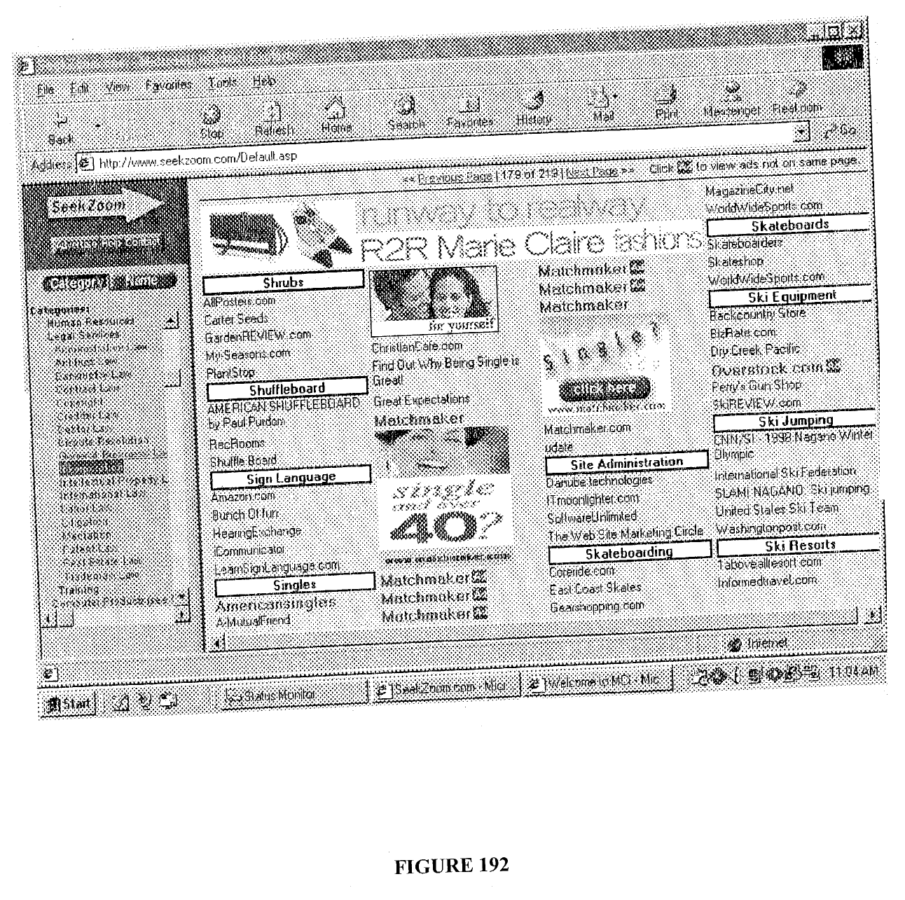

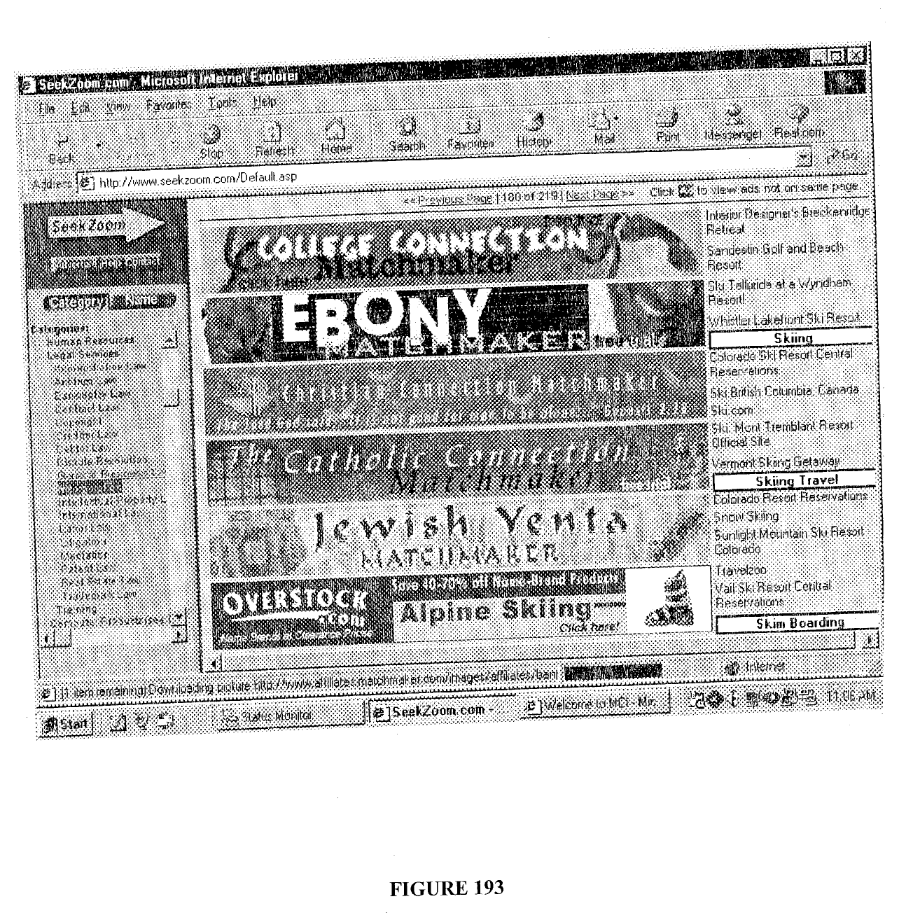

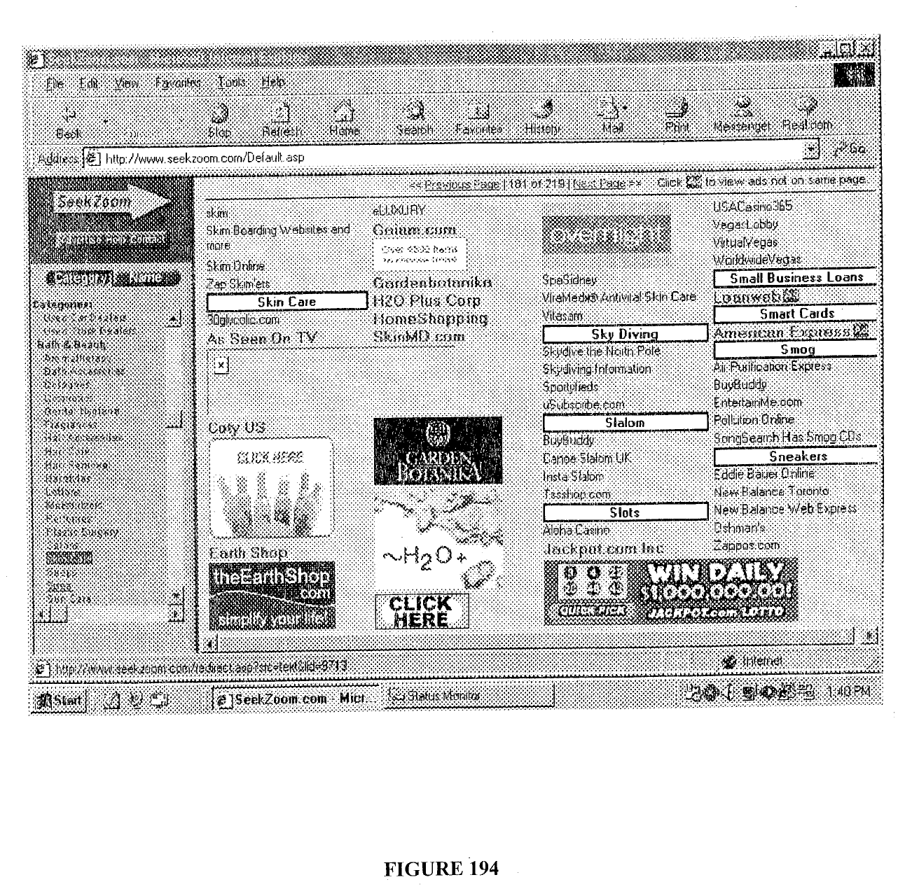

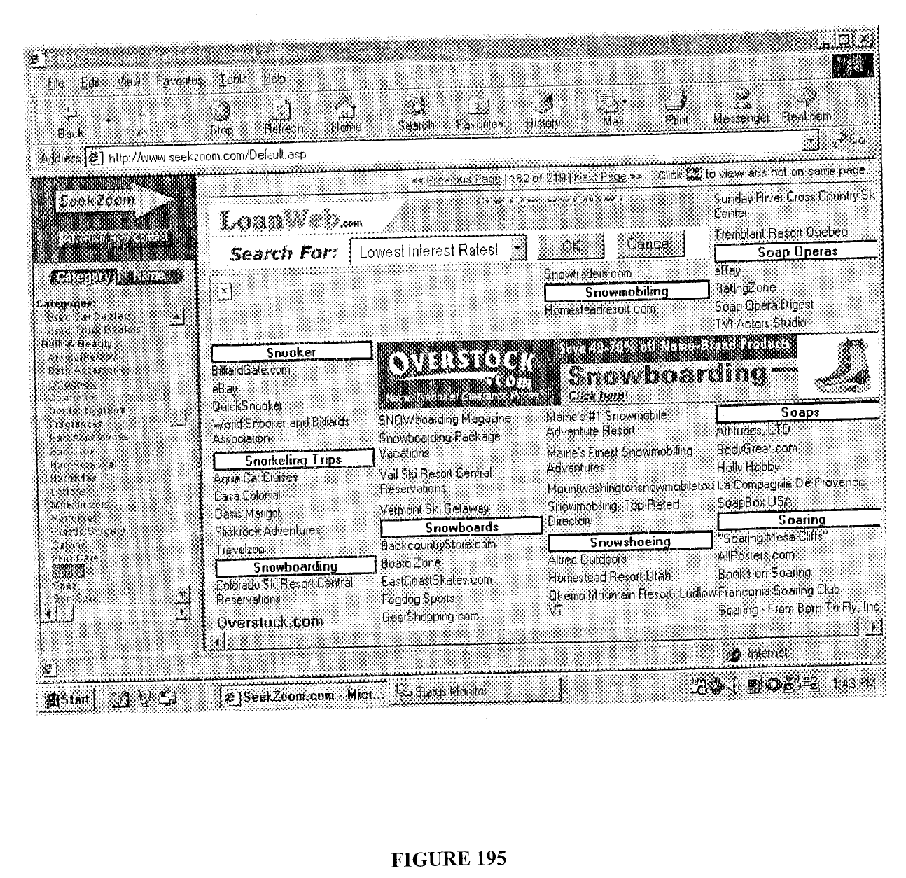

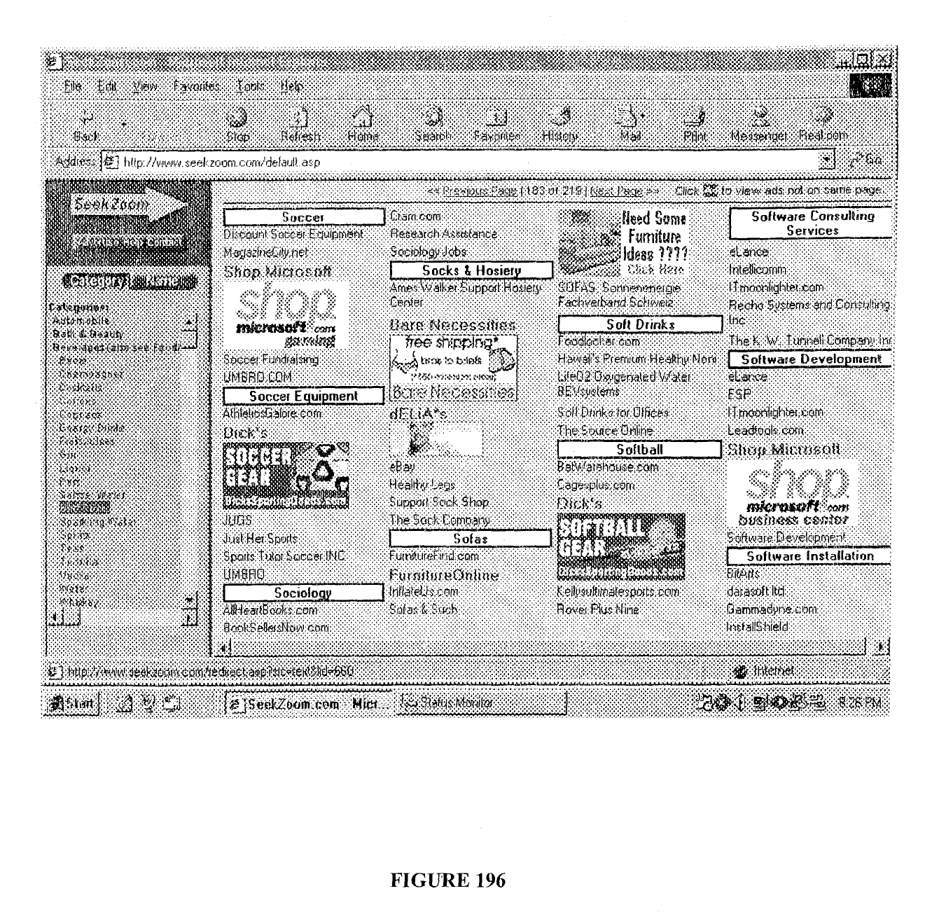

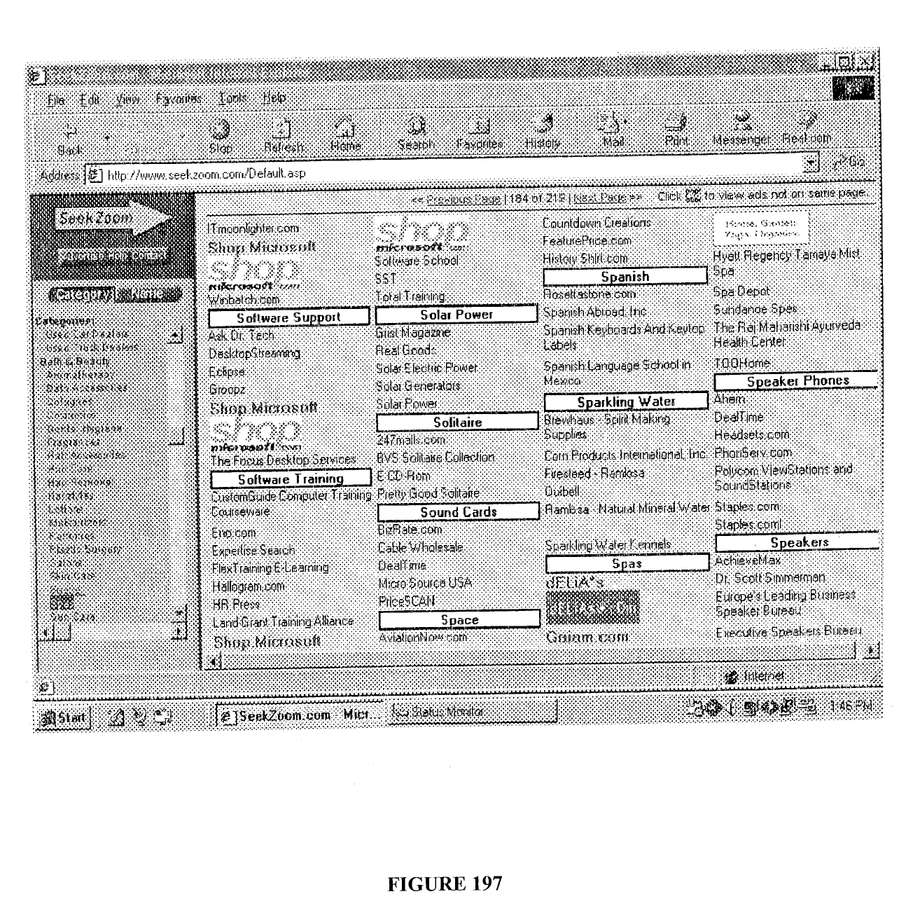

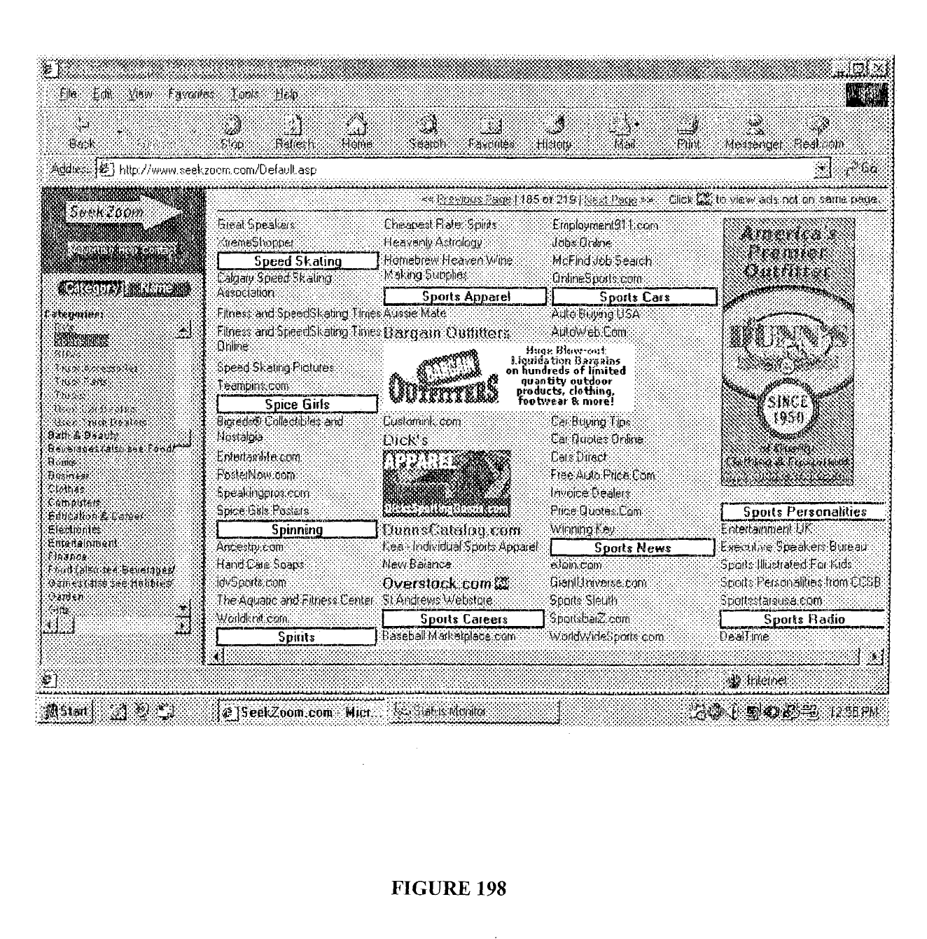

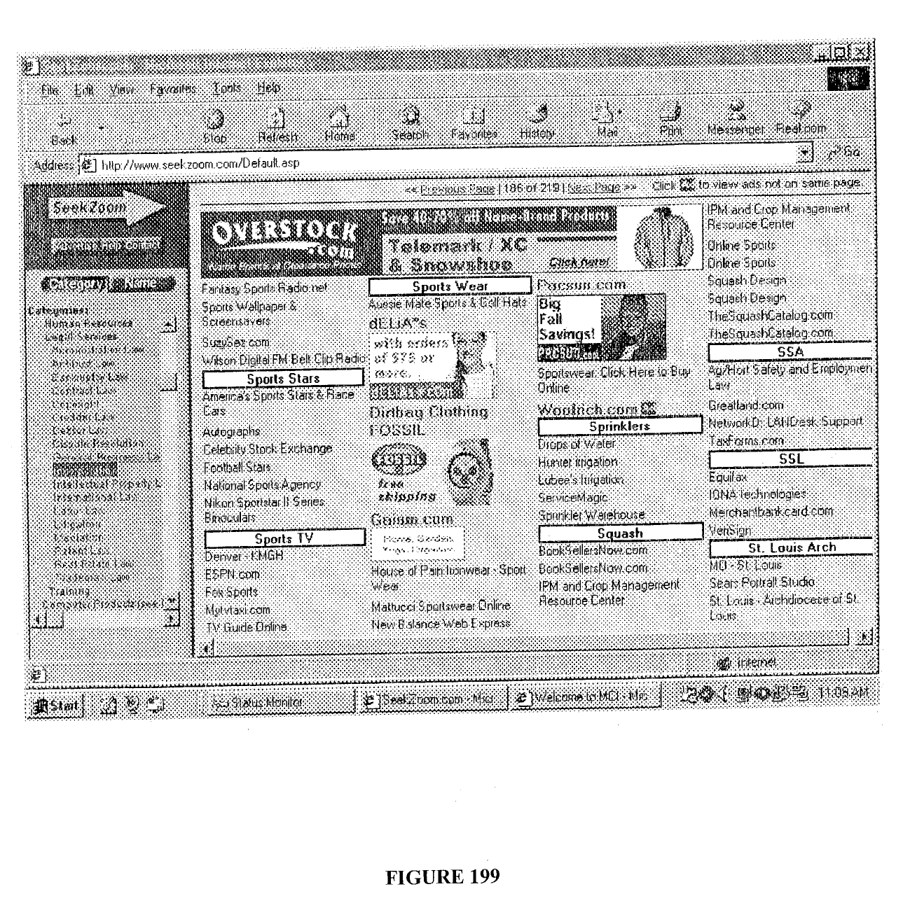

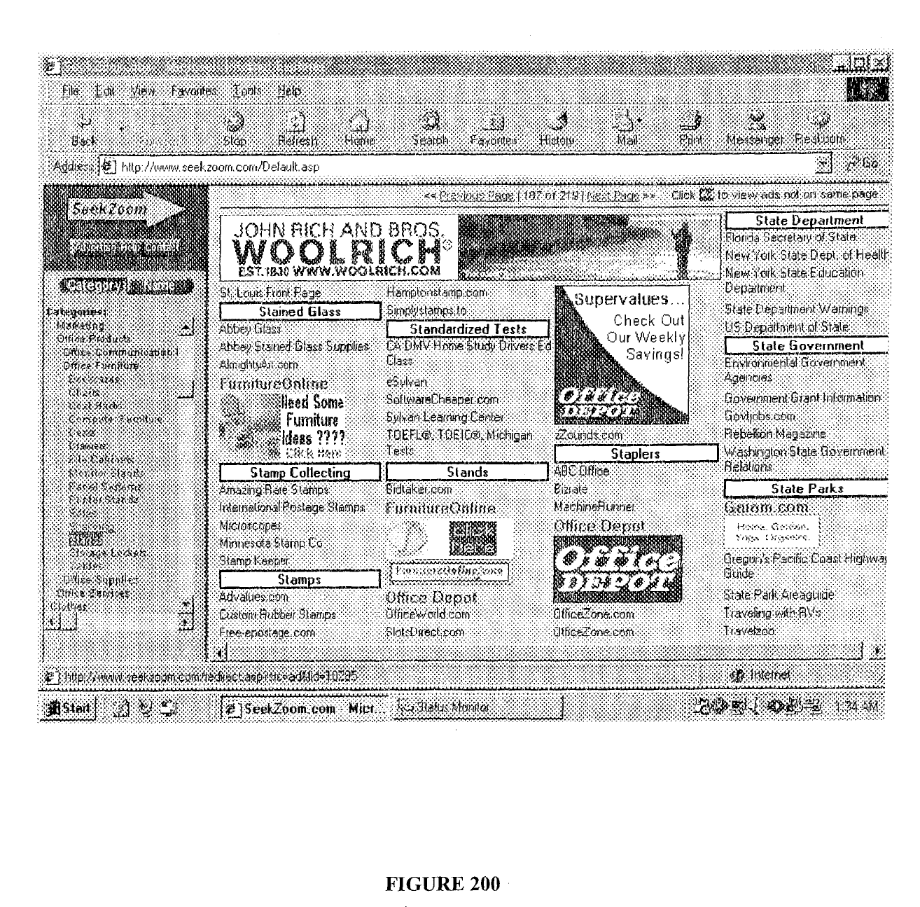

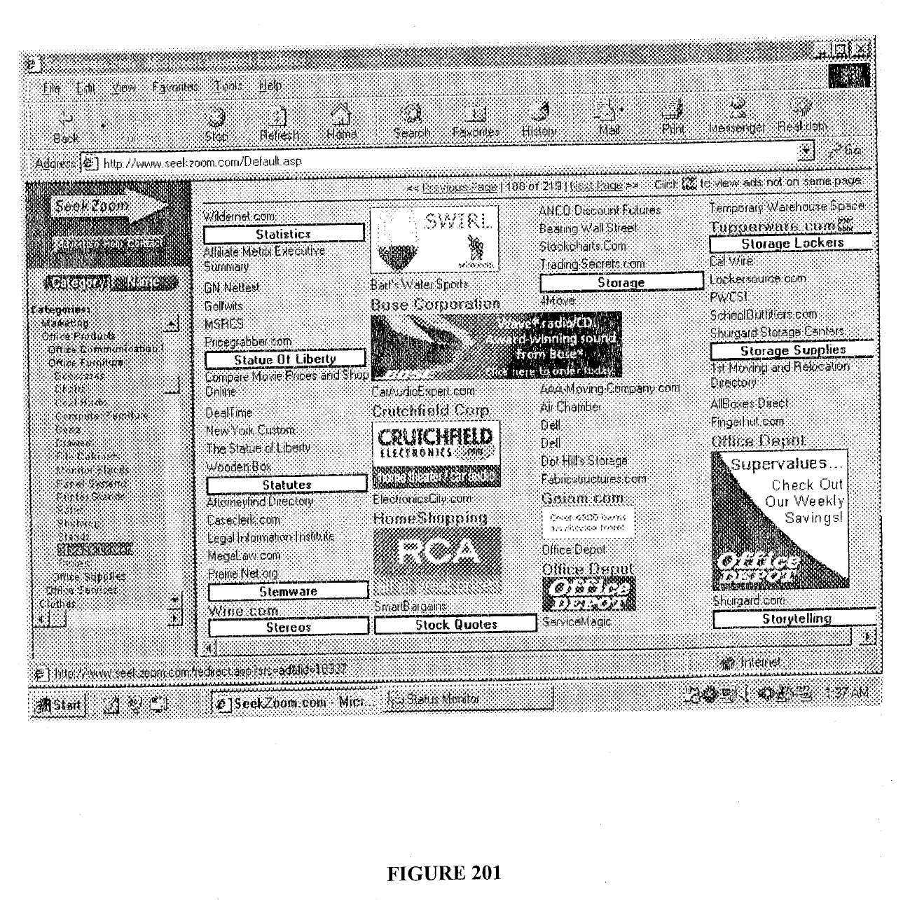

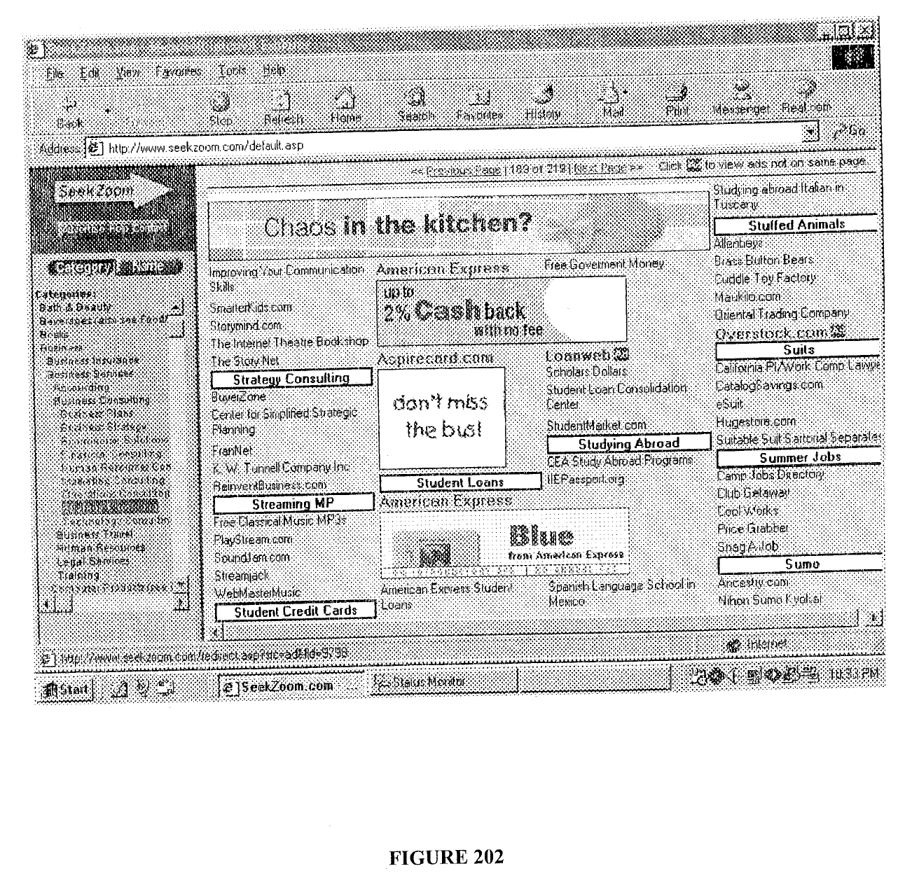

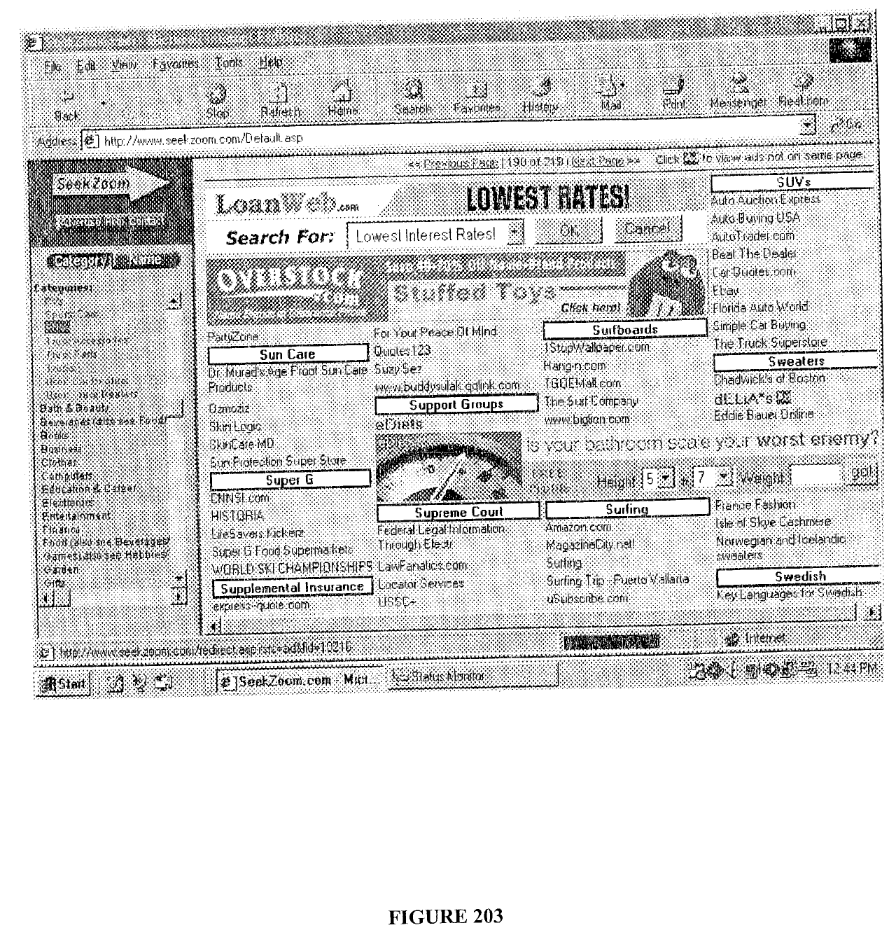

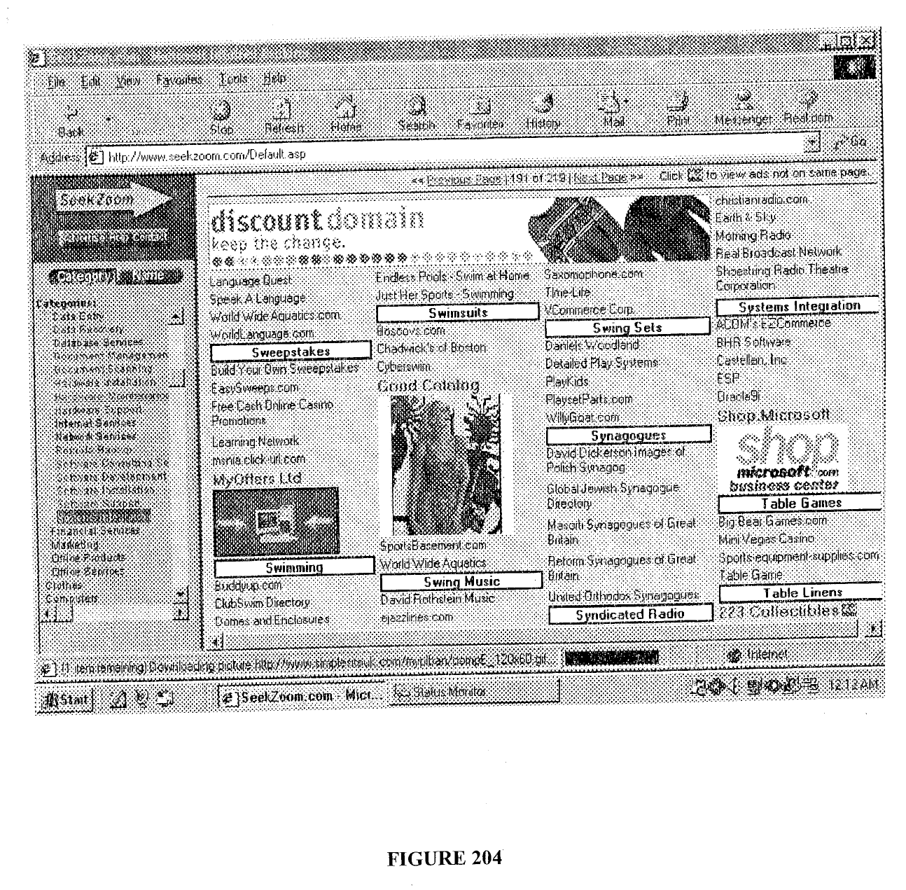

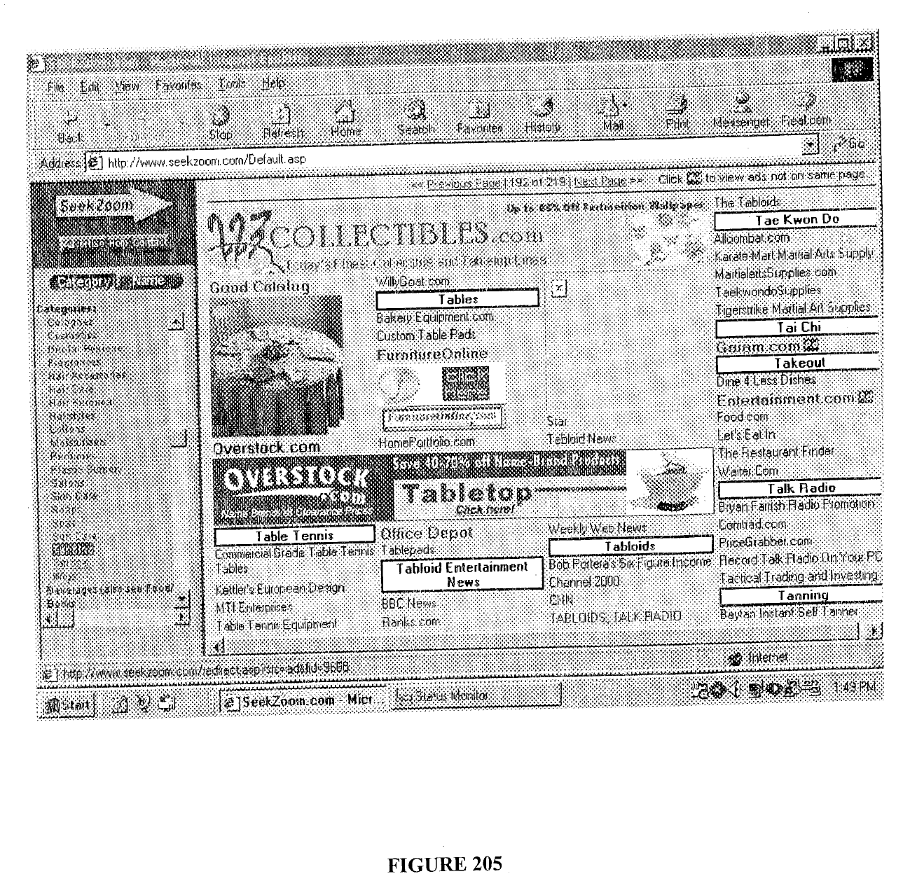

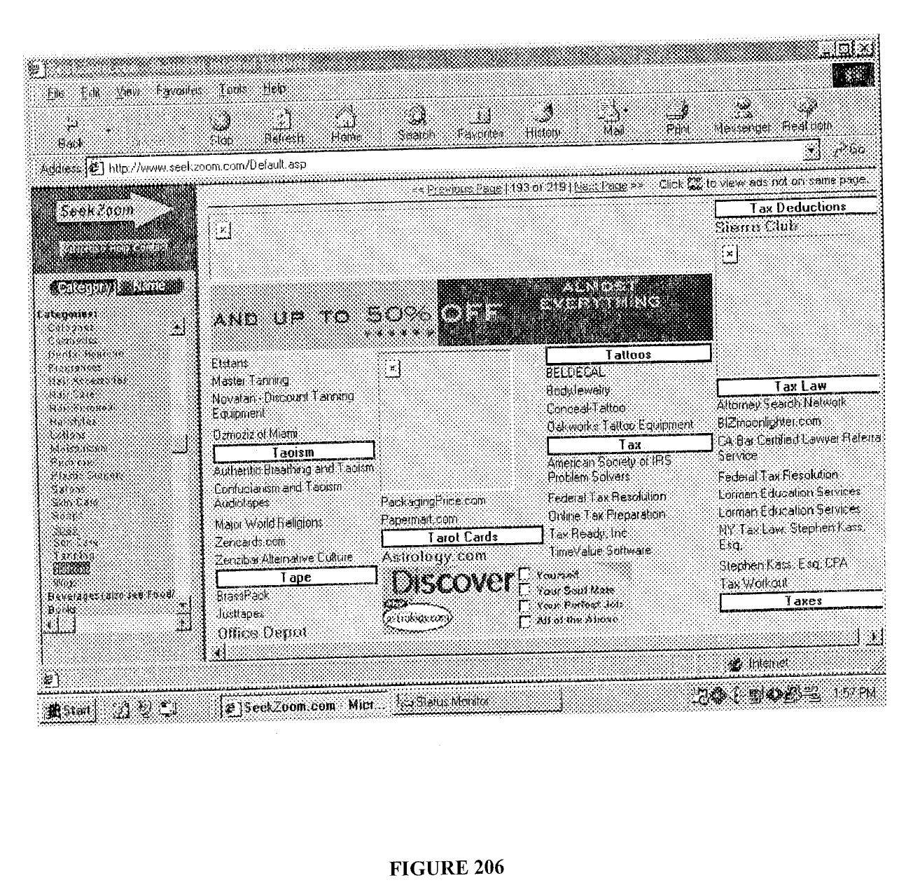

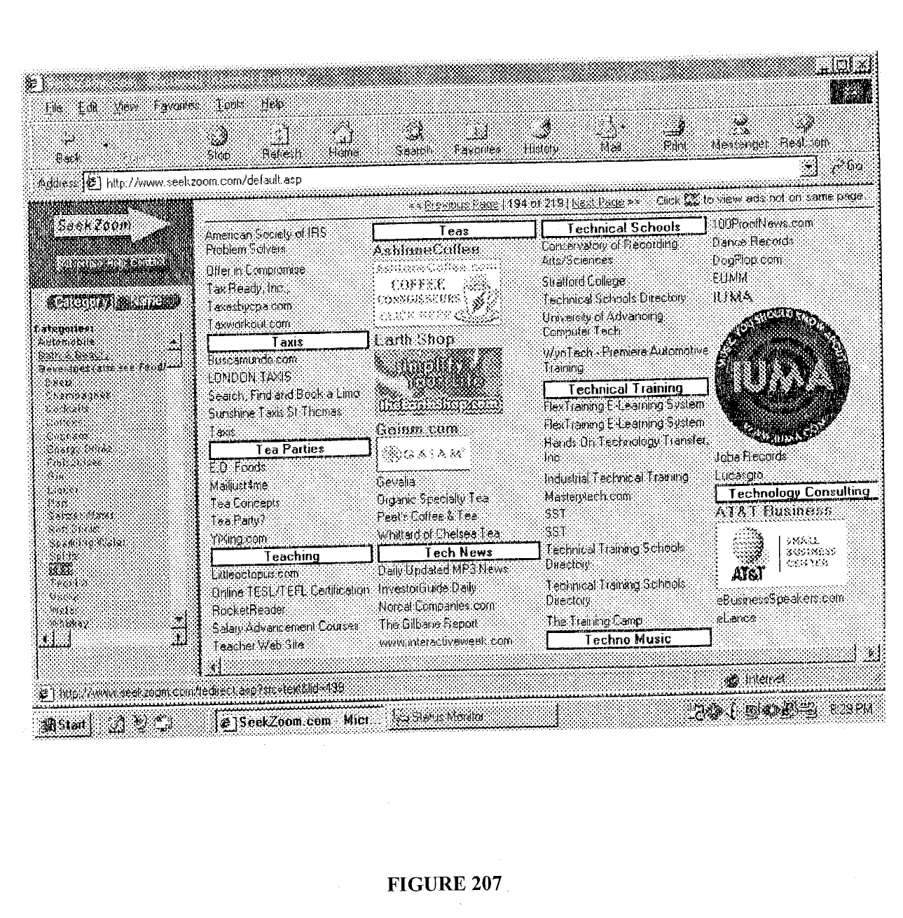

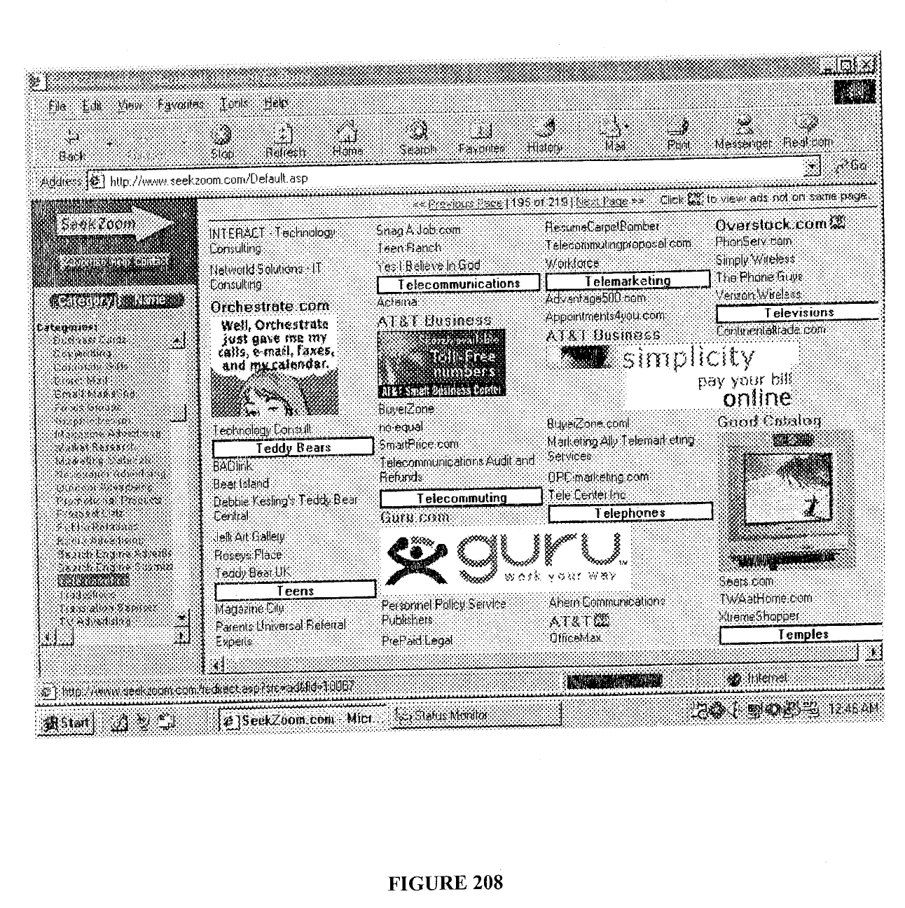

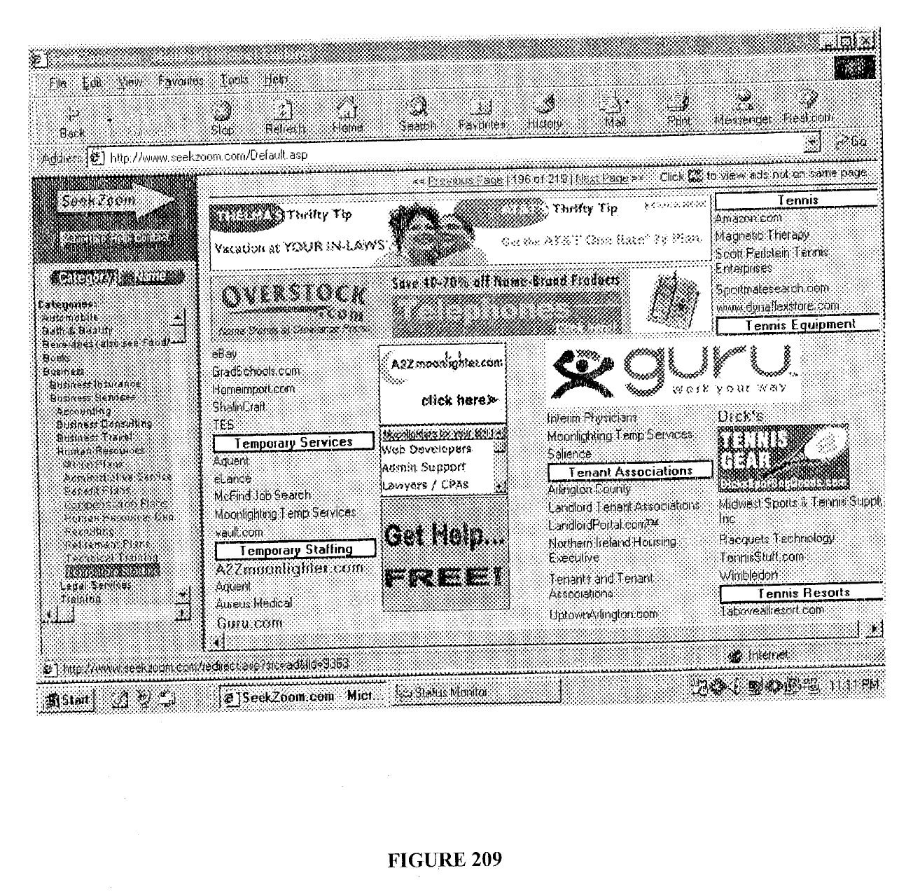

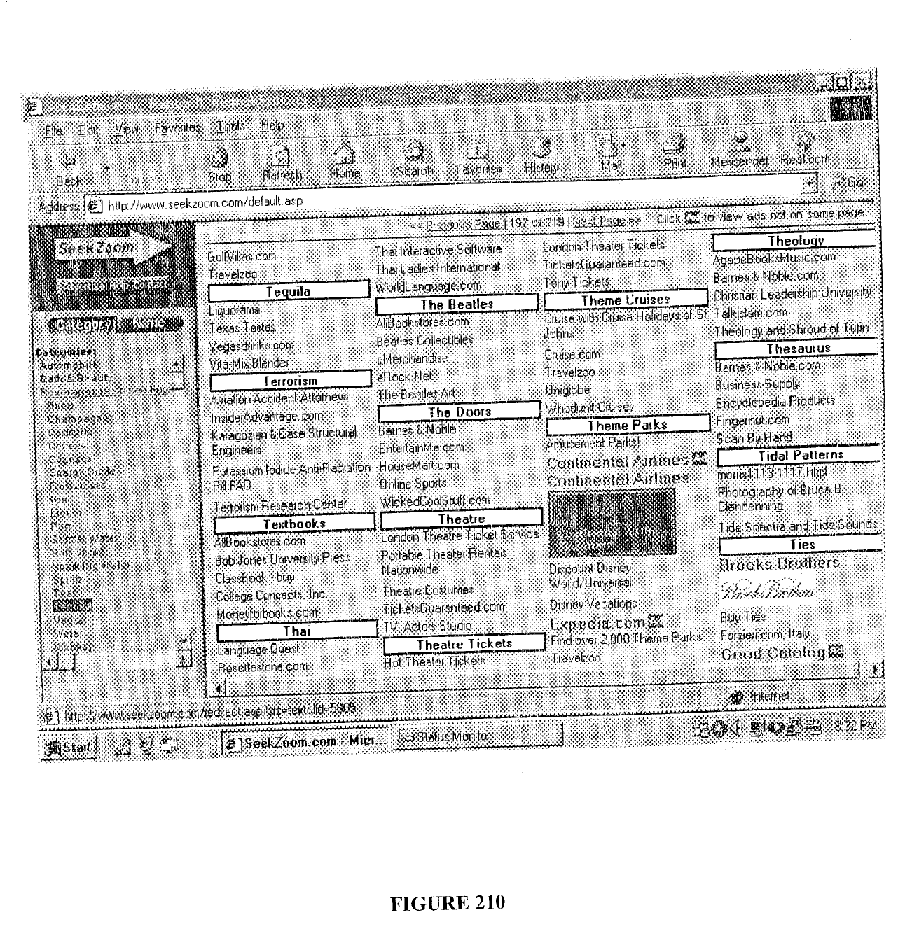

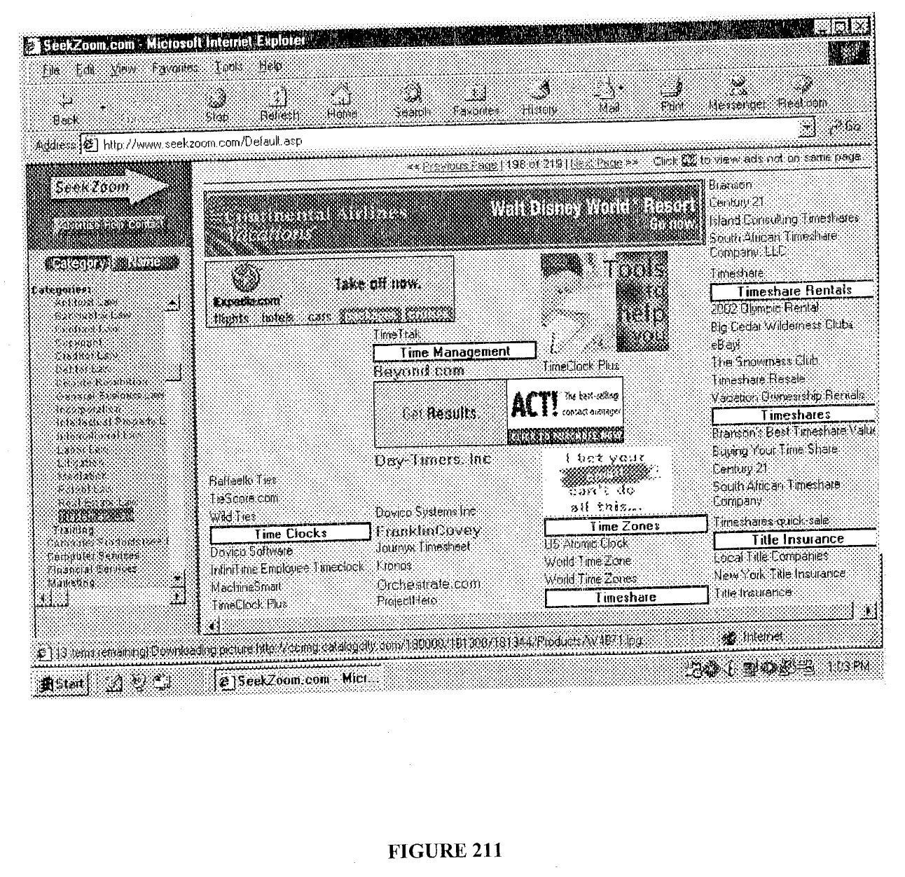

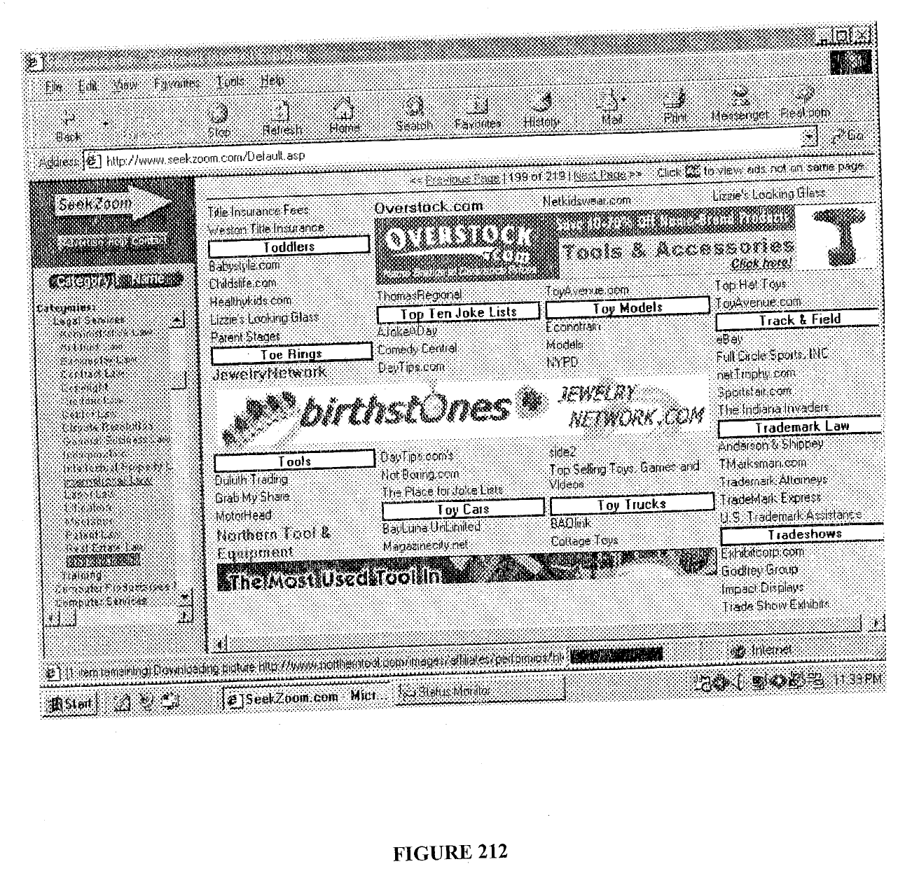

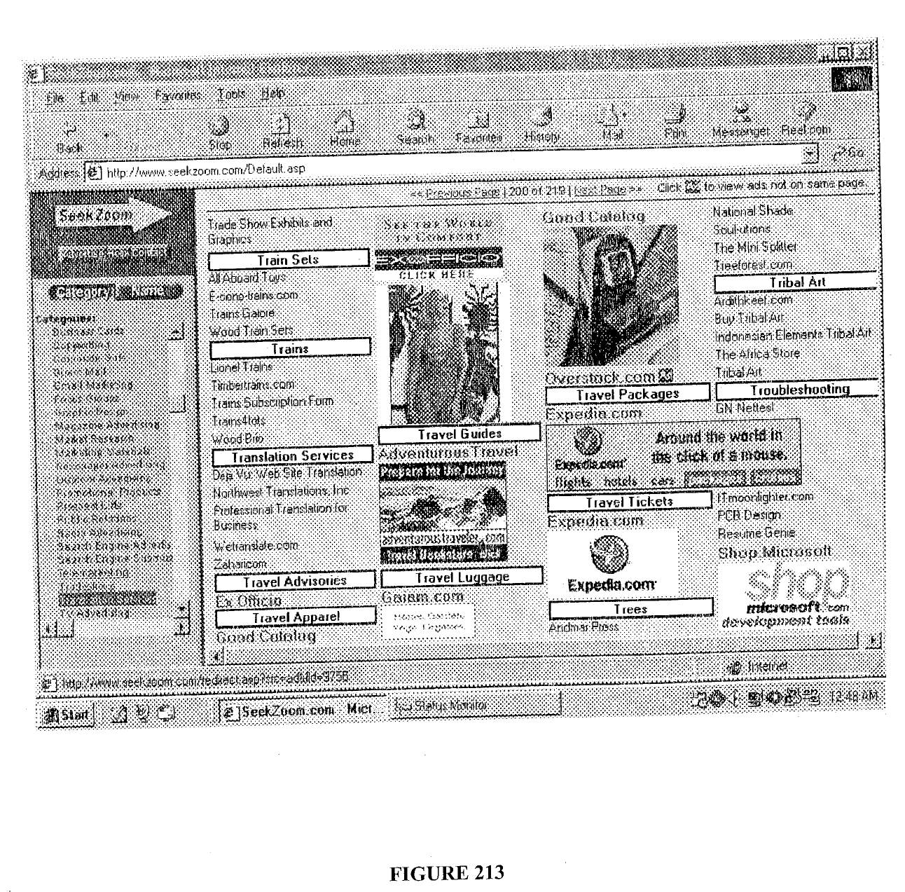

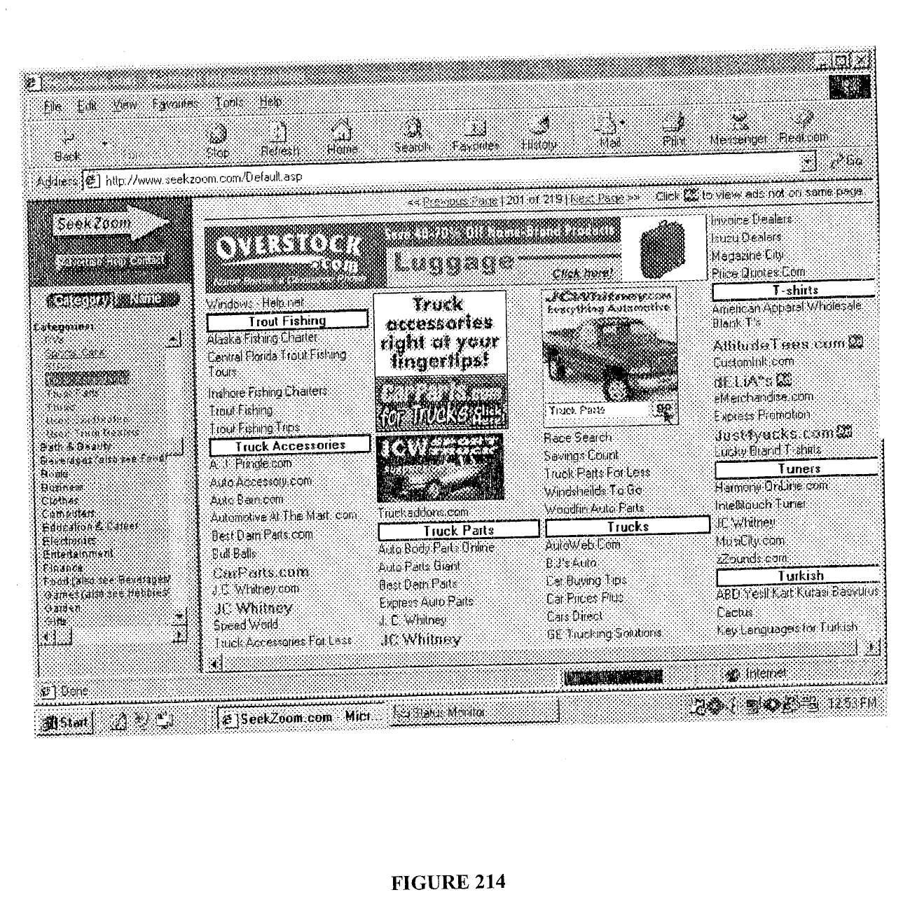

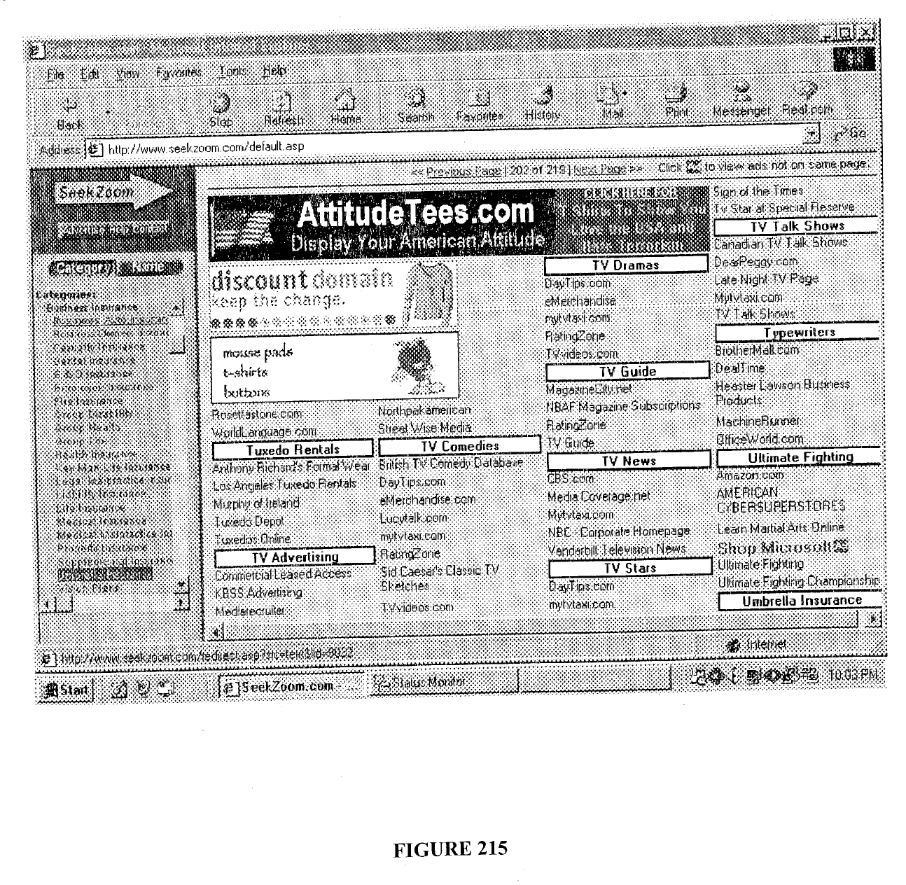

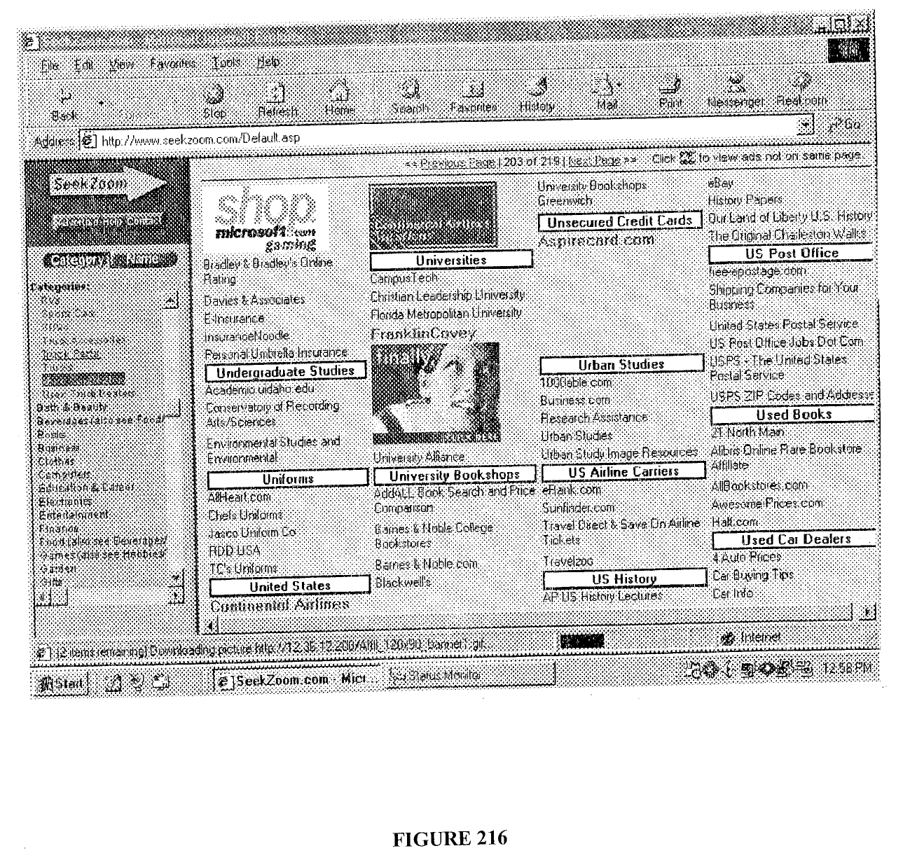

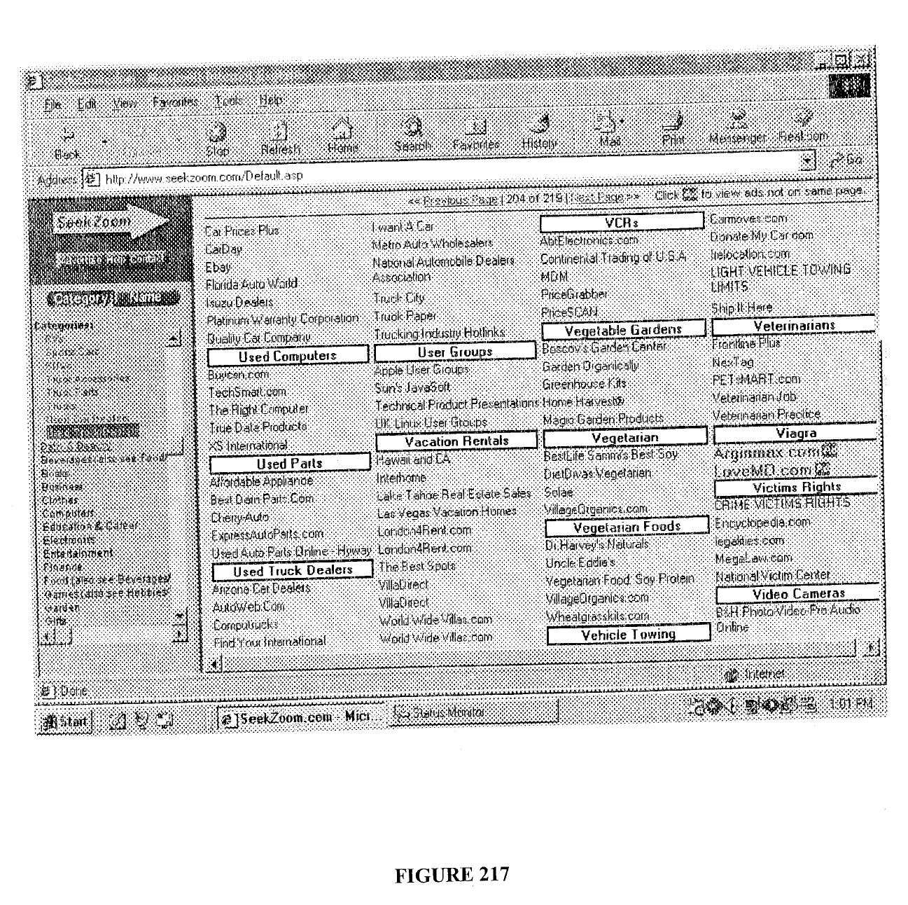

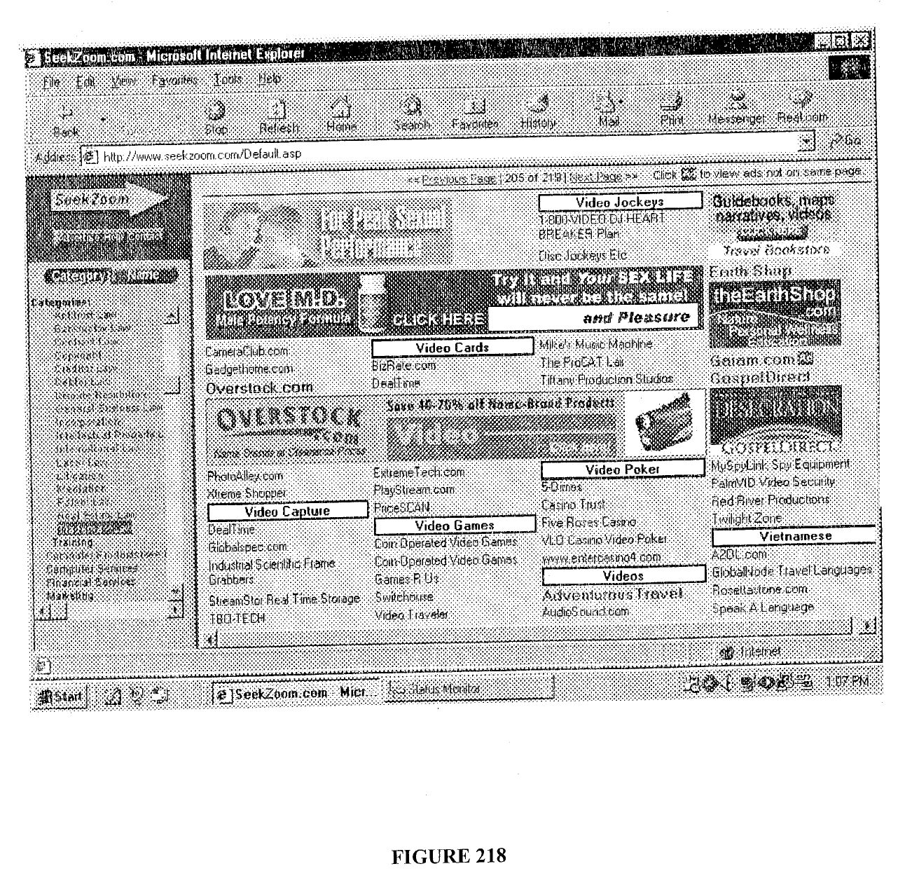

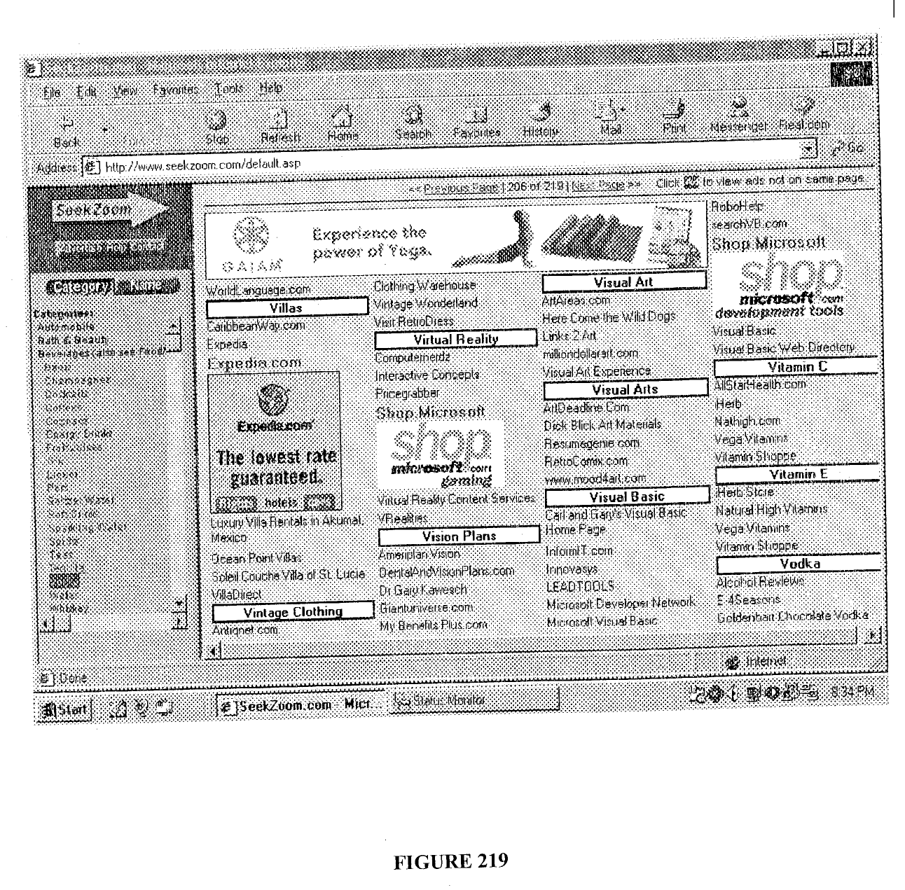

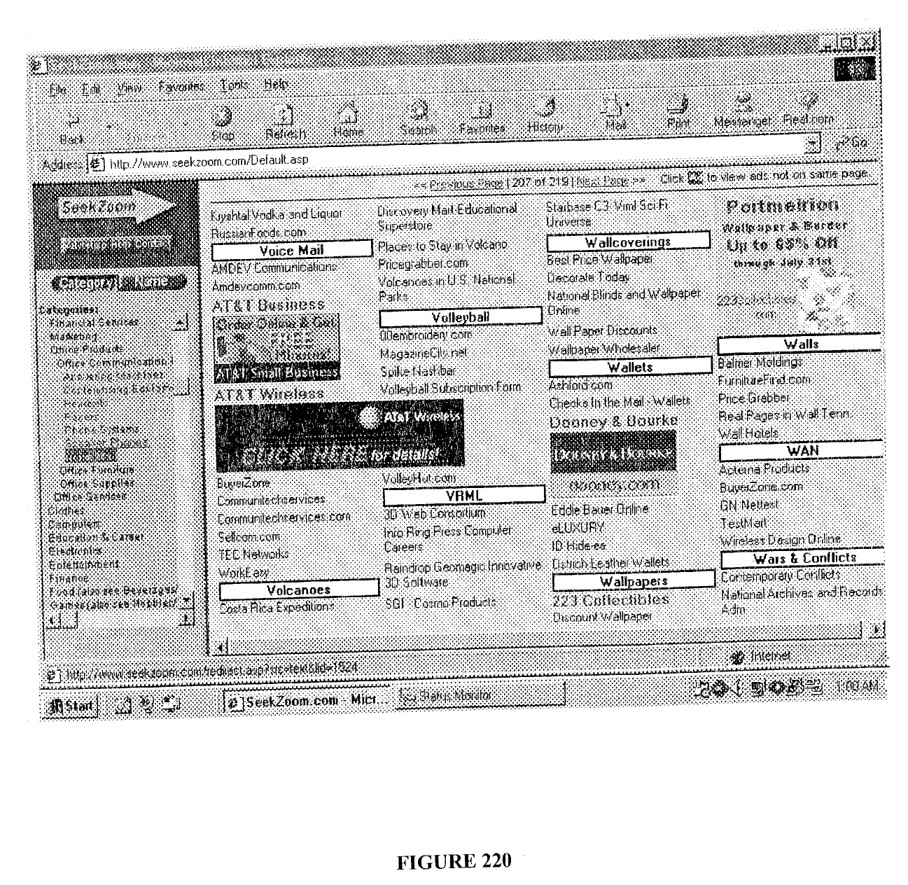

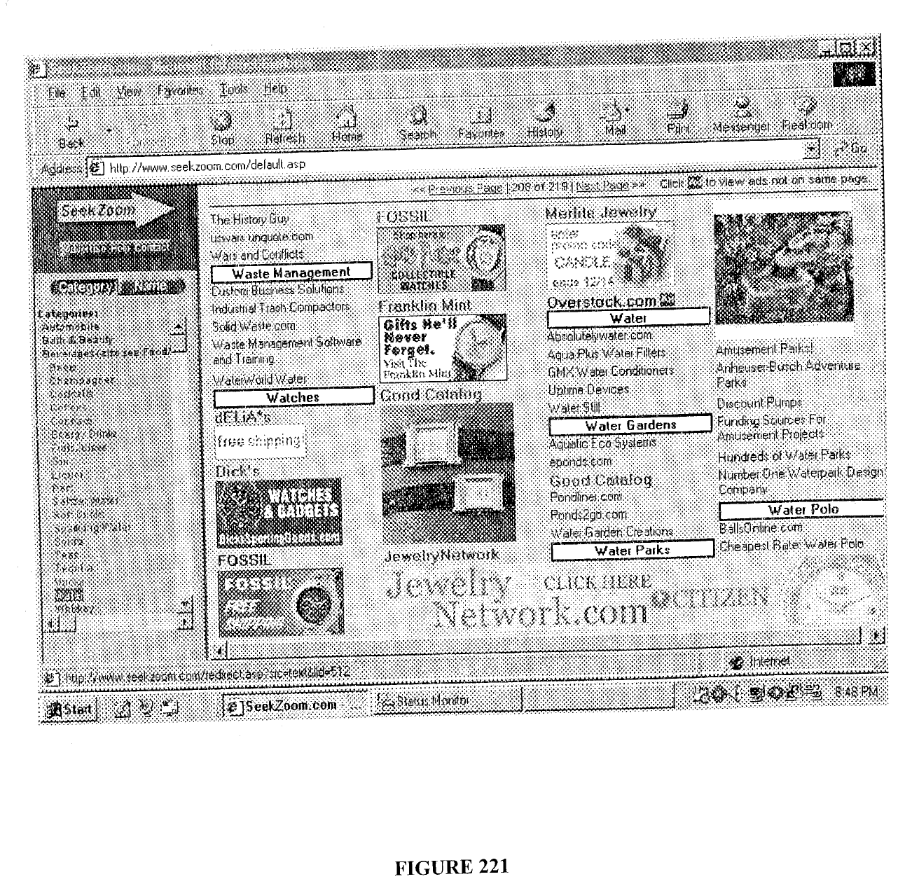

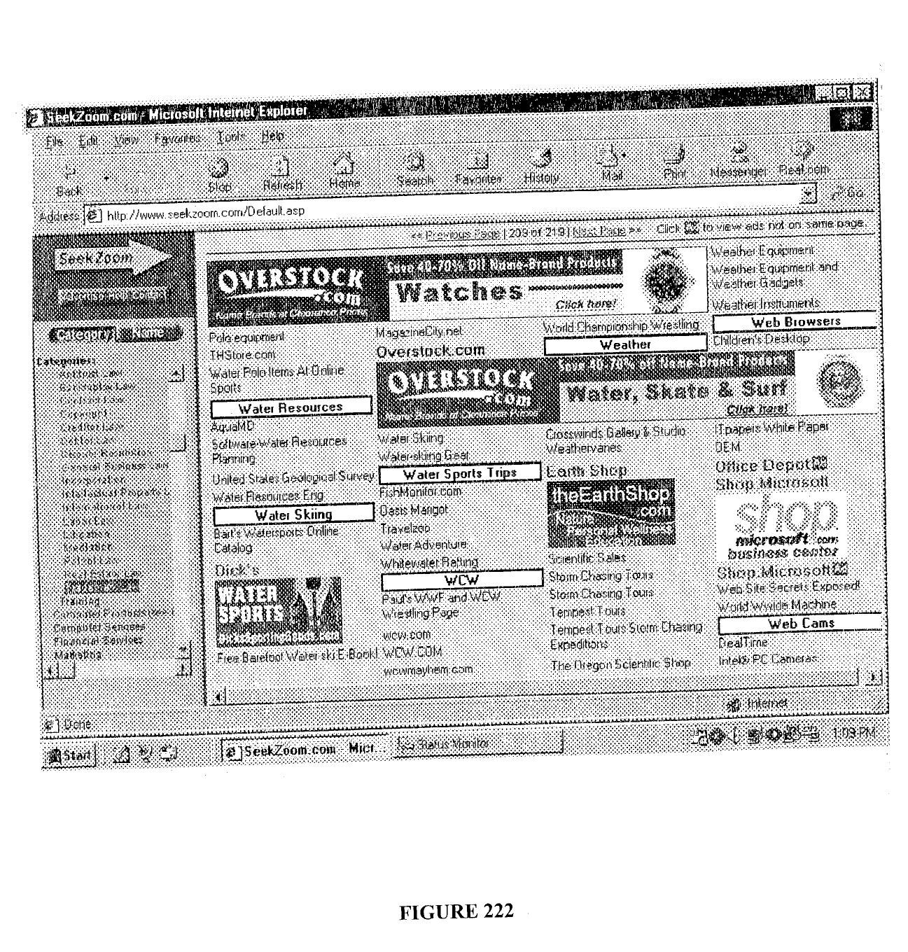

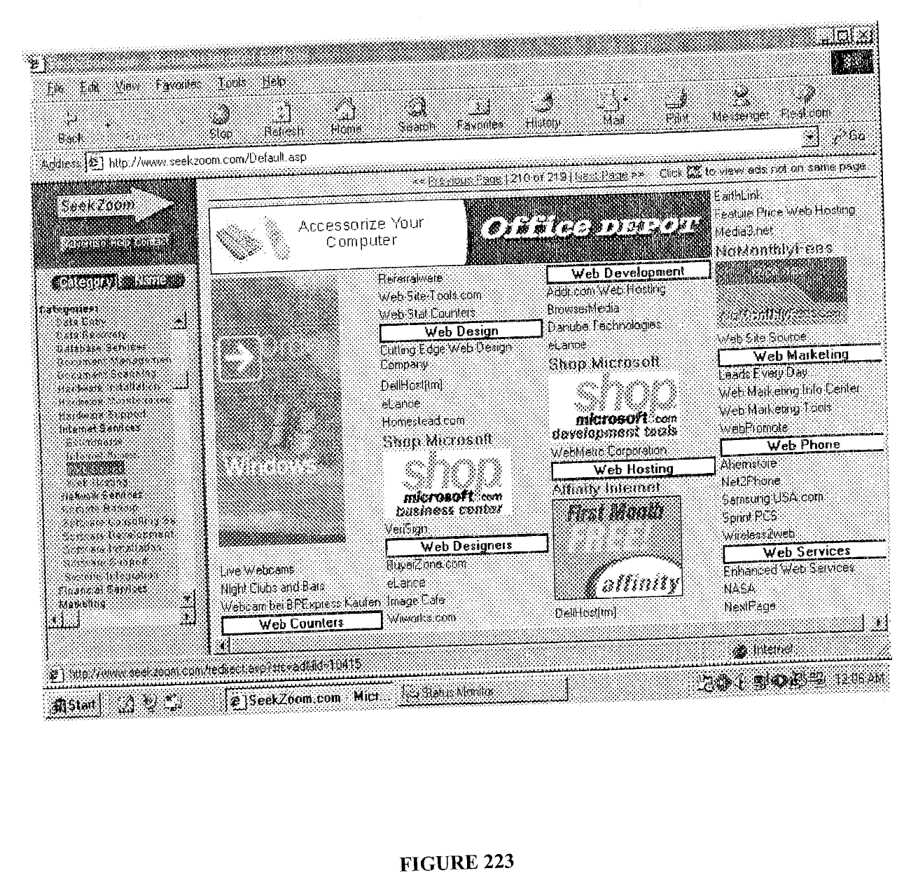

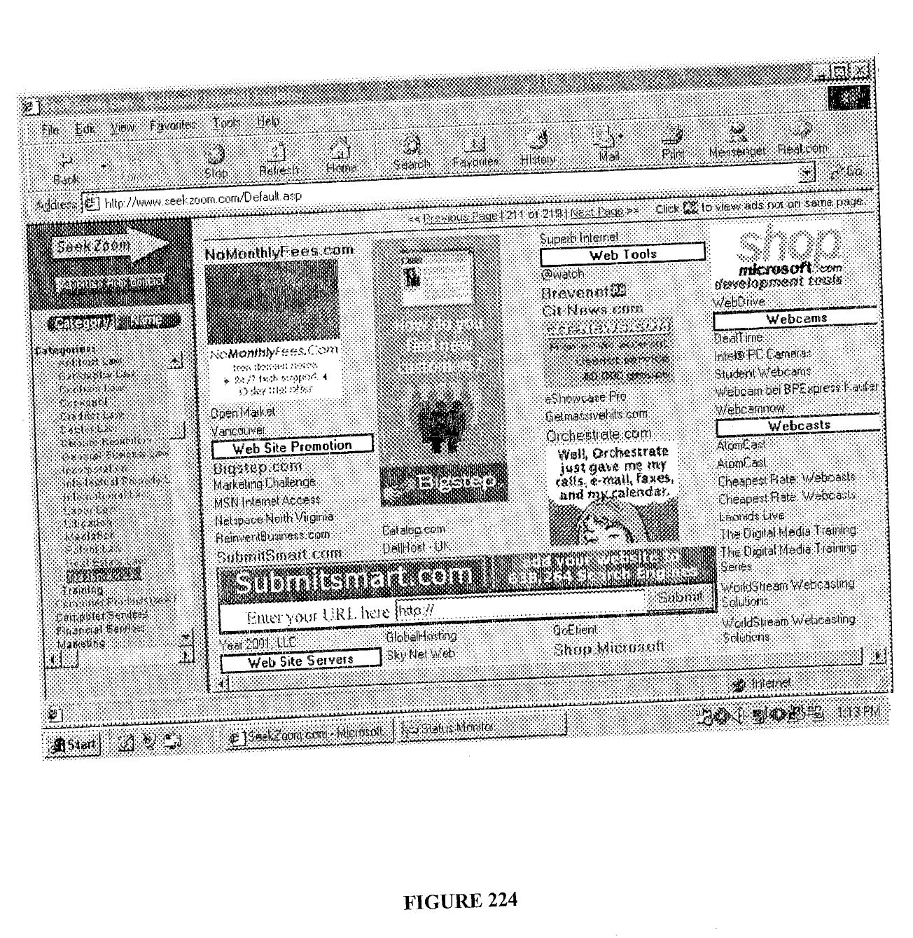

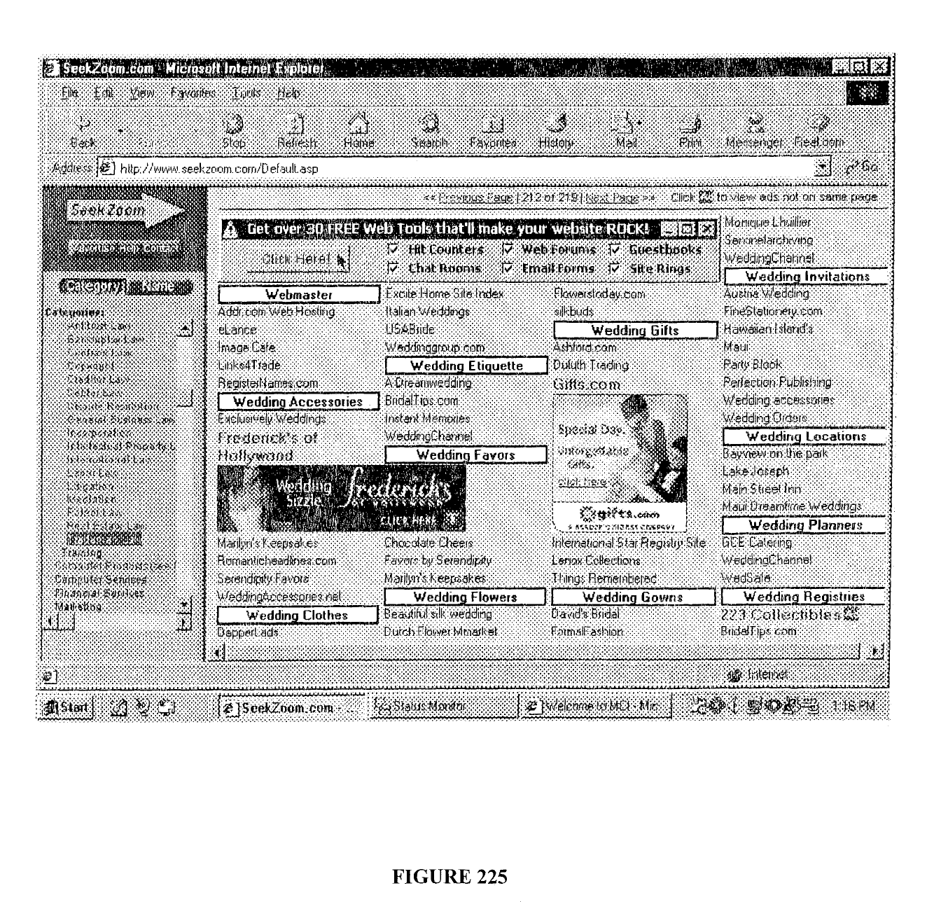

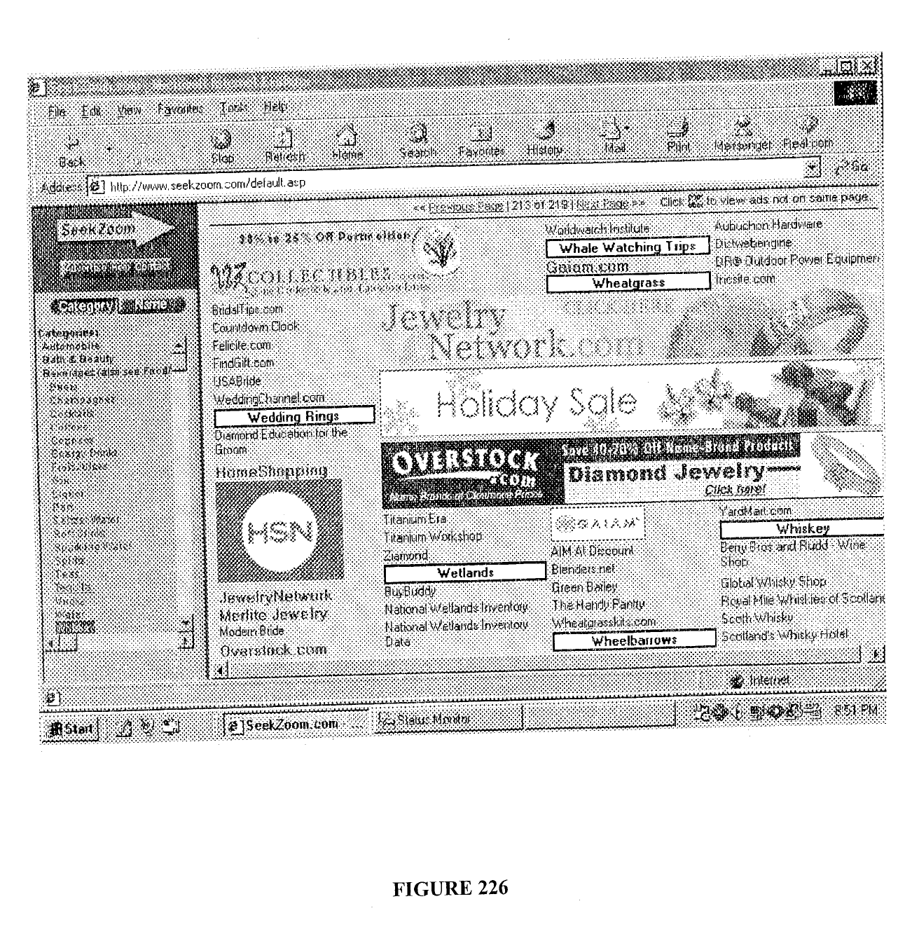

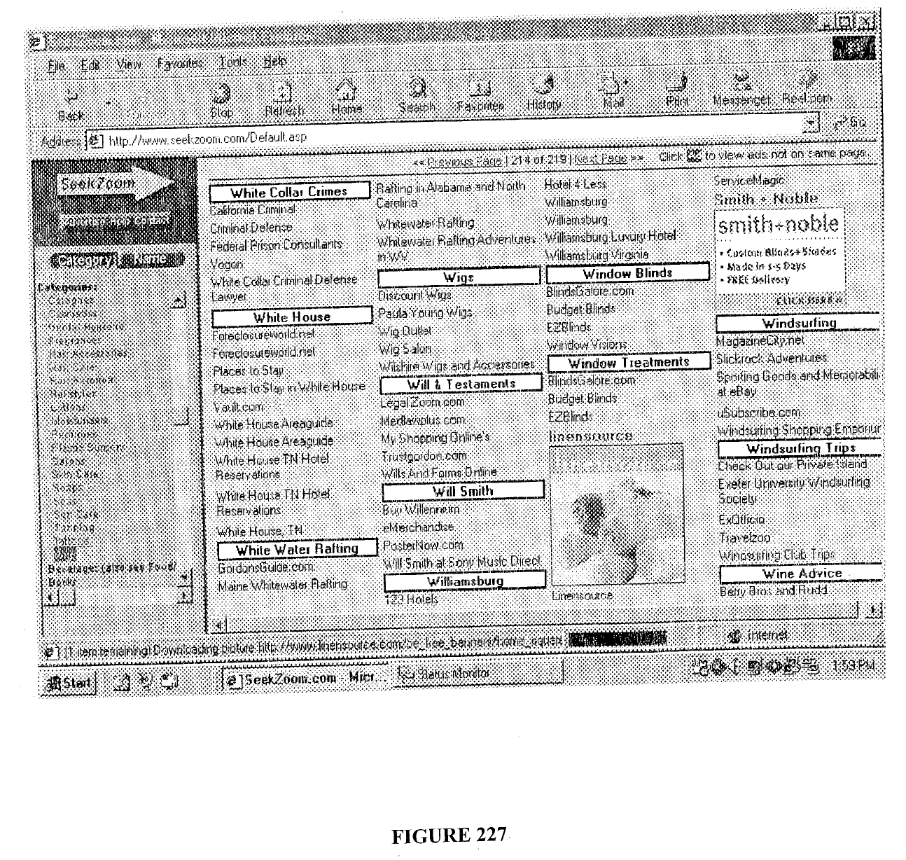

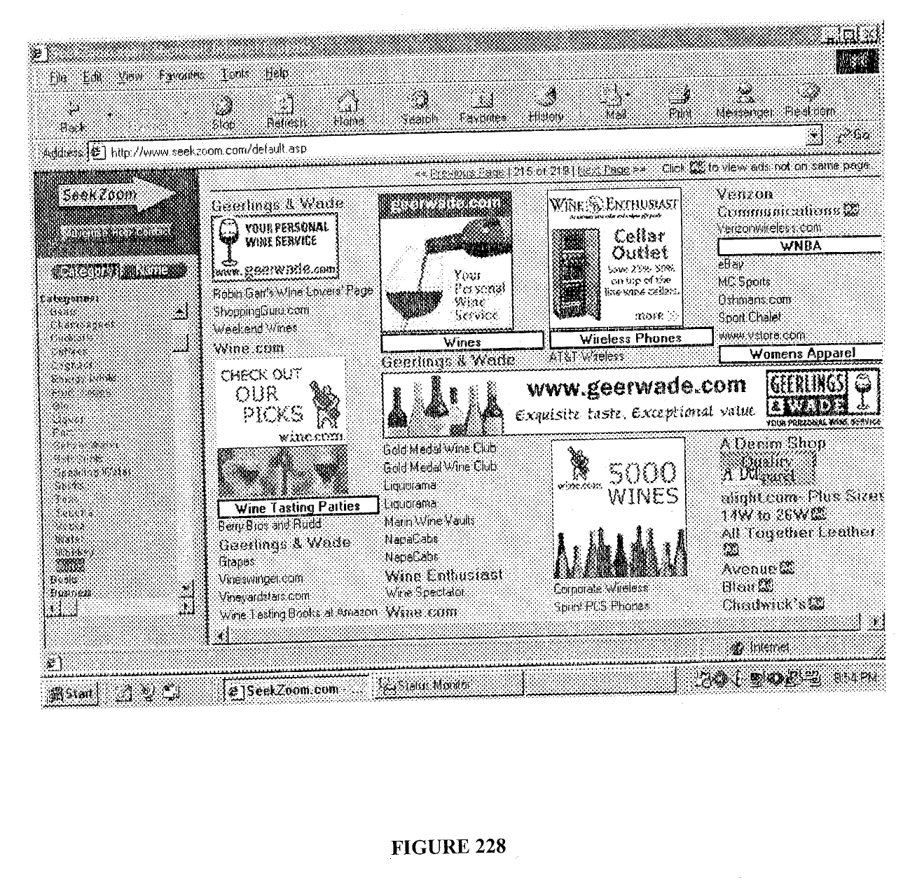

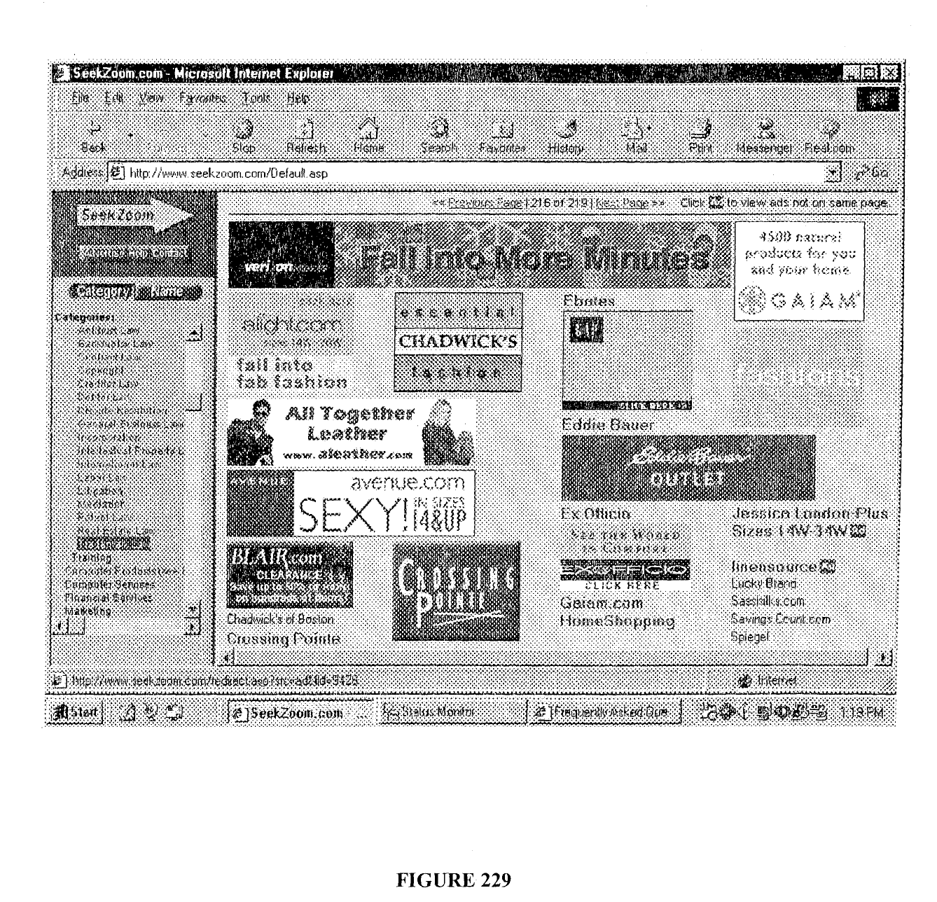

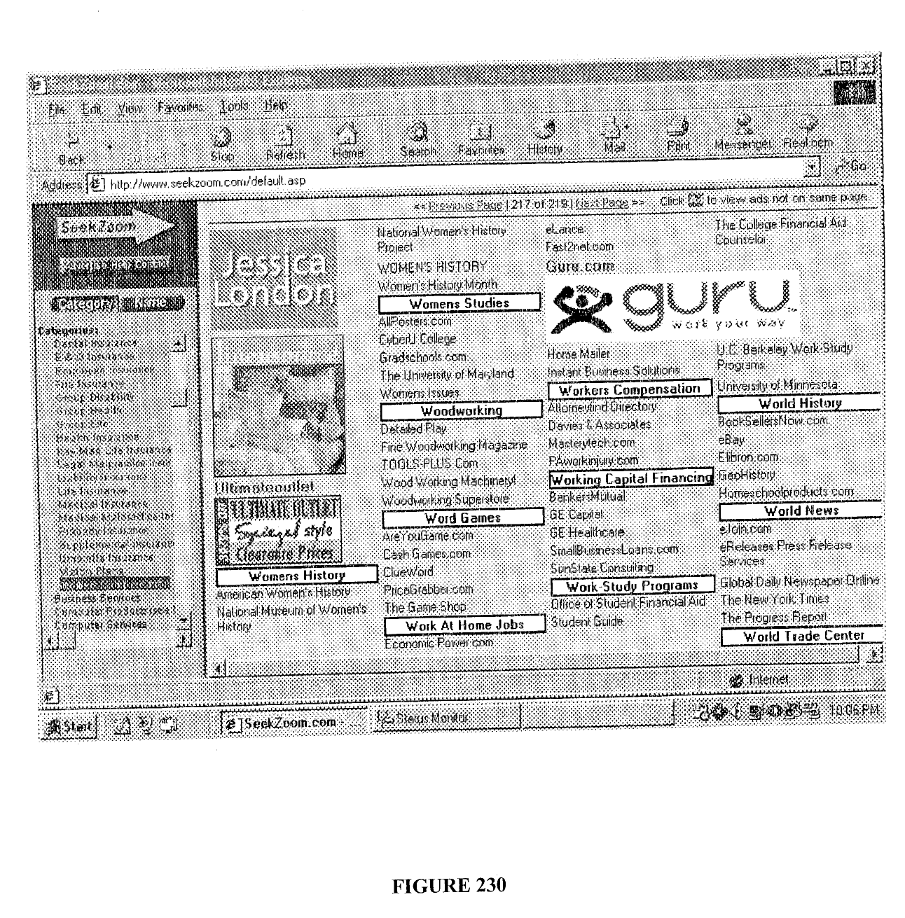

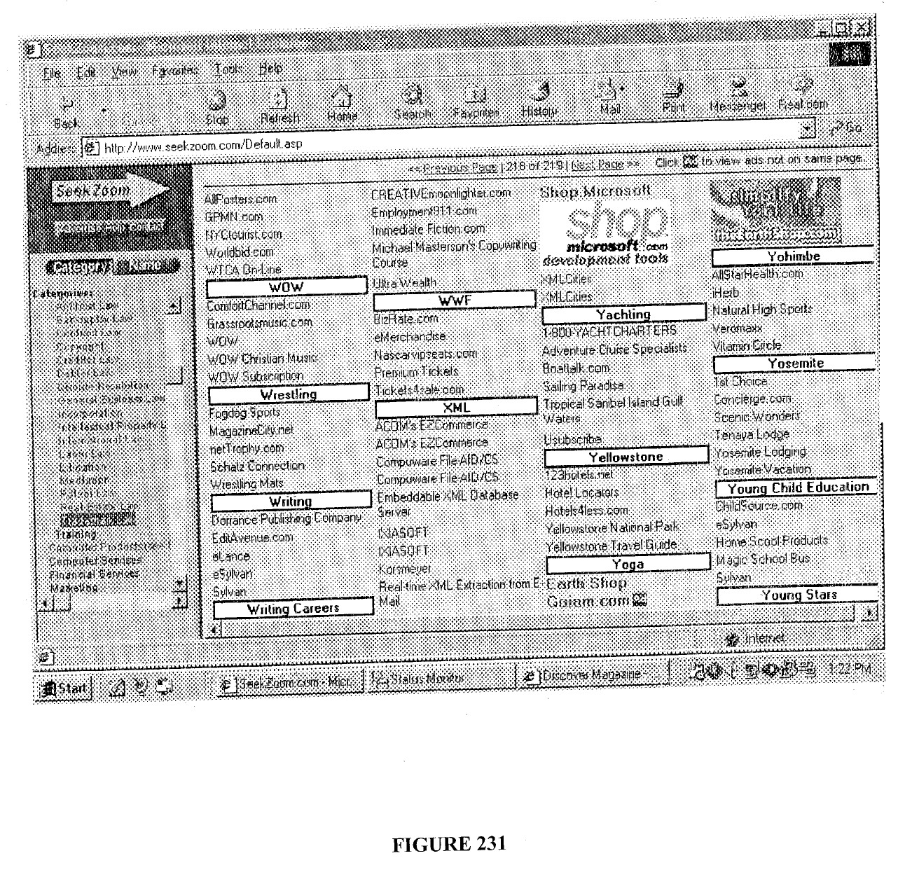

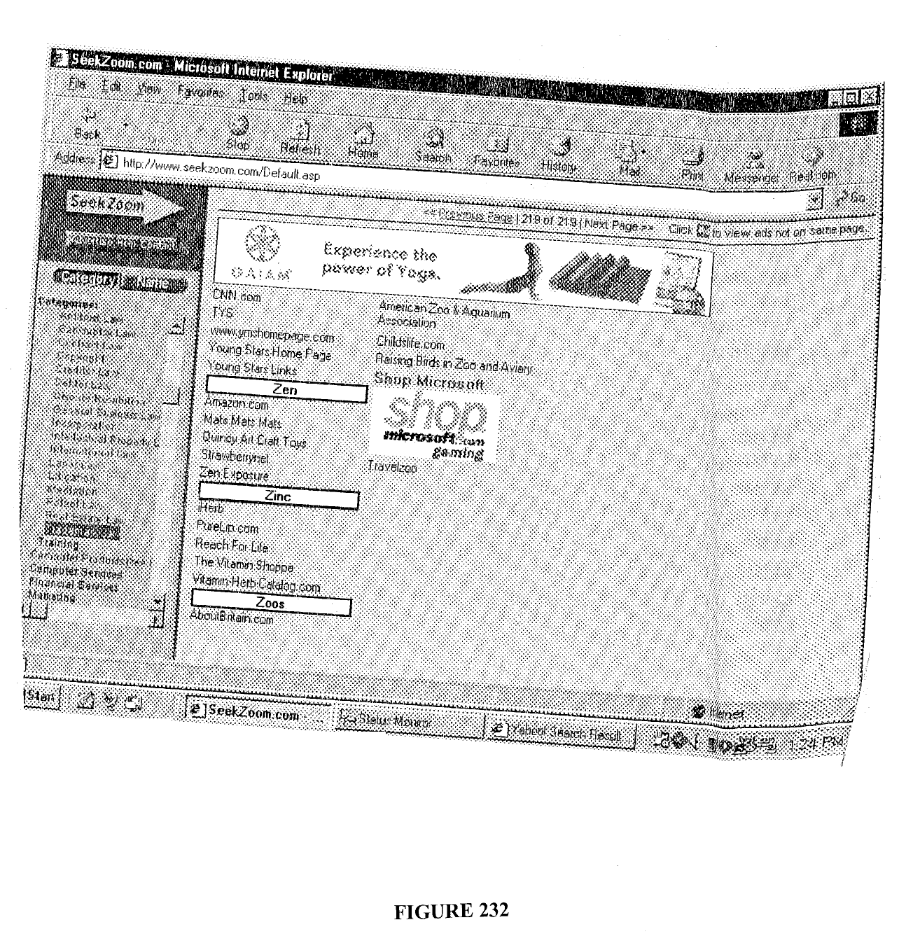

### DESCRIPTION OF THE PREFERRED EMBODIMENT

Business Method Innovation

SeekZoom's Content Generation Optimizer automatically upgrades and integrates an advertiser's data (i.e. name and ad listing) into the preexisting database and reconfigures the content presentation (on the right side of the page) to optimally present this data on the screen page in accordance with any specific limitation and order of that data.

In SeekZoom's case this limitation and order includes:

1) An alphabetic listing of all the and-categories

2) Fitting the company name listing (with the appropriate font size and color) within the proper chosen end-category and presenting it in alphabetic order of all the companies listed in that end-category

3) Presenting these listings in 4 equal vertical columns, progressing from the top left, 1st column to the bottom right, 4th column

4) Placement of the various size graphic (ad/logo) listings as close to the company name listing as possible, while fitting within a 1 to 4 column width and one page height, either on the same page or, if that is not possible, the page closest to the company name listing that is possible to fit that ad (in such cases the company name listing will have a small “Ad” button at the end of it's name listing which when pressed will take the viewer to the page where the company's graphic is listed)

5) The content will be presented in a limited page size (in this case 800×600 pixels) and in successive pages

6) The content page will open to the page that corresponds to the end-category in the left sided frame that was clicked on by the viewer

7) As new advertiser data is entered the content generator will reconfigure itself to optimally integrate this new data into the preexisting one, and present a new content that optimizes the data presentation to most efficiently fill the viewing page, while fulfilling the limits of the above preconditions

8) The content data will be integrated with a category and company name search criteria so that the requested data is easily and quickly retrieved onscreen.

In essence, the Content Generation Optimizer automatically integrates various letter, graphic or other data to optimally fit on a web page while maintaining certain restrictions and requirements in the way that this data is presented and, if needed, integrated with search criteria allowing for quick and easy retrieval of presented data. This allows data to continuously be changed while knowing that the web page presentation will always be configured to both fulfill the set underling preconditions as well as display the most efficient integration of that data onto s web page.

Such combined integrating, optimizing and search capabilities do not currently exist elsewhere on the Internet.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A method for optimizing orderly integration and presentation of a database of listings and related graphics, the method comprising the steps of:
providing an e-commerce directory containing the associated database of listings and related graphics;
providing a search area;
providing a content area;
enabling at least one company name listing to fit within a defined end-category;
presenting the at least one company name listing is alphabetical order;
presenting the at least one company name is substantially equal columns;
presenting information related to the at least one company name listing;
enabling the related graphics to be in relatively close proximity to the company name listing;
receiving additional information related to the at least one company via a global computer network; and,
utilizing a content generator to reconfigure the at least one company name listing to optimally integrate the additional information in order to efficiently fill a viewing page.
